(19) United States
(12) Patent Application Publication
(10) Pub. No.: US 2008/0021778 A1
(43) Pub. Date: Jan. 24, 2008

(54) Web-based brand marketing communication network for enabling e-commerce transactions using Multi-Mode Virtual Kiosks (MMVKS)

(75) Inventors: Thomas J. Perkowski, Darien, CT (US); Vaibhava Muchhal, Darien, CT (US)

Correspondence Address: Thomas J. Perkowski, Esq., P.C.;Soundview Plaza, 1266 East Main Street, Stamford, CT, 06902, US

(73) Assignee: IPF, Inc., Stamford, CT (US)

(21) Appl. No.: 11/823,828

(22) Filed: Jun. 28, 2007

Related U.S. Application Data
(63) Continuation-in-part of application No. 11/477,205, filed on Jun. 28, 2006.
Application No. 11/477,205 is a continuation-in-part of application No. 10/876,261, filed on Jun. 24, 2004.
Application No. 10/876,261 is a continuation-in-part of application No. 10/812,341, filed on Mar. 29, 2004.
Application No. 10/812,341 is a continuation-in-part of application No. 10/693,856, filed on Oct. 24, 2003.
Application No. 10/693,856 is a continuation-in-part of application No. 10/602,990, filed on Jun. 24, 2003.
Application No. 10/602,990 is a continuation-in-part of application No. 09/716,848, filed on Nov. 17, 2000.
Application No. 09/716,848 is a continuation-in-part of application No. 09/695,744, filed on Oct. 24, 2000.
Application No. 09/695,744 is a continuation-in-part of application No. 09/641,908, filed on Aug. 18, 2000, now abandoned.
Application No. 09/641,908 is a continuation-in-part of application No. 09/599,690, filed on Jun. 22, 2000, now abandoned.
Application No. 09/599,690 is a continuation-in-part of application No. 09/483,105, filed on Jan. 14, 2000, now abandoned.
Application No. 09/599,690 is a continuation-in-part of application No. 09/465,859, filed on Dec. 17, 1999, now abandoned.
Application No. 09/465,859 is a continuation-in-part of application No. 09/447,121, filed on Nov. 22, 1999, now Pat. No. 6,625,581.
Application No. 09/465,859 is a continuation-in-part of application No. 09/284,917, filed on Apr. 21, 1999, now abandoned.

(51) Int. Cl. G06Q 30/00

(52) U.S. Cl. 705/14

(57) ABSTRACT

Internet-based enterprise-level Brand Marketing Communication and E-Commerce Enabling Network which provides brand owners command and control over the wide range of brand-building assets, messaging and promotions scattered throughout the Web, and how they are communicated to directly consumers at diverse Web touch points, using server-side driven Multi-Mode Virtual Kiosks (MMVKS) having client/brand/agency and consumer programmable modes of display, as well as transaction tracking and commission-earning services, so as to provide better ways of and means for brand marketers and their agencies to reach empowered consumers, involving and enaging them with the client's brand in new ways, so as to create value and build loyalty, in a participatory manner.

### RELATED CASES

This Application is a Continuation-in-Part of copending application Ser. No. 11/477,205 filed Jun. 28, 2006; which is a Continuation-in-Part of Ser. No. 10/876,261 filed June 24, 2004, which is a Continuation-in-Part of application Ser. No. 10/812,341 filed Mar. 29, 2004, which is a Continuation-in-Part of application Ser. No. 10/693,856 filed Oct. 24, 2003, which is a Continuation-in-Part of application Ser. No. 10/602,990 filed Jun. 24, 2003, which is a Continuation-in-Part of application Ser. No. 09/716,848 filed Nov. 17, 2000; which is a Continuation-in-Part of application Ser. No. 09/695,744 filed Oct. 24, 2000 which is a Continuation-in-Part of application Ser. No. 09/641,908, filed Aug. 18, 2000 which is a Continuation-in-Part of copending application Ser. No. 09/599,690 filed Jun. 22, 2000; which is a Continuation-in-Part of copending application Ser. No. 09/483,105, filed Jan. 14, 2000; application Ser. No. 09/465,859 filed Dec. 17, 1999, now abandoned; which is a Continuation-in-Part of copending application Ser. No. 09/447,121 filed Nov. 22, 1999; copending application Ser. No. 09/441,973 filed Nov. 17, 1999; which is a Continuation-in-Part of application Ser. No. 09/284,917 filed Oct. 27, 1999, now abandoned, wherein each said Application is commonly owned by IPF, Inc., and is incorporated herein by reference in its entirety as if fully set forth herein.

### BACKGROUND OF INVENTION

1. Field of Invention

The present invention generally relates to a novel Internet-based method of and system for educating consumers and marketing branded products and services thereto within both electronic physical and retail environments.

2. Brief Description of the State of the Art

Billions of dollars are spent each year by manufacturer brands to inform, influence, and persuade consumers to buy and consume their branded products and services.

To create demand for their products and services, Client/brands enlist advertising and marketing agencies to achieve greater leverage and capacity to reach and influence empowered consumers to buy their products and consume their services.

Most marketing communication firms promise their client/brands the ability to impact consumers in the most effective manner. However, even with the “clout” of their extensive global networks, best creative talents, and multi-disciplinary advertisement and promotional agencies, these firms are unable to deliver on that promise where it matters, that is, at points of consumer purchase consideration and sale.

At the same time, returns from traditional marketing mediums such as TV, radio, print, and trade sources continue to decline as consumer lifestyles and buying behaviors change. Furthermore, while cable and broadcast TV advertising is still the most expensive marketing medium to produce, and provides high-production and placement control, this median lacks in effectiveness by not being present at points of consumer purchase consideration and sale. And while in-store TV advertising networks like PRN provide significantly improved marketing effectiveness over traditional cable and broadcast TV networks, such networks do not reach consumers at online points of purchase consideration and sale.

While the potential for marketing efficacy is highest at the retail point-of-sale, manufacturer brands typically have little of no control over the consumer experience with their branded products, and this aspect of brand control resides with the online retailer. And as consumers turn to their favorite retail websites to find product information, promotions, and ultimately to purchase products, the opportunity for brands to truly engage consumers at the online retail point of sale is neither available of possible, unless the manufacturer brand controls and operates its own e-commerce enabled retail site, as some larger brands do, while other manufacturer brands hire e-commerce enablers, such as GSI Commerce, to transparently manage and operate their entire e-commerce store operations, under the name of the manufacturer brand.

However, most big-box retail websites continue to represent branded products in a monotonous manner, leaving very little distinction between brands. As consumers browse through products on such online retail stores, they typically miss out on the brand experience which the manufacturer and their agencies work very hard to create and deliver elsewhere in the global marketplace. Consequently, it is very difficult for manufacturer brands and their agencies to be effective in creating demand and inspiring purchases at online points of purchase consideration and sale.

To make online marketing even more difficult for client/brands and their agencies, most online retailers avoid the use of push-type marketing technologies such as pop-up and banner advertisements on their e-commerce sites, as these marketing technologies are generally annoying to consumers, and fail to deliver relevant messaging to the consumer considering a product purchase.

In recent times, many marketers have come to understand the potential of empowering consumers with more richer product information, and have begun investing in creating rich media product presentations. However, while some online creative shops, such as Vendaria, Sellpoint (formerly Tentoe), and Kaon have made efforts at delivering these rich media product presentations and demonstrations at the online point of product display and purchase consideration, sometimes with the assistance of Web Collage's Syndicator™ product information delivery system, most of these rich media presentations still continue to reside on the manufacturers' website.

With the growing ineffectiveness of traditional marketing mediums and the unrealized potential of online retail point of sale, a great need has arisen in the global marketplace for a better way of, and means for enabling manufacturer client/brands and their marketing agencies to more effectively and efficiently reach, serve and influence empowered consumers at online points of purchase consideration and sale, so as to provide consumers with improved service and better brand experiences at the online point of sale, while helping online retailers build their own brands, reduce online store overhead, and drive sales, while avoiding the shortcomings and drawbacks of prior art systems and methodologies.

In WIPO Publication Nos. WO 01/37540 A2 published on May 25, 2001 and WO 2005/001656 A2 published on Jan. 6, 2005, Applicants teach how to practice a revolutionary new marketing communication medium which empowers client brands and their marketing communication agencies to efficiently orchestrate the client/brands brand-building information resources, so as to deliver brand experiences to consumers at the online point of sale, and purchase consideration, in ways which brand marketing managers intend, in effort to provide consumers with effective decision support, brand value and service, while helping the online retailer to reduce its e-commerce store overhead, build the retailer's brand, and drive sales.

However, despite such significant advances in online brand information management and marketing communication processes, there is still a great need for even better ways of reaching empowered consumers, involving and engaging them with the manufacturer's brand in new ways, so as to create value and build loyalty, in a participatory manner.

### OBJECTS OF THE INVENTION

Accordingly, a primary object of the present invention is to provide a novel method of and apparatus for enabling brand owners to manage (command) and tightly control product and service related brand marketing communications to consumers anywhere along the World Wide Web (WWW) in both physical and electronic retail shopping environments, while overcoming the shortcomings and drawbacks of prior art systems and methodologies.

Another object of the present invention is to provide such apparatus in the form of a novel Enterprise-Level Brand Management And Marketing Communication Network based on an innovative brand command, control and communication architecture (BC3), which gives brand owners complete command and control over the wide range of brand-building assets, messaging and promotions scattered throughout the Web, and how they are communicated to directly consumers at diverse Web touch points, with the efficiency and automation of supply-chain management solutions.

Another object of the present invention is to provide such an Enterprise-Level Brand Management And Marketing Communication Network that fuels the “front-office” revolution by allowing manufacturer and retail brands to improve the customer experience along all channels and touchpoints.

Another object of the present invention is to provide an Internet-based Brand Management And Marketing Communication Instrumentation network for deploying, installing and remotely programming brand-building server-side driven Multi-Mode Virtual Kiosks on the World Wide Web (WWW).

Another object of the present invention is to provide an Enterprise-Level Brand Management And Marketing Communication Network, wherein brand management team members display richly-associated brand-building information resources, including ad and promo messages, during the choreographed display modes of a “Multi-Mode Virtual Kiosk” which consumers can launch anywhere on the Web to obtain in-depth information about a brand, as well as rich media images and the latest promotions on a real-time basis.

Another object of the present invention is to provide an Internet-based brand marketing communication network for enabling commission-based e-commerce transactions along the fabric of the world wide web (WWW) using server-side driven MMVKs that are hosted by affiliates who can earn sales commissions on consumer transactions with manufacturers or retailers, that have been initiated through affiliate hosted MMVKs.

Another object of the present invention is to provide an Enterprise-Level Brand Management And Marketing Communication Network, wherein e-commerce transactions conducted through or initiated by a Multi-mode Virtual Kiosks can be tracked and monitored in real-time, and sales commissions to be paid to the hosters of such MMVKs (i.e. affiliates) on their sites or Web properties can also be tracked and managed so as to ensure payments are properly made to such affiliates.

Another object of the present invention is to provide such an Enterprise-Level Brand Management and Marketing Communication Network, wherein registered retailers or manufacturers who deploy e-commerce enabling MMVKs along the fabric of the WWW, can monitor consumer transaction conducted through or initiated by the MMVKs and well as set commissions to be paid to affiliates who host the MMVKs, and wherein the registered affiliates can track and monitor commissions earned on MMVKs installed on their Web sites or other Web properties, so as to ensure that payments due are timely made to such affiliates by the associated retailers or manufacturers.

Another object of the present invention is to provide such an Enterprise-Level Brand Management and Marketing Communication Network, wherein charities can register on the Network and receive donations paid through sales commission earned by affiliates who install e-commerce enabling MMVKs on their Web sites or other Web properties, and wherein affiliates can designate whether all or a portion of earned sales commissions are to be paid to particular charities registered on the Network.

Another object of the present invention is to provide such an Enterprise-Level Brand Management and Marketing Communication Network, wherein e-commerce enabling MMVKS can function as server-side driven storelets (i.e. sales outlets) having multiple modes of display that can be easily programmed to drive commerce using powerful Web-based content programming tools that can be implemented using visual content libraries with thumb name images of all content managed on the Network, as well as “drag-and-drop” programming principles.

Another object of the present invention is to provide such an Enterprise-Level Brand Management and Marketing Communication Network which provides manufacturer and retail brands with a powerful communication studio for dynamically programming the content of MMVKs installed along various marketing and sales channels.

Another object of the present invention is to provide an Internet-based enterprise-level Brand Marketing Communication and E-Commerce Enabling Network which provides brand owners command and control over the wide range of brand-building assets, messaging and promotions scattered throughout the Web, and how they are communicated to directly consumers at diverse Web touch points, using server-side driven Multi-Mode Virtual Kiosks (MMVKs) having client/brand/agency and consumer programmable modes of display, as well as transaction tracking and commission-earning services, so as to provide better ways of and means for brand marketers and their agencies to reach empowered consumers, involving and engaging them with the client's brand in new ways, so as to create value and build loyalty, in a participatory manner.

Another object of the present invention is to provide property registration services in a Web-based brand marketing communication network supporting the deployment of server-side driven multi-mode virtual kiosks (MMVKs), so as to allow web-based property owners and/or their agents to register web-based properties for authorized placement of MMVKs on the brand marketing communication network.

Another object of the present invention is to provide placement fee negotiation services in a Web-based brand marketing communication network supporting the deployment of server-side driven multi-mode virtual kiosks (MMVKs), so as to allow web-based property owners and/or their agents to negotiate placement fees for authorized placement of MMVKs on web-based properties registered on the brand marketing communication network.

Another object of the present invention is to provide MMVK placement services in a Web-based brand marketing communication network supporting the deployment of server-side driven multi-mode virtual kiosks (MMVKs), so as to allow client/brands and/or their agents to place MMVKs on web-based properties registered on the brand marketing communication network.

Another object of the present invention is to provide automated work flow management services in a Web-based brand marketing communication network supporting the deployment of server-side driven multi-mode virtual kiosks (MMVKs), so as to allow automated management of work flow on the brand marketing communication network.

Another object of the present invention is to provide a MMVK-powered Retail Display Appliance (RDA) having bar code reading capabilities to support price look up operations.

These and other objects of the present invention will become apparent hereinafter and in the Claims to Invention.

### BRIEF DESCRIPTION OF THE DRAWINGS

For a more complete understanding of how to practice the Objects of the Present Invention, the following Detailed Description of the Illustrative Embodiments can be read in conjunction with the accompanying Drawings, briefly described below.

FIG. 1A1 through 1A8 sets forth a selected group of screens of a storyboard presentation describing briefly how the Internet-based Brand Management, Marketing Communication and Commerce-Enabling Instrumentation Network (i.e. “Brand Marketing Communication Network”), with its server-side driven, brand-building Multi-Mode Virtual Kiosks (MMVKs), helps brand marketers rise above online clutter, in accordance with the principles of the present invention;

FIG. 2A is a high-level schematic representation of the Internet-based Brand Marketing Communication Network of the present invention, shown realized as an industrial-strength, carrier-class Internet-based communications network of object-oriented system design (OOD), implemented using a Java-based object-oriented integrated development environment (IDE) such as WebObjects 5.2 by Apple Computer Inc, Websphere IDE by IBM, or Weblogic IDE by BEA;

FIG. 2B is a systems block diagram of the Internet-Based Marketing Communication Network of the present invention, deployed on the globally-extensive packet-switched information network supporting numerous industries on the planet Earth, comprising diverse kinds of subsystems and network components thereon, as shown;

FIGS. 3A and 3B are schematic representations of two alternative implementations of the enterprise-level Brand Marketing Communications Network of the present invention using the WebObjects IDE and Java Application Server;

FIG. 4 is a table setting forth definitions of terms used throughout the present detailed description of the Brand Marketing Communication Network of the present invention;

FIG. 5 is a schematic diagram of the relational database management system (RDBMS) used to store the persistent enterprise objects associated with the Brand Marketing Communication Network of the illustrative embodiment of the present invention;

FIG. 6A is the home-page located GUI panel of the Internet-based Brand Marketing Communication Network of the present invention which, as shown, comprises five separate Subsystems that support User Services, namely, Brandkey Manage™ Subsystem, the Brandkey Create™ Subsytem, Brandkey Deliver™ Subsystem, the Brandkey Advertise™ Subsystem, and the Brandkey Promote™ Subsystem;

FIGS. 6B1 through 6B10, taken together, sets forth a table listing the numerous marketing information service suites and instruments supported by the Brand Management and Marketing Communication Network of the present invention;

FIGS. 7A through 7C set forth a select group of GUI panels facilitating access to marketing information services supported by the Brandkey Manage™ Subsystem;

FIGS. 7D through 7J set forth a select group of GUI panels facilitating access to metrics reporting services supported by the Brandkey® Metrics Suite within the Brandkey Manage™ Subsystem;

FIGS. 8A through 8C set forth a select group of GUI panels facilitating access to marketing information services supported by the Brandkey Create™ Subsytem;

FIGS. 9A through 9C set forth a select group of GUI panels facilitating access to marketing information services supported by the Brandkey Deliver™ Subsystem;

FIGS. 10A through 10C set forth a select group of GUI panels facilitating access to marketing information services supported by the Brandkey Advertise™ Subsystem; and

FIGS. 11A through 11C set forth a select group of GUI panels facilitating access to marketing information services supported by the Brandkey Promote™ Subsystem;

FIG. 11D illustrates an exemplary process describing how a vendor brand manager can work with a retailer brand manager to use the Brand Management and Marketing Communications Network of the present invention in order to deploy and install Product-Specific Multi-Mode Virtual Kiosks on the retailers WWW site at points of virtual product display;

FIGS. 12A through 12F2, taken collectively, set forth GUI panels supported by a Product-Specific (PS) Multi-Mode Virtual Kiosk (MMKV) deployed and remotely programmed by the enterprise-level, collaboration-enabling Brand Management and Marketing Communication Network of the present invention;

FIG. 12G sets forth the GUI panel supported by an alternative embodiment of the Product-Specific (PS) Multi-Mode Virtual Kiosk (MMKV) deployed and remotely programmed by the enterprise-level, collaboration-enabling Brand Management and Marketing Communication Network of the present invention, wherein the manufacturer client/brand is provided with the option of enabling a fourth additional mode of display (at the time of MMVK creation and installation) allowing a consumer, or other party, wishing to install and host a MMVK on its Web-based property, so as to program consumer generated or sponsored content (e.g. user-uploaded video, user-generated text and/or other graphics, for display during this fourth (i.e. personal or MyMode™) mode of programmable display, as shown, which can be useful in connection with the affiliate marketing communication services described in connection with FIGS. 17 through 21I;

FIGS. 13A and 13B, taken together, set forth a schematic state diagram of a Multi-Mode Virtual Kiosk (MMKV), having a fourth CGC display mode of display enabled, as shown in FIGS. 12A through 12G, illustrating the various states of operation thereof in response to interaction by a consumer with the GUIs of the MMVK;

FIG. 14 is a schematic state diagram illustrating the operation of the automatic client browser and media player detection subsystem of the present invention, embodied with both the client side (i.e. MMVK) and server side of the Marketing Communication Network of the present invention;

FIG. 15A is a first implementation of a Multi-Mode Virtual Kiosk of the present invention, employing HTML, and an Embedded Media Player;

FIG. 15B is a second implementation of a Multi-Mode Virtual Kiosk of the present invention, employing HTML, Flash and an Embedded Media Player;

FIG. 15C is a third implementation of a Multi-Mode Virtual Kiosk of the present invention, employing D/HTML, and an Embedded Media Player;

FIG. 15D is a fourth implementation of a Multi-Mode Virtual Kiosk of the present invention, employing an Embedded Flash Media Player and embedded Flash-controlled Content Links (associated with the BIN Menu Display Mode of a MMVK);

FIG. 15E is a fifth implementation of a Multi-Mode Virtual Kiosk of the present invention, employing Scalable Vector Graphics (SVG);

FIG. 16A is a graphical representation of an exemplary Web page of a retailer's e-commerce site (i.e. e-store), wherein the MMVK (i.e. HTML) tag associated with a Multi-Product (e.g. Vendor-Specific, Retailer-Specific or Corporate Specific) MMVK of the present invention, is embedded within a banner ad on the retailer's e-commerce site;

FIG. 16B is a graphical representation of the exemplary Web page of the retailer's ecommerce store shown in FIG. 16A, from which a Multi-Specific MMVK, programmed with a number of different products (i.e. UPNs) falling under a particular manufacturer brand (i.e. Trademark), has been launched and is shown running an ad spot for the manufacturer brand in its content display panel, while the different models of MP3 player product available for selection are shown in a horizontally-scrollable product menu section of the GUI of the MMVK;

FIG. 16C is a graphical representation of the exemplary Web page of the retailer's ecommerce store shown in FIG. 16B, wherein the Multi-Product MMVK is shown running an promo spot for the manufacturer brand in its content display panel, while the different models of MP3 player product available for selection are shown in a horizontally-scrollable product menu section of the GUI of the MMVK;

FIG. 16D is a graphical representation of the Multi-Product MMVK shown in FIGS. 16B through 16C, wherein the ad or promo spot for the product brand running is interrupted when the user selects a particular product from the product menu stage section of the MMVK GUI, at which time, the MMVK plays the preprogrammed ads, promos and brand information links for the selected branded product;

FIG. 16E is a graphical representation of the Multi-Product MMVK of FIG. 16B, wherein after the ad and promo display modes have been played through in their programmed sequence, a particular brand information link has been selected from the brand information menu section of the MMVK GUI, during the third displayed Brand Information (Info) Network display mode, and in response thereto, the product information page is displayed in the display area of the Retailer-Specific MMVK;

FIG. 16F is a graphical representation of the Multi-Product MMVK of FIG. 16E, wherein after the Brand Information Network display mode has displayed a menu of information links, the consumer selects a first one of the displayed information links, and in response thereto, the product information page is displayed in the display area of the Retailer-Specific MMVK;

FIG. 16G is a graphical representation of the Multi-Product MMVK of FIG. 16F, wherein after the Brand Information Network display mode has displayed a menu of information links, the consumer selects a second one of the displayed information links, and in response thereto, another product information page is displayed in the display area of the Retailer-Specific MMVK;

FIG. 16H is a graphical representations of the Multi-Product MMVK of FIG. 16G, wherein the user scrolls forward through the brand information link scroll bar in the MMVK GUI, so as to make other programmed information links viewable and accessible to the user;

FIG. 16I is a graphical representation of the Multi-Product MMVK, wherein the user selects a different product from the product menu selection section of the MMVK GUI;

FIG. 16J shows a graphical representation of the Multi-Product MMVK displaying, in the content display section of the MMVK GUI, a particular brand information link (i.e. “Enjoy Uncertainty”) from the brand information display area of the MMVK GUI;

FIG. 16K is a graphical representation of the Multi-Product MMVK displaying, in the content display are of the MMVK GUI, another particular brand information link (i.e. “1,000 Songs . . . ”) from the brand information display area of the MMVK GUI

FIGS. 16L and 16M show graphical representations of the Multi-Product MMVK of FIG. 16K, wherein the user selects the Shop Now (i.e. Buy Now) button on the MMVK GUI which then automatically (and seamlessly) takes the consumer/user to the Check Out page of the retailer's ecommerce site (shown in FIG. 16M), so as to enable the consumer to consummate the purchase of the selected product;

FIG. 17 is a schematic representation of Web-based MMVK-driven marketing communication and e-commerce enabling network of the present invention (i.e. Brand Marketing Communication Network), illustrated in FIG. 2B, and showing how its Web, Application and Database Servers are integrated with the Web servers associated with retailer e-commerce sites as well as Web sites hosting e-commerce transaction enabling MMVKs of the present invention (i.e. provided with a “Buy Now” or like button and having network affiliate services enabled), and further illustrating how e-commerce transactions enabled by MMVKs installed on affiliate Web sites and other properties, as well as sales commissions earned therethrough by network affiliates, are automatically tracked and managed by the Brand Marketing Communication Network, wherein Java-enabled Application Server B hosts the Brand Marketing Communication Network Application, wherein Java-enabled Application Server D hosts the MMVK Serving Application, wherein the Application Server B also provides registered affiliate Web sites with the necessary MMVK tags to launch sponsored MMVKs (using Application Server D), and once launched, installed MMVKs automatically send, detailed consumer metric data back to the Application Server B, and the MMVK allows the consumer to begin a transaction in the specified retailer's shopping cart, wherein the retailer's e-commerce process is customized with a Transaction Tracking Script (TTS) so that the Brand Marketing Communication Network is able to track all MMVK-initiated transactions from beginning to completion, wherein the Transaction Tracking Script (TTS) is provided to retailers via the Transaction/Commission Management/Tracking Server, C, and wherein Transaction/Commission Management/Tracking Server receives data from the Retailers' e-commerce engines regarding all MMVK-initiated transactions, and the Transaction/Commission Management/Tracking Server C processes all transaction data received from the e-commerce engines, generates commissions data for all affiliates, and transfers that commission data to the Application Server B for storage on the Database Server A;

FIG. 18 is a description of the technical details underlying the e-commerce enabling and tracking process of the present invention that is carried out on the global communication network depicted in FIG. 17, whereby e-commerce enabling MMVK are deployed, installed and operated on the Brand Marketing Communication Network of the present invention, with automatic retail transaction and sales commission tracking services being enabled in accordance with the principles of the present invention;

FIG. 19A is schematic representation indicating the higher-level process that occurs among retailers, manufacturers, affiliates and consumers during the execution of the e-commerce enabling and tracking process of the present invention carried out on the global communication network depicted in FIG. 17, including the installation of e-commerce enabling MMVKs by affiliates on Web sites and/or related properties, the initiation of e-commerce transactions through these MMVKS by consumers, the automatic tracking of e-commerce transaction initiated through installed MMVKs, and the automatic tracking of commission earned by affiliates through such transactions, in accordance with the principles of the present invention;

FIG. 19B is a description of the flow of events associated with the higher-level process associated with FIG. 19A;

FIG. 20 is a description of the flow of events that occur when an affiliate installs a MMVK on a Web site or property (as indicated in Step 3 of FIG. 18A) using the network of the present invention with transaction and commission tracking services enabled.

FIG. 21A is a graphical representation of the home page of an exemplary weblog hosting site which is driven by the Web-based MMVK-driven marketing communication and e-commerce enabling communication network of the present invention, depicted in FIGS. 2A and 17, wherein transaction and commission tracking services enabled so as to enable affiliates can earn sales commissions by installing e-commerce enabling MMVKs (e.g. e-stands™) of manufacturers and/or retailers, on affiliate web sites and/or properties (e.g. web-log sites);

FIG. 21B is a graphical representation of a web page an exemplary weblog hosting site, wherein during Step 1 of the MMVK set up process, the User (i.e. Affiliate) enters the Affiliate Area of an Affiliate Program (e.g. e-Stand™ Affiliate Program) that is made accessible on a weblog hosting site through a branded link, and if this is the first time the affiliate has visited the Affiliate Area, then the Web hosting site will ask the affiliate to confirm his or her user information against what was provided by them to their weblog hosting site;

FIG. 21C is a graphical representation of a web page for an exemplary weblog hosting site, wherein during Step 2 of the MMVK (e.g. e-stand™) set up process, to make things easier for the affiliate, the affiliate is asked to select an area of interest on which he or she would like to see or view a list of available MMVKs, and only those MMVKs on the list will be displayed to the affiliate when logging back onto the system at a future date;

FIG. 21D is a graphical representation of a web page an exemplary weblog hosting site, wherein during Step 3 of the MMVK set up process, the Brand Marketing Communication Network displays to the affiliate (1) a list of available MMVKs, (2) a list of MMVKs that he or she has installed (i.e. set up) on their blog site, and (3) his or her blog site for reference purposes;

FIG. 21E is graphical representation of a web page of an exemplary weblog hosting site, wherein during Step 4 of the MMVK set up process, when the affiliate selects a MMVK, the Brand Marketing Communication Network displays detail information about the selected MMVK, and if this MMVK has been previously installed, then the network displays any commission related information relating to the MMVK, for review by the affiliate;

FIG. 21F is a graphical representation of a web page an exemplary weblog hosting site, wherein during Step 5 of the MMVK set up process, the affiliate can install the MMVK at any set location on his or her blog site (e.g. as an embedded object or embedded link), as well as remove the MMVK, without possessing any knowledge of HTML or HTML tag technology;

FIG. 21G is a graphical representation of a web page an exemplary weblog hosting site, wherein during Step 7 of the MMVK set up process, the affiliate can also make donations to charities of his or her choice from commission earned/received through sales originated through MMVKs installed on his or her blog site;

FIG. 21H is a graphical representation of a web page an exemplary weblog hosting site, wherein during Step 8 of the MMVK set up process, at any time, the affiliate can change the position or location of a MMVK set up on his or her blog site;

FIG. 21I is a graphical representation of a web page an exemplary weblog hosting site, wherein during Step 9 of the MMVK set up process, at any time, the affiliate can change the commission percentages to be donated to any charity, or completely change the charities to receive any commission-based donations earned through the Web-based brand marketing communication and ecommerce enabling network (i.e. Brand Marketing Communication Network) of the present invention;

FIG. 22 is a perspective view of a Web-enabled retail display appliance (RDA) of the present invention having a LCD touchscreen panel mounted in an ultra-thin, lightweight housing, and having an integrated imaging-based bar code symbol reader for reading UPC symbols on consumer products, and capable of supporting MMVKs of the present invention, including the multi-product MMVK illustrated in FIGS. 23A through 24;

FIG. 23 is one GUI screen displayed by the Multi-Product MMVK of the present invention during the MMVK control process described in FIG. 24;

FIG. 24 is a high-level flow chart describing the various states of operation supported by the Multi-Product MMVK of the present invention, which can be executed on the RDA of FIG. 22, and installed in a retail store environment and having bar code reading capabilities for reading UPC symbols on consumer products during price look-up operations;

FIG. 25 is a flow chart illustrating a process supported on the marketing communication network of the present invention, whereby a prospective or actual channel partner, wishing to allow manufacturer or service client/brands and their agencies to install MMVKs on their Web-based properties (e.g. online stores, catalogs and the like), logs-into the network of the present invention, and registers its Web-based properties on the network, sets default rates for registered properties, and makes specific parcels of its Web-based properties available for the placement and installation of MMVKs thereon to the agree to MMVK placement fees;

FIG. 26 is a flow chart illustrating a process supported on the marketing communication network of the present invention, whereby agencies of a manufacturer brand are enabled to negotiate (with property owner or their agents) final MMVK placement fee rates required to be paid for placing and installing their client/brand's product-specific and brand-specific MMVKs on registered online properties of property owners (e.g. on the product pages of registered online retail stores, catalogs etc);

FIG. 27 is a flow chart chart illustrating a process supported on the marketing communication network of the present invention, whereby a client/brand or its agent place generates and installs (i.e. places) a MMVK for its client's product, on one or more Web-based properties that have been registered with the marketing communication network of the present invention; and

FIG. 28 is a flow chart illustrating the automated work flow (WFA) process supported on the marketing communication network of the present invention, whereby proposed changes to be made to programmed brand-building content contained in installed MMVKs, or changes to be made to the functionalities thereof, are approved by designated users before such changes are made effective on the installed MMVKs for public viewing.

### DETAILED DESCRIPTION OF THE ILLUSTRATIVE EMBODIMENTS OF THE PRESENT INVENTION

Referring to the accompanying Drawings, like structures and elements shown throughout the figures thereof shall be indicated with like reference numerals.

In general, the Detailed Description set forth below discloses a detailed specification of an illustrative embodiment of the enterprise-level brand management and marketing communications network of the present invention, supporting the creation, configuration, deployment, installation and programming of server-side driven brand-building Multi-Mode Virtual Kiosks (MMVKs) of various types, in accordance with the principles of the present invention. In general this illustrative embodiment employs many of the inventive principles disclosed in Applicants' International Patent Application Publication Nos. WO 2005/001656 A2 published on Jan. 6, 2005, WO 01/37540 A2 published on May 25, 2001, and WO 98/19259 published on May 7, 1998, each of which is incorporated herein by reference in their entirety as if set forth fully herein.

Internet-Based Brand Management and Marketing Communication Instrumentation Network of the Present Invention Employing Remotely Programmable Server-Side Driven Brand-Building Multi-Mode Virtual Kiosks

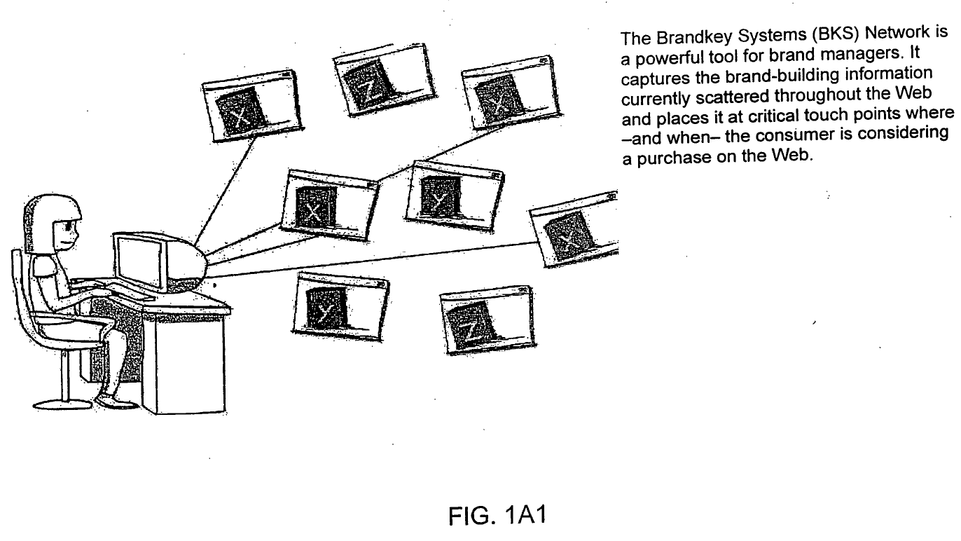

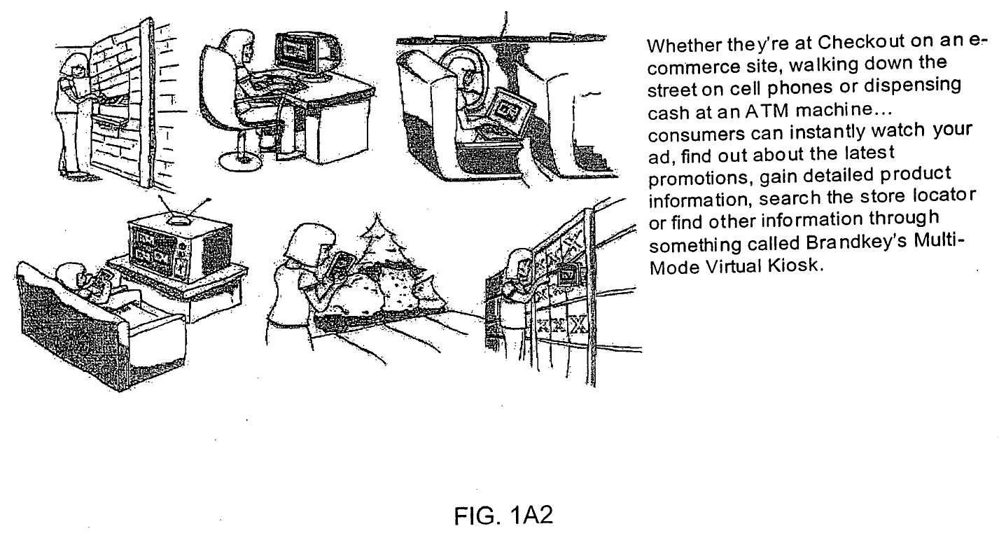

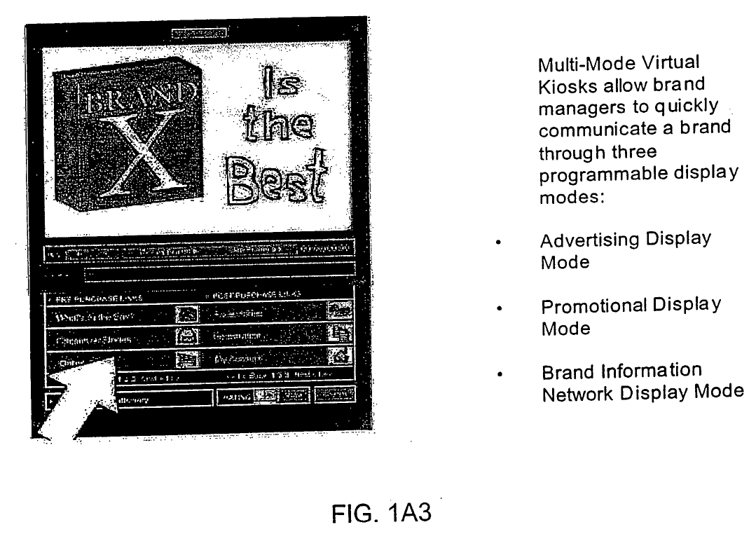

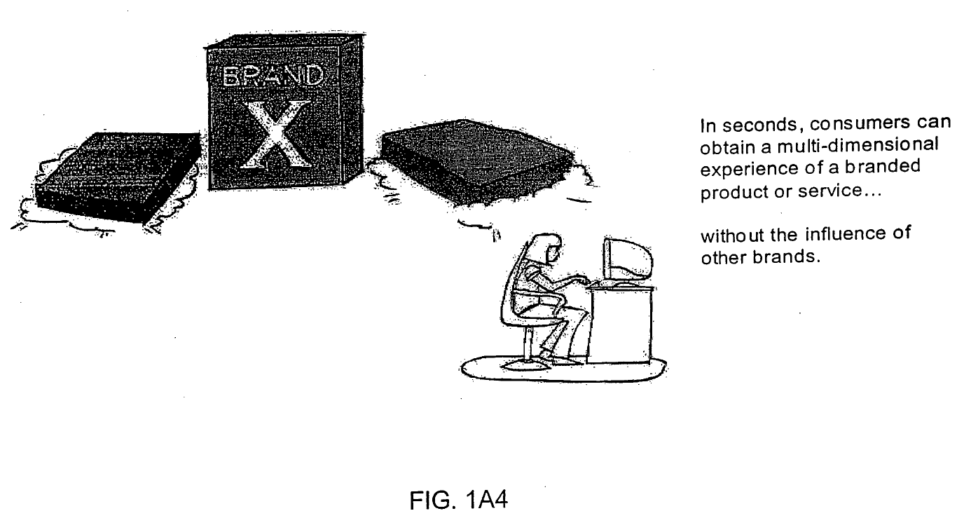

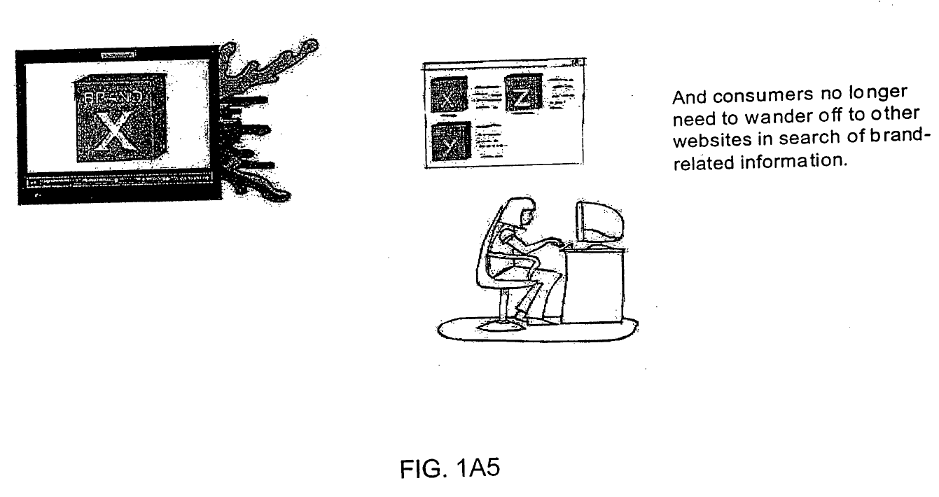

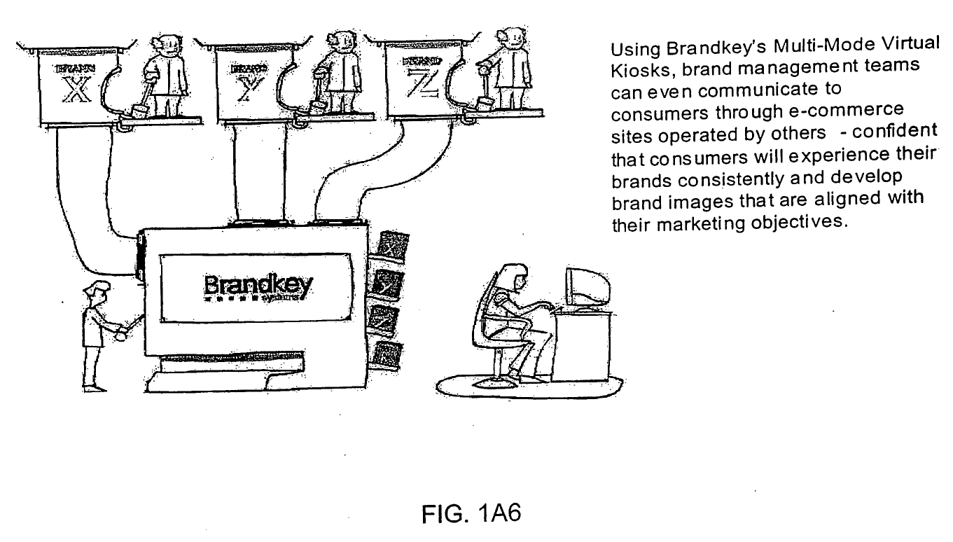

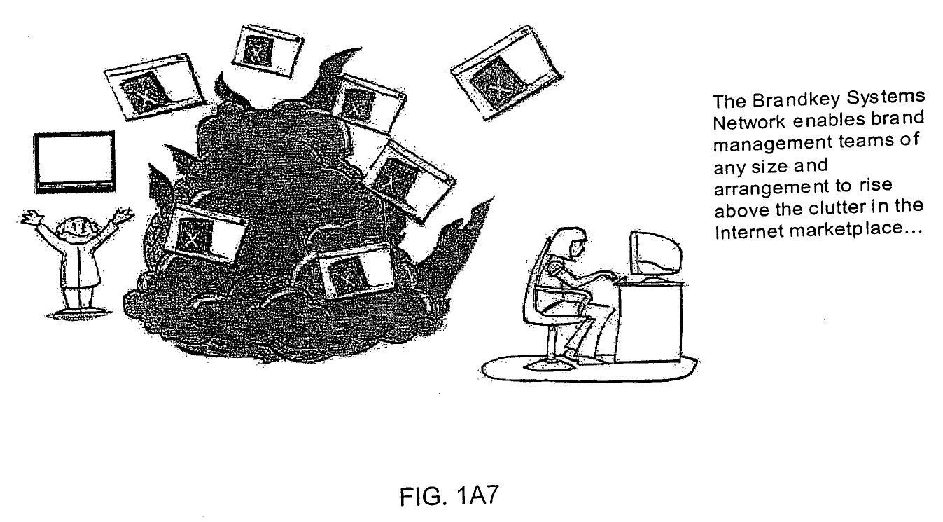

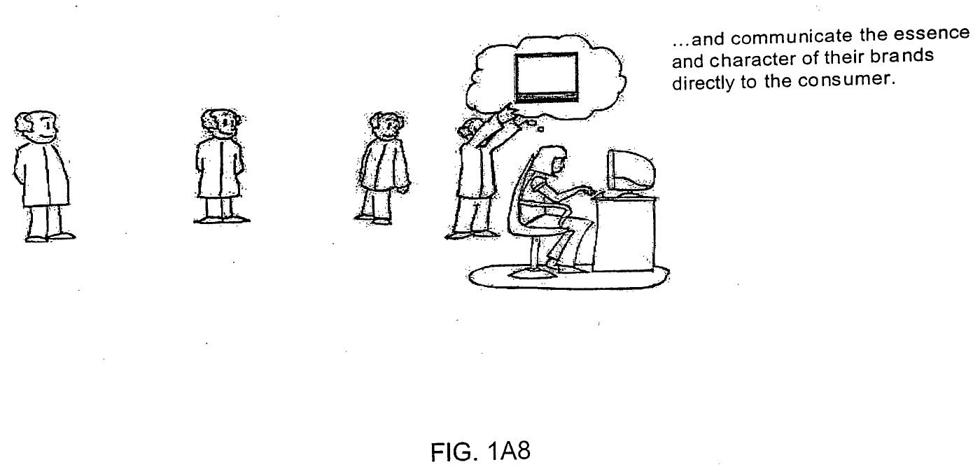

Referring to FIGS. 1A1 through 1H6, the Internet-based (inter-) enterprise-level Brand Management and Marketing Communication Instrumentation Network of the present invention will now be described in detail as a robust solution to the online brand management and marketing communication problems experienced by product, service and corporate brand marketers, world-over.

As shown in FIG. 1A1, the Brand Management and Marketing Communication Network of the present invention is a powerful tool for brand managers. It captures the brand-building information currently scattered throughout the Web and places it at critical touch points where and when the consumer is considering a purchase on the Web.

As indicated in FIG. 1A2, whether they are at a checkout on an e-commerce site, walking down the street on cell phones or dispensing cash at an ATM machine, consumers can instantly watch your ad, find out about the latest promotions, gain detailed product information, search the store locator or find other information through something called a “Multi-Mode Virtual Kiosk”.

As shown in FIG. 1A3, Multi-Mode Virtual Kiosks allow brand managers to quickly communicate a brand through three programmable display modes: Advertising Display Mode; Promotional Display Mode; and Brand Information Network Display Mode As indicated in FIGS. 1A4 and 1A5, in seconds, consumers can obtain a multi-dimensional experience of a branded product or service without the influence of other brands, and consumers no longer need to wander off to other websites in search of brand-related information.

As shown in FIG. 1A6, using Multi-Mode Virtual Kiosks, brand management teams can even communicate to consumers through e-commerce sites operated by others confident that consumers will experience their brands consistently and develop brand images that are aligned with their marketing objectives.

As shown in FIGS. 1A7 and 1A8, the Brand Management and Marketing Communication Instrumentation Network of the present invention enables brand management teams of any size and arrangement to rise above the clutter in the Internet marketplace, and communicate the essence and character of their brands directly to the consumer.

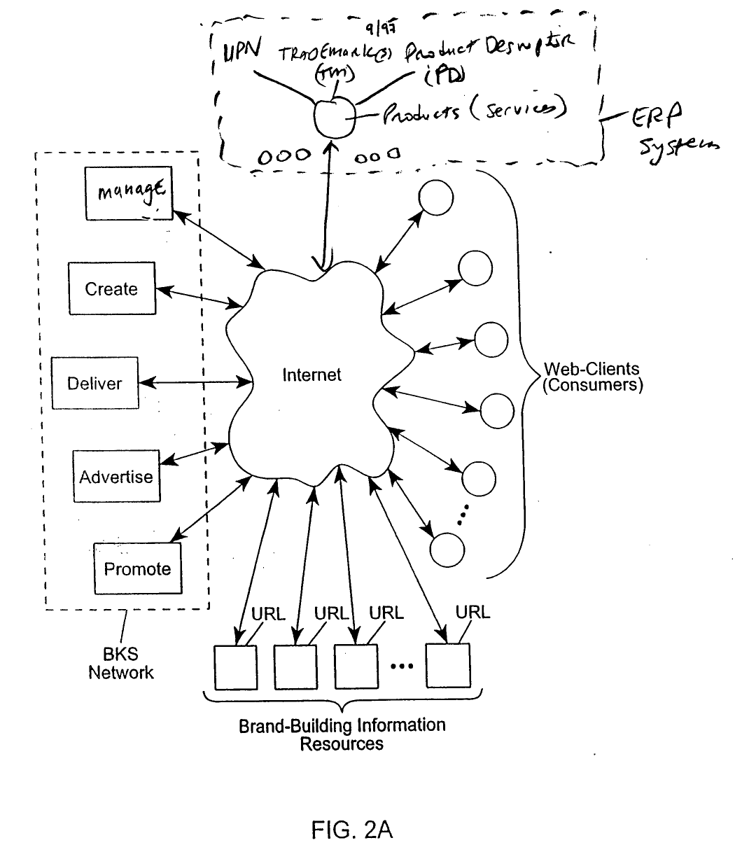

Referring now to FIGS. 2A through 2B, an overview will be provided on how such capacities are provided by the Brand Marketing Communication of the present invention.

As shown in FIG. 2A, the Brand Marketing Communication Network of the present invention is composed of five primary Subsystems connected to the infrastructure of the Internet; five of these Subsystems are used by Client users, whereas a sixth Subsystem is used exclusively by BKS Administrators, employees and consultants. Also, a seventh subsystem, entitled the BKS™ Multi-Mode Virtual Kiosk Serving Subsystem, serves up all Multi-Mode Virtual Kiosks to Consumers anywhere the Internet, but this subsystem does not support any client user GUIs. Each of first five Subsystems supports one or more Service Suites, and each Service Suite contains one or more Control Panels. These Control Panels support the delivery of the Brand Marketing Communication Network's Marketing Instruments.

The Brand Management and Marketing Communication Network of the present invention allows brand management teams to rapidly configure, deploy and install Brand-Building Multi-Mode Virtual Kiosks (MMVKs) at the various consumer touch-points.

These Consumer Touch-points include:
Desktop Computers
WiFi-enabled Portable Devices
Physical Retail Kiosks
ATMs Interactive Television Sets
PDAs and
Cell Phones

At each of these consumer touch-points, brand management teams have the option of delivering their Brands' Multi-Mode Virtual Kiosks through a number of different Launch Environments. Such Launch Environments include:
BKS™ Virtual Kiosk Launch Buttons
HTML-Encoded Documents
HTML-Encoded Images
HTML-Encoded Desktop Icons
RDA-based Kiosks
   These brand marketing and sales Channels and Consumer Touch-points and Launch Environments allow Brand Management Teams to reach a broad range of Consumer markets over the Internet.

The Network of the present invention provides a single communication platform for integrating these online and offline channels and touchpoints of manufacturer and retailer brands, and driving commerce over these channels and touchpoints with brand-powered (i.e. manufacturer/vendor assisted) merchandising and retailing services.

Multi-Mode Virtual Kiosks of the present invention support three independently programmable modes of display: (1) Advertising Spot Display Mode, in which the Multi-Mode Virtual Kiosk displays Ad Spots programmed by the Brand Management Team or their Agents; (2) Promotional Spot Display Mode during which the Multi-Mode Virtual Kiosk displays Promo Spots programmed by the Brand Management Team or their Agents; and (3) Brand Information Network Display Mode in which the Multi-Mode Virtual Kiosk displays a menu of Brand-Building Information Resource Links consistent with the Team's brand marketing objectives.

These modes of marketing communication and display cooperate with the purpose of allowing consumers to experience any product, service or corporate brand without the influence of other Brands as well as marketplace clutter (i.e. pop-ups and banner ads). Brand Management Teams may select any combination of these Modes to be displayed in their Multi-Mode Virtual Kiosks.

As shown in FIG. 2A, each ad, promotion or other brand building resource that is placed or otherwise published on the WWW, has a unique address thereon specified by a Uniform Resource Locator (URL). Also, each product offered for sale in physical and/or electronic streams of commerce has three unique identifiers: a Universal Product Number (UPN), a Trademark (TM), and a Product Descriptor (PD). Together, they form a Product Data String (UPN/TM/PD). Branded services also have three unique identifiers: a Universal Service Number (USN), a Service Mark (SM) and a Service Descriptor (SD). Together, they form a Service Data String (USN/SM/SD).

The Web-based Brandkey Create® subsystem enables brand management team members and their agencies to simply attach the Uniform Resource Locators (or URLs) of brand-building information resources on the Web, to these Product Data Strings (UPN/TM/PD) or Service Data Strings (USN/SM/SD), so as to produce Product Data Links (UPN/TM/PD/URL) or Service Data Links (USN/SM/SD/URL), as the case may be. From these Product and Service Data Links, brand management team members create Brand Information Networks (BINs) by selecting particular links to be active and assigning a display schema to the active links which will be displayed to consumers through the display modes of Multi-Mode Virtual Kiosks. In other words, the Brandkey Create Subsystem allows brand management team members to select and set the links that consumers will see in the Ad, Promo or Brand Information Network Display modes of Multi-Mode Virtual Kiosks deployed on the Network, and supports the brand information management aspects of the network of the present invention.

The Brandkey Manage™ Subsystem enables brand management team members to track and manage the users and brands on their brand's Multi-Mode Virtual Kiosks.

The Brandkey Deliver® Subsystem provides tools which enable brand management team members, trading partners (and even consumers), to deploy and install Multi-Mode Virtual Kiosks and set these interactive Web-based in motion. In a few simple steps, one can create, deploy and install the Multi-Mode Virtual Kiosk.

The Brandkey Advertise and Brandkey Promote Subsystems enable brand management team members, as well as their advertising and their promotional agents, to program and update their brand's ad spots and latest sales promotions on installed MMVKS, quickly and easily.

The Brandkey Manage Subsystem enables users to perform a range of management and administration functions. The brand manager, chief marketing officer (CMO), or the like can decide who can create content for its brand's Multi-Mode Virtual Kiosks. The brand manager can track the activities of both team members and outside agents whom s/he has given the right to place advertising and promotion spots on the brand's Multi-Mode Virtual Kiosks. Using Brandkey Deliver Subsystem, the brand manager can also shut down any Multi-Mode Virtual Kiosk s/he desires. In the Brandkey Manage System, one can also monitor and measure consumer activity on the Multi-Mode Virtual Kiosks. One can find out how consumers rated the effectiveness or usefulness of an ad or resource, or identify potential new customers based on who downloads one's Multi-Mode Virtual Kiosks.

The brand manager (or its designated staff member) begins by creating a Product Data String for the branded product by entering the UPN, Trademark and Product Descriptor, or Service Data String for the branded service by entering the USN, Servicemark and Service Descriptor. This information can be entered manually, or automatically imported from a UPC Product Sales Catalogue on the product brand's supply-chain information management system, using the Import Data Strings Function supported in the Brandkey Create Subsystem.

The brand management team decides which ad, promo or other brand building links (or URLs) they wish to attach to the Data String on their Multi-Mode Virtual Kiosk.

To help reinforce the essence and character of the brand, the Brandkey Create Subsystem allow a brand management team member to select a Display Schema for visually presenting to consumers, a selected arrangement of brand information resources (i.e. nodes) in the Brand Information Network that is supported by an underlying set of Product Data Links (UPN/TM/PD/URLs) or Service Data Links (USN/SM/SD/URLs).

Once the content that will appear on the Multi-Mode Virtual Kiosk has been created and integrated within a richly-associated Brand Information Network (formed by Product or Service Data Links with a selected Display Schema, etc), the brand management team can then simply and quickly preview the composite brand image likely to be projected by the created Brand Information Network. Using the ‘test link’ feature, IT managers can ensure that an ad spot or other link in the Brand Information Network loads quickly.

The Brandkey Create Subsystem also includes easy-to-use tools that enable brand management teams to host content on the Web as well, e.g. on the networks own Internet information servers, or on the content data network of an affiliated global CDN such as provided by Akamai. Along with its other benefits, the Brandkey Create Subsystem can be a very useful tool to manage one online brand information resourses, to ensure consistent brand image communication across all brand marketing communication channels on the Internet.

When the brand management team wishes to change information about their product, service or corporate brand, the Brand Management and Marketing Communication Network can be used modify brand building information resources linked to brand-information keys (e.g. Product Data Strings or Service Data Strings) that are automatically synchronized with the brand's information maintained on the supply side of the retail value chain.

Multi-Mode Virtual Kiosks come in a variety of types and sizes designed for the special needs of your trading partners. Multi-Mode Virtual Kiosks (MMVKs) can feature one product or several products using Product-Specific MMVKs or Vendor-Specific MMVKs, respectively. Services can be showcased in a special manner using Service-Specific MMVKs, and Service-Provider-Specific MMVKs. Retailers can create Multi-Mode Virtual Kiosks that present multiple vendors, without overwhelming their own brand, using Retailer-Specific MMVKs. Corporate Specific and Industry-Specific MMVKS are yet other types of Multi-Mode Virtual Kiosks that are supported by the Brand Management and Marketing Communication Network of the present invention.

Using the Brandkey Deliver® Subsystem, the brand management team sets the Multi-Mode Virtual Kiosk in motion. They can rapidly configure, deploy and install a Multi-Mode Virtual Kiosk in as little as ten minutes. One can generate a Multi-Mode Virtual Kiosk by following a few simple steps: Configure; Create; Deploy; and Activate. One begins by configuring the Multi-Mode Virtual Kiosk. Select the modes and installers, and define the domains where the Multi-Mode Virtual Kiosk can and cannot be installed. Here one can ensure that Multi-Mode Virtual Kiosks will not appear on a brand-damaging site, for example. Then, one can determine the look and feel of the Multi-Mode Virtual Kiosk by choosing colors, wallpaper, textures, etc. One then decides which launch environments is needed or desired. Will the Multi-Mode Virtual Kiosk be a link embedded in an email to prospective customers? A link in a registration package for new customers? Or an image of a product that consumers might click on while shopping on an e-commerce site? The brand management team member can provide this image or s/he can insert the Default BKS button when they do not have an image. The Multi-Mode Virtual Kiosk could even be a link in a fact sheet that consumers find while browsing on the brand's website or a desktop icon which consumers can quickly install on their computer desktops, and launch anytime they want the latest sales or other information about the product, service or corporate brand. It is easy to update or otherwise modify the images or information on the Multi-Mode Virtual Kiosks.

Once deployment is complete, the Multi-Mode Virtual Kiosk is catalogued on a Web information server associated with the network. Each Multi-Mode Virtual Kiosks receives a ‘tag’, or launch button, which the brand management team member, or it agent, can embed throughout the Internet. Then, when a consumer clicks on a tag that has been embedded somewhere along the fabric of the Web, the Multi-Mode Virtual Kiosk launches from the Network Server, and appears on the consumer's web-enabled computer.

Once consumers launch the Multi-Mode Virtual Kiosk, it automatically plays through its three display modes, inviting them to interact with ad spots, promotional spots, and a richly-associated network of brand-building information. The Network also allows one to quickly measure the interaction between consumers and Multi-Mode Virtual Kiosks. For example, one can ask consumers to rate from 1-5 how useful a link, presented during the Brand Information Network Display Mode, was to them. The Brand Management And Marketing Communication Network of the present invention can generate detailed reports to help brand management team members analyze the effectiveness of their online brand-building campaigns.

The Brand Marketing Communication Network of the present invention also simplifies the challenge of managing online advertising and promotion campaigns with the Brandkey Advertise and Brandkey Promote Subsystems. Using these subsystems, Advertising and Promotion Directories can automatically produce directory listings of all the installed Multi-Mode Virtual Kiosks, on which agents may place ad or promotion spots on the World Wide Web. Authorized agents can quickly start, stop or modify campaigns.

With the Brand Marketing Communication Network of the present invention, Multi-Mode Virtual Kiosks are easy to create and deploy, and brand management teams have the opportunity to quickly reach millions of empowered consumers at points of purchase consideration and sale on the Web, and effectively communicate a multi-dimensional picture of ones branded product. Everything is within the brand manager's control to ensure that consumers receive consistent brand-building messages and images in accordance with the brand marketing objectives of the team.

The Vision behind the Brand Marketing Communication Network of the present invention is to enable the creation of a global marketplace in which all brand marketers of products and services, large and small, have equal access to a relatively inexpensive, simple-to-use, yet extremely powerful set of Web-based marketing instruments that allow them to communicate directly and freely with consumers anywhere along the World Wide Web, while creating value for consumers and their retail trading partners alike. Such new forms of brand marketing communication will occur without adversely affecting the brand marketer's trading partners, while enabling the reliable delivery of the best and most valuable brand building information resources to consumers wherever they might be needed most, and regardless of where such brand building information resources may actually be hosted on the Internet, e.g.: Akamia® Global Content Delivery Network (CDN), or elsewhere.

New value will be simultaneously created in the marketplace for consumers, brand owners, their agents and retail trading partners alike by providing widespread distribution of brand-building Multi-Mode Virtual Kiosks, in which their Multiple Display Modes are (i) remotely programmable through an industrial-strength carrier-class Internet-based Brand Marketing Communication Instrumentation Network, and (ii) are capable of displaying rich-media advertising spots, promotional spots, and Brand Information Networks (BINS) composed of virtually any form information media on the Internet simply indexed using brand-related information keys, e.g. Universal Product Numbers (UPNs), Trademarks, (™s) Product Descriptors (PDs), Universal Service Numbers (USNs), Servicemarks (^{SM}s), Brand Names, etc.—so that Brand Managers are provided complete control over their brand marketing communications on the Internet, while improving collaboration among brand management team members within and outside of the Brand's enterprise.

In general, such an Internet-based Brand Marketing Communication Instrumentation Network of the present invention should be capable of deploying server-side driven brand-building Multi-Mode Virtual Kiosks at any point along the World Wide Web, and remotely programming the display modes thereof so as to deliver advertising and promotional campaigns and brand knowledge Building Information Networks (of links) to consumers whenever and wherever they may be on the WWW. The stakeholders associated with this object-oriented system are brand managers, their advertising and promotional agents, the brand entities which they represent, and their primary interests are to build brand equity in the minds and hearts of consumers, while protecting Brands by maintaining the highest possible system integrity and security-trustworthiness. The minimal guarantees sought by the Network are to provide brand management teams, large and small, and of any possible arrangement, with the ability to simply and rapidly program and deliver brand-building information content through the multiple display modes of server-side driven Multi-Mode Virtual Kiosks launchable from numerous types of environments at virtually any touchpoint on the World Wide Web—using only simple mouse-clicks and data entry operations and without the assistance of Java programmers. By ensuring the delivery of valuable brand-building information resources to consumers through Multi-Mode Virtual Kiosks, the strength of Brand Entities in the lives of consumers should be increased.

The Brand Marketing Communication Network of the present invention provides an advanced ensemble of revolutionary Web-based Brand-Marketing Instruments (i.e. tools) which enable brand management teams (including chief brand officers, marketing officers, brand managers, staff members and their advertising and promotional agents, brand consultants, etc) to provide consumers with rich, multimedia brand experiences, based on advertisements, promotions and other information about their specific Products and Services at specific Internet-enabled point-of-sale consumer touch-points. These marketing instruments also to help brand management teams to manage the brand knowledge that consumers develop about a company's products and services in order to shape and reinforce the desired Brand Image that consumers develop in their minds before, during and after product and service purchases.

The Brand Marketing Communication Network of the present invention enables brand management teams of any size and arrangement to effectively manage and communicate the essence and character of their Brands over the Internet.

System Architecture of the Brand Management and Marketing Communication Network of the Present Invention Deployed on the Global Data Packet Information Network

As shown in FIG. 2B, the Internet-based Enterprise-Level Brand Management and Marketing Communication Instrumentation Network of the present invention (i.e. Brand Marketing Communication Network) is realized as an industrial-strength, carrier-class Internet-based multi-media communications network of object-oriented system design, deployed on the global data packet information network comprising numerous information subsystems and systems and network components, as shown. As such, the brand marketing communication network of the present invention is often referred to herein as the “System.”

As shown in FIG. 2B, the Brand Marketing Communication Network is uniquely situated so as to tie into, or integrate with, two separate networks currently used to propagate Supply-Side marketing and Demand-Side marketing. EDI is a well-established technology and is widely used by manufacturing concerns and their trading partners to pass information from one to the other. The Brand Marketing Communication Network harnesses the capabilities of the EDI Network and its VANs to be able to capture the basic information required to identify Products and Services. The Brand Marketing Communication Networks also synchronized with such EDI systems to as to keep updated with any changes in the universe of Products and Services offered. Via the infrastructure of the Internet, the Brand Marketing Communication Network is also connected via the Internet to the Ad/Promo Delivery Networks (Doubleclick, etc.), Content Delivery Networks (Akamai, etc.) and Ad/Promo Management Networks (MSN, etc.) to use their services to place and monitor Virtual Kiosks throughout the Internet. Advertisers and Promoters are able to access the Brand Marketing Communication Network to place Ads and Promos on Multi-Mode Virtual Kiosks, which will then be placed on HTTP Servers over the Internet. Throughout this process, the Vendors, Service Providers and Retailers will be able to monitor and manage this process over the internet and be able to hook into their Content Management Systems (CMS) to select which brand-building assets to deliver to consumers at what point on the Internet through the installed Multi-Mode Virtual Kiosks.

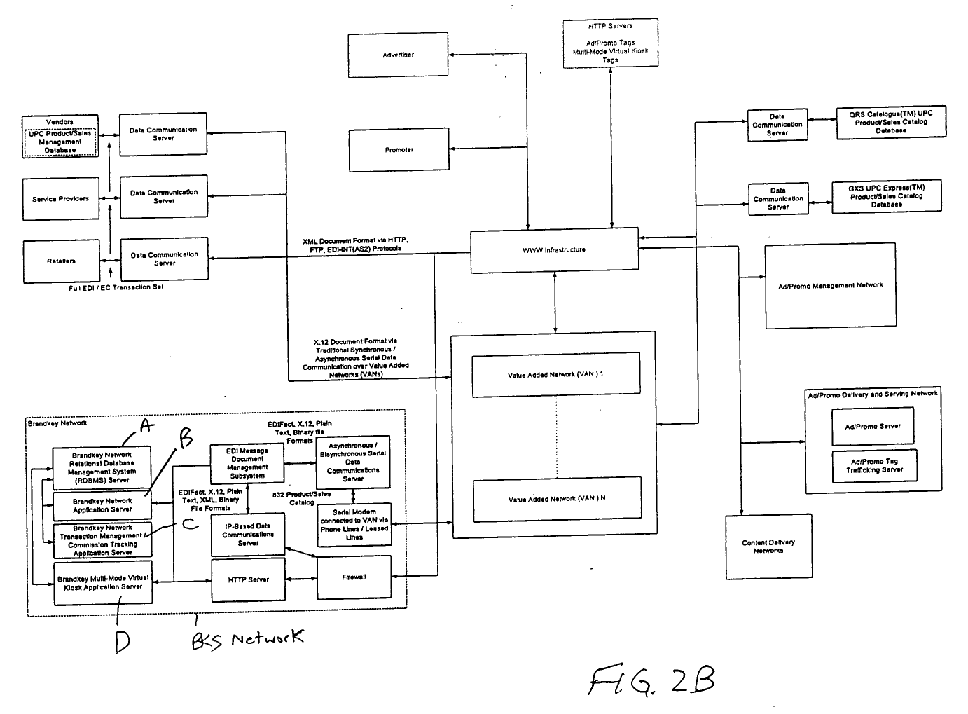

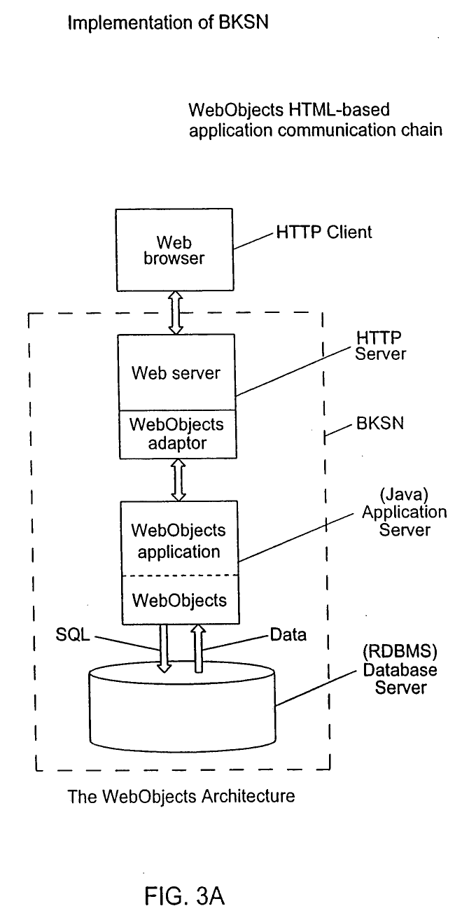

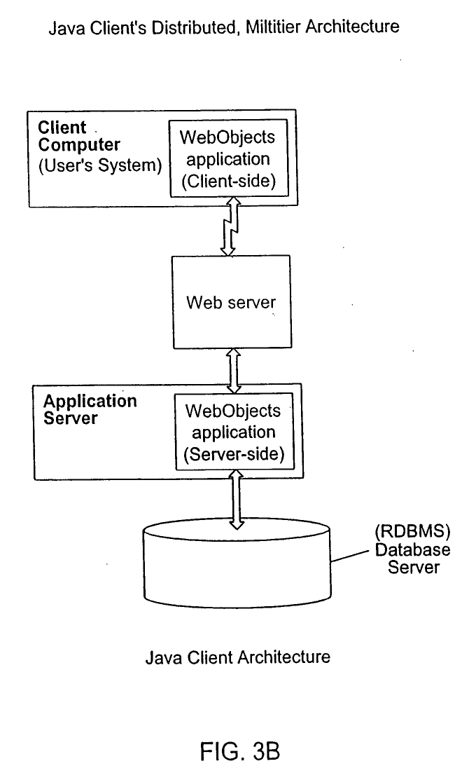

In general, the Internet-based Brand Marketing Communication Network of the present invention can be implemented using any Java-based object-oriented integrated development environment (IDE) such as WebObjects 5.2 by Apple Computer Inc, Websphere IDE by IBM, or Weblogic IDE by BEA, or even an non-Java IDE such as Microsoft's .NET IDE. Two different Network implementations using the WebObjects IDE are illustrated in FIGS. 3A and 3B using Web-based and Java-client technology, respectively. The entire Brand Management and Marketing Communication Instrumentation Network of the present invention is designed according to object-oriented systems engineering (OOSE) methods using UML-based modeling tools such as ROSE by Rational Software, Inc. or Together by Borland Software, using the industry-standard Rational Unified Process (RUP) or Enterprise Unified Process (EUP), both well known in the art. A three-tier server architecture with double-firewall would provide a preferred deployment platform on the Internet.

In the illustrative embodiment, the Brand Management and Marketing Communication Instrumentation Network is realized as a hosted service using an application service provider (ASP) model, but is understood that some or all of the services provided by the subsystems of the Brand Management and Marketing Communication Instrumentation Network can be realized as Java clients, running behind a client/brand's enterprise firewall, and the RDBMS associated with a given client/brand can be maintained locally within the client/brand's enterprise, and synchronized with the centralized RDBMS of the Brand Management and Marketing Communication Instrumentation Network using XML and EDI techniques described in great detail in Applicant's PCT International Patent Application Publication Nos. WO 98/19259 published on May 7, 1998, and WO 01/37540 A2 published on May 25, 2001, incorporated herein by reference.

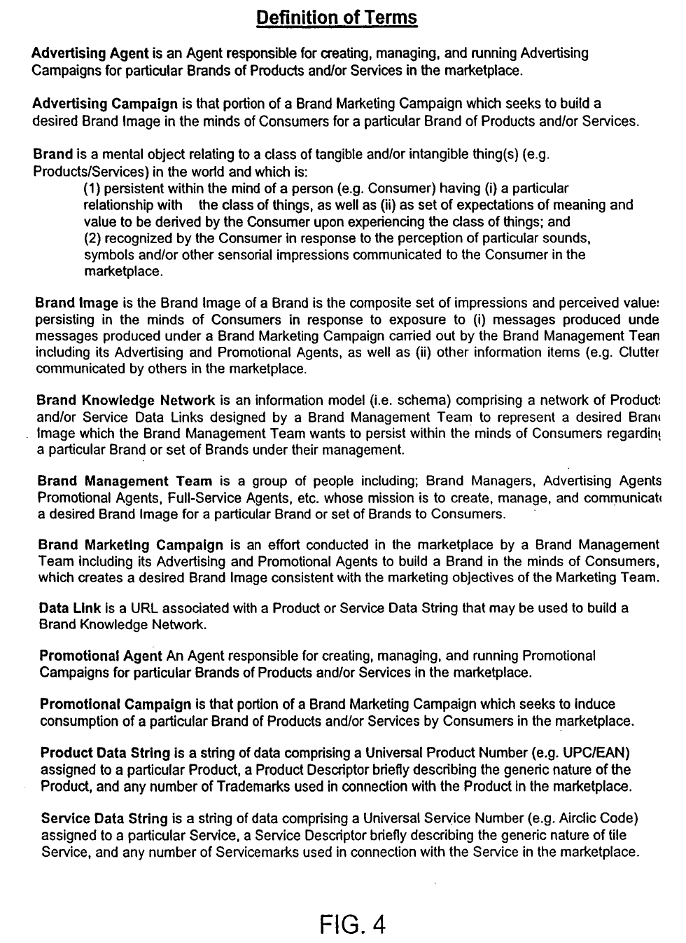

Precise definition of terms used in the analysis, design and development of the Brand Management and Marketing Communication Instrumentation Network of the present invention are set forth in the table of FIG. 4, and should be carefully considered while reading the present Specication.

Detailed Description of the Enterprise Brand Management and Marketing Communication Instrumentation Network of the Illustrative Embodiment of the Present Invention

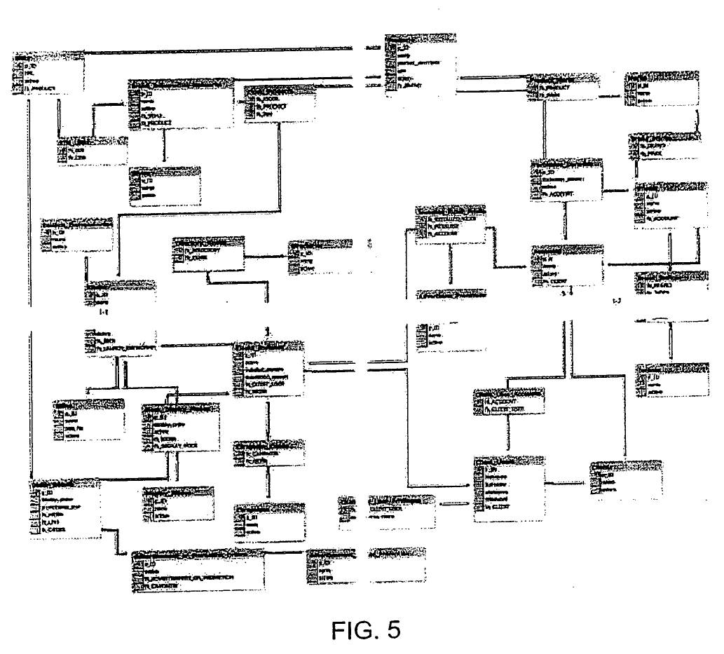

In FIG. 5, a basic database schema diagram is shown for the RDBMS used to implement the Brand Management and Marketing Communication Instrumentation Network of the illustrative embodiment. Any SQL database program compatible with the WebObject 5.2 Java Application Server can be used to implement this network component. Notably, during object-oriented design (OOD) and system developed, the tables and relationships in the RDBMS are ultimately converted to Java class based Enterprise Object (EO) model within the WebObject 5.2 Java Application Server, whereas the GUI components for the Network are converted to a Java class based Web Objects (WO) model therewithin.

As shown in FIG. 4, the tables in the RDBMS comprise the following attributes and relationships:

Description of the Database Layer of the Brand Management and Marketing Communication Network of the Illustrative Embodiment (Brand Marketing Communication Network)

Account

Attributes:

p_ID→Primary Key
name→Account Name
active→Denotes whether the Account is active or not
fk_CLIENT→Foreign Key. Holds relationship to the Client table
   Relationships:
clients→1-to-1 relationship. Each Account must be assigned to a single Client.
   Advertisement_or_Promotion
   Attributes:
p_ID→Primary Key
name→name of the item. In this case there will be two items in the table (‘Promotion’ and ‘Advertisement’)
active→Denotes whether the item is active or not
   Relationships:
toAdvertisement_or_PromotionOrders→1-to-many relationship. Each Advertisement_or_Promotion Order must be assigned an advertisement or promotion Type.
   Advertisement_or_PromotionOrders
   Attributes:
p_ID→Primary Key
active→Denotes whether the item is active or not
fk_ADVERTISEMENT_OR_PROMOTION→Foreign Key. Holds relationship to the Advertisement_or_Promotion table
fk_CAMPAIGN→Foreign Key. Holds relationship to the Campaign table
   Relationships:
advertisement_or_promotions→1-to-1 relationship. Each Order must be assigned an advertisement or promotion Type.
campaigns→1-to-1 relationship. Each Order must be assigned to a specific Campaign.
   Advertising_Promotional_Privileges
   Attributes:
p_ID→Primary Key
name→Holds the value of the Type of Privilege. (In this case there will be only three types; ‘Exclusive’, ‘Shared’, or ‘Not Allowed’)
active→Denotes whether the item is active or not
   Relationships:
toInstalledKioskPrivileges→1-to-many relationship. The allowed Privileges for placing Advertisements and Promotions on any installed Retailer-Specific Virtual Kiosk are controlled through this relationship
   BIN_Links
   Attributes:
fk_BIN→Foreign Key. Holds relationship to the Brand Information Networks table. The links assigned to that Brand Information Network are stored in this table.
fk_LINK→Foreign Key. Holds relationship to the Link table. Which Links are to be assigned to the Brand Information Network are stored in this table
   Relationships:
BINs→1-to-1 relationship. Denotes which Brand Information Network is being populated by the stored Links
Links→1-to-1 relationship. Denotes which Links are to be assigned to the Brand Information Networks
   Brand_Indices
   Attributes:
fk_BRAND→Foreign Key. Holds relationship to the Brand table. Denotes which Brand is assigned to the stored Indices
fk_INDEX→Foreign Key. Holds relationship to the Index table. Denotes which Indices are assigned to the Brand
   Relationships:
Brands→1-to-1 relationship. Denotes which Brand is assigned to the stored Indices
Indices→1-to-1 relationship. Denotes which Indices are assigned to the Brand.
   Brand_Information_Networks
   Attributes:
p_ID→Primary Key
name→The name of the Brand Information Network
active→Denotes whether the Brand Information Network is active or not
fk_STYLE→Foreign Key. Holds relationship to the Style table. Denotes which Style is assigned to the Brand Information Network
fk_PRODUCT→Foreign Key. Holds relationship to the Product table. Denotes to which Product the Brand Information Network is assigned
   Relationships:
Styles→1-to-1 relationship. Denotes which Style is assigned to the Brand Information Network
Products→1-to-1 relationship. Denotes to which Product the Brand Information Network is assigned
   Brand_Marks
   Attributes:
fk_BRAND→Foreign Key. Holds relationship to the Brand table. Denotes to which Brand the Marks are assigned
fk_MARK→Foreign Key. Holds relationship to the Mark table. Denotes which Marks are assigned to the Brand
   Relationships:
Brands→1-to-1 relationship. Denotes to which Brand the Marks are assigned
Marks→1-to-1 relationship. Denotes which Marks are assigned to the Brand
   Brands
   Attributes:
p_ID→Primary Key
name→Name of the Brand
active→Denotes whether the Brand is active or not
fk_ACCOUNT→Foreign Key. Holds relationship to the Account table. Denotes to which Account does the Brand belong
   Relationships:
Accounts→1-to-1 relationship. Denotes to which Account does the Brand belong
   Campaign_Kiosks
   Attributes:
fk_CAMPAIGN→Foreign Key. Holds relationship to the Campaign table. Denotes to which Campaign do the Kiosks belong
fk_KIOSK→Foreign Key. Holds relationship to the Kiosk table. Denotes which Kiosks belong to the Campaign
   Relationships:
Campaigns→1-to-1 relationship. Denotes to which Campaign do the Kiosks belong
Kiosks→1-to-1 relationship. Denotes which Kiosks belong to the campaign
   Campaign
   Attributes:
p_ID→Primary Key
name→Name of the Campaign
active→Denotes whether the Campaign is active or not
   Relationships:
toCampaign_Kiosks→1-to-many relationship. Denotes Kiosks are assigned to which Campaigns
toAdvertisement_or_PromotionOrders→1-to-many relationship. Denotes which Order belong to which Campaigns
   Client_User_Accounts
   Attributes:
fk_ACCOUNT→Foreign Key. Holds relationship to the Account table. Denotes to which Account does the Client User belong
fk_CLIENT_USER→Foreign Key. Holds relationship to the Client_User table. Denotes which Client Users belong to the Account
   Relationships:
Accounts→1-to-many relationship. Denotes to which Account does the Client User belong
Client_Users→1-to-many relationship. Denotes which Client Users belong to the Account
   Client_User_Privileges
   Attributes:
fk_CLIENT_USER→Foreign Key. Holds relationship to the Client User table. Denotes which Client User has this privilege in the System
service_name→The Service to which the Client User has the privilege
   Relationships:
Client_Users→1-to-many relationship. Denotes which Client User has this privilege in the System
   Client_Users
   Attributes:
p_ID→Primary Key
firstname→The First Name of the Client User
lastname→The Last Name of the Client User
username→The username the Client User uses to enter the System
password→The password the Client User uses to enter the System
active→Denotes whether the Client User is active or not
fk_CLIENT→Foreign Key. Holds relationship to the Client table. Denotes to which Client does the Client User belong
   Relationships:
Clients→1-to-1 relationship. Denotes to which Client does the Client User belong
toClient_User_Accounts→1-to-many relationship. Denotes to which Accounts does the Client User have access
toClient_User_Privileges→1-to-many relationship. Denotes which Privileges the Client User has
toKiosks_Installed→1-to-many relationship. Denotes which Kiosks the Client User has installed
   Clients
   Attributes:
p_ID→Primary Key
name→Name of the Client
active→Denotes whether the Client is active or not
   Relationships:
toClient_Users→1-to-many relationship. Denotes which Client Users are assigned to the Client
toAccounts 1-to-many relationship. Denotes which Accounts are assigned to the Client
   Directories
   Attributes:
p_ID→Primary Key
name→Name of the Directory
active→Denotes whether the Directory is active or not
   Relationships:
toDirectory_Kiosks→1-to-many relationship. Denotes which Virtual Kiosks are assigned to the Directory
   Director_Kiosks
   Attributes:
fk_DIRECTORY→Foreign Key. Holds relationship to the Directory table. Denotes to which Directory the Kiosks are assigned
fk_KIOSK→Foreign Key. Holds relationship to the Kiosk table. Denotes which Kiosks are assigned to the Directory
   Relationships:
Directories 1-to-1 relationship. Denotes to which Directory the Virtual Kiosks are assigned
Kiosks 1-to-1 relationship. Denotes which Kiosks are assigned to the Directory
   Display_Modes
   Attributes:
p_ID→Primary Key
name→Name of the Display Mode
active→Denotes whether the Display Mode is active or not
   Relationships:
toKioskDisplayModes→1-to-many relationship. Denotes which Display Modes are assigned to the Kiosk
   Forbidden_Domains
   Attributes:
p_ID→Primary Key
forbidden_domain→The URL of the Domain that is forbidden
active→Denotes whether the Forbidden Domain is active or not
fk_ACCOUNT→Foreign Key. Holds relationship to the Account table. Denotes to which Account does this Forbidden Domain apply
   Relationships:
Accounts→1-to-1 relationship. Denotes to which Account does this Forbidden Domain apply
   Indices
   Attributes:
p_ID→Primary Key
name→Name of the Index
active→Denotes whether this Index is active or not
   Relationships:
toBrandlndices→1-to-many relationship. Denotes which Indices are assigned to a Brand
   Installed_Kiosk_Privileges
   Attributes:
fk_INSTALLED_KIOSK→Foreign Key. Holds relationship to the Installed Kiosk table. Denotes which Installed Kiosks have which Privileges for which Accounts
fk_PRIVILEGES→Foreign Key. Holds relationship to the Privileges table. Denotes which Privileges are assigned to which Installed Kiosks for which Accounts
fk_ACCOUNTS→Foreign Key. Holds relationship to the Accounts table. Denotes which Accounts have which Installed Kiosks with which Privileges assign to them
   Relationships:
InstalledKiosks→1-to-1 relationship. Denotes which Installed Kiosks have which Privileges for which Accounts
Privileges→1-to-1 relationship. Denotes which Privileges are assigned to which Installed Kiosks for which Accounts
Accounts→1-to-1 relationship. Denotes which Accounts have which Installed Kiosks with which Privileges assigned to them
   Kiosk_Display_Modes
   Attributes:
p_ID→Primary Key
display_order→Denotes in which Order are the Display Modes presented when the Kiosk is launched
active→Denotes whether the Display Mode for this Kiosk is active or not
fk_KIOSK→Foreign Key. Holds relationship to the Kiosk table. Denotes which Kiosk is assigned the Display Mode and Order
fk_DISPLAY_MODE→Foreign Key. Holds relationship to the Display Mode table. Denotes which Display Mode is assigned to the Kiosk
   Relationships:
toKiosks→1-to-1 relationship. Denotes which Kiosk is assigned the Display Mode and Order toDisplayModes 1-to-I relationship. Denotes which Display Modes are assigned to the Kiosk
   Kiosk_Products
   Attributes:
fk_KIOSK→Foreign Key. Holds relationship to the Kiosk table. Denotes to which Kiosk are the Products assigned
fk_PRODUCT→Foreign Key. Holds relationship to the Product table. Denotes which Products are assigned to the Kiosk
fk_BIN→Foreign Key. Holds relationship to the Brand information Network table. Denotes which Brand Information Network is assigned to each Product in each Kiosk
   Relationships:
Kiosks→1-to-1 relationship. Denotes to which Kiosk are the Products assigned
Products→1-to-1 relationship. Denotes which Products are assigned to the Kiosk
BINs→1-to-1 relationship. Denotes which Brand Information Network is assigned to each Product in each Kiosk
   Kiosks
   Attributes:
p_ID→Primary Key
name→Name of the Kiosk
active→Denotes whether the Kiosk is active or not
fk_SKIN→Foreign Key. Holds relationship to the Skin table. Denotes the Skin to be applied to the Kiosk
fk_LAUNCH_ENVIRONMENT→Foreign Key. Holds relationship to the Launch Environment table. Denotes in which Launch Environment the Kiosk shall launch.
   Relationships:
Skins→1-to-1 relationship. Denotes which Skin is to be applied to the Kiosk
LaunchEnvironments→1-to-1 relationship. Denotes in which Launch Environment shall the Kiosk be launched
toKioskDisplayModes→1-to-many relationship. Denotes to which Kiosk the Display Modes are assigned
toKioskProducts→1-to-many relationship. Denotes to which Kiosk the Products are assigned
toKiosksInstalled→1-to-many relationship. Denotes which Kiosk have been installed
   Kiosks_Installed
   Attributes:
p_ID→Primary Key
active→Denotes whether the Installed Kiosk is active or not
installed_domain→Records the Domain on which the Kiosk shall be placed
installation_reason→Records the reason for the installation of the Kiosk
fk_CLIENT_USER→Foreign Key. Holds relationship to the Client User table. Denotes which Client User installed the Kiosk
fk_KIOSK→Foreign Key. Holds relationship to the Kiosk table. Denotes which Kiosk has been installed
   Relationships:
ClientUsers→1-to-1 relationship. Denotes which Client User has installed the Kiosk
Kiosks→1-to-1 relationship. Denotes which Kiosks have been installed
toCampaignKiosks→1-to-many relationship. Denotes which Installed Kiosks are assigned to the Campaign
toDirectoryKiosks→1-to-many relationship. Denotes which Installed Kiosks are assigned to the Directory
toInstalledKioskPrivileges→1-to-many relationship. Denotes which Privileges are assigned to the Installed Kiosk
toOrderDetails→1-to-many relationship. Denotes which Installed Kiosk holds the Order Details
   Launch_Environments
   Attributes:
p_ID→Primary Key
name→Name of the Launch Environment
active→Denotes whether the Launch Environment is active or not
   Relationships:
toKiosks→1-to-many relationship. Denotes from which Launch Environment the Kiosk will be launched
   Marks
   Attributes:
p_ID→Primary Key
name→Name of the Trademark
active→Denotes whether the Trademark is active or not
   Relationships:
toBrandMarks→1-to-many relationship. Denotes which Marks are assigned to Brands
toProducts→1-to-many relationship. Denotes which Marks are assigned to Products
   Order_Details
   Attributes:
p_ID→Primary Key
display_order→Denotes in which Order will the Advertisements or Promotions be displayed
promotional_text→The Promotional Text to be displayed under the Promotion
fk_KIOSK→Foreign Key. Holds relationship to Kiosk table. Denotes on which Kiosk will the Advertisements or Promotions play
fk_LINK→Foreign Key. Holds relationship to Link table. Denotes which Link is to be used as the Advertisement or Promotion
fk_ORDER→Foreign Key. Holds relationship to Order table. Denotes to which Order this Detail item belongs
   Relationships:
Kiosks→1-to-1 relationship. Denotes on which Kiosk will the Advertisement or Promotion play
Links→1-to-1 relationship. Denotes which Link is to be used as the Advertisement or Promotion
Orders→1-to-1 relationship. Denotes to which Order this Detail item belongs
   Product_Marks
   Attributes:
fk_PRODUCT→Foreign Key. Holds relationship to Product table. Denotes which Product holds which Marks
fk_MARK→Foreign Key. Holds relationship to Mark table. Denotes which Marks are assigned to which Products
   Relationships:
Products→1-to-1 relationship. Denotes which Products hold which Marks
Marks→1-to-1 relationship. Denotes which Marks are assigned to which Products
   Products
   Attributes:
p_ID→Primary Key
name→Name of the Product
product_descriptor→Assigned Product Descriptor
upn→Universal Product Number assigned to the Product
active→Denotes whether the Product is active or not
fk_BRAND→Foreign Key. Holds relationship to Brand table. Denotes to which Brand the Product is assigned
   Relationships:
Brands→1-to-1 relationship. Denotes to which Brand the Products are assigned
toBrandInformationNetworks→1-to-many relationship. Denotes which Products are assigned to the Brand Information Network
toKioskProducts→1-to-many relationship. Denotes which Products are assigned to the Kiosk
toProductMarks→1-to-many relationship. Denotes which Products are assigned which Marks
toURLs→1-to-many relationship. Denotes which URLs are assigned to which Products
   Skins
   Attributes:
p_ID→Primary Key
name→Name of the Skin
skin_file→File location of the Configuration File as well as the sample skin image
active→Denotes whether the Skin is active or not
   Relationships:
toKiosks→1-to-many relationship. Denotes which Kiosks are assigned which Skins
   Styles
   Attributes:
p_ID→Primary Key
name→Name of the Style
active→Denotes whether the Style is active or not
   Relationships:
toBrandInformationNetworks→1-to-many relationship. Denotes what Styles are assigned to which Brand Information Networks
   URLs
   Attributes:
p_ID→Primary Key
URL→The URL string
active→Denotes whether the URL is active or not
fk_PRODUCT→Foreign Key. Holds relationship to Product table. Denotes to which Product the URL is assigned
   Relationships:
Products→1-to-1 relationship. Denotes to which Product the URL is assigned
toBINLinks→1-to-many relationship. Denotes which URLs make up the Links on which Brand information Networks
toOrderDetails→1-to-many relationship. Denotes which URLs make up the Advertisements or Promotions in the Order Detail record
   Description of the Presentation and Control Layers of the Brand Management and Marketing Communication Network of the Illustrative Embodiment (Brand Marketing Communication Network)

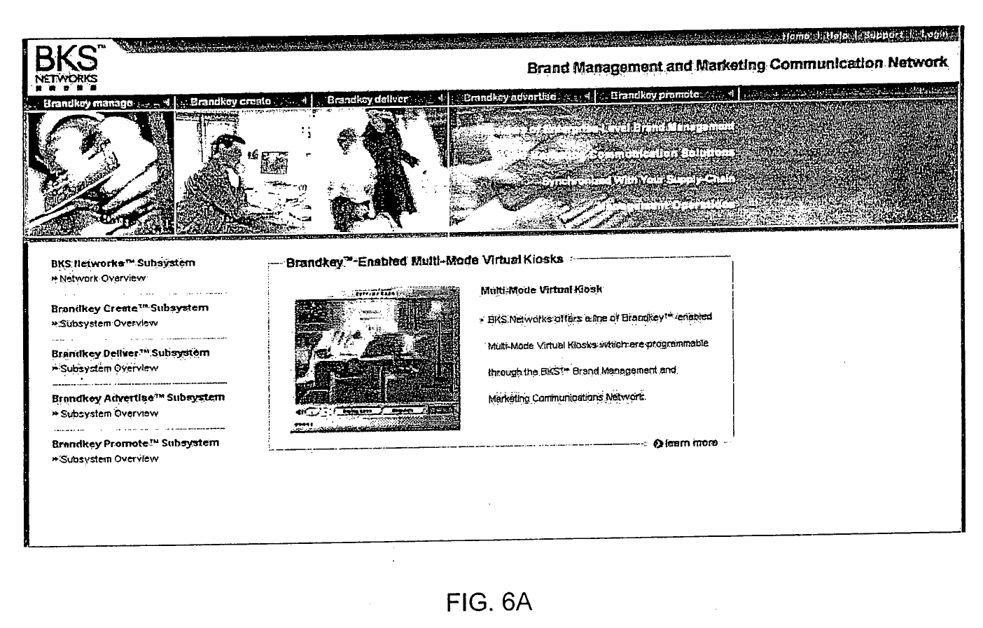

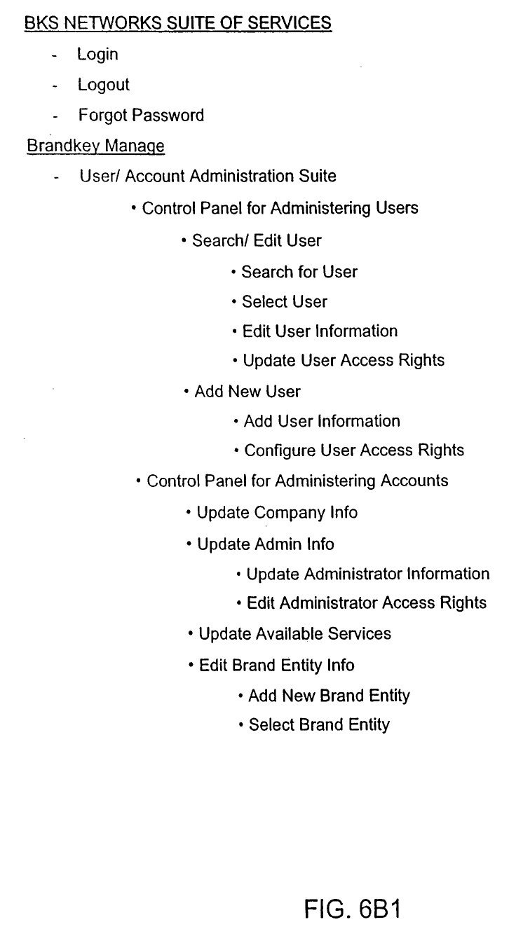

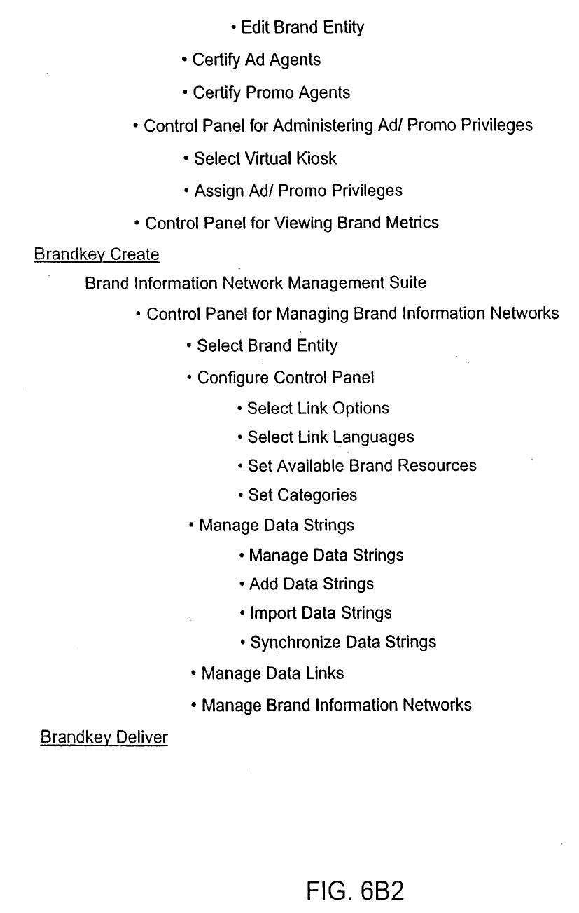

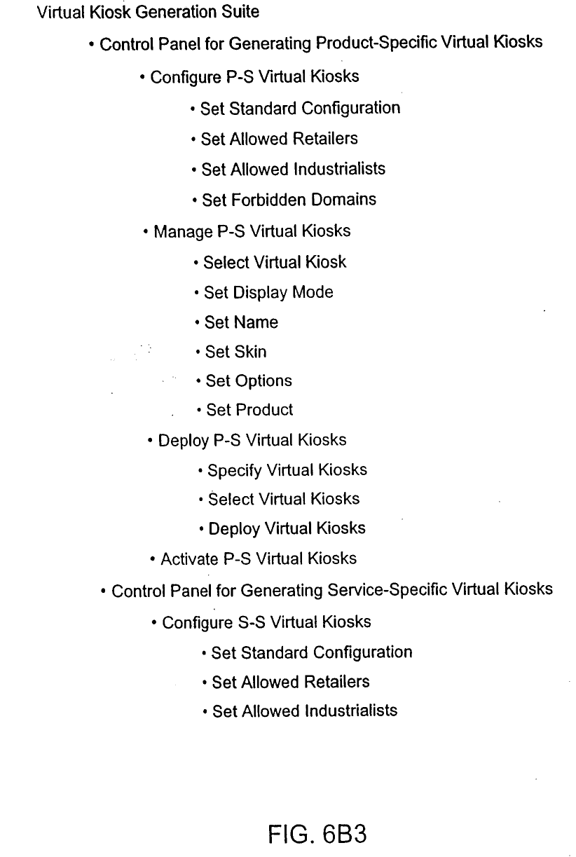

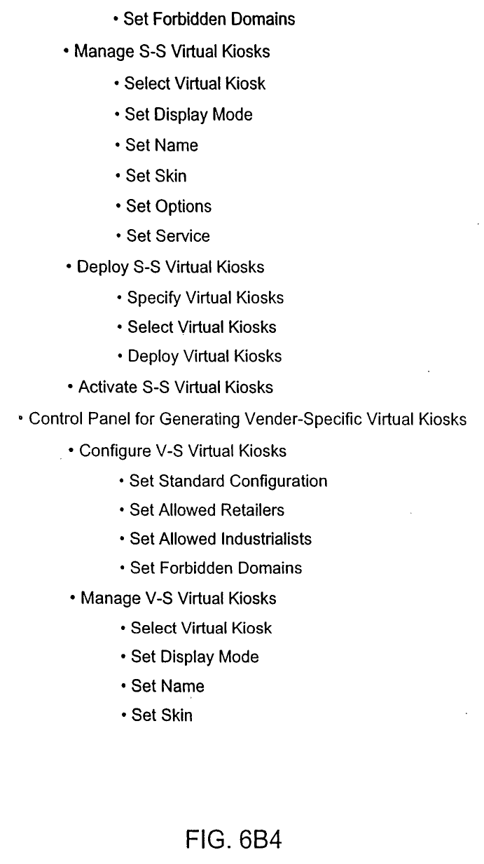

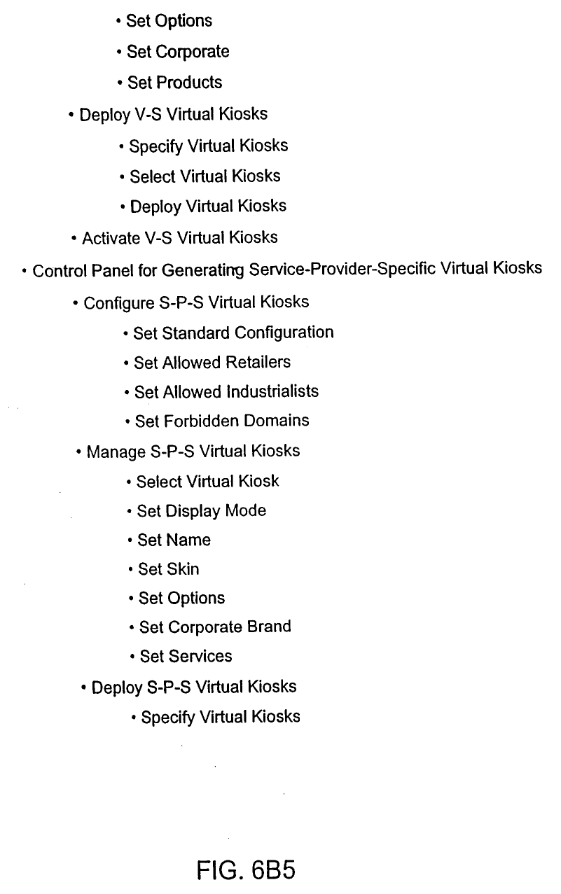

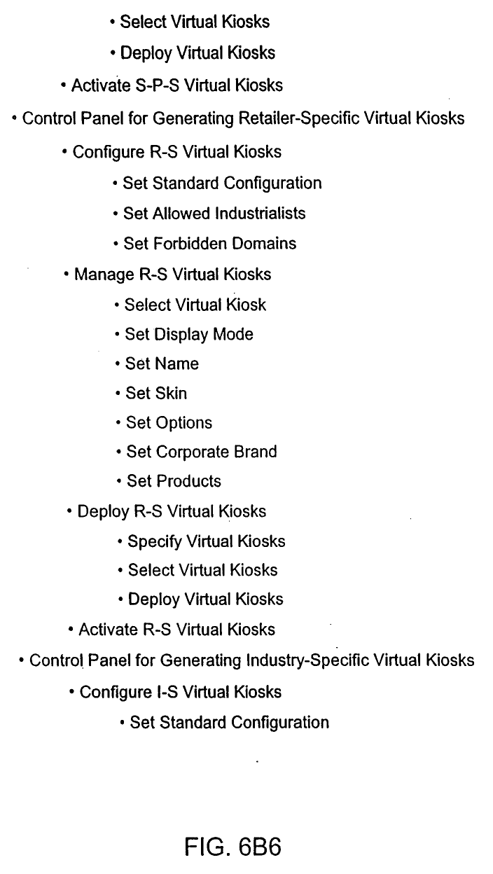

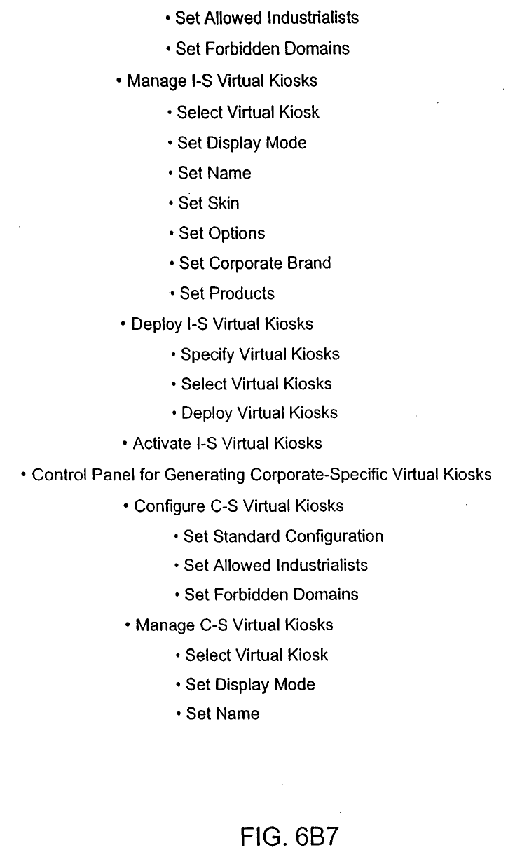

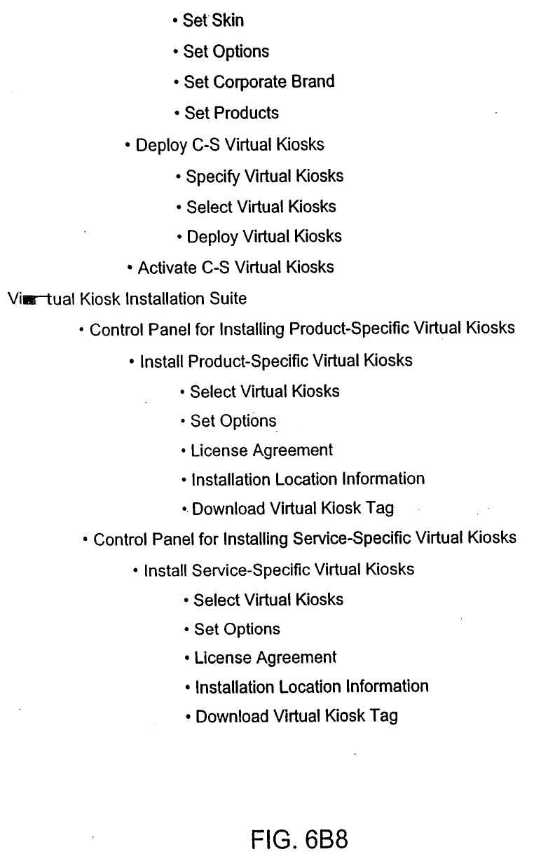

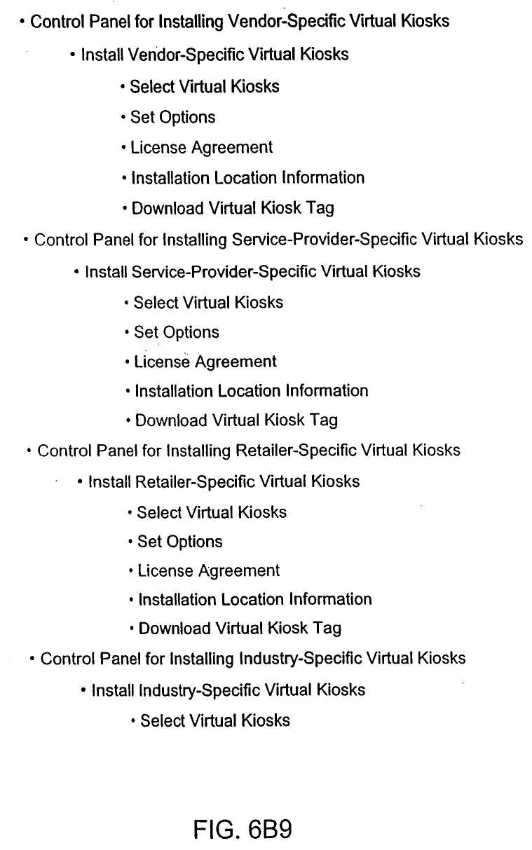

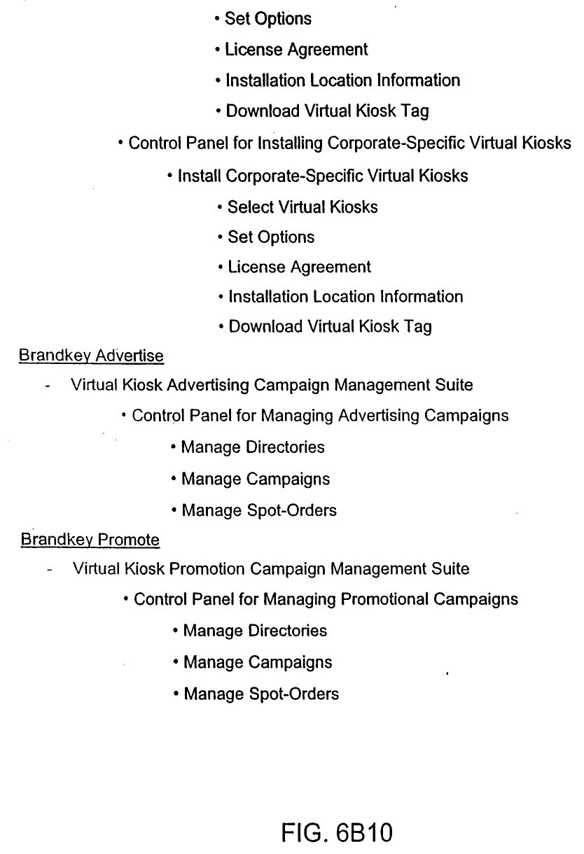

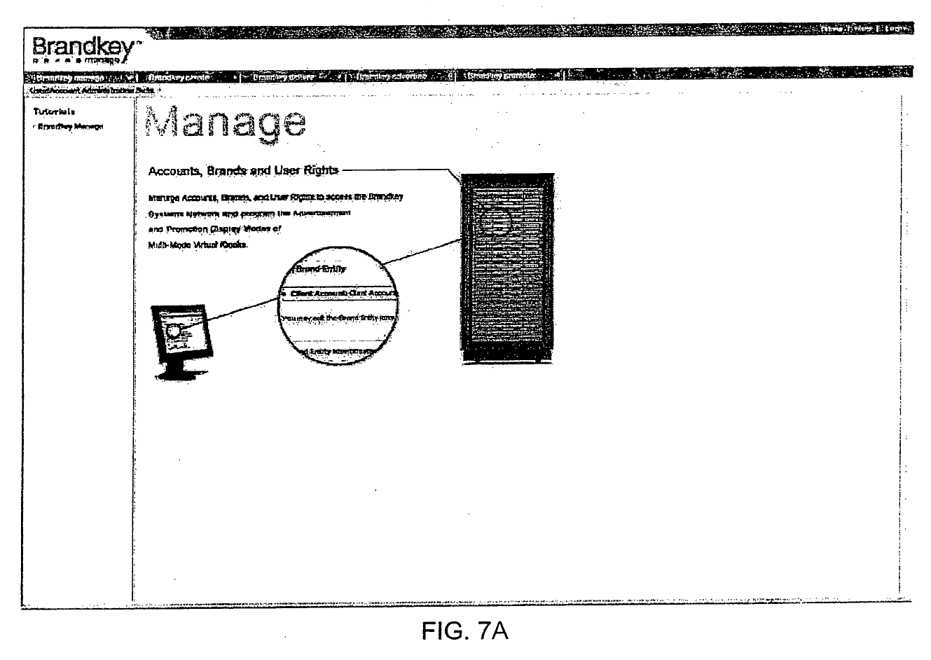

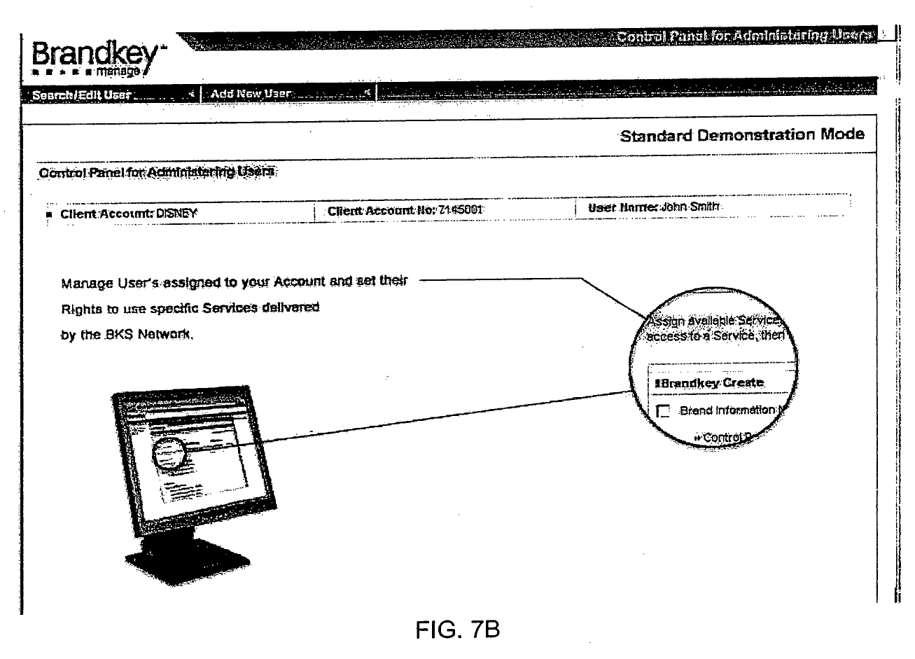

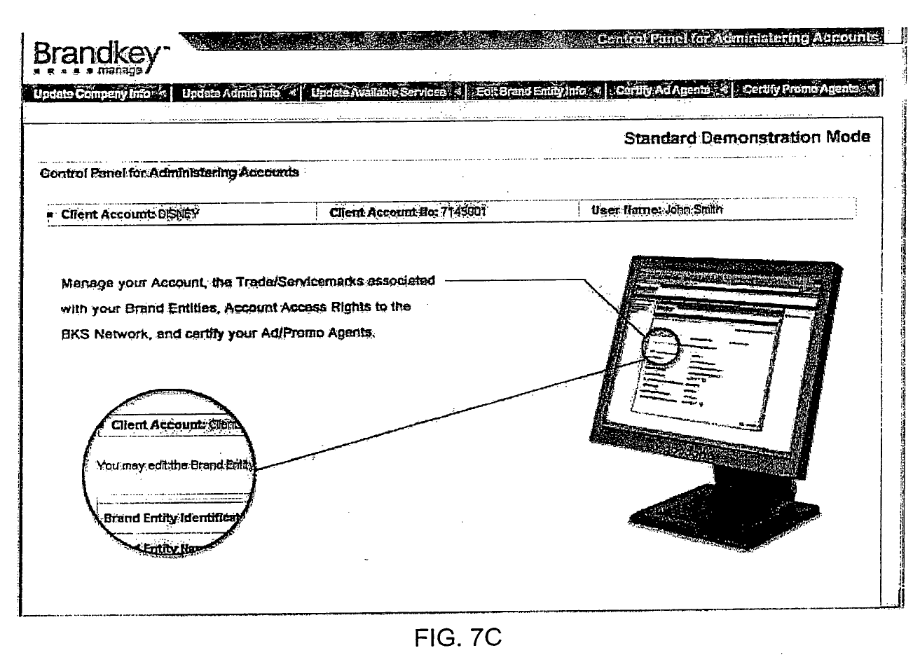

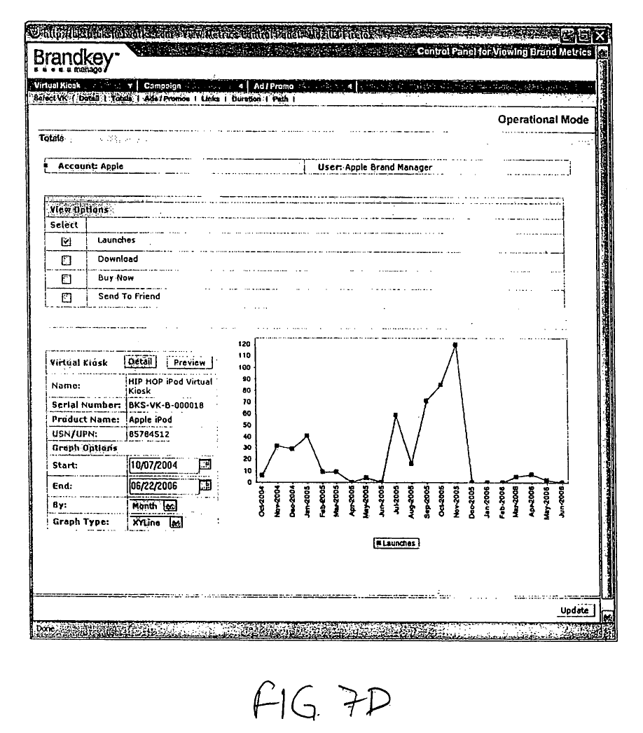

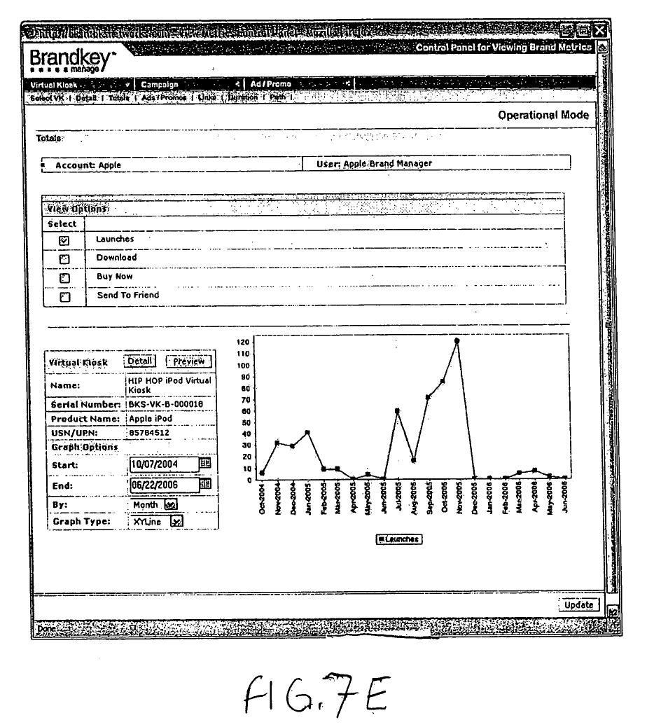

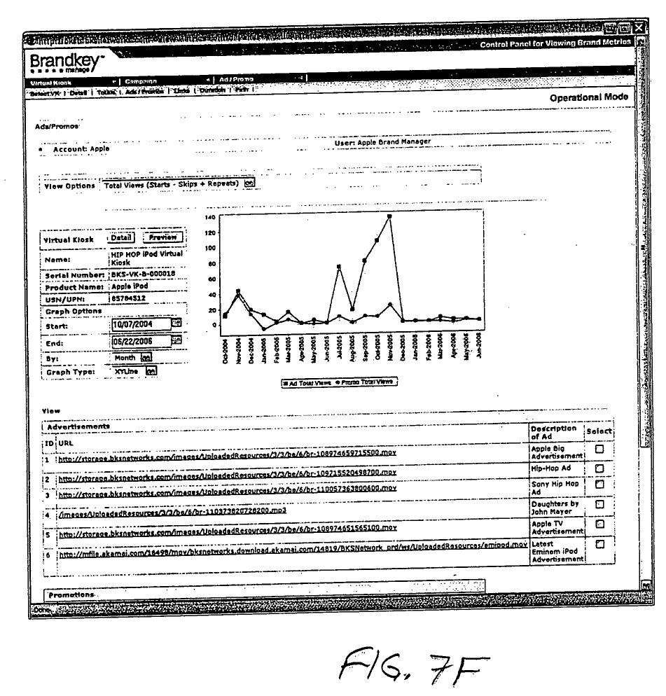

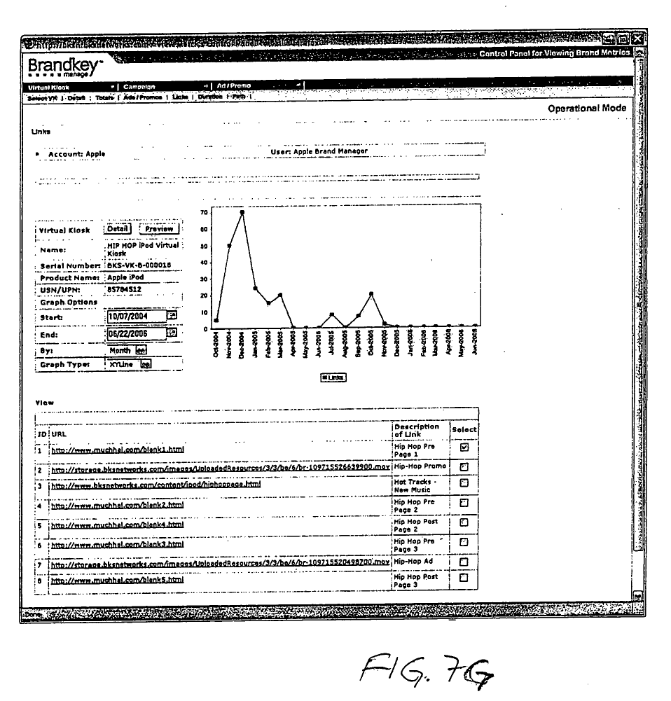

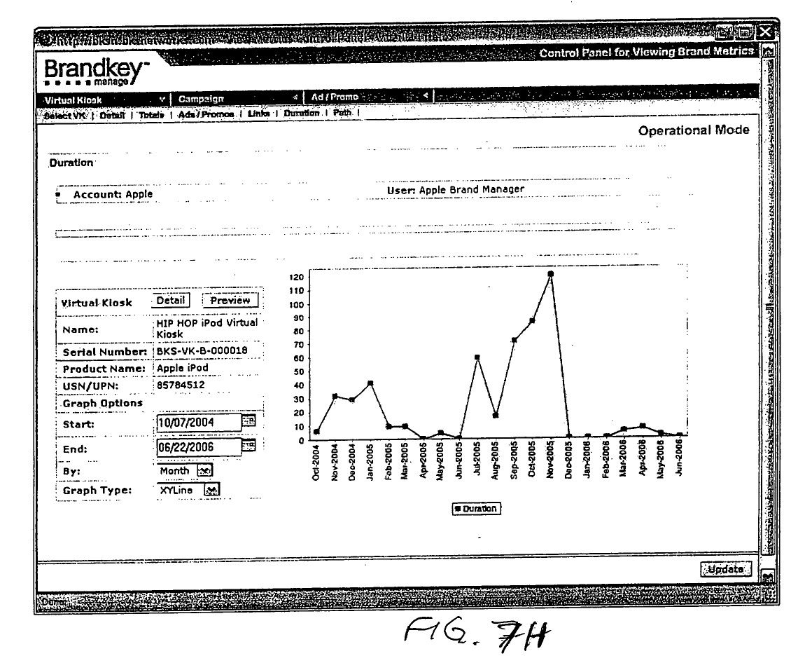

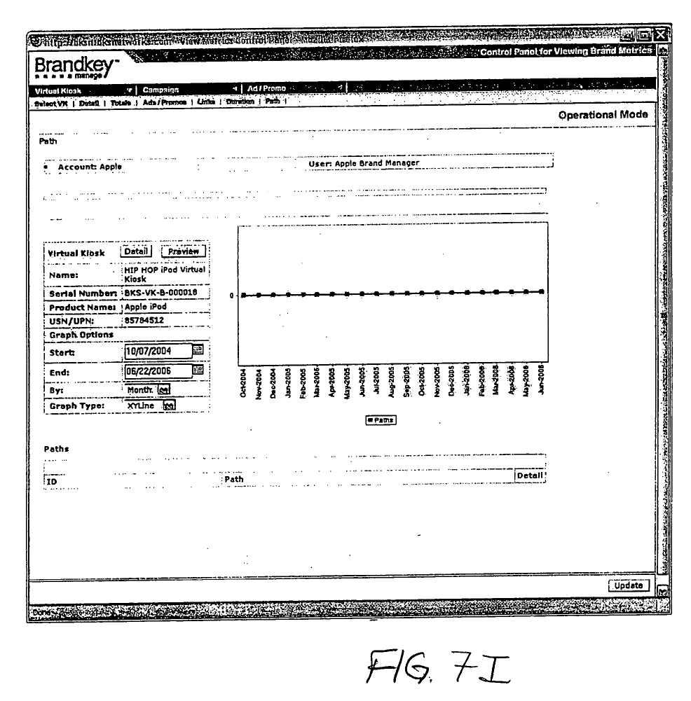

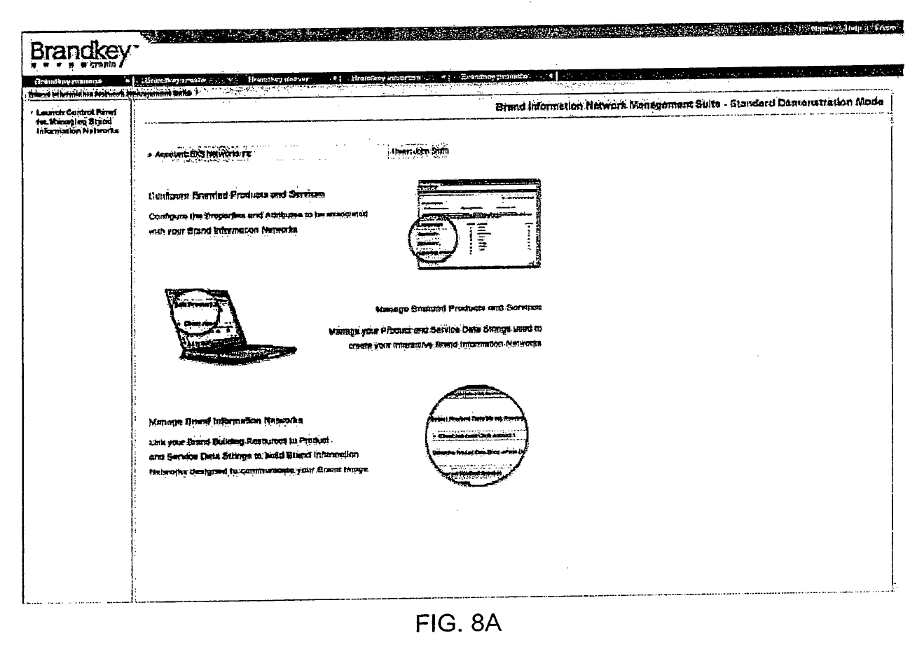

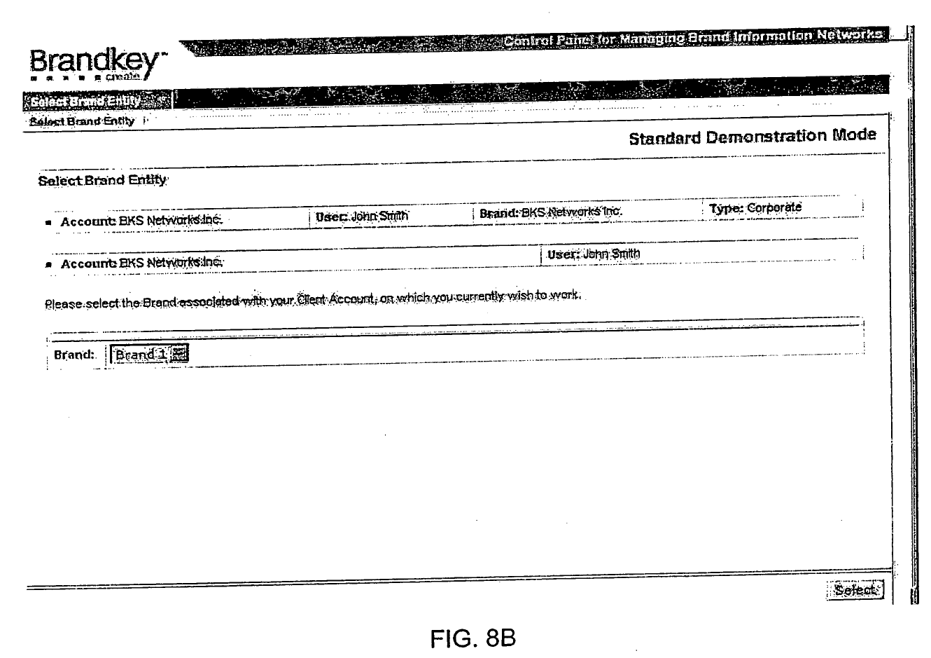

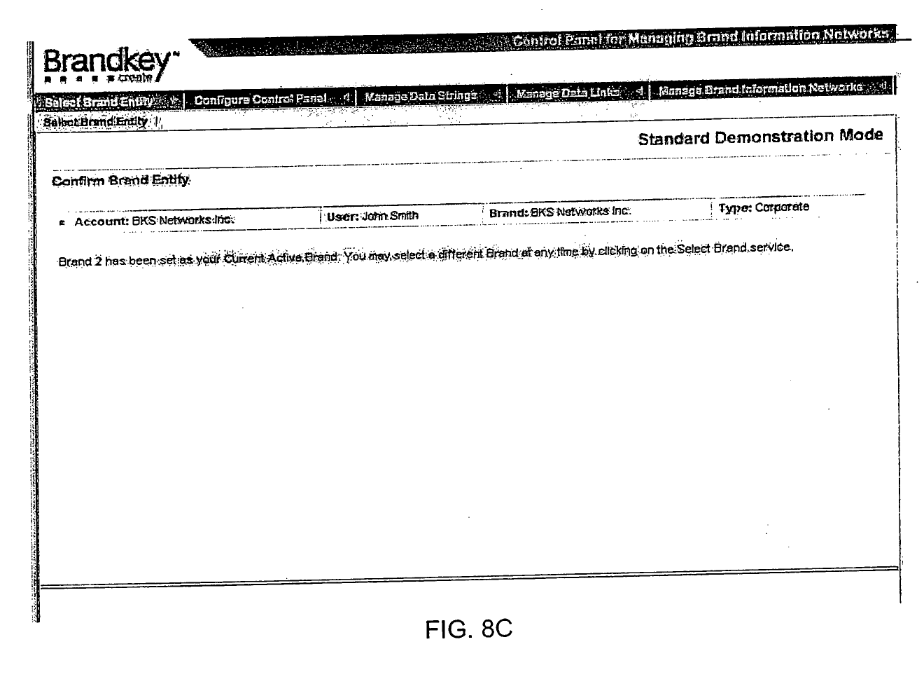

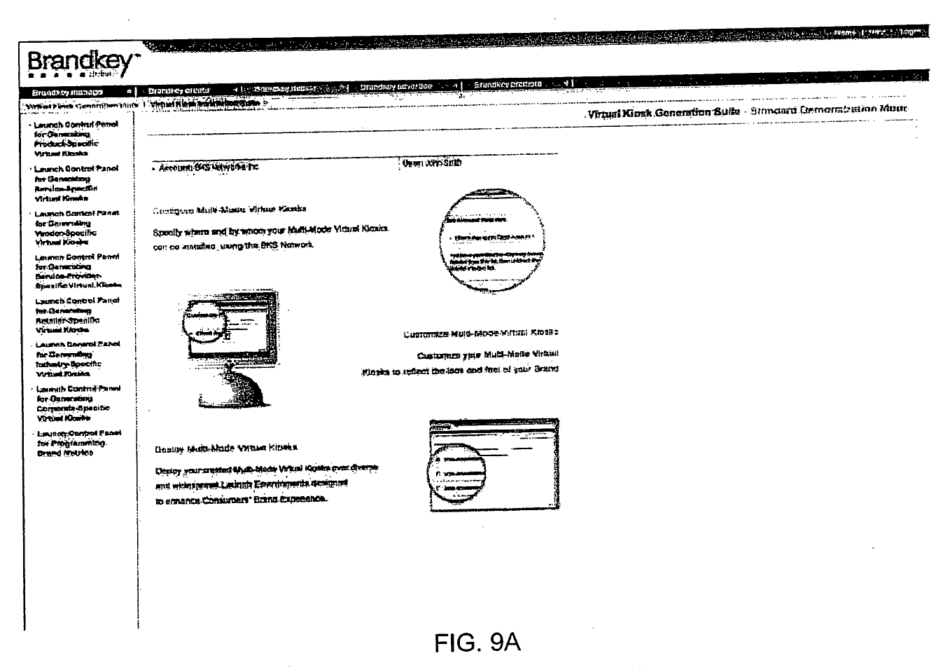

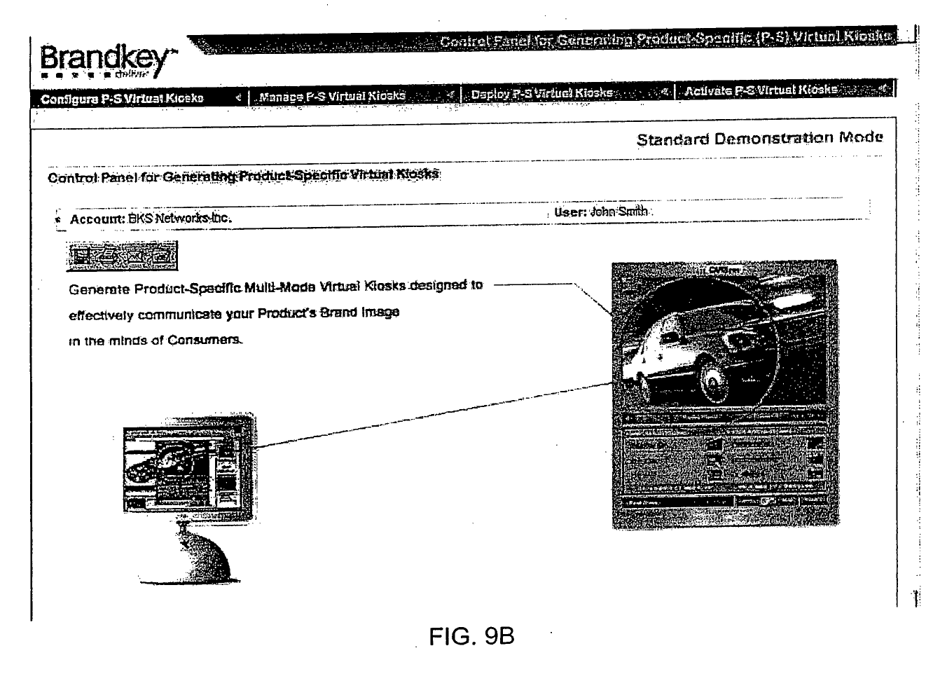

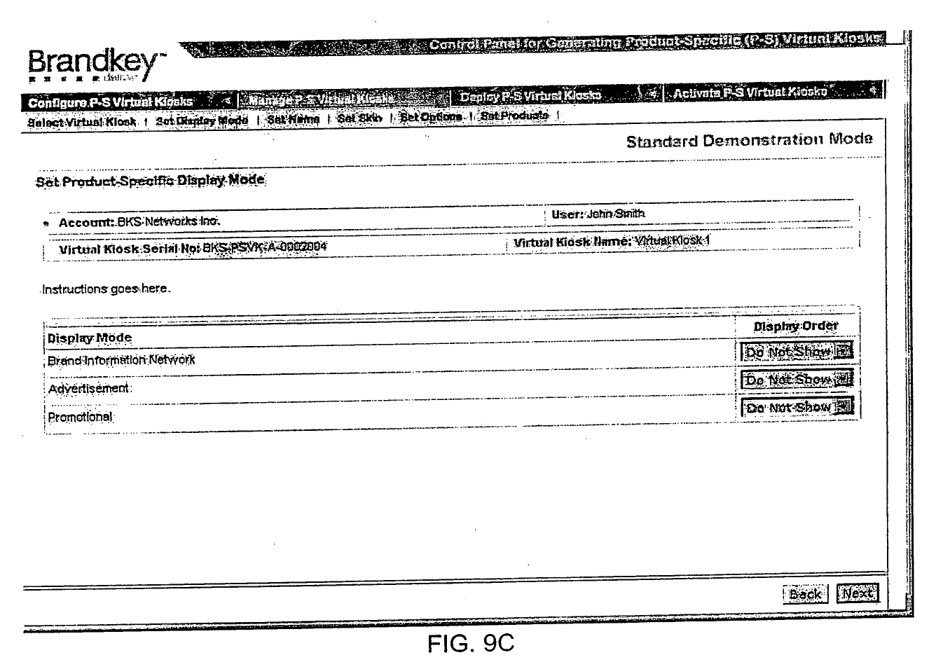

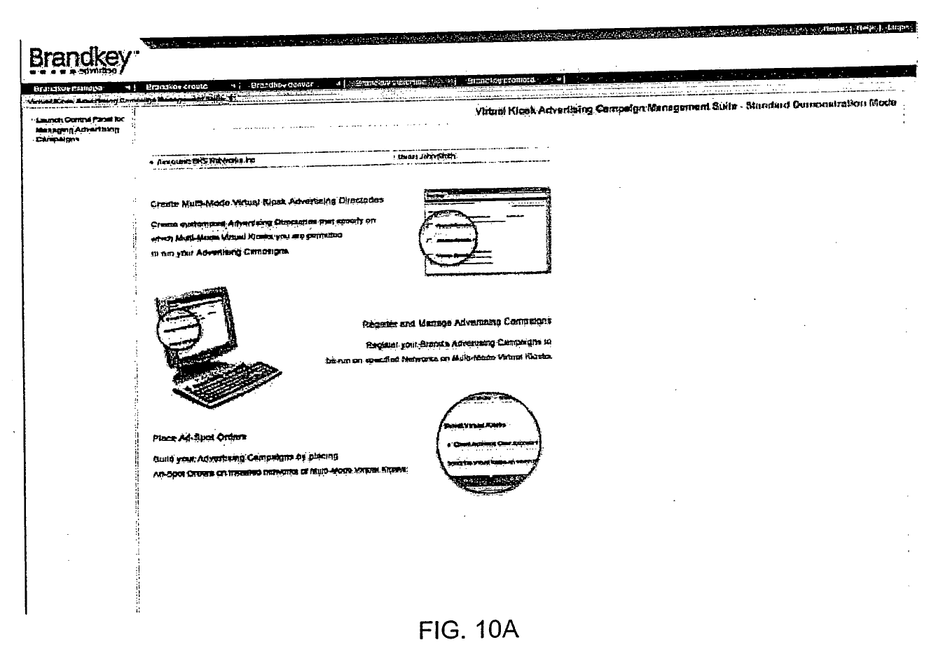

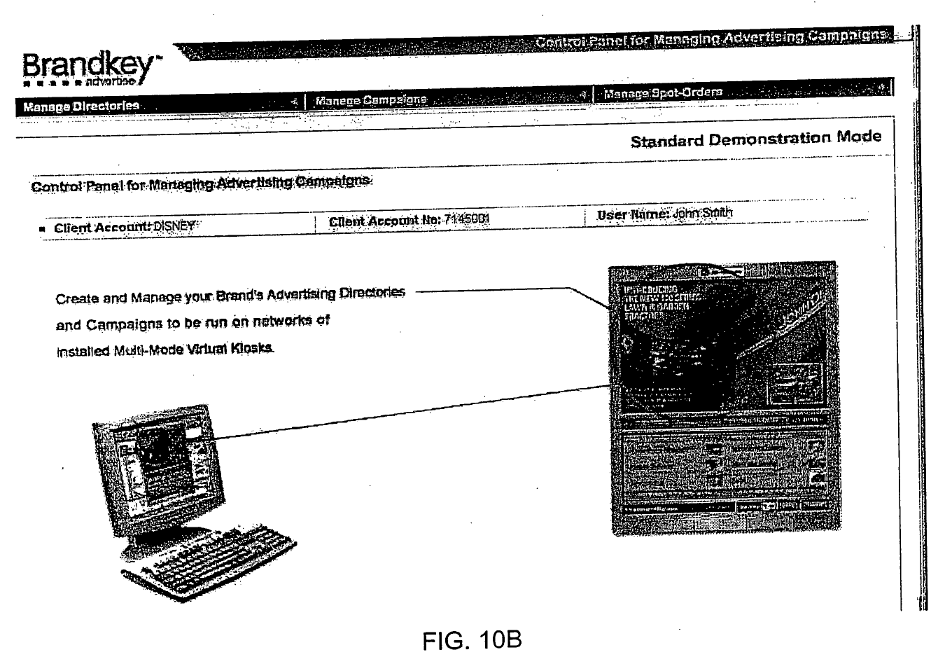

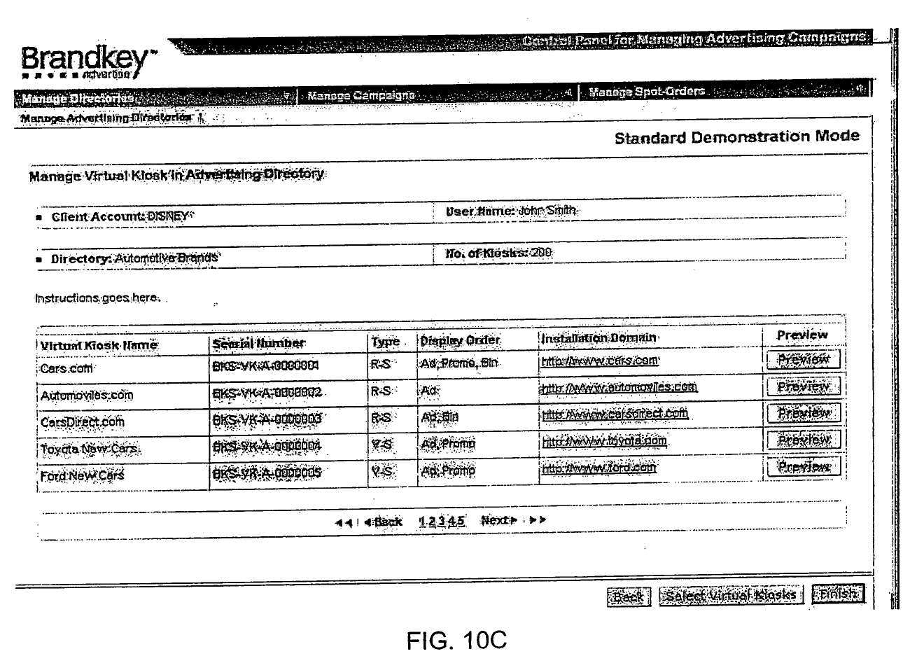

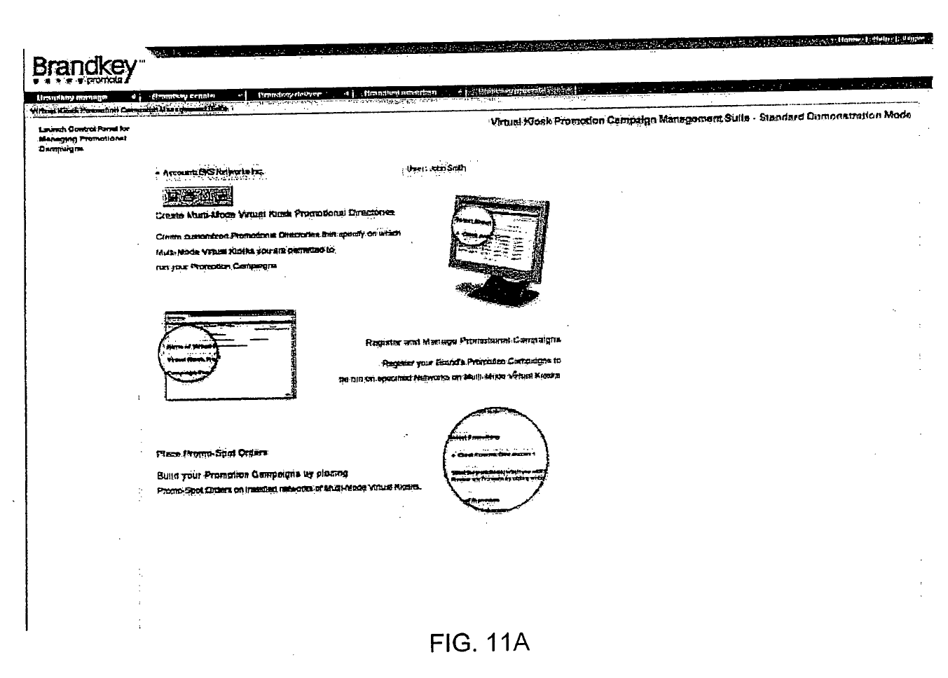

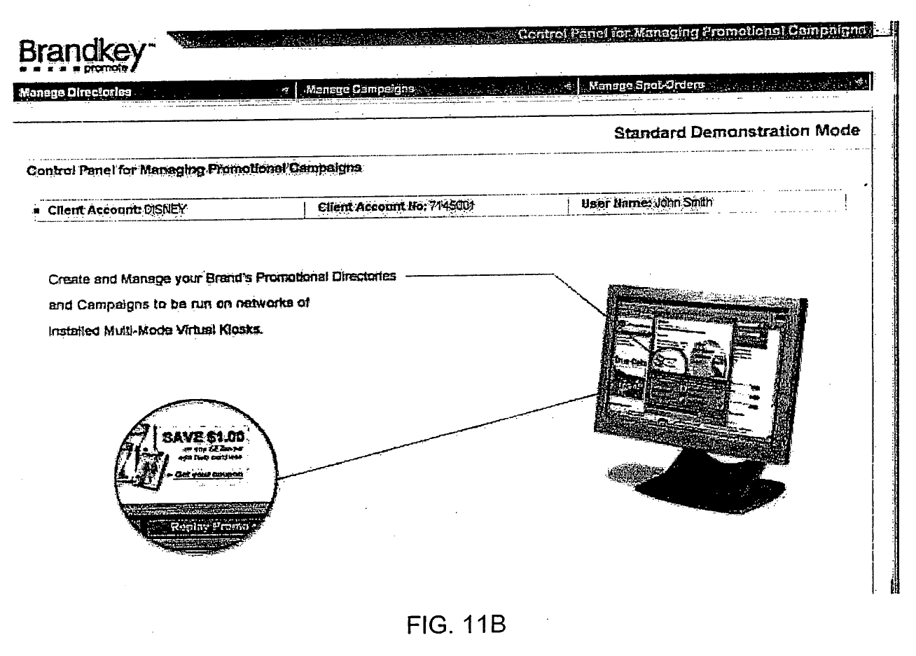

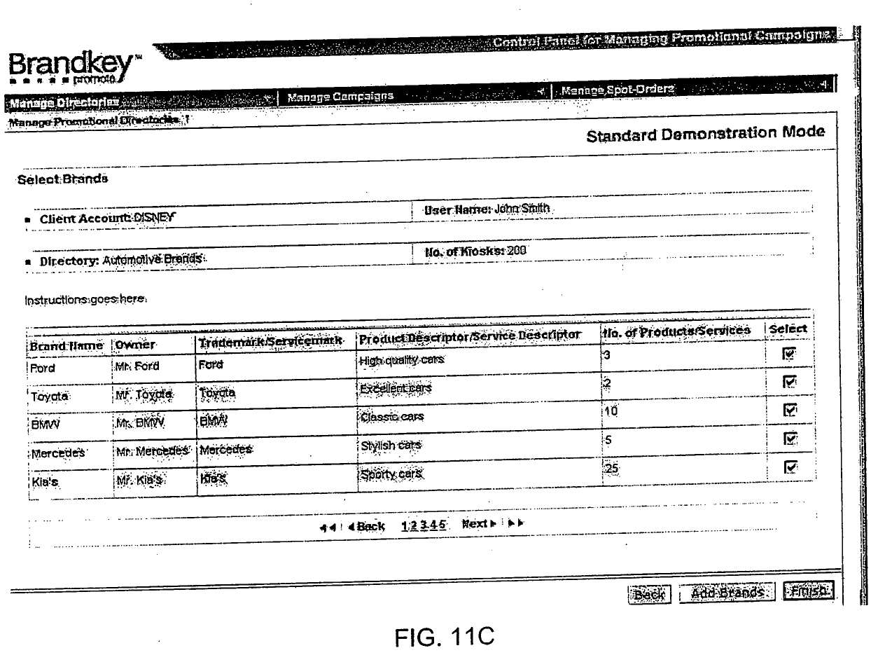

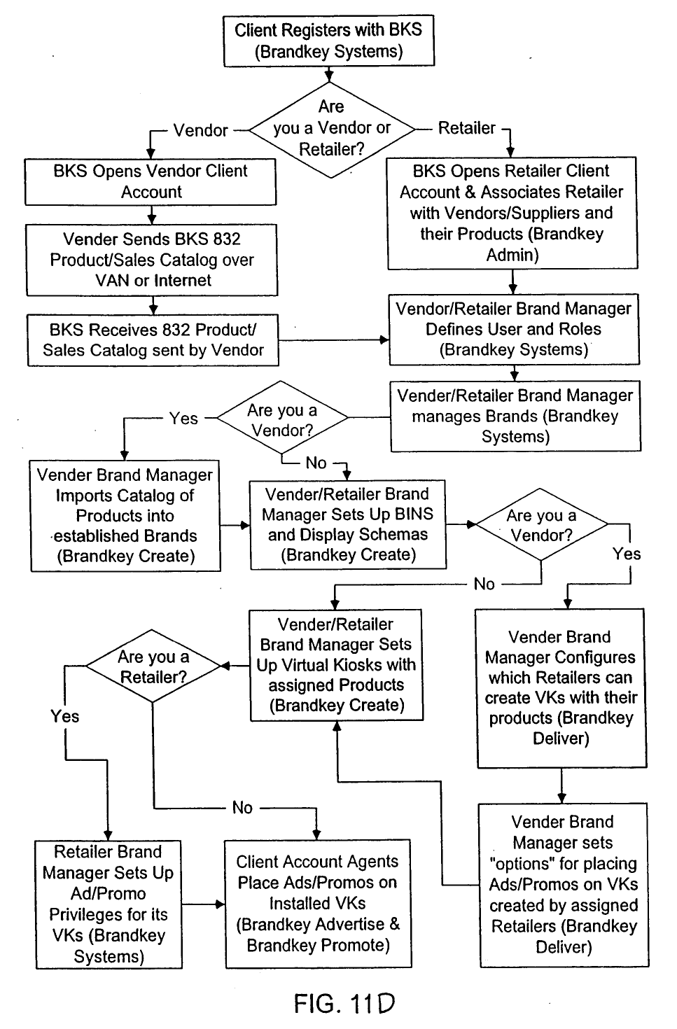

As illustrated in the GUI panel shown in FIG. 6A, the Brand Management and Marketing Communication Instrumentation Network of the present invention is divided into five customer-based Subsystems, identified by the following intent-to-use (ITU) trademarks: Brandkey Manage™ Subsystem whose GUI panels and services are illustrated in FIGS. 7A through 7H, and 7I through 7R; Brandkey Create™ Subsystem whose GUI panels and services are illustrated in FIGS. 8A through 8I; Brandkey Deliver Subsystem whose GUI panels and services are illustrated in FIGS. 9A through 9K; Brandkey Advertise™ Subsystem whose GUI panels and services are illustrated in FIGS. 10A through 10H; Brandkey Promote™ Subsystem whose GUI panels and services are illustrated in FIGS. 11A through 11G; and Brandkey Admin™ Subsystem whose GUI panels and services are described below.

The Brandkey Deliver™ Subsystem provides Brand Management Teams the ability to rapidly configure, deploy, and install Multi-Mode Virtual Kiosks anywhere on the Internet.

The Brandkey Advertise™ Subsystem enable Brand Managers and their Agents to program the Advertising Spot Display Mode of their Multi-Mode Virtual Kiosks in a simple an convenient manner. These operations are carried out by creating, executing and managing Advertising Campaigns designed to run on networks of Multi-Mode Virtual Kiosks.

Using the Brandkey Promote™ Subsystem, Brand Managers and their Agents can program the Promotional Spot Display Mode of their Multi-Mode Virtual Kiosks. These programming operations are carried out by creating, executing and managing Promotional Campaigns designed to run on networks of Multi-Mode Virtual Kiosks.

The Brandkey Create™ Subsystem enables Brand Managers and their Agents to program the Brand Information Network Display Mode of their Multi-Mode Virtual Kiosks using simple mouse-clicks and data-entry operations. Programming operations are carried out by creating and deploying interactive models of Product and Service Brands represented in the form of richly-associated Brand-Building Information Networks. These Information Networks create and reinforce the intended Brand Image of Products and Services within the minds of Consumers.

As discussed above, Web-based Brand-Building Information Networks (BINs) can be constructed for Product-type Brands by linking the Uniform Resource Locators (URLs) of Brand Building Information Resources to Product Data Strings (UPN/TM/PD) consisting of the Universal Product Number (UPN), Trademark (TM) and Product Descriptor (PD) of branded products. For Service-type Brands, these Brand Information Networks can be created by linking the Uniform Resource Locators (URLs) to Service Data Strings (USN/SM/SD) consisting of the Universal Service Number (USN), Servicemark (SM) and Service Descriptor (SD) of branded services. Similarly, for Corporate-type Brands, these Brand Information Networks can be created by linking the Uniform Resource Locators (URLs) to Service Data Strings (USN/SM/SD) consisting of the Universal Service Number (USN), Servicemark (SM) and Service Descriptor (SD) of branded services.

The Brandkey Systems™ Administration Subsystem enable Users to perform basic management and administration functions relating to Client Accounts, Brands, and User Rights and Privileges.

Using the Multi-Mode Virtual Kiosks supported by the Network, consumers can learn about brands in a more effective and enjoyable manner, and develop strong preferences for them.

As will be described in detail below, each of these Subsystems has one or more service suites, and each suite supports one or more Control Panels, which may be realized as either Web-based clients or Java clients. As shown in FIGS. 6B1 through 6B10, these Control Panels and related services (i.e. Marketing Instruments) are identified in hierarchical order as they are provided within the Brand Management and Marketing Network of the illustrative embodiment, namely.

The purpose of these Control Panels is to perform specific operations that support the revolutionary ensemble of brand marketing communication instruments of the present invention, in a manner quite independent of the other Subsystems. The back-end relational database management subsystem (RDBMS) used by the Brand Marketing Communication Network (i.e. “BKS Network” or “BKSN”) schematically depicted in FIGS. 2, 3A and 3B, is the common item that integrates together the subsystems of the entire the Brand Management and Marketing Communication Instrumentation Network.

The Brandkey Admin Subsystem

In the illustrative embodiment, the Brandkey Admin Subsystem is reserved for use by Brandkey Systems (BKS) Employees, and preferably is realized as a standalone WebObjects Application on an Application Server, as is the Multi-Mode Virtual Kiosk (MMVK) Serving Subsystem shown in FIG. 2B. The Admin Subsystem will contain all the back-end functionality network service providers will use to maintain the network and the accounts that make up the Brand Marketing Communication Network. The Admin Subsystem shall be divided into six Service Suites; the Administrator Management Suite, the Marketing Management Suite, the Account Management Suite, the Revenue Management Suite and the Technical Management Suite.

All Brandkey Employee administration will occur in the Administrator Management Suite. There will be six (6) levels of BKS Employees; SuperUsers, Account Supervisors, Marketing Managers, Account Managers, Revenue Managers and Technical Managers. SuperUsers have full access throughout the system. Account Supervisors report to SuperUsers and are responsible for certain assigned Accounts. Account Manager. Account Managers, Revenue Managers and Technical Managers report to Account Supervisors and are responsible for certain aspects of assigned Accounts.

The primary marketing functions for Prospective Client Accounts occur in the Marketing Management Suite. Only SuperUsers, Account Supervisors and Marketing Managers have access to this Suite.

The primary management functions for BKS Accounts occurs in the Account Management Suite. Only SuperUsers, Account Supervisors and Account Managers have access to this Suite.

The primary revenue management functions for BKS Accounts occur in the Revenue Management Suite. Only SuperUsers, Account Supervisors and Revenue Managers have access to this Suite.

The primary technical and user-support management function for BKS Accounts occur in the Technical Management Suite. Only SuperUsers, Account Supervisors and Technical Managers have access to this Suite.

The following describes briefly the functions provided in each of the five core Subsystems of the Brand Marketing Communication Instrumentation Network of the present invention.

The Brandkey Manage Subsystem

The Brandkey Manage™ Subsystem, illustrated in part in FIGS. 7A through 7I, and greater detail in WIPO Publication No. 2005/001656, incorporated herein by reference, is the central location where Brand Managers and Client Account Administrators can manage their Client Accounts and Brands, set User Rights to access the Brand Marketing Communication Network as well as program the Advertisement and Promotion Display modes of Multi-Mode Virtual Kiosks. This Subsystem allows the Brand Managers to:
Register with Brand Marketing Communication Networks to set up Client Accounts
Manage users assigned to the client account as well as their rights to use specific services delivered by the Brand Marketing Communication Network
Manage Accounts, the Trade/Servicemarks associated with the Brand Entities, account Access rights to the Brand Marketing Communication Network and certify Ad/Promo Agents.
Assign business associates privileges to place Ad/Promo Spots on the installed Multi-Mode Virtual Kiosks
View Brand Metrics relating to services delivered by the Brand Marketing Communication Network.

The Brandkey Manage™ Subsystem is an extension of the overall Brand Marketing Communication Network from the front page of its Web-based GUI. There are Administrative instruments as well as Demonstration and Tutorial instruments designed to instruct and illuminate the User in the workings of the Brand Information Management and Marketing Communication Network of the present invention as a whole.

In the illustrative embodiment, the Brandkey Manage™ Subsystem is divided into the following Suites; the Demonstration Suite, the Tutorial Suite, the Registration Suite, and the User/Account Administration Suite.

The Demonstration Suite contains Flash and other types of Demonstration materials for the various parts of the Brand Marketing Communication Network. These demonstrations are designed to give the User a bird's eye (10,000 foot) view of the System and its capabilities.

The Tutorial Suite contains Flash Tutorials for every part of the Brand Marketing Communication Network. These tutorials are designed to give the User an in-depth understanding of the functionality of the every aspect of the Brand Marketing Communication Network and how to best utilize its revolutionary Brand Marketing Communications Instruments.

The Registration Suite contains the Registration Control Panel, which new Users use to register with the Brand Marketing Communication Network. Generally these Registrants will be Brand Managers, Advertising or Promotional Agents, etc., or those people with certain high-level responsibilities for Brands. The Registration Process asks the Registrant for their Personal Information, then their Brand Entity Information, then their relationship with the Owner of the Brand. Once this information is filled in, it is recorded to the database and sent to the BKS Administrators to verify. If the Registrant is a Consumer, they will be given immediate access to the System. However, they will only have access to the Virtual Kiosk Installation Suite in the Brandkey Deliver™ Subsystem.

Once a User's Registration has been approved, they will gain access to the User/Account Administration Suite. This Suite is accessible only to those Users who are the Administrators of their Client Account. By default the Registrant is initially set as the default Administrator of the Client Account. This can be changed with a request to the Client Account's Brandkey Administrator.

In the User/Account Administration Suite, there are four Control Panels for the User to select; the Control Panel for Administering Users, the Control Panel for Administering Accounts, the Control Panel for Administering Ad/Promo Privileges, and the Control Panel for Viewing Brand Metrics shown in FIGS. 7D through 7I.

The Control Panel for Administering Users allows the Administrator to edit the personal information for any User associated with their Client Account and to mange that User's Access Rights for the Network. The Administrator can also add new Users and configure their Access Rights for the Network.

The Control Panel for Administering Accounts allows Administrators to manage their Client Account Information. They may update their Company Information, their own personal information and access rights; they may also edit the list of Brand Entities associated with their Client Account or add new Brand Entities to their Client Account. Along with these Brand Entities the Administrator is allowed to manage or add new Trademarks or Servicemarks associated with those Brand Entities. Finally in this Control Panel, the Administrator is also able to Certify or Decertify any Advertising and Promotional Agents associated with their Client Account. When an Advertising or Promotional Agent signs up with the Brand Marketing Communication Network, they are asked which Brands they work for. Once that information is received from the Agent, they are put into the queue of pending Agents for certification by the Administrator of those Brands. If the Administrator certifies those Agents, then they are added to the Certified Agents list. If the Administrator does not certify those Agents, then they are deleted from the Database for that relationship. Likewise, if a Certified Agent is then decertified, their relationship with that Client Account is deleted from the Database.

The third Control Panel is the Control Panel for Administering Ad/Promo Privileges for installed Virtual Kiosks. Each Multi-Mode Virtual Kiosk can support Advertisements and/or Promotions. It is up to the Virtual Kiosk owner to decide which Vendors, Service Providers, etc. have access to which Virtual Kiosks containing their Products, Services, or Brands. The Administrator will select a Virtual Kiosk from the list and see which Vendors, Service provider, etc. have Products, Services, and Brands associated with that Multi-Mode Virtual Kiosk. They may then assign Shared privileges or Exclusive privileges for that Client to place Advertising or Promotional spots on that Virtual Kiosk. If the Administrator chooses a Shared privilege for a Client on a Virtual Kiosk, this means that the Administrator may add other Clients to share the Advertising space on that Virtual Kiosk. However, if the Administrator chooses an Exclusive privilege for a Client on a Virtual Kiosk, then that Virtual Kiosk is blocked for any other Client to place Advertising or Promotional spots on it. If a Virtual Kiosk had Shared privileges, then a Client gains Exclusive privileges, then that Exclusive privilege trumps any Shared privilege previously configured for the Virtual Kiosk.

The fourth Control Panel is the Control Panel for Viewing Brand Metrics for installed MMVKs. A brief overview of such metrics is in order.

Every action in the Virtual Kiosk is saved to the Brandkey Metrics tables as raw data keyed to the unique, individual session for each User who launches a Virtual Kiosk.

The reporting functionalities of the Network of the present invention allows the easy reporting of collected Brand Metrics for specific views as requested by the Client. Typical Views (i.e. basic data) that would be supported by the Network include, for each installed MMVK for example:

Date of creation of the MMVK

Which Products/Services are deployed on the MMVK

Number of Launches of the MMVK

Number of Ads assigned to the MMVK

Number of Promos assigned to the MMVK

Date and location the MMVK was installed

Other installations of the MMVK (e.g. along other sales and marketing channels)

Totals for the installed MMVK:

Number of Launches of the MMVK

Number of Downloads from the MMVK

Number of times Viral Marketing was initiated on the MMVK

Number of people to which the MMVK was sent

Number of Conversions on the MMVK (i.e. selections of the BUY NOW button)

Advertisement/Promotion detailed information for each Advertisement and Promotion:

Number of Total Views (Starts−Skips+Repeats)

Number of Starts

Number of Skips

Number of Repeats

Number of Views for each Link in the BIN (Brand Information Network) of the MMVK

Average Duration of viewing the MMVK

Average of Most Common User Paths within the MMVK.

By using the above-described Control Panels and Suites, the Administrator and other Users can safely navigate the Brand Marketing Communication Network and set up accurate representations of their Brand Account and access rights and ad/Promo spot placement privileges for their Multi-Mode Virtual Kiosks, as well as view Brand Metrics collected on installed MMVKs anywhere along the Network.

The Brandkey Create Subsystem

The Brandkey Create™ Subsystem, illustrated in part in FIGS. 8A through 8C and in greater detail in WIPO Publication No. 2005/001656, supra, employs the latest advances in cognitive science and learning theory to enable Brand Managers and their team members to create and deploy multi-level interactive audio-visual models of product, service and corporate brands represented in the form of Brand Information Networks supported by brand-building information resources on the Internet (e.g. WWW, ftp sites, etc).

These Brand Information Networks are constructed upon a network of Brand-Building Information Links located at the nodes of the Brand Information Network. Each node in the Network can be encoded with brand-identifying graphics and audio clips selected by the Brand Manager's team and build and reinforce the Brand Image intended by the Brand Managers.

By strengthening the intended Brand Image associated with their Brand Entity, Brand Managers can effectively combat the forces of brand-related confusion, erosion, and dilution created by marketplace clutter.

The results of delivering Brand Information Networks to Consumers at Internet-based touchpoints before, during and after purchases are consumers learn about and remember what is relevant and important about the particular Brand Entities represented by the delivered Brand Information Network; brand managers build stronger, more powerful Brands in the minds and hearts of Consumers; and stronger, more powerful Brands increase the level of influence brand managers have along their distribution channels.

The Brandkey Create™ Subsystem enable Brand Managers to manage their list of Products and Services and to create the networks of richly associated Brand-Building Resources used on the Multi-Mode Virtual Kiosks to build stronger, more powerful Brands in the minds and hearts of Consumers. The Brandkey Create™ Subsystem consists of one Suites; the Brand Information Network Management Suite.

Brandkey Create Subsystem also supports several different mechanisms for visualizing brand images projected by brand information networks (BINs) created by brand management team members, as described in WIPO Publication No. 2005/001656 supra, below.

Brandkey Deliver Subsystem

The Brandkey Deliver™ Subsystem, illustrated in part in FIGS. 9A through 9C and in greater detail in WIPO Publication No. 2005/001656 supra, is the component of the Brand Management and Marketing Communication and Commerce Enabling Network where the User is allowed to Create, Customize, Deploy, and Install Brand Building Multi-Mode Virtual Kiosks across various Consumer Touchpoints through a number of different Launch Environments. Generally, the Brand Managers or full-service Agents will be the ones who will use this Subsystem.

Once the Brand Information Networks are programmed in the Brandkey Create™ Subsystem, they need to be associated with Multi-Mode Virtual Kiosks. This will be accomplished in the Brandkey Deliver™ Subsystem.

The Brand Marketing Communication Network supports several different types of Multi-Mode Virtual Kiosks for each of the different kinds of trading partners along the retail value chain:
Product-Specific (PS)
Service-Specific (SP)
Vendor-Specific (VP)
Service-Provider-Specific (SPS)
Retailer-Specific (RS)
Industry-Specific (IS)
Corporate-Specific (CS)

In general, Multi-Mode Virtual Kiosks (MMVKs) of the present invention have have a number of similar characteristics in common, namely:

(1) the ability to display information in any combination of 3 Modes; Advertising, Promotion, and Brand Information;

(2) the ability to be launched from any Internet-enabled touchpoint;

The ability to have a programmed “Call to Action” button (e.g. Buy Now, Order Now, etc.);

(3) the ability to support e-commerce transactions, and support the generation and tracking of sales commissions earned by affiliates on the transactions initiated by (or conducted through) MMVKs having affiliate services of the present invention enabled;

(4) the ability to facilitate viral marketing in the form of “Send this Kiosk” button;

(5) the ability to collect metrics regarding consumer interaction with the interface objects in the GUI screens of the MMVK; and

(6) the ability to initiate e-commerce transactions at manufacturer or retailer sponsored e-commerce sites, and for network affiliates who host such MMVKs on their Web sites and properties, to automatically track transactions initiated by the such MMVKs, as well as sales commission earned by such affiliates under agreement with manufacturers and retailers.

Further details on each of these different kinds of MMVKs can be found in WIPO Publication No. 2005/001656, supra.

Implementing MMVKs on the Brand Marketing Communication Network of the Present Invention

To implement a Product-Specific (Single-Product) MMVK, the RDBMS of the network (which functions in part as a UPN/TM/PD/URL database server) stores and manages a single UPN/TM/PD/URL data link structure for each single-product MMVK registered on the marketing communication network of the present invention. The UPN/TM/PD/URL data link structure includes (i) a Universal Product Number (UPN) assigned to the consumer product, a Trademark (TM) associated with the consumer product, (ii) a Product Descriptor (PD) associated with the consumer product, and (iv) a set of URLs specifying the location of a plurality of brand-building information resources located on the WWW, for programming the plurality of independently programmable display modes of the MMVK created and deployed for the corresponding consumer product identified by the UPN. Using the UPN/TM/PD/URL data link structure, one or more Brand Information Network (BINs) can be created and managed on the Network. Where multiple BINs are desired (for different targeted consumer segments), different groups of URLs associated with the UPN/TM/PD product data string can be formed and related to the product's UPN, maintained within the RDBMS. The single-product MMVK is implemented by (a) a computer-executable server-side component stored on an Internet-enabled information server associated with the network, and (b) a MMVK (i.e. HTML) tag to be embedded within any of the HTML-encoded pages located along the fabric of the WWW. Notably, the MMVK tag embodies a unique URL, and references its corresponding computer-executable server-side component. Also, the computer-executable server-side component includes code specifying (i) a connection to the UPN/TM/PD/URL database server (i.e. RDBMS), and (ii) a brand/production information requesting query to be executed on the UPN/TM/PD/URL database server (i.e. RDBMS), and dependent on the UPN, TM and/or PD assigned to the consumer product, for which brand experience is to be supported by the MMVK at the point of MMVK installation along the fabric of the WWW.

To implement such a Multi-Product MMVK (such as a Vendor-Specific MMVK or a Retail-Specific MMVK), the RDBMS of the network (which functions in part as a UPN/TM/PD/URL database server) stores and manages multiple UPN/TM/PD/URL data link structures for each multi-product MMVK registered on the marketing communication network of the present invention. Each said UPN/TM/PD/URL data link structure includes (i) a Universal Product Number (UPN) assigned to the consumer product, a Trademark (TM) associated with the consumer product, (ii) a Product Descriptor (PD) associated with the consumer product, and (iv) a set of URLs specifying the location of a plurality of brand-building information resources located on the WWW, for programming the plurality of independently programmable display modes of the MMVK created and deployed for the corresponding consumer product identified by the UPN. The MMVK is implemented by (a) a computer-executable server-side component stored on an Internet-enabled information server associated with the network, and (b) a MMVK (i.e. HTML) tag to be embedded within any of the HTML-encoded pages located along the fabric of the WWW. Notably, the MMVK tags embodies a unique URL, and references its corresponding computer-executable server-side component. Also, the computer-executable server-side component includes code specifying (i) a connection to the UPN/TM/PD/URL database server (i.e. RDBMS), and (ii) a brand/production information requesting query to be executed on the UPN/TM/PD/URL database server (i.e. RDBMS), and dependent on the UPN, TM and/or PD assigned to the consumer product, for which brand experience is to be supported by the MMVK at the point of MMVK installation along the fabric of the WWW.

Implementing Single-Service MMVKs such as Service-Specific MMVKs is carried out in a manner similar to Single-Product MMVKs, except that UPN/TM/PD product data strings are replaced by USN/SM/SD service data strings. Also, implementing Multiple-Service MMVKs such as Service-Provider-Specific MMVKs is carried out in a manner similar to Multi-Product MMVKs, except that UPN/TM/PD product data strings are replaced by USN/SM/SD service data strings.

Service Architecture of Brandkey Deliver™ Subsystem

The Brandkey Deliver™ Subsystem is divided into two Suites; the Virtual Kiosk Generation Suite and the Virtual Kiosk Installation Suite. As the titles represent, the former Suite allows Users to Create, Customize and Deploy Brand Building Multi-Mode Virtual Kiosks while the latter Suite allows Users to Install Brand Building Multi-Mode Virtual Kiosk tags at different Consumer Touchpoints.

There are six Control Panels available in the Virtual Kiosk Generation Suite. Each Control Panel's instruments are specialized for a different type Multi-Mode Virtual Kiosk. In general, no single User will have access to all of these Control Panels.

The Virtual Kiosk Installation Suite of the Brandkey Deliver™ Subsystem contains six similar Control Panels. The difference is that these Control Panels allow Users to install the Tags for the Virtual Kiosks that are created and deployed in the Virtual Kiosk Generation Suite. Only Consumers will have the ability to install all six types of Virtual Kiosk Tags. Other types of Users will only be able to install the Tags for those Virtual Kiosks they are associated with.

Each Control Panel in the Virtual Kiosk Generation Suite allows Users to Create, Customize, Modify, and deploy different types of Multi-Mode Virtual Kiosks.

When a User first enters a Control Panel they will have the opportunity to set the basic configuration of the Virtual Kiosks they create.

User will be asked to specify the following items:
If they wish to have the Brand Marketing Communication Network automatically create default Virtual Kiosks for all their registered Products, Services, and Brands.
If they wish to allow Consumers to install the tags for their Multi-Mode Virtual Kiosks.
The list of Retailers and/or Industrialists who have permission to install the tags for their Virtual Kiosks.
The list of Domains that are forbidden from launching their Virtual Kiosks.

Users will be able to update these items whenever they wish by re-entering this area in the Control Panel.

Once the User has set the configuration for the Multi-Mode Virtual Kiosks, they can create the Virtual Kiosks. The creation process for Product-Specific and Service-Specific Virtual Kiosks is different from the rest of the Virtual Kiosks to the degree that Users can create multiple Product-Specific and Service-Specific Virtual Kiosks at one time, whereas they can only create one of all the other types of Virtual Kiosks at a time.

To create a Multi-Mode Virtual Kiosk, the User first must select the display mode that the Virtual Kiosk will run. There are at least three possible display modes for each Multi-Mode Virtual Kiosk, namely; a First Mode, a Second Mode, and Third-Mode. The First Mode allows the displaying of Advertising Spots, Promotional Spots and the Brand Information Network. The Second Mode allows the displaying of Advertising-Spots and the Brand Information Network. The Third Mode allows the display of only the Brand Information Network. Once the running mode of the Virtual Kiosk is selected, the User must select the Product(s), Service(s), or Brand(s) that will be available in the Virtual Kiosk. Once those have been selected, the User is asked to give the Virtual Kiosk a significant name. The name of the Virtual Kiosk is collected in order to give Users a chance to give their Virtual Kiosks a meaningful identification. With the name taken care of, the User can then customize the Virtual Kiosk. The Brand Marketing Communication Network allows for detailed customization of the Virtual Kiosks. Users can change their Logo at the top of the Virtual Kiosk, the geometric shape, surface texture, surface color, button style set, and button set color for the Virtual Kiosk being created. During the customization process the User is able to view a sample of what the Virtual Kiosk may look like with the selected customizations employed.

Customizing the Multi-Mode Virtual Kiosk is the last step in the Virtual Kiosk creation process. With this done, the Virtual Kiosk is ready for either further modification or deployment.

Users are able to modify any created Virtual Kiosk whenever they wish. After selecting the Virtual Kiosk they wish to modify, the User will be able to modify the mode in which the Virtual Kiosk is set to operate. They may also delete the Virtual Kiosk if they wish to. If the Virtual Kiosk is of type; Vendor-Specific, Service-Provider Specific, Retailer Specific, Industry Specific, or Corporate Specific, then the User will also be able to edit the list of Products, Services, or Brands that are associated with the Virtual Kiosk. Users may add new Products, Services, or Brands and remove any that are currently associated.

After creating the Multi-Mode Virtual Kiosk, if the User is satisfied with it, they can deploy it. Deploying a Virtual Kiosk is the process the User goes through to select the Launch Environment and set the Virtual Kiosk up to be downloaded and installed in the Virtual Kiosk Installation Suite.

There are four launch environments for the User to choose from; HTML-Encoded BKS™ Button, HTML-Encoded Document, HTML-Encoded Image, and an HTML-Encoded Desktop Icon. Each of the launch environments have a different setup procedure the User must walk through to set them up.

To set up the HTML-Encoded BKS™ Button, the User simply selects the Virtual Kiosks they wish to deploy and the System does the rest.

To set up the HTML-Encoded Document, the User must first select only one Virtual Kiosk. Once the Virtual Kiosk has been selected, the User must go through the process of creating the Document and encoded the HTML tag for the Virtual Kiosk into it. Once that has been done, the System will prepare the Virtual Kiosk for Deployment.

To set up the HTML-Encoded Image, the User must first select only one Virtual Kiosk. Once the Virtual Kiosk has been selected, the User must go through the process of creating the composite image for the Virtual Kiosk tag. Once that has been done, the System will prepare the Virtual Kiosk for Deployment.

To set up the HTML-Encoded Desktop Icon, the User must first select only one Virtual Kiosk. Once the Virtual Kiosk has been selected, the User must go through the process of setting up the Desktop Icon. Once that has been done, the System will prepare the Virtual Kiosk for Deployment.

These different launch environments can be adopted to serve as different marketing and sales channels which can be realized as online as well as offline channels.

Once the Virtual Kiosk has been deployed, the last step to allow Users to install the tags for that Virtual Kiosk is to activate it. Users are also able to deactivate any Virtual Kiosks that have been previously activated, even if they have been installed on the Internet. If the User deactivates any installed Virtual Kiosks, then the next time that Virtual Kiosk is launched, the end-user will get a message saying the selected Virtual Kiosk is no longer available.

With all the Virtual Kiosks created and deployed, the next step is to get them installed on the Internet. The Virtual Kiosk Installation Suite handles this process. Like the Virtual Kiosk Generation Suite, the Virtual Kiosk Installation Suite is also divided up into six Control Panels, one for each type of Virtual Kiosk. Depending on who you are, you will have access to only certain Installation Control Panels, unless you are a Consumer, in that case you will have access to all the Installation Control Panels.

Each Virtual Kiosk Installation Control Panel works in the same manner, just customized for the specific type of Virtual Kiosks to which they cater.

The User first is allowed to select the Virtual Kiosks they wish to download and install. If the User is a Consumer, they may select from a list of all the virtual Kiosks whose owners have designated as being available for Consumers. If the User is a Vendor or Service Provider, they are only allowed to install those Virtual Kiosks belonging to their account. If the User is a Retailer or Industrialist, then they are allowed to install only those Virtual Kiosks whose owners have specified that these Retailers and Industrialists have permission to install their Virtual Kiosks.

Using the Alphabetic and Numeric search bar at the top of the table, the User may search for the Virtual Kiosks of Vendors, Service Providers, etc. beginning with that letter or number. The User also has the ability to search for specific Vendors, Service Providers, etc. by clicking the Search button. This will take them to the Search from where they can search for specific Vendors, Service Providers, Retailers, etc. depending on the Control Panel they are in. From the Search form they will be able to select Vendor, etc. whose listing of Virtual Kiosks they wish to view.

Once the User has selected the Virtual Kiosks to download and install they will be asked where the Virtual Kiosk will be installed. This information is required by the System in order for it to provide the most accurate data to the Brand Managers about where their Virtual Kiosks are being installed. This enables Brand Managers and their Agents to customize the Advertising and Promotions campaigns in the most useful manner.

After the User has entered the installation location information they are able to download the Virtual Kiosk tags along with the accordant instructional files and needed images. The User may download up to four sets of Virtual Kiosks depending on the different launch environments for the Virtual Kiosks selected.

The download file for the Virtual Kiosks contain the full instructions on how to install the Virtual Kiosk tags.

It is then up to the User to place the tags in the appropriate websites or disseminate them via email to propagate the Virtual Kiosks through the Internet.

The Multi-Mode Virtual Kiosks will be downloadable from the Installation Suite in this Subsystem. Once they are downloaded and installed in the appropriate place, they shall be functional for Consumers and other general users to launch.

To launch the Multi-Mode Virtual Kiosk from any launch environment, the user shall click on the Tag that will launch the Multi-Mode Virtual Kiosk. The Tag shall contain information used by the Brand Marketing Communication Network when the request is made for a Multi-Mode Virtual Kiosk to determine the type of the Multi-Mode Virtual Kiosk, the style of the requested Multi-Mode Virtual Kiosk, the layout of the requested Multi-Mode Virtual Kiosk and the Brand Entity(s) that is to be displayed.

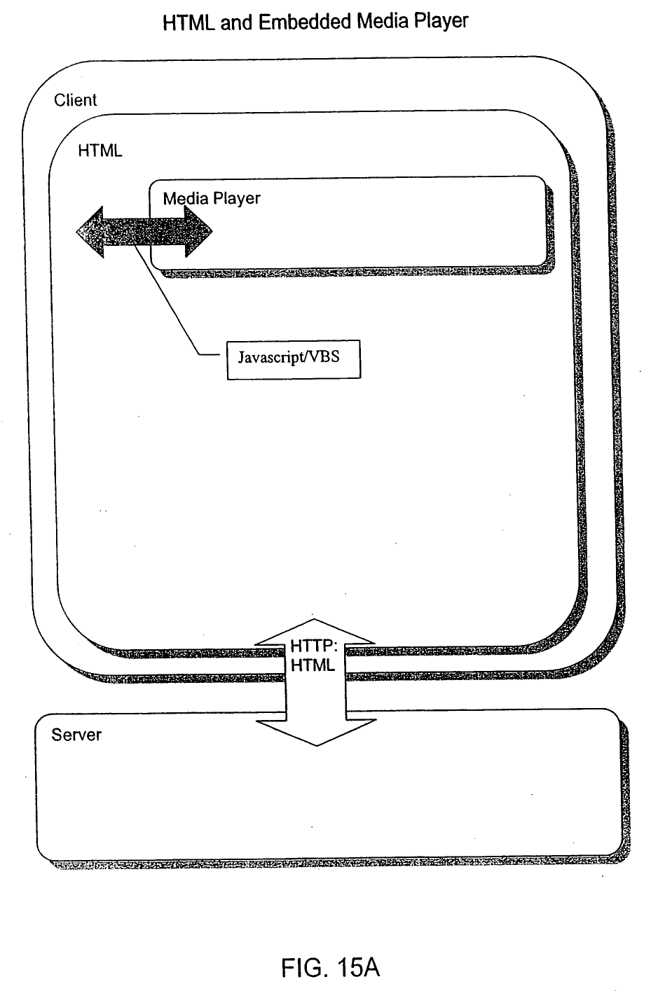

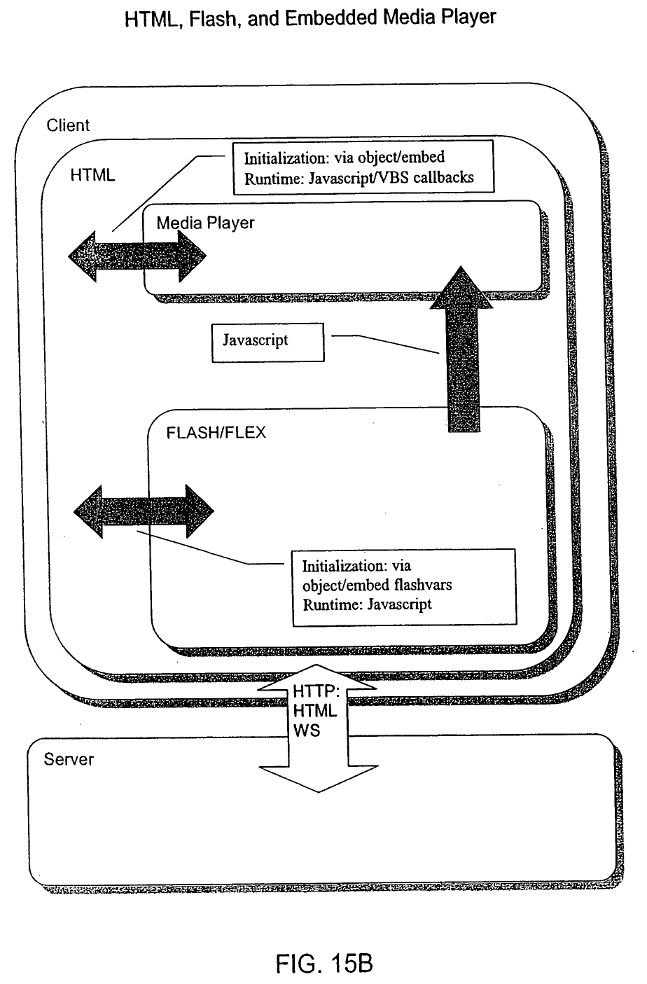

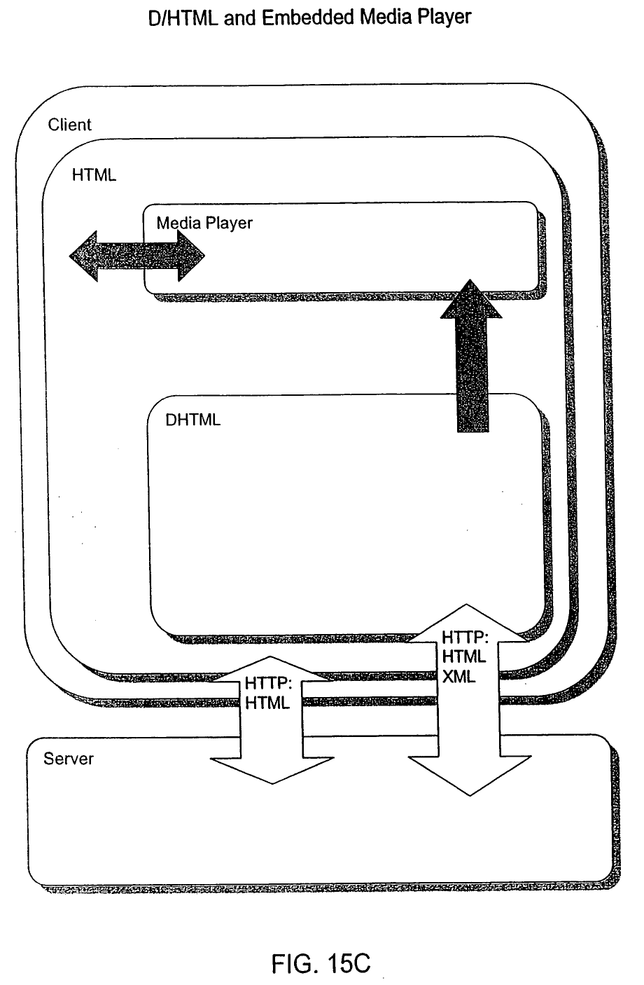

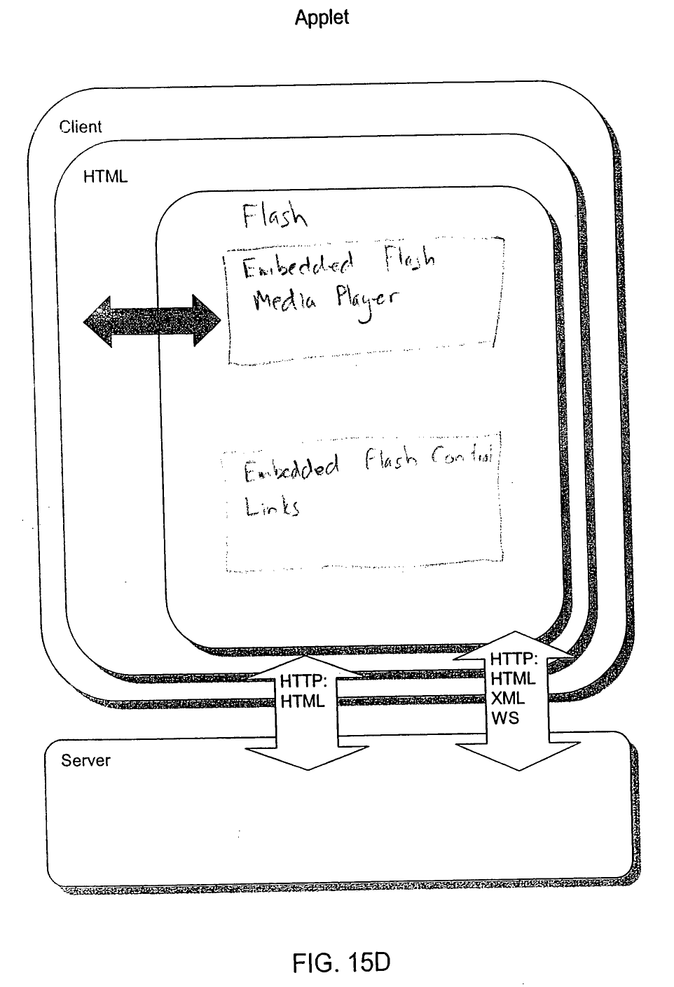

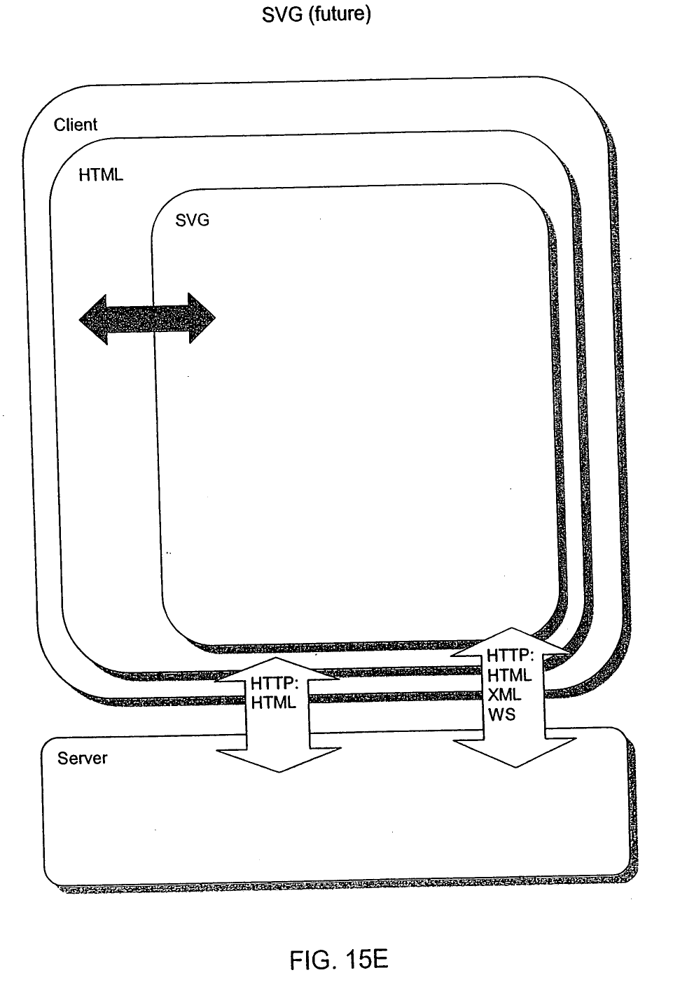

When a user clicks on the MMVK Tag, an HTML request shall be sent to the Brand Marketing Communication Network for the appropriate type of Multi-Mode Virtual Kiosk. When the request comes into the Brand Marketing Communication Network, the Network shall respond to the request by launching a new stripped-down browser window on the desktop of the user. This window shall be displayed over the current location of the user, thereby saving that location for the user to return to later on with ease if they so wish. In the illustrative embodiment, the new window containing the Multi-Mode Virtual Kiosk shall be a completely stripped-down browser. Inside the window the Brand Marketing Communication Network shall display graphics having the basic look and feel of one of three formats. The Brand Marketing Communication Network (i.e. “the System”) shall find and play any relevant advertisements in the Advertisement-Display window of the Multi-Mode Virtual Kiosk. The Multi-Mode Virtual Kiosk shall have a set of buttons to skip the current Advertisement and to replay the current Advertisement. The Multi-Mode Virtual Kiosk shall also have a set of buttons to control the volume for the Advertisement that is currently being played. The Multi-Mode Virtual Kiosk shall also display the time that has lapsed for the current Advertisement. The BKS Network can play Advertisements in the Multi-Mode Virtual Kiosks using the JavaMediaFramework (JMF), from Sun Microsystems, Inc., in an Applet on the Virtual Kiosk. The JavaMediaFramework can take multiple video and audio formats and play them in a customized applet that we program. Different MMVK design implementation are described in FIGS. 15A through 15E. The list of Advertisements shall be processed on the server, possibly using SMIL technology and then passed to the Virtual Kiosk Applet to play in the prescribed order. Details regarding JMF API can be found at, incorporated herein by reference.

Once the Advertisements have been played, the Multi-Mode Virtual Kiosk shall check to see if there are any Promotions that are associated with this Virtual Kiosk. If there are Promotions that need to be displayed then the Kiosk shall resize itself to show the Promotions Window. The Promotions shall be displayed along with their corresponding videos. The Multi-Mode Virtual Kiosk shall have a set of buttons to skip the current Promotion and to replay the current Promotion. The Multi-Mode Virtual Kiosk shall also have a set of buttons to control the volume for the Promotional video that is currently being played. The Multi-Mode Virtual Kiosk shall also display the time that has lapsed for the current Promotion. The Brandkey Systems Network shall play the Promotions in the Multi-Mode Virtual Kiosks using the JavaMediaFramework in an Applet on the MMVK. The JavaMediaFramework can take multiple video and audio formats and play them in a customized applet that we program. The list of Promotions shall be processed on the server, possibly using SMIL technology and then passed to the Virtual Kiosk Applet to play in the prescribed order.

Once the Advertisement and Promotions have completed then the Multi-Mode Virtual Kiosk shall display the related brand knowledge network as described by the Brand Manager in Brandkey Create. One of the three schemas shall be displayed that were specified in Brandkey Create; Dual-Column Schema, Single-Column Schema, and Complex Schema. When the user clicks on a specific node in any of the schemas, the system shall display the link from that node within the display window in the frame above the Brand Information Network display window. The system shall provide the user with the ability to enlarge this window causing the entire browser window to enlarge in proportion. The system shall also resize the Brand Information Network in proportion with the link display window. The system shall maintain a nice look-and-feel to the Brand Information Network display during the resizing. A suggested method for achieving this is using Scaling Vector Graphics (SVG). All links from any node in the Brand Information Network shall be displayed in this link display screen, thereby allowing the user to remain inside the Brandkey Virtual Kiosk Environment. There shall be a Search button to allow the User to search for Products/Services/Brands depending on the type of Multi-Mode Virtual Kiosk they are in.

Once the Advertisements and Promotions (if any) have completed, the system shall then resize the existing window to show the Search Screen, if the Virtual Kiosk is a Vendor-Specific, Service-Provider-Specific, Retailer-Specific, Industry-Specific, or Corporate-Specific Virtual Kiosks. Product-Specific and Service-Specific Virtual Kiosks do not have a Search function.

In the Brand Information Network display window, the system shall first display a search screen that provides the user with the ability to search for products/brands for the particular Vendor who is sponsoring the Virtual Kiosk. In this search screen the user shall be able to search for products/brands based on UPN/USN, TM/SM, PD/SD or Product/Service Category. When the user presses the “search” button, the system shall perform a search and display the results list of all products/services/brands that matched the search criteria. Since each Virtual Kiosk shall be associated with a specific language, the search shall only bring back the results of products/brands that have Brand Information Networks with Brandkey Data Links in that language. The user shall click on the UPN/USN in order to have the Brand Information Network displayed for that product/brand.

The system shall also provide a button on the Search Screen to launch a virtual keyboard. When the user presses this button, the system shall launch a virtual keyboard in a small stripped-down browser window on top of the current search window. When the user clicks on any of the keyboard buttons on this screen, the system shall display the corresponding letters or numbers in the search text box on the search window.

When the user selects the product/brand from the Search Results list the system shall first the Advertisements and Promotions associated with the selected Product/Service/Brand Entity. The Advertisements and Promotions shall be displayed in the same manner as the Advertisements and Promotions that were displayed when the Multi-Mode Virtual Kiosk was launched. Once the Advertisement and Promotions have completed then the Multi-Mode Virtual Kiosk shall display the related brand knowledge network as described by the Brand Manager in Brandkey Create. One of the three schemas shall be displayed that were specified in Brandkey Create; Pre-Post Purchase Schema, Simplex Schema and Complex Schema. When the user clicks on a specific node in any of the schemas, the system shall display the link from that node within the display window in the frame above the Brand Information Network display window. The system shall provide the user with the ability to enlarge this window causing the entire browser window to enlarge in proportion. The system shall also resize the Brand Information Network in proportion with the link display window. The system shall maintain a nice look-and-feel to the Brand Information Network display during the resizing. A suggested method for achieving this is using Scaling Vector Graphics (SVG). All links from any node in the Brand Information Network shall be displayed in this link display screen, thereby allowing the user to remain inside the Brandkey Virtual Kiosk Environment.

The System shall maintain a counter for each Virtual Kiosk. The counter shall be updated whenever a user activates a Virtual Kiosk at a consumer touch-point and also whenever a user clicks on a link from the Brand Information Network.

Brandkey Advertise Subsystem

The Brandkey Advertise™ Subsystem, illustrated in part in FIGS. 10A through 10C, and in greater detail in WIPO Publication No. 2005/001656, supra, is the central location where all Advertising Spots are placed on installed Multi-Mode Virtual Kiosks on the Internet. With The Brandkey Advertise™ Subsystem enables Brand Managers and their Agents to advertise branded products and services by building and managing Advertising Campaigns on Multi-Mode Virtual Kiosks delivered to the consumer this service, the user may customize Advertising Directories that specify which Multi-Mode Virtual Kiosks are sanctioned by the Brand Manager or retail trading partner to run an Advertising Campaign. The user may also register the Brand's Advertising Campaign to be run on specified networks of Multi-Mode Virtual Kiosks, as well as build an Advertising Campaign by placing ad spot orders on installed networks of Multi-Mode Virtual Kiosks. The highlights of this service are that with simple point and click technology the user may:
Register a Campaign to be run on specified networks of Multi-Mode Virtual Kiosks
Flexibly add or delete Multi-Mode Virtual Kiosks at any time to Modify a Campaign
Run/Stop Campaigns in a flexible manner to meet marketing objectives
View up-to-date metrics kept by the Brand Marketing Communication Network to Monitor Campaigns

In order for the Advertisement Display Mode of any Virtual Kiosk to be fully enabled, the Advertisements to be played on those Virtual Kiosks need to be configured.

The Brandkey Advertise™ Subsystem provides Users with a central area where they can see where their available Virtual Kiosks have been installed. Users can create Directories of their Virtual Kiosks by Virtual Kiosk type and even Brand. This enables them to locate Virtual Kiosks and create Advertising Campaigns in a more efficient manner.

These Advertising Campaigns are made up of a sub-network of Multi-Mode Virtual Kiosks that the User selects. Users can then place Advertisements on any combination of Virtual Kiosks and order those Advertisements any way they wish for each individual Virtual Kiosk.

Using the Brandkey Advertise™ Subsystem, Users can also monitor, modify, run and stop any of their Advertising Campaigns. These features allow the User to determine which Campaigns are working well for them and what combination of Advertisements and Virtual Kiosks are the most effective and which do not work at all.

The Brandkey Advertise™ Subsystem consists of one Suite; the Virtual Kiosk Advertising Campaign Management Suite. This Suite contains one Control Panel; the Control Panel for Managing Advertising Campaigns.

The three main services offered in the Control Panel for Managing Advertising Campaigns are; Directory Management, Campaign Management, and Ad-Spot Management.

In Directory Management, Users are allowed to create and manage the Virtual Kiosk Advertising Directories they use to populate their Advertising Campaigns with Multi-Mode Virtual Kiosks.

To create an Advertising Directory the User must first select the type of Directory they wish to create. There are two types of Directories that the User can create; the General Type Advertising Directory and the Brand-Specific Advertising Directory.

If the User selects the General Type Advertising Directory then the next step for them is to select the types of Virtual Kiosks they wish to include in this Directory. They may select all the Virtual Kiosks that are available to them. Available Virtual Kiosks means any Virtual Kiosks on which their Product, Services, or Brands are displayed and on which they have permission to place Advertising Spots. Only those types of Virtual Kiosks that are available to the User are displayed.

Once the User has selected the Virtual Kiosk types, they are asked to name the Directory. This gives the User an opportunity to give the Directory a name that will be relevant to them. The System is then ready to generate the Virtual Kiosk Directory for the User. When the User clicks the Generate Directory button, the System will pull together all the information requested by the User into a table of the available Virtual Kiosks and display it to the User. The User will also have the opportunity to download a PDF version of the Directory if they want. The Virtual Kiosk Advertising Directory is now created and ready for use.

The only difference between the General Type Virtual Kiosk Advertising Directory and the Brand-Specific Virtual Kiosk Advertising Directory is that at the start of the creation process, the User is asked to search for and select the Brand Entities they wish to filter for in the Directory. Only those available Virtual Kiosks displaying the selected Brand Entities will be listed in the Directory.

When modifying any Virtual Kiosk Advertising Directory, the User will be able to select different types of Virtual Kiosks to be included in the Directory and different Brand Entities to be filtered for in the Directory.

Once the Virtual Kiosk Advertising Directories have been created, the User can then register the Advertising Campaigns.

After filling out the basic information needed for the Campaign such as; its name, registration number, start date, and end date, the User must select a Virtual Kiosk Directory from where to pull the Virtual Kiosks to include in this Campaign. The User must first select Virtual Kiosk Directory type, General or Brand-Specific. Then the User is presented with the list of Directories for the selected type. The User must select one Directory from the list and the System will pull in all the Virtual Kiosks from that Directory to include in this Campaign.

When modifying an Advertising Campaign, the User will first select the Campaign to modify, and then they will get a chance to modify the list of Virtual Kiosks included in the Campaign. They may remove Virtual Kiosks from the list or include Virtual Kiosks from the list in the Campaign.

All Campaigns that have ever been run or are presently running are stored with Brandkey Systems Network. The User may select any Advertising Campaign that has previously been run to run it again if they wish. They may also select any Advertising Campaign that is currently running to stop it before the due date. They may wish to do this if they feel that the Campaign is not reaching the audience they wanted it to reach, or is not as effective as they thought it would be. This gives the User a better level of control over the Advertising Campaign they put together and propagate through the Multi-Mode Virtual Kiosks.

In order to tell how effective a Campaign is, the User would monitor the Campaign. When monitoring the Campaign, the Subsystem presents the user with a wide variety of data such as; number of Advertisements placed, number of Advertisements run, number of Advertisement-Spot interruptions, and number of Brand Information Networks accessed, etc. This information will give the User a clear picture of the activity behind the Virtual Kiosk and the Advertising Campaign.

The third and arguably the central instrument in this Control Panel is to place Advertising Spot Orders on the Virtual Kiosks in Campaigns. To place these ad-spot orders, the User must first select the Advertising Campaign on whose Virtual Kiosks to place the Advertising Spots.

When the User has selected the Campaign, the list of available Advertisements is displayed for the User to select which Advertisements they want to place on the Campaign. This list of Advertisements is pulled from the list of nodes in the all the Brand Information Networks associated with the selected Virtual Kiosks. The User is also given the opportunity to view the actual Advertisement by clicking on the Advertisement URL in the table.

Once the User has selected the Advertisements to place on the Campaign, the System requires them to configure the Advertisements for each of the Virtual Kiosks they wish to place it on. The User is allowed to select the Virtual Kiosks on which the Advertisement will play, the data on which the Advertisement will become available, and the frequency at which the Advertisement will play when the Virtual Kiosk is left running. Once each Advertisement has been configured, the User will be allowed to set the order in which the Advertisements will play on each of the Virtual Kiosks. Even if there are several Virtual Kiosks, which play the exact same list of Advertisements, they may still play them in different orders, thus allowing for more granular control.

The Order will be placed once the Advertisement order has been set by the User.

When modifying Advertising Spot Orders, the User may modify all aspects of the Order. In this case they move backwards through the section, starting with the Advertisement ordering and going back to the Virtual Kiosk Directory that was selected.

Once an Advertising Spot Order has been placed, then those Advertisements are placed on installed Virtual Kiosks and the full functionality of the Advertisement Display Mode of the Virtual Kiosks is realized.

Brandkey Promote Subsystem

The Brandkey Promote™ Subsystem, illustrated in part in FIGS. 11A through 11C, and in greater detail in WIPO Publication No. 2005/001656, supra, is the central location where all Promotional Spots are placed on installed Multi-Mode Virtual Kiosks on the Internet. With the use of the Brandkey Promote™ Subsystem, Brand Managers and their Agents can program the Promotional Spot Display Mode of their Multi-Mode Virtual Kiosks. Similar to the service offered for Advertisers the user may also register the Brand's Promotional Campaign to be run on specified Networks as well as build a Promotional Campaign by placing promo spot orders on installed networks of Multi-Mode Virtual Kiosks. Also similar to the Brandkey Advertise Subsystem, the highlights of this service are that with simple point and click technology the user may:
Register a Campaign to be run on specified networks of Multi-Mode Virtual Kiosks
Flexibly add or delete Multi-Mode Virtual Kiosks at any time to Modify a Campaign
Run/Stop Campaigns in a flexible manner to meet marketing objectives
View up-to-date metrics kept by the Brand Marketing Communication Network to Monitor Campaigns

In order for the Promotion Display Mode of any Virtual Kiosk to be fully enabled, the Promotions to be played on those Virtual Kiosks need to be configured.

The Brandkey Promote™ Subsystem provides Users with a central area where they can see where their available Virtual Kiosks have been installed. Users can create Directories of their Virtual Kiosks by Virtual Kiosk type and even Brand. This enables them to locate Virtual Kiosks and create Promotional Campaigns in a more efficient manner.

These Promotional Campaigns are made up of a sub-network of Multi-Mode Virtual Kiosks that the User selects. Users can then place Promotions on any combination of Virtual Kiosks and order those Promotions any way they wish for each individual Virtual Kiosk.

Using the Brandkey Promote™ Subsystem, Users can also monitor, modify, run and stop any of their Promotional Campaigns. These features allow the User to determine which Campaigns are working well for them and what combination of Promotions and Virtual Kiosks are the most effective and which do not work at all.

The Brandkey Promote™ Subsystem consists of one Suite; the Virtual Kiosk Promotional Campaign Management Suite. This Suite contains one Control Panel; the Control Panel for Managing Promotional Campaigns.

The three main services offered in the Control Panel for Managing Promotional Campaigns are; Directory Management, Campaign Management, and Promo-Spot Management.

In Directory Management, Users are allowed to create and manage the Virtual Kiosk Promotional Directories they use to populate their Promotional Campaigns with Multi-Mode Virtual Kiosks.

To create a Promotional Directory the User must first select the type of Directory they wish to create. There are two types of Directories that the User can create; the General Type Promotional Directory and the Brand-Specific Promotional Directory.

If the User selects the General Type Promotional Directory then the next step for them is to select the types of Virtual Kiosks they wish to include in this Directory. They may select all the Virtual Kiosks that are available to them. Available Virtual Kiosks means any Virtual Kiosks on which their Product, Services, or Brands are displayed and on which they have permission to place Promotional Spots. Only those types of Virtual Kiosks that are available to the User are displayed.

Once the User has selected the Virtual Kiosk types, they are asked to name the Directory. This gives the User an opportunity to give the Directory a name that will be relevant to them. The System is then ready to generate the Virtual Kiosk Directory for the User. When the User clicks the Generate Directory button, the System will pull together all the information requested by the User into a table of the available Virtual Kiosks and display it to the User. The User will also have the opportunity to download a PDF version of the Directory if they want. The Virtual Kiosk Promotional Directory is now created and ready for use.

The only difference between the General Type Virtual Kiosk Promotional Directory and the Brand-Specific Virtual Kiosk Promotional Directory is that at the start of the creation process, the User is asked to search for and select the Brand Entities they wish to filter for in the Directory. Only those available Virtual Kiosks displaying the selected Brand Entities will be listed in the Directory.

When modifying any Virtual Kiosk Promotional Directory, the User will be able to select different types of Virtual Kiosks to be included in the Directory and different Brand Entities to be filtered for in the Directory.

Once the Virtual Kiosk Promotional Directories have been created, the User can then register the Promotional Campaigns.

After filling out the basic information needed for the Campaign such as; its name, registration number, start date, and end date, the User must select a Virtual Kiosk Directory from where to pull the Virtual Kiosks to include in this Campaign. The User must first select Virtual Kiosk Directory type, General or Brand-Specific. Then the User is presented with the list of Directories for the selected type. The User must select one Directory from the list and the System will pull in all the Virtual Kiosks from that Directory to include in this Campaign.

When modifying a Promotional Campaign, the User will first select the Campaign to modify, and then they will get a chance to modify the list of Virtual Kiosks included in the Campaign. They may remove Virtual Kiosks from the list or include Virtual Kiosks from the list in the Campaign.

All Campaigns that have ever been run or are presently running are stored with Brandkey Systems Network. The User may select any Promotional Campaign that has previously been run to run it again if they wish. They may also select any Promotional Campaign that is currently running to stop it before the due date. They may wish to do this if they feel that the Campaign is not reaching the audience they wanted it to reach, or is not as effective as they thought it would be. This gives the User a better level of control over the Promotional Campaign they put together and propagate through the Multi-Mode Virtual Kiosks.

In order to tell how effective a Campaign is, the User would monitor the Campaign. When monitoring the Campaign, the System presents the user with a wide variety of data such as; number of Promotions placed, number of Promotions run, number of Promotion-Spot interruptions, and number of Brand Information Networks accessed, etc. This information will give the User a clear picture of the activity behind the Virtual Kiosk and the Promotional Campaign.

The third and arguably the central instrument in this Control Panel is to place Promotional Spot Orders on the Virtual Kiosks in Campaigns. To place these promo-spot orders, the User must first select the Promotional Campaign on whose Virtual Kiosks to place the Promotional Spots.

When the User has selected the Campaign, the list of available Promotions is displayed for the User to select, which Promotions they want to place on the Campaign. This list of Promotions is pulled from the list of nodes in the all the Brand Information Networks associated with the selected Virtual Kiosks. The User is also given the opportunity to view the actual Promotion by clicking on the Promotion URL in the table.

Once the User has selected the Promotions to place on the Campaign, the System requires them to configure the Promotions for each of the Virtual Kiosks they wish to place it on. The User is allowed to select the Virtual Kiosks on which the Promotion will play, the data on which the Promotion will become available, and the frequency at which the Promotion will play when the Virtual Kiosk is left running. Once each Promotion has been configured, the User will be allowed to set the order in which the Promotions will play on each of the Virtual Kiosks. Even if there are several Virtual Kiosks, which play the exact same list of Promotions, they may still play them in different orders, thus allowing for more granular control.

The Order will be placed once the Promotion order has been set by the User.

When modifying Promotional Spot Orders, the User may modify all aspects of the Order. In this case they move backwards through the section, starting with the Promotion ordering and going back to the Virtual Kiosk Directory that was selected.

Once a Promotional Spot Order has been placed, then those Promotions are placed on installed Virtual Kiosks and the full functionality of the Promotion Display Mode of the Virtual Kiosks is realized.

Detailed Use-Case Based Description of Subsystems. Functions and Services Supported within the Internet-Based Brand Management and Marketing Communication Network of the Present Invention (i.e. Brand Marketing Communication Network)

For a detailed use-case based description of subsystems, functions and services supported within the Internet-Based Brand Management and Marketing Communication Network of the Present Invention (i.e. “Brand Marketing Communication Network”), please refer to FIGS. 6A through 11G and corresponding sections of WIPO Publication No. 2005/001656, supra, which is incorporated herein by reference in its entirety.

Using the Brand Management and Marketing Communication Network of the Present Invention

The Brand Management and Marketing Communication Network of the present invention was designed for the ‘non-techie’ marketer. Brand managers with minimal technical knowledge can easily create, install and modify Multi-Mode Virtual Kiosks from their own computers using the five simple tools detailed above, namely: Brandkey Manage™ which allows brand owners to manage accounts, brands and user rights on the Network for organizations having any kind of collaborative arrangement; Brandkey Create™ Subsystem which allows users to choose the content, arrangement and “look and feel” of Brand Information Networks; Brandkey Deliver™ Subsystem which enables users to create and deploy Multi-Mode Virtual Kiosks anywhere on the Web; Brandkey Advertise™ Subsystem which provides brand managers and their advertising agents with a collaborative online marketing communication network to build, track and modify Virtual Kiosk based advertising campaigns in real-time; and Brandkey Promote™ Subsystem Subsystem which, similar to Brandkey Advertise Subsystem, enables brand managers to create, monitor and modify their ever-changing campaigns with promotional agents in real-time.

This suite of Web-based marketing tools or instruments enables brand management teams and their trading partners to deploy and install Multi-Mode Virtual Kiosks at points of display and purchase on the Web. With a few mouse clicks, brand managers regulate the rights and privileges of team members and trading partners on the Subsystem.

Brand management team members and trading partners build and install Multi-Mode Virtual Kiosks. Then brand management team members, as well as their agents and trading partners, simply program the multiple display modes of installed Virtual Kiosks, so that rich media advertising spots, promotional spots, and brand building resources are delivered to shoppers where it counts, creating information-rich brand experiences as intended by brand owners, developing more consistent brand images across all e-tail marketing channels, while simultaneously creating great value and benefits for e-tailer trading partners.

Creating Brand Information Networks

At the heart of the present invention is the Brand Information Network (BIN), which serves as an invisible, but critical foundation for all activities on the Network, and storehouse of links for the digital assets consumers view in each Multi-Mode Virtual Kiosk. Each Brand Information Network is, in essence, a set of data comprised of the following items:
Basic information about the product/service which function as Brand Information Search Keys: Universal Product or Service Number; Trademark or Service mark; Product or Service Descriptor; Product or Service Brand Name; and Product or Service Category
Web location or address (URL) of brand assets/content at the brand owner's disposal (e.g., product video, audio, product image, etc.—in multiple languages if applicable)
Basic, practical display attributes of the brand assets (i.e., text for clickable links, icons displayed next to the links, sound files associated with the links, types of links, etc.).

Brand owners use combinations of these data links to build and manage Brand Information Networks anywhere using a Web-enabled computer. They can quickly access, shift or change these components when seasonality, pre-purchase/post-purchase considerations and different target audiences require them to modify Brand Information Networks.

The same brand-related information keys (e.g., Universal Product Numbers, Trademarks, Product Descriptors, Universal Service Numbers, Servicemarks, Brand Names, etc.) are used to index each rich media advertising spot, promotional spot, and other brand asset associated with a created Brand Information Network, and these brand-related information keys represent basic building blocks of brand information management and communication system architecture.

Once the Brand Information Networks are in place, brand owners can decide how and where to showcase their brands by building and deploying Multi-Mode Virtual Kiosks. Brand images and messages can be communicated to shoppers through one or more of the three distinct display modes in each Virtual Kiosk: Advertising Display Mode (e.g., rich media intended to create emotional connection); Promotional Display Mode (e.g., time-limited offers in the form of price-based messaging); and Brand Information Network Display Mode (a set of links providing a wide range of information about the product or service, along with search capabilities for the brand's other offerings)

When the user clicks on a Multi-Mode Virtual Kiosk, a combination of the three display modes will play automatically for the consumer, in a sequence determined by the brand owner or trading partner who creates and deploys the Multi-Mode Virtual Kiosk to deliver an effectively choreographed brand experience to the consumer. For example, a Multi-Mode Virtual Kiosk could open with a rich media advertisement, followed by a promotional offer and finally lead the consumer to a custom set of additional brand information—all in a seamless progression. To help marketers rise above the clutter, the same brand-related information keys (e.g., Universal Product Numbers, Trademarks, Product Descriptors, Universal Service Numbers, Servicemarks, Brand Names, etc.) used to index rich media advertising spots, promotional spots, and other brand assets associated with creating Brand Information Networks, are also used to program “virtual brand communication channels” in each Multi-Mode Virtual Kiosk installed on the Network. These brand-related information keys enable consumers to easily search for and access brand information from Multi-Mode Virtual Kiosks at diverse consumer touchpoints.

Customizing and Programming Multi-Mode Virtual Kiosks

Brand owners also have multiple options to customize every Multi-Mode Virtual Kiosk, from selecting its look-and-feel variables (including ‘skin type’ defined by surface texture, color, button style, etc.) and placement of the brand logo, to the type and arrangement of links in each Brand Information Network.

Because brand management teams can create and modify these Virtual Kiosks in-house, they can easily and inexpensively test consumer reception to the arrangement and sequence of these assets in specific Virtual Kiosks.

One of the most intriguing utilities of the Brand Marketing Communication Network solution is the sophisticated search capabilities within the same Virtual Kiosk for multiple products and services from a brand owner. The Network has been designed to cater to virtually any level of brand portfolio complexity, and provides the capability for consumers to search for an unlimited number of products or services through the Virtual Kiosk, as determined by the brand owner.

By experimenting with various different display schemas for Brand Information Networks as well as their presentation, brand managers can create powerful new vehicles that convey the value of their product or service brands more effectively than ever before. Because most new combinations of brand assets in a Brand Information Network are protectable under copyright laws, the Brand Management and Marketing Communications Network of the present invention offers brand owners the opportunity to create new forms of intellectual property.

Deploying Multi-Mode Virtual Kiosks

Once the brand owner has built the Virtual Kiosk, s/he can instantly install it on the Web by placing a ‘trigger point’ (tag) on an online retail partner's site.

The Virtual Kiosks can then be ‘brought to life’ (opened) by the user in four simple, intuitive ways: Launch button on an e-tail site or other Web touch point; Clickable image on a website; Image embedded in a document; and Icon on a computer desktop.

The brand owner can, of course, turn any Virtual Kiosk on or off with one click of the mouse, through Network's easy-to-use Web-based system management interface.

Managing Multi-Mode Virtual Kiosks

Once brand owners or their trading partners have placed Virtual Kiosks on the Web, they can easily manipulate the way their Virtual Kiosks deliver brand communications. For example, they can create an advertising campaign (with Advertising Display Mode as the dominant user experience) for a certain length of time and monitor its outcome. They can then shift the focus of the communication to a more promotionally-oriented experience (emphasizing the Promotional Display Mode), without having to recreate the whole set-up process from scratch and spend additional time, money and resources. When important new information about the product or service changes or fresh information becomes available, they can easily add one or more links to the Brand Information Display Mode, with a maximum of ten links.

Collaborating with Trading Partners

The Brand Management and Marketing Communications Network has intuitive, easy-to-use system management interfaces ifor brand management team members. This system enables brand managers to collaborate with advertising and promotional agents as well as trading partners with an unprecedented level of efficiency and accountability. By simply using a Web browser and a mouse, for example, brand managers can set and adjust the rights and responsibilities of their associates and/or agency and retail trading partners ‘on the fly’.

The Brand Management and Marketing Communications Network provides brand owners with the ability to tightly control their online brand assets, effectively collaborate with their advertising and promotional agents and e-tail trading partners during online brand marketing campaigns, as well as directly communicate with online shoppers across multiple e-tail channels, both at points-of-sale and other places on the Web. The result is that consumers have information-rich brand experiences as intended by brand owners and develop more consistent brand images across all e-tail marketing channels, while great value and benefits are simultaneously created for e-tailer trading partners.

Tracking Web Metrics

The Network offers invaluable insights for brand owners into the way their online marketing programs perform. By continuously monitoring user activity in collaboration with the brand management team, upcoming online communication initiatives can be planned more effectively and efficiently.

The most critical metrics offered for ROI calculations are:
Most typical user paths/behaviors within the Virtual Kiosks
Relative popularity of content within the Virtual Kiosks
Sales where the Virtual Kiosk played a role
How multiple Virtual Kiosks perform against each other within the same campaign
How a brand owner's Virtual Kiosk measures up against other Virtual Kiosks competing in the same category (with all information confidential and anonymous)

The Brand Management and Marketing Communications Network will be filling a critical need for brand managers, e-tailers, advertising agents promotion partners who will need to work even harder in the years to come to communicate rich brand experiences to the impatient consumer on a variety of Web-enabled devices when and where they decide to make a purchase decision. With its ability to target messages to online shoppers, modify content in real-time, and monitor and measure consumer buying behavior in both online and offline platforms, the Brand Management and Marketing Communications Network of the present invention is set to become an indispensable tool to marketers worldwide.

Brief Overview of Brandkey™ Metrics

Every action in a launched MMVK is saved to the Brandkey Metrics tables (in the Network RDBMS Server) as raw data keyed to the unique individual session for each User who launches the MMVK. Brandkey Metric's reporting functionality allows easy reporting of collected metrics for specific views as requested by the Client. Views supported by the Network include:
(1) Basic data for each Virtual Kiosk, including:

Date of MMVK creation

Which Products/Services are deployed on the MMVK

Number of Launches of the MMVK

Number of Ads assigned to the MMVK

Number of Promos assigned to the MMVK

Date and location the MMVK was installed

Other installations of the MMVK
(2) Totals for the MMVK:

Number of Launches of the MMVK

Number of Downloads of the MMVK

Number of times Viral Marketing was initiated on the MMVK

Number of people to which the MMVK was sent

Number of Conversions on the MMVK (i.e. selection of BUY NOW)
(3) Detailed Information for each Advertisement and Promotion running on the MMVK:

Number of Total Views of Ad or Promo (i.e. Starts−Skips+Repeats)

Number of Starts of Ad or Promo

Number of Skips of Ad or Promo

Number of Repeats of Ad or Promo
(4) Number of Views for each Link in the Brand Information Network (BIN) of the MMVK;
(5) Average Duration of viewing the MMVK; and
(6) Average of Most Common User Paths within the MMVK.
   How Metrics are Saved
User lLaunches Kiosk.
   System records a new MetricEvent record in the MetricEvent table.
   InstalledVirtualKioskID is saved
   SessionID for the Virtual Kiosk launch is saved
   MetricEventTypeID of 1 is saved
   System records a new MetricEventMetaData record in the MetricEventMetaData table
   The LaunchEnvironment is stored in the MetaDataValue field
Ad Plays
   System records a new MetricEvent record in the MetricEvent table
   InstalledVirtualKioskID is the same
   SessionID is the same
   MetricEventTypeID of 16 is saved
   System records a new MetricEvenMetadata record in the MetricEventMetaData table
   The LinkID of the Ad that was played is stored in the MetaDataValue field
Ad Stops playing by itself
   System records a new MetricEvent record in the MetricEvent table
   InstalledVirtualKioskID is the same
   SessionID is the same
   MetricEventTypeID of 17 is saved
   System records a new MetricEvenMetadata record in the MetricEventMetaData table
   The LinkID of the Ad that was played is stored in the MetaDataValue field
If Ad is skipped
   System records a new MetricEvent record in the MetricEvent table
   InstalledVirtualKioskID is the same
   SessionID is the same
   MetricEventTypeID of 10 is saved
   No MetricEventMetaData record is saved for this event
If Ad is repeated
   System records a new MetricEvent record in the MetricEvent table
   InstalledVirtualKioskID is the same
   SessionID is the same
   MetricEventTypeID of 9 is saved
   No MetricEventMetaData record is saved for this event
Promo Plays
   System records a new MetricEvent record in the MetricEvent table
   InstalledVirtualKioskID is the same
   SessionID is the same
   MetricEventTypeID of 18 is saved
   System records a new MetricEvenMetadata record in the MetricEventMetaData table
   The LinkID of the Promo that was played is stored in the MetaDataValue field
Promo Stops playing by itself
   System records a new MetricEvent record in the MetricEvent table
   InstalledVirtualKioskID is the same
   SessionID is the same
   MetricEventTypeID of 19 is saved
   System records a new MetricEvenMetadata record in the MetricEventMetaData table
   The LinkID of the Ad that was played is stored in the MetaDataValue field
If Promo is skipped
   System records a new MetricEvent record in the MetricEvent table
   InstalledVirtualKioskID is the same
   SessionID is the same
   MetricEventTypeID of 10 is saved
   No MetricEventMetaData record is saved for this event
If Promo is repeated
   System records a new MetricEvent record in the MetricEvent table
   InstalledVirtualKioskID is the same
   SessionID is the same
   MetricEventTypeID of 9 is saved
   No MetricEventMetaData record is saved for this event
If a Link is Clicked
   System records a new MetricEvent record in the MetricEvent table
   InstalledVirtualKioskID is the same
   SessionID is the same
   MetricEventTypeID of 14 is saved
   System records a new MetricEventMetaData record in the MetricEventMetaData table
   The LinkID of the Link displayed is stored in the MetaDataValue field
If a Link Page Navigation button is clicked
   System records a new MetricEvent record in the MetricEvent table
   InstalledVirtualKioskID is the same
   SessionID is the same
   MetricEventTypeID of 15 is saved
   System records a new MetricEventMetaData record in the MetricEventMetaData table
   The position of Next, Previous, or Page Number is stored in the MetaDataValue field
If a Buy Now button is clicked
   System records a new MetricEvent record in the MetricEvent table
   InstalledVirtualKioskID is the same
   SessionID is the same
   MetricEventTypeID of 13 is saved
   System records a new MetricEventMetaData record in the MetricEventMetaData table
   The full URL is stored in the MetaDataValue field
If a Send to Friend Button is clicked
   System records a new MetricEvent record in the MetricEvent table
   InstalledVirtualKioskID is the same
   SessionID is the same
   MetricEventTypeID of 11 is saved
   No MetricEventMetaData is saved
   If User clicks Send button on the email page, then another MetricEvent record is also saved, with a MetricEventTypeID of 22 is saved.

The Duration of the User interaction with each mode and link and of the Kiosk itself can be determined by comparing the date created times for each MetricEvent and MetricEventMetaData. Full time can be measured from time the Kiosk launches to time it either closes or Session Timeouts.

User Path should be compiled based on sequence of MetricEvent sorted by Created and linked with MetricEventMetaData where applicable.

When displaying Ads/Promos or Links, the form on the page allows the User to select which Ads/Promos and Links they want to see. Please display only those Ads/Promos and Links that are active in that Virtual Kiosk in the list for choosing. This can be found in the following tables:

Ads/Promos—Look in the SpotOrderDetails table for all records for the selected InstalledVirtualKioskID and look for Active Links

Links—Look in a linking of the following tables; InstalledVirtualKiosk □ VirtualKioskProductsServices □ ProductServiceBKNNodes □ Link. Look for all Active Links for that Product in the selected Virtual Kiosk.

In FIGS. 7D through 7I, the GUIs for Brandkey® Metrics Services are illustrated.

The System shall provide comprehensive Metrics to authorized Users in a Client Account. Every interaction consumers have with a Virtual Kiosk once it is installed shall be recorded by the Brandkey network and reports will be made available to Users through the Metrics Control Panel in the Brandkey Manage subsystem.

The User will first be shown a list of Virtual Kiosks for which they can view Metrics. Users will able to view Metrics not only for Virtual Kiosks generated within their own Client account, but they will also be able to view limited Metrics for Virtual Kiosks generated by their Trading and Channel Partners which contain any of their registered Products or Services. This list will be sorted by Installation Type so that the User will be able to judge where all their Client Account's Virtual Kiosks are being placed.

The User will then need to select for which Virtual Kiosks they wish to view Metrics. The User may select more than one Virtual Kiosk at a time in order to compare how different Virtual Kiosks are performing. The User will be able to view the current makeup of any Virtual Kiosk by clicking on the Preview button.

The User will be able to get basic detail information about the selected Virtual Kiosk. This information would include such items as: the number of Campaigns the Virtual Kiosk has run, the number of Ads, Promos, Links the Virtual Kiosk has been assigned currently, whether the Buy Now and Send To Friend features have been activated, and the number of times the Virtual Kiosk has been launched.

In graphical format, the User will be able to view the Total number of times the Virtual Kiosk has been Launched, Downloaded, the number of times the Buy Now was used, and the number of times the Send To Friend has been used. The User will be able to select the date range for which they wish to view the data and the type of graph they wish to see.

The User will be able to view basic information on Advertisement and Promotions, such as the number of times the Ad and Promo have been Launched, Skipped and Replayed.

The User will be able to view basic information on the Information Links for the Virtual Kiosk, such as the number of times each Information Link has been requested. The User will be able to view the average Duration of Consumers viewing the Virtual Kiosk, so that they will know on average how much time people spend within the Virtual Kiosk. The basic spread duration numbers will also be given.

The User will also be provided with more detailed information in regards to User Path within the Virtual Kiosk, this will show most used User Paths for the Virtual Kiosk, the full picture of Consumer interactivity within the Virtual Kiosk, from Advertisements to Exit.

All of these Metrics Reports will be available on Demand to Users of the Brandkey Network.

Setting Up and Using the Brand Marketing Communication Network

Getting setup to use the Brand Marketing Communication Network of the present invention involves a relatively simple procedure. First, the client/brand completes a Registration Form, and allow BKS Networks, Inc. (i.e. the Network Administrator) to verify the information contained therein. The Network Administrator then sets up the Client Account. The client and/or its agents can then manage the client's Users and other partners through the Brandkey Manage Subsystem interface. Once completed, the client and/or its agents can begin to mange product and service related information associated with its Products and Services through the Brandkey Create Subsystem interface. The client and/or its agents can create and manage the Brand Information Networks (BINs) through Brandkey Create Subsystem. Once Brand Information Networks have been created for the client's Products and Services, the client and/or its agents use the Brandkey Deliver Subsystem interface to create and install the Multi-Mode Virtual Kiosks it needs or desires to achieve its marketing communication objectives and strategies. Once Multi-Mode Virtual Kiosks have been installed on different Internet touchpoints, the client and/or its Ad/Promo Agents can create Directories and Campaigns and then place Advertisement and/or Promotion Spots on those Virtual Kiosks using the Brandkey Advertise and Brandkey Promote Subsystem interfaces. The client and/or its agents can then manage all of the client/brand's Multi-Mode Virtual Kiosks, Advertisements, Promotions, Users, and Metrics using the five subsystems supported by the Brand Marketing Communication Network.

FIG. 11D illustrates an exemplary process describing how a vendor/manufacturer brand manager can work with a retailer brand manager to use the Brand Marketing Communications Network of the present invention in order to deploy and install Product-Specific Multi-Mode Virtual Kiosks on the etailer's WWW site at points of virtual product display.

Specification of the MMVK of the Present Invention Supporting a User-Generated Content/Message Display Mode (“MyMode™ Display”)

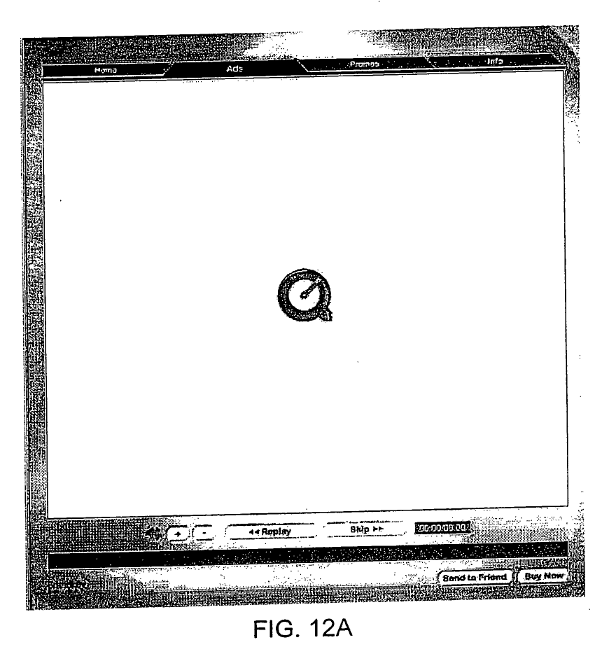

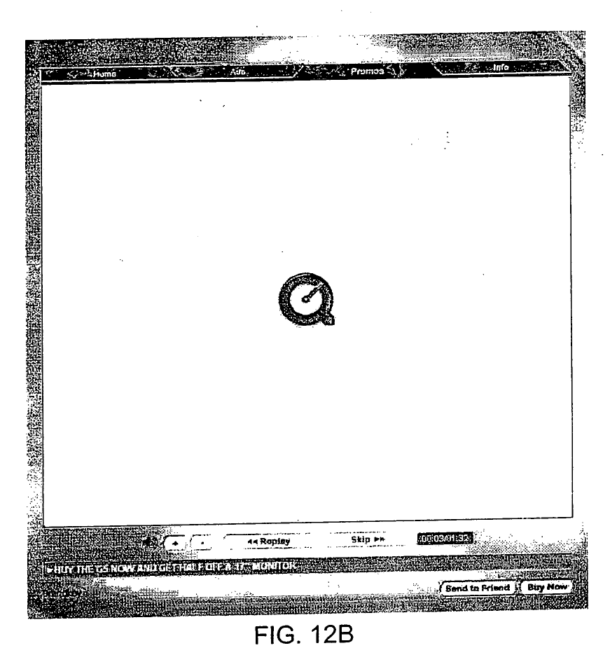

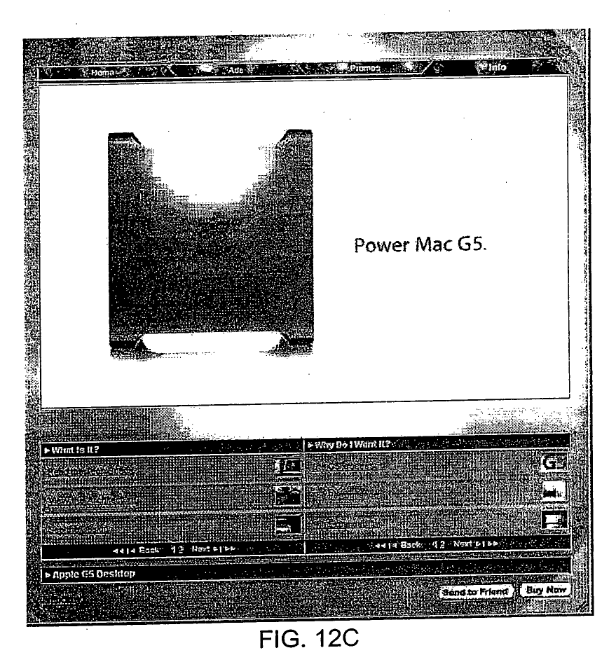

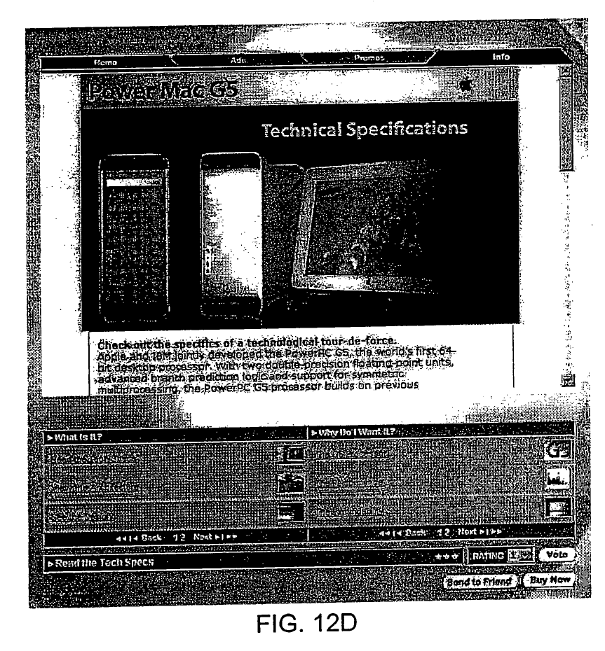

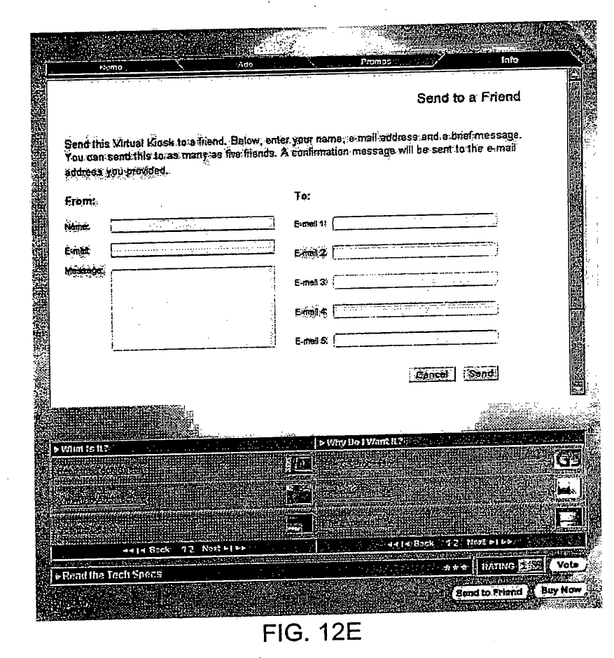

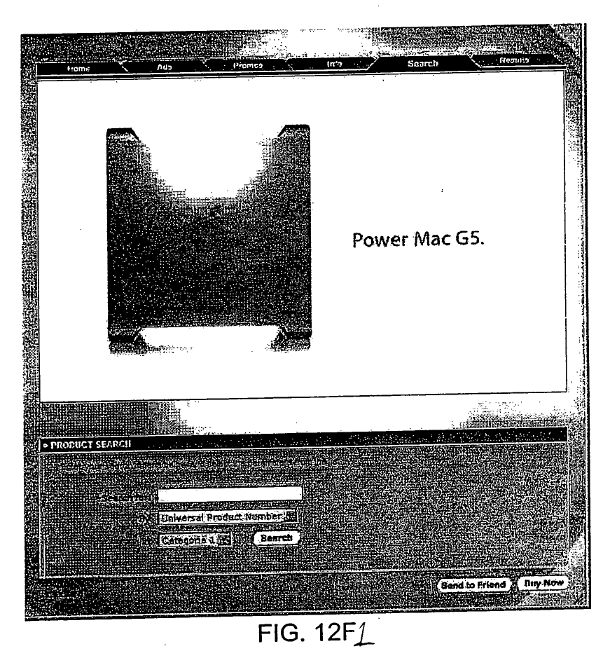

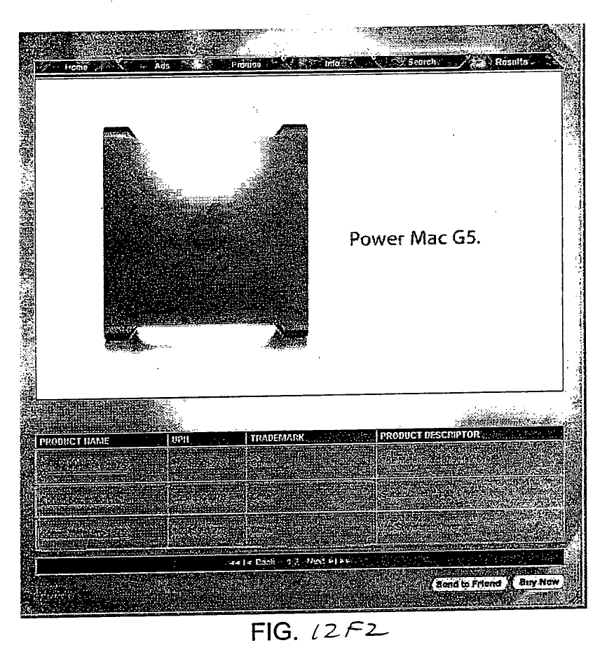

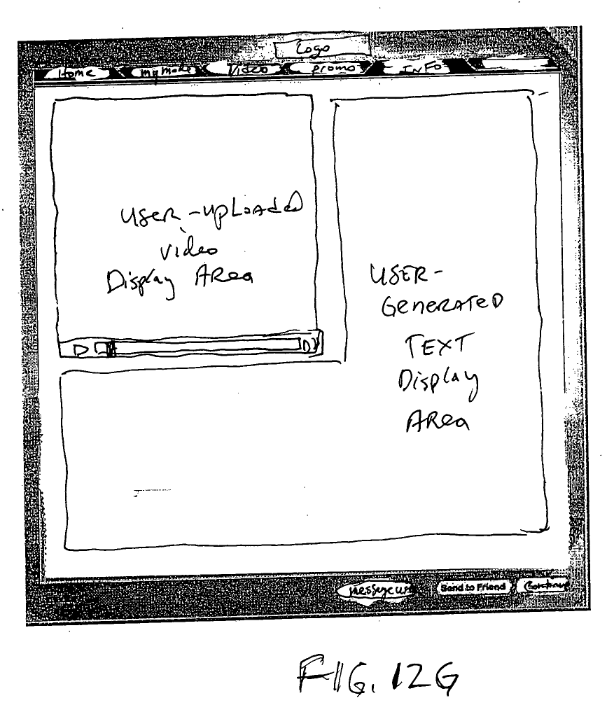

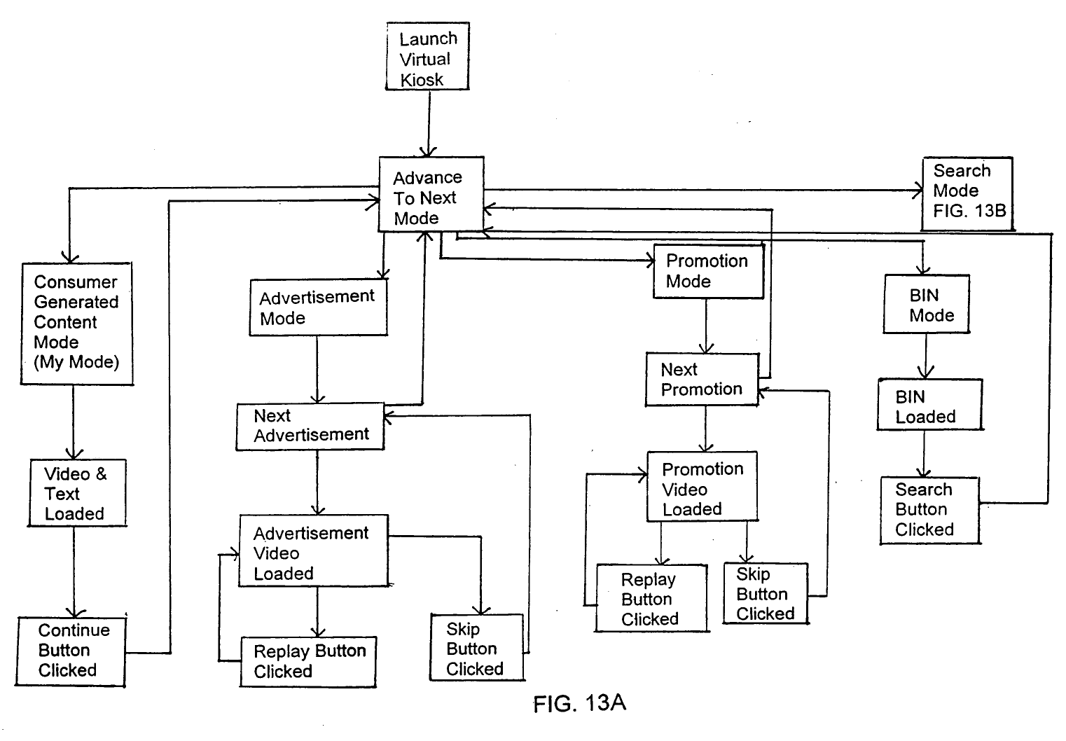

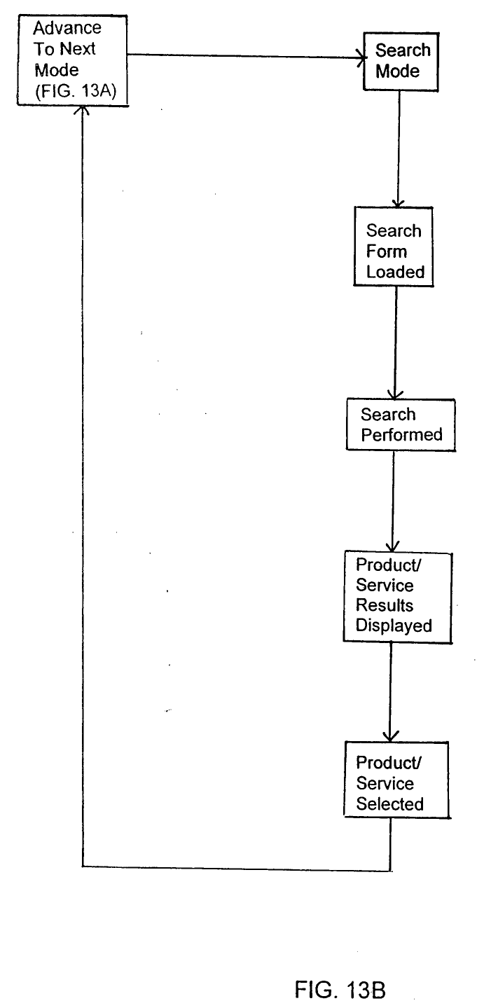

As shown in FIG. 12G, the Brand Marketing Communication Network of the present invention shall also support, in some embodiments, the creation, deployment and installation (by consumers) of MMVKs having an additional Mode of display (i.e. beyond the three primary modes, i.e. Ad Display Mode, Promo Display Mode and Brand Information Display Mode) for containing and displaying Consumer-Generated or Selected Content (CGC) including videos and text messaging and/or graphics. To support this information service on the brand marketing communication network of the present invention, a fourth Web-based subsystem, realized as part of or separate from the Brandkey Create Subsystem, is provided for allowing consumers to remotely and independently program the CGC display modes of each MMVK with consumer generated or selected content.

When Manufacturers or their Agents generate such MMVKs, one of the Deployment Environments available to them will be Consumer-Generated (“My Mode”) Installations. If the Manufacturer or their Agent chooses this Deployment Environment, then that Virtual Kiosk will be available for Consumers to install and add their own content to the specific Mode made available to them, after they have downloaded the HTML tag of the MMVK.

Consumers will enter the Brandkey network through a separate Application designed specifically for them. In this application, they will be able to Install Virtual Kiosks with the My Mode feature and customize that Mode for themselves. Consumers will first be presented with a list of Virtual Kiosks that are available for Installation by them and that meet their preferred areas of interest. When the Consumer has chosen the Virtual Kiosk they wish to install, then they will be allowed to upload their own videos and insert text and images into one of several templates of their choosing. Once the Virtual Kiosk has been customized, they will complete the Installation process by downloading the virtual Kiosk Installation Package and installing the tag onto their webpage.

Once the Virtual Kiosk has been installed, the Manufacturer and Agents will be able to target it for customized Advertisements and Promotions through the Brandkey Advertise and Promote Subsystems.

The Virtual Kiosk will operate in much the same way as a regular Virtual Kiosk operates. The only difference will be that the My Mode mode will appear first when the Virtual Kiosk loads. This mode will remain until the User who is viewing the Virtual Kiosk clicks to move on, and then the Virtual Kiosk proceeds with its choreographed message of advertisements, promotions and product information.

Notably, the fourth Web-based subsystem, realized as part of or separate from the Brandkey Create Subsystem, is provided for allowing consumers to remotely and independently program the CGC display modes of each MMVK with consumer generated or selected content.

Design Specifications for the Multi-Mode Virtual Kiosks (MMVKs) of the Present Invention

HTML & Embedded Media Player

In this configuration, shown in FIG. 15A, the basic layout of the Multi-Mode Virtual Kiosk is created in HTML. All components are also done in HTML with the Media Player part of the Virtual Kiosk as the media layer components of the individually supported players, such as Windows Media Player, QuickTime, etc. Control over the Media Player is held by the base Virtual Kiosk using JavaScript and VBScript.

The Virtual Kiosk will communicate with the Server using HTTP and HTML. The SVG application will communicate with the Server using HTTP and HTML

HTML, Flash & Embedded Media Player

In this configuration, shown in FIG. 15B, the basic layout of the Multi-Mode Virtual Kiosk is again done in HML. The difference is that the Brand Information Network part of the Virtual Kiosk is programmed in Flash. The Media Player portion of the Virtual Kiosk is composed of the individually supported players. Control over the Media Player section of the Virtual Kiosk is held by the base Virtual Kiosk component as well as the Flash component through JavaScript and VBScript.

The Virtual Kiosk will communicate with the Server using HTTP and HTML. The SVG application will communicate with the Server using HTTP, HTML and WS (Web Services).

DHTML & Embedded Media Player

In this configuration, shown in FIG. 15C, the base layout of the Multi-Mode Virtual Kiosk is done in HTML with the Brand Information Network done in DHTML. He Media Player portion of the Virtual Kiosk is composed of the individually supported players. Control over the Media Player section of the Virtual Kiosk is held by the base Virtual Kiosk as well as the DHTML section through JavaScript and VBScript.

The Virtual Kiosk will communicate with the Server using HTTP and HTML. The SVG application will communicate with the Server using HTTP, HTML and XML (Extensible Markup Language).

Embedded Flash Media Player and Flash Information Link Controls

In this configuration, shown in FIG. 15D, the base layout of the Virtual Kiosk is again in HTML, but all of the internal components form an Applet. Each internal component such as the Flash-based Media Player and Flash-based BIN links communicate internally to provide the User Experience.

The Virtual Kiosk will communicate with the Server using HTTP and HTML. The SVG application will communicate with the Server using HTTP, HTML, XML (Extensible Markup Language) and WS (Web Services).

SVG

In this configuration, shown in FIG. 15E, the base layout of the Virtual Kiosk is again in HTML, but all of the internal components are done in SVG (Scalar Vector Graphics). Each internal component such as the Media Player and Brand Information Network communicate internally to provide the User Experience.

The Virtual Kiosk will communicate with the Server using HTTP and HTML. The SVG application will communicate with the Server using HTTP, HTML, XML (Extensible Markup Language) and WS (Web Services).

Automatic Client Browser and Media Player Plug-In Detection Mechanism for Automatically Configuring Multi-Mode Virtual Kiosks of the Present Invention

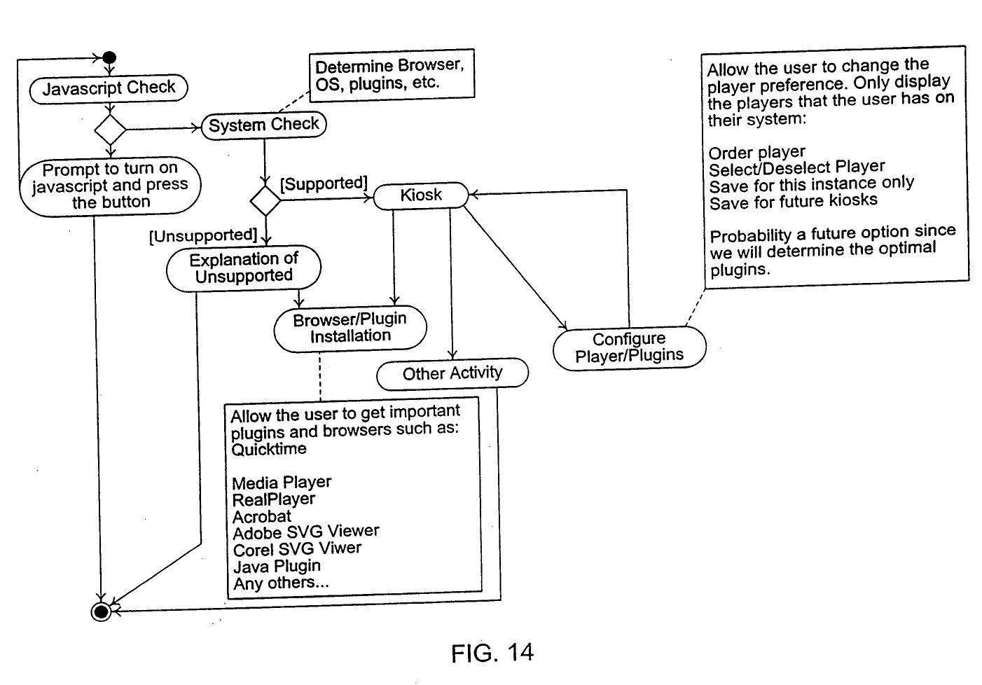

Referring to FIG. 14, the automatic client browser and media player detection mechanism for use in automatically configuring MMVKs of the present invention upon launch (on any Web-enabled client computer) will now described in detail below.

Upon launch, the Multi-Mode Virtual Kiosk shall first check on the client-side of the Network whether JavaScript is turned on within the Client computer supporting the MMVK. If JavaScript is not turned on, then the Multi-Mode Virtual Kiosk shall display a message prompting the User to turn on JavaScript and to then re-launch the Virtual Kiosk.

If JavaScript was already enabled, then the Multi-Mode Virtual Kiosk shall continue to detect which Browser and Operating System the Client is operating on. If an unsupported configuration is detected, then the Multi-Mode Virtual Kiosk shall display a message detailing the reason for the stoppage and listing which platforms are supported. The list of supported platforms and browsers would include: Internet Explorer 5.0 and up; Netscape 7.0 and up; AOL 6.0 and up; Safari; Firefox; Mozilla; and Opera.

On the server-side of the Network, the Multi-Mode Virtual Kiosk uses the Request Headers provided by all Browsers and Operating System to determine which platform it is running on. The Request Header is parsed for the information specific to each platform.

If the Multi-Mode Virtual Kiosk is running on a supported platform, then it progresses to check whether all required plug-ins are available. This can be done by polling the Client computer to determine its setup. If any plug-in is missing, the Multi-Mode Virtual Kiosk shall display a notification page regarding the missing plug-in, and if the plug-in is critical, then it will direct the User to download the plug-in. If the plug-in is not critical, it will give the User a choice to download the plug-in or continue with their experience. Once the platform is accepted and all plug-ins are in place, the Virtual Kiosk shall immediately proceed through its programmed modes.

Description of the Automatic OS/Browser/Media-Player Plug-In Detection Subsystem of the Network of the Present Invention

The Brand Marketing Communication Network and MMVK applications are Web browser-based and supported on more than one operating system. There are certain situations where knowing information about the user's operating environment can be used to tailor and enhance the user's experience. For example, if a user wants to download and install a Multi-Mode Virtual Kiosk (MMVK) that can be launched from the computer Desktop, the system/network needs to know the user's operating system (OS) so that the appropriate launch files can be downloaded. If the system can detect the operating system, then the correct launch files can be downloaded without having to prompt the user to select their operating system from a list.

The MMVK usually includes video clips or other media that may require that certain plugins have been installed on the user's computer before before viewable. Some media cannot play or have limited capabilities on some operating system, browser, or plugin versions. In any of these cases, the user could have a poor experience using a MMVK. Part of the detection design implementation is to warn the user if the Virtual Kiosk contain files which cannot be played with the user's current operating environment.

The Automatic OS/Browser/Media-Player Plug-In Detection Subsystem of the present invention is realized using both server-side and client-side components that cooperate to support a robust set of functional capabilities, including:

The ability to detect the operating system\version, browser\version, and plugin\version of all environments supported by Brand Marketing Communication Network or the MMVK (Virtual Kiosk).

The ability to detect the most popular operating systems\versions and browsers\versions even if it is not supported by the Brand Marketing Communication Network or the MMVK. The ability to detect if the user is using Brand Marketing Communication Network or the Virtual Kiosk from an unsupported operating system or version.

The ability to detect if the user is using Brand Marketing Communication Network or the MMVK from a browser/version that is not supported for the current operating system and version.

The ability to detect if the user does not have all the plugins/versions that may be required for the current MMVK to operate properly.

The MMVK must include a feature where a user can be advised if the system has detected an unsupported operating environment, i.e., the system has detected that current operating system/version are not supported or are unknown, or the system has detected that the current browser/version are not supported or are unknown, or the system has detected that at least one of the required plugins/version are missing.

The MMVK must also include a feature to help a user to determine which operating environments are supported and, where possible, assist a user with downloading/installing incorrect or missing software.

The design must be flexible enough to be enhanced when new features are introduced to the Brand Marketing Communication Network or to the MMVK. The implementation of the design must allow different supported environments for different applications, e.g., the design must allow the MMVK to support different operating environments from the Brand Marketing Communication Network or future browser based applications.

Javascript

In the illustrative embodiment, the design of the Automatic OS/Browser/Media-Player Detection Subsystem uses JavaScript to detect if the plugins that the Network supports are installed for the current browser and when possible, to detect the installed plugin version. The JavaScript is called when a form is submitted, and sends two hidden fields to the server. One of the hidden fields contains a formatted string with the plugin identifier and version. The other hidden field contains the user agent from the browser.

User Agent

The browser's user agent is retrieved from the useragent property of a browser. By examining the user agent it is generally possible to distinguish one browser from another and usually other information as the Operating System. This document includes a more in depth explanation in the section where the UserAgent table is described under “Detailed Database Table Information” toward the end of this document.

Plugin Detection

Part of the job of the detection javascript is to try to determine if the user's browser has certain plugin installed. There are two distinct methods to determine if a browser plugin is installed for a particular browser. Most browsers will return an array of plugins that are installed for the browser.

Internet Explorer does not have this feature. Instead you must query the browser for each plugin in which you are interested and Internet Explorer will reply whether or not that plugin is installed or not.

Usually additional information associated with a plugin can be parsed to find the plugin version. The rules for doing this vary from plugin to plugin. This logic is part of the code in detection.js.

Java Classes

Several Java classes provide the framework for applications such as BKSMMVK or BKSNetwork to query whether or not a user's environment is supported. The base class for detection is UserEnvironment in BKSFoundation. HTMLBrowserUserEnvironment in BKSLookNFeel is a subclass of UserEnvironment. MMVKHTMLUserEnvironment in BKSMMVK is a subclass of HTMLBrowserUserEnvironment.

Database

Additional tables described below are added to the Network's database (RDBMS) for supporting the Automatic OS/Browser/Media-Player Plug-In Detection Subsystem of the Present invention. A detailed description of these tables is described below. These tables can be maintained by hand or by an automated mechanism.

Description of Component Cooperation in the Automatic OS/Browser/Media-Player Plug-In Detection Subsystem of the Present Invention

When the user launches a browser, a form is submitted that runs the detection javascript. Currently the subsystem only looks for specific plugins. When one of these plugins is found, the system formats a plugin identifier followed by a pipe ‘|’ and a plugin version number. These are concatenated into a string with a caret ‘ˆ’ separating one plugin from another. The javascript fills in a hidden field with the user agent string, and another hidden field with the delimited list of plugin/version information. Once the server reads the browser header, it will be able to process this information.

On the server, an application creates a subclass and saves it in the User's session. During this process, the system creates a PlatformBrowser object, either by matching the browser's userAgent to one of the rows in the UserAgent table, or by piecing together the PlatformBrowser by matching different regular expressions against the browser's userAgent. These regular expressions are from the uaRegex columns in the detection tables.

The system also parses the string of plugin information and tries to find a matching plugin in the database. If one of the strings does not find an exact match, the system creates a local plugin using the name and version passed from the javascript. An array of these plugins, along with the PlatformBrowser object, are saved in the database as part of the subclass, and will always be available.

Once the system makes sure that the requested Virtual Kiosk is active and it passes all the other criteria for being launchable, the system checks if the user's PlatformBrowser is supported. It and also tries to determine what plugins will be needed by checking all Ad/Promo links for all the products in the Virtual Kiosk that the user is loading. The system then checks in the user's plugins support all of the mime types associated with all of the Ad/Promo links.

If either the PlatformBrowser object is not supported or if any required plugins are missing, the BKSMMVK displays a series of pages that provides information such as whether the Operating System or Browser is supported or if any plugins are missing. These pages also guide the user through downloading missing software. At each step of the way the user is allowed to continue with the detection process, to quit, or to continue anyway.

Once the Virtual Kiosk launches, each time an Ad or Promo is ready display, the system checks the mime type associated with that link and loads the best available plugin. Enhanced detection will be added later that will turn on or off features based on the plugin. For example, if a plugin does not support adjusting the volume, the volume control will not display.

Detailed Description of Database Tables Used to Support the Automatic OS/Browser/Media-Player Plug-In Detection Subsystem of the Network of the Present Invention

PluginFamily/Plugin

These tables should include all the plugins that the system should have knowledge of. Even unsupported plugins can be included.

| | Desc | Optional |
|---|---|---|
| PluginFamily | | |
| pluginFamilyID | unique id | N |
| name | name that will identify the plugin family | Y |
| downloadImageID | image that will display in the MMVK during detection, for the use | Y |
| | to download the plugin. These images are usually mandated by a | |
| | trademark or similar agreement. This only needs to be entered if the | |
| | plugin is supported and will appear on the detection page. | |
| created | timestamp of when this row was added to database | Y |
| lastUpdated | timestamp of last update | Y |
| lastUpdatedBy | user id of who added/edited this row to the table | Y |
| Plugin | | |
| pluginID | unique id | N |
| pluginFamilyID | foreign key to PluginFamily table | Y |
| name | descriptive name of this version of the plugin. it may not be the | Y |
| | same as the pluginVersion | |
| pluginVersion | the actual version number | Y |
| created | timestamp of when this row was added to database | Y |
| lastUpdated | timestamp of last update | Y |
| lastUpdatedBy | user id of who added/edited this row to the table | Y |

DownloadImage

This table is used in the MMVK serving application during the detection process. When the system detects that the user is missing a supported browser or required plugin, a page will display with links to download the missing browser or plugin. Usually the icon, links, and other information is mandated by the company or project who supplies the browser or plugin. Usually there are specific rules about what image is used, its size, placement, and the url to link to their download page. Sometimes the company also mandates that the image must be referenced directly from their website, e.g., “http://www.theircompany.com/icons/theirbrowser.jpg”

| DownloadImage | Desc | Optional |
|---|---|---|
| downloadImageID | unique id | N |
| downloadImage | name of gif or jpg file to display for the download link. This may | N |
| | be the name of an image in BKSKioskResources or it may be a url | |
| | to an image on another web page. | |
| url | url that will download the browser or plugin. This is ofter | N |
| | mandated by a usage or similar agreement | |
| kioskResource | True if the image is in BKSKioskResources. | Y |
| title | text to use for “alt” tag | Y |
| width | width of the downloadImage | Y |
| height | height of the downloadImage | Y |
| notice | copyright or similar notice that appears at the bottom of a page that | Y |
| | uses this image. This is usually mandated by a usage or license | |
| | agreement | |
| created | timestamp of when this row was added to database | N |
| lastUpdated | timestamp of last update | N |
| lastUpdatedBy | user id of who added/edited this row to the table | N |

MimeType

This table should be populated with as many MimeTypes as we want the system to recognize, even if they are not supported by the MMVK serving application (i.e. BKS MMVK) or the network application (i.e. BKSNETWORK) used for supporting the services provided on the Network. This table is used by Brandkey Create to populate the mime type for links that are marked as Ads or Promos. Then in the BKSMMVK, the mime type of the link is used to determine the best plugin to load. All the mimetypes that are included in the drop down list in Brandkey Create should also have a plugin defined.

| MimeType | Desc | Optional |
|---|---|---|
| mimeTypeID | unique id | N |
| name | name of mime type that the system will display | Y |
| knownDuration | indicator whether or not this mime type has a duration associated | Y |
| | with it. For example a video clip usually has a duration from its | |
| | start to finish while a static image does not. In order for the | |
| | BKSMMVK to know how long to display an image, the use | |
| | needs to enter a duration. If this indicator is false, then the system | |
| | can look for a duration in the link table. | |
| created | timestamp of when this row was added to database | Y |
| lastUpdated | timestamp of last update | Y |
| lastUpdatedBy | user id of who added/edited this row to the table | Y |

HTML Engine

There are several HTML engines that are used by different browser. Sometimes more than one browser will use the same HTML engine. The HTML engine influences certain behaviors of a browser.

| HTMLEngine | Desc | Optional |
|---|---|---|
| htmlEngineID | unique id | N |
| name | name of the html engine. This is for | Y |
| | identification purposes and the system | |
| | will probably not display this to a user. | |
| created | timestamp of when this row was added to | Y |
| | database | |
| lastUpdated | timestamp of last update | Y |
| lastUpdatedBy | user id of who added/edited this row | Y |
| | to the table | |

BrowserFamily/Browser

These tables should include all the browsers that the system should have knowledge of. Even unsupported browsers can be included. If an unsupported browser is in this table, then the detection pages in the BKSMMVK can identify the browser and display a message with the browser and version and state that the browser is not supported. If the browser is not in the table, all the system can do is to state than an unknown browser was detected. Examples of browser families are IE or Netscape. Examples of browsers are the specific versions. Browsers should really be thought of as the combination of browser and browser family.

| | Desc | Optional |
|---|---|---|
| BrowserFamily | | |
| browserFamilyID | unique id | N |
| name | name that will identify the browser family. An example is Firefox. | Y |
| uaRegex | Java regular expression that helps identify a BrowserFamily from a | Y |
| | browser's User Agent. These can have a slightly different syntax | |
| | than regular expressions in other languages. If you enter a new | |
| | BrowserFamily but don't yet know the proper regular expression to | |
| | use, just fill in some unique characters, or leave it blank, and this | |
| | can be updated later during testing. (It's possible that this column | |
| | will be removed later if it turns out it is not useful to use the regular | |
| | expression to identify the browser family) | |
| downloadImage | image that will display in the MMVK during detection, for the use | N (This column |
| ID | to download the browser. These images are usually mandated by a | should probably |
| | trademark or similar agreement. This only needs to be entered if the | be changed to |
| | browser is supported and will appear on the detection page. | optional Y) |
| created | timestamp of when this row was added to database | Y |
| lastUpdated | timestamp of last update | Y |
| lastUpdatedBy | user id of who added/edited this row to the table | Y |
| Browser | | |
| browserID | unique id | N |
| browserFamilyID | foreign key to BrowserFamily table | Y |
| htmlEngineID | foreign key to htmlEngine table. Knowing the html engine is useful | Y |
| | for identifying some shared behavior of browsers with the same | |
| | html engine. | |
| uaRegex | Java regular expression that helps identify a Browser from a | Y |
| | browser's User Agent. These can have a slightly different syntax | |
| | than regular expressions in other languages. If you enter a new | |
| | Browser but don't yet know the proper regular expression to use | |
| | just fill in some unique characters, or leave it blank, and this can be | |
| | updated later during testing. | |
| browserVersion | the actual version number | Y |
| created | timestamp of when this row was added to database | Y |
| lastUpdated | timestamp of last update | Y |
| lastUpdatedBy | user id of who added/edited this row to the table | Y |

OSFamily/OS

In the current design, only supported Operating Systems should be in the OSFamily/OS tables. An example of OSFamily is Windows. Examples of OS's are Windows 95 and Windows 98.

| | Desc | Optional |
|---|---|---|
| OSFamily | | |
| osFamilyID | unique id | N |
| name | name that will identify the OS, or Unknown | Y |
| uaRegex | Java regular expression that helps identify a OSFamily from a | Y |
| | browser's User Agent. These can have a slightly different syntax | |
| | than regular expressions in other languages. If you enter a new | |
| | OSFamily but don't yet know the proper regular expression to use | |
| | just fill in some unique characters, or leave it blank, and this can be | |
| | updated later during testing. | |
| created | timestamp of when this row was added to database | Y |
| lastUpdated | timestamp of last update | Y |
| lastUpdatedBy | user id of who added/edited this row to the table | Y |
| OS | | |
| osID | unique id | N |
| osFamilyID | foreign key to OSFamily table | Y |
| osVersion | Version of the OS. Since determining the OS currently relies on the | Y |
| | User Agent, there are some sub-versions that cannot be | |
| | distinguished. For example, it is not possible to distinguish between | |
| | OS × 10.2 and OS × 10.3, so the version is shown as 10.x | |
| uaRegex | Java regular expression that helps identify an OS from a browser's | Y |
| | User Agent. These can have a slightly different syntax than regular | |
| | expressions in other languages. If you enter a new OS but don't yet | |
| | know the proper regular expression to use, just fill in some unique | |
| | characters, or leave it blank, and this can be updated later during | |
| | testing. | |
| created | timestamp of when this row was added to database | Y |
| lastUpdated | timestamp of last update | Y |
| lastUpdatedBy | user id of who added/edited this row to the table | Y |

CPUFamily/Platform

The CPUFamily table identifies a family of CPU's such as x86, Sparc, etc. It is used in combination with other tables to identify the operating system. Even CPU families that are not supported by BKSNetworks and the BKSMMVK can be entered in this table. Platform is made up of a CPUFamily and an OS combination.

| CPUFamily | Desc | Optional |
|---|---|---|
| cpuFamilyID | unique id | N |
| name | name of the CPU Family. This is for identification purposes and | Y |
| | the system will probably not display this to a user. | |
| uARegex | Java regular expression that helps identify a CPUFamily from a | Y |
| | browser's User Agent. These can have a slightly different | |
| | syntax than regular expressions in other languages. If you enter | |
| | a new CPUFamily but don't yet know the proper regular | |
| | expression to use, just fill in some unique characters, or leave it | |
| | blank, and this can be updated later during testing. | |
| created | timestamp of when this row was added to database | Y |
| lastUpdated | timestamp of last update | Y |
| lastUpdatedBy | user id of who added/edited this row to the table | Y |

| Platform | Desc | Optional |
|---|---|---|
| cpuFamilyID | foreign key to the CPUFamily table | N |
| osID | foreign key to the OS table | N |
| created | timestamp of when this row was added | Y |
| | to database | |
| lastUpdated | timestamp of last update | Y |
| lastUpdatedBy | user id of who added/edited this | Y |
| | row to the table | |

UserAgent

Using javascript, it is easy to get the useragent property from a browser. Each browser has a useragent that identifies the browser. The format of useragents has developed over time to follow a general pattern with many variations. For example, one of the useragents for IE for XP is “Mozilla/4.0 (compatible; MSIE 6.0; Windows NT 5.1)” The useragent contains “Mozilla” since originally IE was written using the Mozilla codebase, but they chose to add the additional phrase “compatible.” MSIE 6.0 is the browser version. Windows NT 5.1 means that this browser is on XP. The useragent column in the UserAgent table contains a full user agent that can be matched against the useragent property of the browser. Even useragents that are not supported by BKSMMVK can be added to this table.

The detection design provides another mechanism to determine the browser from the useragent since many browsers have multiple variations of user agents. For example, sometimes when a user installs additional software or plugins, the useragent will be modified to include additional text. Rather than adding a new row to the UserAgent table for each variation, the design also uses a regular expression to apply against the UserAgent. The uaRegex column in some of the other detection tables uses this matching/identification scheme.

| UserAgent | Desc | Optional |
|---|---|---|
| userAgentID | unique ID | N |
| browserID | foreign key to the browser table | Y |
| cpuFamilyID | foreign key to the CPUFamily table | Y |
| osID | foreign key to the OS table | Y |
| useragent | string to match against a browser's | Y |
| | user agent | |
| notes | ?? | Y |
| created | timestamp of when this row was added to | Y |
| | database | |
| lastUpdated | timestamp of last update | Y |
| lastUpdatedBy | user id of who added/edited this row | Y |
| | to the table | |

MMVKUserAgent

Only browser/cpufamily/os combinations that are supported by the BKSMMVK should be included in this table. It is also possible that a combination that is not included in this table can still be supported by the BKSMMVK if the other detection mechanism described under UserAgent includes the combination.

| MMVKUserAgent | Desc | Optional |
|---|---|---|
| userAgentID | unique ID | N |
| created | timestamp of when this row was added | Y |
| | to database | |
| lastUpdated | timestamp of last update | Y |
| lastUpdatedBy | user id of who added/edited this row | Y |
| | to the table | |

PlatformBrowser

This table contains rows with valid cpufamily, os, and browser combinations. During detection, the system tries to find the correct row in the PlatformBrowser table by first finding the separate components.

Basically the system tries to match the regular expression in the OS table to find the corresponding OS. Next the system tries to match the regular expression in the CPUFamily table to find the corresponding CPUFamily. Lastly the system tries to match the regular expression in the browser table to find the corresponding browser. These pieces are used to find a matching row in the PlatformBrowser table.

| PlatformBrowser | Desc | Optional |
|---|---|---|
| browserID | foreign key to the browser table | N |
| cpuFamilyID | foreign key to the CPUFamily table | N |
| osID | foreign key to the OS table | N |
| created | timestamp of when this row was added to | Y |
| | database | |
| lastUpdated | timestamp of last update | Y |
| lastUpdatedBy | user id of who added/edited this row to | Y |
| | the table | |

MMVKPlatformBrowser

This table contains rows with valid cpufamily, os, and browser combinations. If a cpufamily/os/browser combination is found in this table, then that combination is supported by the BKSMMVK. If a combination is supported by the BKSMMVK and it is NOT found in this table, it must have a row in the MMVKUserAgent table.

| MMVKPlatformBrowser | Desc | Optional |
|---|---|---|
| browserID | foreign key to the browser table | N |
| cpuFamilyID | foreign key to the CPUFamily | N |
| | table | |
| osID | foreign key to the OS table | N |
| created | timestamp of when this row was | Y |
| | added to database | |
| lastUpdated | timestamp of last update | Y |
| lastUpdatedBy | user id of who added/edited this | Y |
| | row to the table | |

PlatformBrowserPlugin

This table contains valid cpufamily/os/browser/plugin combinations.

| PlatformBrowserPlugin | Desc | Optional |
|---|---|---|
| browserID | foreign key to the browser table | N |
| cpuFamilyID | foreign key to the CPUFamily | N |
| | table | |
| osID | foreign key to the OS table | N |
| pluginID | foreign key to the plugin table | N |
| created | timestamp of when this row was | Y |
| | added to database | |
| lastUpdated | timestamp of last update | Y |
| lastUpdatedBy | user id of who added/edited this | Y |
| | row to the table | |

MMVKPlatformBrowserPlugin

This table contains valid cpufamily/os/browser/plugin combinations that are supported by the BKSMMVK. An additional column, rank, contains a numerical ranking. The plugin that has the lowest number in the rank column, for a cpufamily/os/browser/plugin combination, is the best plugin to use. All cpufamily/os/browser/plugin combinations that are supported by the BKSMMVK, should be contained in this table.

| MMVKPlatformBrowserPlugin | Desc | Optional |
|---|---|---|
| browserID | foreign key to the browser | N |
| | table | |
| cpuFamilyID | foreign key to the | N |
| | CPUFamily table | |
| osID | foreign key to the OS table | N |
| pluginID | foreign key to the plugin | N |
| | table | |
| rank | rank for this plugin | Y |
| created | timestamp of when this row | Y |
| | was added to database | |
| lastUpdated | timestamp of last update | Y |
| lastUpdatedBy | user id of who added/edited | Y |
| | this row to the table | |

PlatformBrowserPluginMimeType

This table contains valid cpufamily/os/browser/plugin/mimeType combinations. Only valid combinations that are supported by BKSNetwork should be contained in this table. This table is used to determine what plugin to use for a link that has a certain mimetype.

| PlatformBrowserPluginMimeType | Desc | Optional |
|---|---|---|
| browserID | foreign key to the | N |
| | browser table | |
| cpuFamilyID | foreign key to the | N |
| | CPUFamily table | |
| osID | foreign key to the OS | N |
| | table | |
| pluginID | foreign key to the plugin | N |
| | table | |
| mimeTypeID | foreign key to the | N |
| | mimeType table | |
| created | timestamp of when this | Y |
| | row was added to | |
| | database | |
| lastUpdated | timestamp of last update | Y |
| lastUpdatedBy | user id of who added/ | Y |
| | edited this row to the | |
| | table | |

Operation of the Product-Specific Multi-Mode Virtual Kiosk of the Illustrative Embodiment

The following use case describes the operation of a Product-Specific Multi-Mode Virtual Kiosk (MMVK) from a launch environment. When the user clicks to launch the Product-Specific Virtual Kiosk from a launch environment, the follow flow of occurs occur:

Launch Multi-Mode Virtual Kiosk with BIN, Ad, and Promo Modes Respectively

The use case begins when the user clicks on the HTML-Encoded Brandkey™ Button to launch the Product-Specific Multi-Mode Virtual Kiosk. The embedded URL tag contains the encrypted identification number of the installed Product-Specific Virtual Kiosk to be launched. The tag sends a request to the system for the virtual kiosk. The system searches for the installed virtual kiosk id, and the system responds by sending back a “Loading . . . ” splash screen to the requestor. When the system finds the virtual kiosk id, the system then determines whether or not the requested virtual kiosk is still active and deployed. If the virtual kiosk is active and deployed, the system shall check whether the requesting domain (website where the virtual kiosk is launched from) is an allowed domain. If the virtual kiosk is launched from an allowed domain, the system shall determine the type of virtual kiosk that is being requested. The system shall determine the layout, color, button set style, and surface texture (skin) to be used in displaying the requested Product-Specific Virtual Kiosk. The system shall determine which display modes and the order they play on the specific Product-Specific Virtual Kiosk. The system shall replace the opened splash screen with the actual Product-Specific Virtual Kiosk. If the Brand Information Network (BIN) Mode was selected first when installing the virtual kiosk, the system shall display the BIN Mode under the “Info” tab to the right of the “Home” tab followed by the “Ads” tab (See FIG. 1). The BIN Mode layout shall contain a Content Display window near the top, all associated links (BIN) in the middle, and an information text bar near the bottom. If the “Send to Friend” feature has been enabled, the system shall display the “Send to Friend” button at the bottom of the BIN Mode layout. As long as a desktop icon has been uploaded, and if the “Download” feature has been enabled, the system shall display the “Download” button at the bottom of the BIN Mode layout. The system shall display the “Buy Now” feature at the bottom of the BIN Mode layout if it is enabled and an associated link has been specified. The system shall display a default image supplied by the virtual kiosk owner in the Content Display window whenever the virtual kiosk is in an idle state (See FIG. 3). The system checks if the multi-mode virtual kiosk has been installed by a retailer. If so, the system checks if there are any purchase-enabling links within the BIN. If true, the system shall not display the purchase-enabling links in the BIN. The Content Display window shall serve as a web browser whenever an associated BIN link is clicked. The system shall display the contents of the link in the Content Display window. (See FIG. 4) In addition, if any of the associated BIN links contains a video clip, the system shall display the virtual kiosk video components while the specific link is clicked and viewed. The virtual kiosk video components shall consist of a graphical mute button, “+” and “−” volume control buttons, a “<<Replay” button, a “Skip>>” button, and a time-lapse meter. After viewing the video clip contained in the link, if the user clicks another BIN link that contains no video clip, the system shall hide the video components from the BIN Mode layout. Within the BIN, the system shall display the associated links of the brand as either Simple Tabular format or Pre-Post Purchase format (See FIG. 3). If there are more than 3 associated links for the BIN, the system shall display the batch navigation bar at the bottom of the Simple Tabular or Pre-Post Purchase table. If the creator of the MMVK had previously selected the “Enable Voting for Link” feature in Brandkey Create™, the system shall display the “Rating” Indicator pull-down list along with the “Vote” button when an associated link in the BIN is clicked. When the user votes for the selected link: The system shall save the vote in the database. The system re-calculates the “Rating” Indicator. The system shall refresh the “Rating” Indicator if needed. If the Ad Mode was selected second when creating the virtual kiosk, the system shall determine the Ad Mode as the next mode and display the Ad Mode under the “Ads” tab to the right of the “Info” tab. If the play list is empty for the Ad Mode, the system shall not display “Ads” tab in the virtual kiosk. If the user clicks the “Ads” tab, the system shall generate a list of ad-spot video clips previously selected in Brandkey Advertise™. If the Promo Mode was selected third when creating the virtual kiosk, the system shall determine the Promo Mode as the next mode and display the Promo Mode under the “Promos” tab to the right of the “Ads” tab when the “Ads” tab is clicked the first time. If the play list is empty for the Promo Mode, the system shall not display the “Promos” tab in the virtual kiosk. For the Ad Mode, the system shall resize, display, and run the generated list of ad-spot video clips in the Ad-Spot Display window. The system shall display the video components below the Ad-Spot Display window, an information text bar near the bottom, and three buttons at the bottom, namely, “Send to Friend”, “Download”, and “Buy Now” as long as they each have been enabled and there has been a desktop icon image uploaded for the Download button and there has been a link specified for the Buy Now button. While the ad-spot video clips are playing, the user may click the “<<Replay” or “Skip>>” button at any time. If the user clicks the “<<Replay” button, the system shall replay the currently playing ad-spot video clip. If the user clicks the “Skip>>” button, the system shall interrupt the ad-spot video clip currently playing, advance to the next video, and start playing. When the last ad-spot video in the list has played, the system shall display the contents of the “Promos” tab automatically. If the user clicks the “Promos” tab prior to the last ad-spot video completing, the system shall generate a list of promo-spot video clips previously selected in Brandkey Promote™. The system shall resize, display, and run the generated list of promo-spot video clips in the Promo-Spot Display window. The system shall display the video components below the Promo-Spot Display window, and a promotions-related text bar near the bottom. If the “Send to Friend” feature has been enabled, the system shall display the “Send to Friend” button at the bottom of the Promo Mode layout. As long as a desktop icon has been uploaded, and if the “Download” feature has been enabled, the system shall display the “Download” button at the bottom of the Promo Mode layout. The system shall display the “Buy Now” feature at the bottom of the Promo Mode layout if it is enabled and an associated link has been specified. The system shall display a default image supplied by the virtual kiosk owner in the Content Display window whenever the virtual kiosk is in an idle state. While the promo-spot video clips are playing, the user may click the “<<Replay” or “Skip>>” button at any time. If the user clicks the “<<Replay” button, the system shall replay the currently playing promo-spot video clip. If the user clicks the “Skip>>” button, the system shall interrupt the promo-spot video clip currently playing, advance to the next video, and start playing. When the last promo-spot video in the list has played, the system shall remain in that state until the user clicks a button. The system shall display the default image, if one has been defined for the BIN, in the Content Display window. If the user clicks the “Home” tab at anytime, the system shall reset the virtual kiosk to the original order while the system re-displays the “Loading . . . ” splash screen. When the reset is complete, the system shall replace the splash screen with the Product-Specific Virtual Kiosk displaying the “Info” tab section, the “Ads” tab, and the “Promos” tab to the right of the “Info” tab.

Launch Multi-Mode Virtual Kiosk with BIN, and Ad Modes

After the system has displayed the BIN Mode and Ad Mode, the system shall check for the next mode. The system determines there is no Promo Mode, and the system shall remain in Ad Mode state until the user clicks a button. If the user clicks the “Home” tab at anytime, the system shall reset the virtual kiosk to the original order while the system re-displays the “Loading.” splash screen. When the reset is complete, the system shall replace the splash screen with the Product-Specific Virtual Kiosk displaying the “Info” tab section, and the “Ads” tab to the right of the “Info” tab.

Launch Multi-Mode Virtual Kiosk with BIN Only

After the system has displayed the BIN Mode, the system shall check for the next mode. The system determines there is neither Ad Mode nor Promo Mode, and the system shall remain in the BIN Mode. If the user clicks the “Home” tab at anytime, the system shall reset the virtual kiosk to the original order while the system re-displays the “Loading . . . ” splash screen. When the reset is complete, the system shall replace the splash screen with the Product-Specific Virtual Kiosk displaying the “Info” tab section.

Launch Multi-Mode Virtual Kiosk with Ad and Promo Modes

If the Ad Mode was selected first when creating the virtual kiosk, the system determines there is no BIN Mode and displays the Ad Mode under the “Ads” tab to the right of the “Home” tab (See FIG. 1). The system shall check for the next mode. The system determines the Promo Mode is next and displays the Promo Mode under the “Promos” tab to the right of the “Ads” tab (See FIG. 2). If the user clicks the “Home” tab at anytime, the system shall reset the virtual kiosk to the original order while the system re-displays the “Loading . . . ” splash screen. When the reset is complete, the system shall replace the splash screen with the Product-Specific Virtual Kiosk displaying the “Ads” tab section, and the “Promos” tab to the right of the “Ads” tab.

Launch Multi-Mode Virtual Kiosk with only Ad or Promo Mode

If either the Ad Mode or Promo Mode was selected as the only mode when creating the virtual kiosk, the system determines there is neither a BIN Mode nor Ad/Promo Mode and displays the Ad/Promo Mode under the “Ads”/“Promos” tab to the right of the “Home” tab. If the user clicks the “Home” tab at anytime, the system shall reset the virtual kiosk to the original order while the system re-displays the “Loading . . . ” splash screen. When the reset is complete, the system shall replace the splash screen with the Product-Specific Virtual Kiosk displaying either the “Ads” or “Promos” tab section to the right of the “Home” tab.

The Replay Button is Clicked

If the system is in Ad Mode, the system shall replay the currently playing ad-spot video clip. If the system is in Promo Mode, the system shall replay the currently playing promo-spot video clip. If the system is in BIN Mode, and if any of the associated BIN links contains a video clip, the system shall play the video contained in the BIN link from the beginning.

The Skip Button is Clicked

If the system is in Ad Mode, the system shall interrupt the ad-spot video clip currently playing, advance to the next video, and start playing. If the system is in Promo Mode, the system shall interrupt the promo-spot video clip currently playing, advance to the next video, and start playing. If the system is in BIN Mode, and if any of the associated BIN links contains a video clip, the system shall advance the video to the end and stop.

The Volume Control (+) Button is Clicked

The system increases the volume.

The Volume Control (−) Button is Clicked

The system decreases the volume.

The Send to Friend Button is Clicked

If the user clicks the “Send to Friend” button, the system shall display a small form in the Content Display window that contains a “From:” section comprised of a “Name:” text field, an “E-mail:” text field, and a “Message” text area, a “To:” section comprised of an “E-mail1:” text field, an “E-mail2:” text field, an “E-mail3:” text field, an “E-mail4:” text field, an “E-mail5:” text field, a “Send” button, and a “Cancel” button (See FIG. 5). If the user fills the information on the form and clicks the “Send” button, the system shall send the message via the system SMTP server. The message is sent and the system shall replace the message form with a confirmation page. The confirmation page shall display the following message, “A link to this virtual kiosk has been sent, and a confirmation e-mail has also been sent to your e-mail address. Click here to re-launch this Virtual Kiosk.” If the user clicks the “Cancel” button, the system shall replace the message form with the contents of the previously selected tab. If the User clicks the link to re-launch the Virtual Kiosk, then the system shall reset the virtual kiosk to the original order while the system re-displays the “Loading . . . ” splash screen.

The Download Button is Clicked

If the user clicks the “Download” button, the system shall replace the contents of the Content Display window with the “Download Multi-Mode Virtual Kiosk” form. The “Download Multi-Mode Virtual Kiosk” page shall contain user instructions at the top, a “Name” text field, “City” text field, “State” text field, “Zip/Postal Code” text field, “Country” text field, an “Operating System” pull-down list, a “Purpose of Installation” text area, a “Cancel” button, and a “Next” button. All required fields shall be denoted by an asterisk next to the field name. If the user omits a required field, the system shall display a message indicating the required field is blank. If the user clicks the “Cancel” button, the system shall redisplay the default mode in the Content Display window. If the user clicks the “Next” button, the system shall start the download process and display the second “Download Multi-Mode Virtual Kiosk” page. The second “Download Multi-Mode Virtual Kiosk” page shall contain information indicating the actual download is in progress, instructions for an alternate method, “click here”, to download, a “Back” button, and a “Re-Launch Virtual Kiosk” button. If the user clicks the “Back” button, the system shall reload the first “Download Multi-Mode Virtual Kiosk” page If the user clicks the “Re-Launch Virtual Kiosk” button, the system shall reset the virtual kiosk and display the default mode. During the download process, the system shall display a download dialog window. The user shall choose where to save the zipped virtual kiosk package on their computer through the download dialog window.

The Buy Now Button is Clicked

If the user clicks the “Buy Now” button, the system shall determine where to open the “Buy Now” associated link. If the creator of the virtual kiosk originally selected to open the associated link in the virtual kiosk, the system shall open the “Buy Now” link in the Content Display window. If the creator of the virtual kiosk originally selected to open the associated link outside of the virtual kiosk, the system shall determine whether there is a parent window to open the virtual kiosk in or open the virtual kiosk in a new window.

Requested Virtual Kiosk is no longer Active or Deployed

The system shall display the following error message on the screen, “The requested Virtual Kiosk is no longer available from [Virtual Kiosk Sponsor's Name].”

The Launching Domain is a Forbidden Domain

The system shall display the following error message on the screen, “This website is not authorized to launch the requested Virtual Kiosk. Please contact admin@bksnetworks.com to inform them of any illegal use of the requested Virtual Kiosk. Thank you.”

One or More Visual Attributes of the Requested Virtual Kiosk are Not Available

The system shall display the following error message on the screen, “The requested Virtual Kiosk is currently not available. Please try back again later.”

Operation of the Vendor-Specific Multi-Mode Virtual Kiosk of the Illustrative Embodiment

This use case describes the operation of a Vendor-Specific Virtual Kiosk from a launch environment. When the user clicks to launch the Vendor-Specific Virtual Kiosk from a launch environment, the following flow of events occur:

Launch Multi-Mode Virtual Kiosk with BIN, Ad, and Promo Modes Respectively

The use case begins when the user clicks on the HTML-Encoded Brandkey™ Button to launch the Vendor-Specific Multi-Mode Virtual Kiosk. The embedded URL tag contains the encrypted identification number of the installed Vendor-Specific Virtual Kiosk to be launched. The tag sends a request to the system for the virtual kiosk. The system searches for the installed virtual kiosk id, and the system responds by sending back a “Loading . . . ” splash screen to the requestor. When the system finds the virtual kiosk id, the system then determines whether or not the requested virtual kiosk is still active and deployed. If the virtual kiosk is active and deployed, the system shall check whether the requesting domain (website where the virtual kiosk is launched from) is an allowed domain. If the virtual kiosk is launched from an allowed domain, the system shall determine the type of virtual kiosk that is being requested. The system shall determine the color to be used in displaying the requested Vendor-Specific Virtual Kiosk. The system shall determine which display modes and the order they play on the specific Vendor-Specific Virtual Kiosk. The system shall replace the opened splash screen with the actual Vendor-Specific Virtual Kiosk. If the Brand Information Network (BIN) Mode was selected first when creating the virtual kiosk, the system shall display the BIN Mode under the “Info” tab to the right of the “Home” tab followed by the “Ads” tab. The BIN Mode layout shall contain a Content Display window near the top, all associated links (BIN) in the middle, and an information text bar near the bottom. The system shall check how many products are associated with this virtual kiosk. If there is more than one product associated, the system shall display the “Search” tab to the right of all other tabs (See FIG. 6). If there are no products associated, the “Search” tab will not be displayed. If there is only one product associated with the virtual kiosk, the system shall not display the “Search” tab. As soon as the “Promo” tab is selected, the system shall display the “Info” tab. (See FIG. 2) If the “Send to Friend” feature has been enabled, the system shall display the “Send to Friend” button at the bottom of the BIN Mode layout. As long as a desktop icon has been uploaded, and if the “Download” feature has been enabled, the system shall display the “Download” button at the bottom of the BIN Mode layout. The system shall display the “Buy Now” feature at the bottom of the BIN Mode layout if it is enabled and an associated link has been specified. The system shall display a default image supplied by the virtual kiosk owner in the Content Display window whenever the virtual kiosk is in an idle state. The system checks if a retailer has installed the multi-mode virtual kiosk. If so, the system checks if there are any purchase-enabling links within the BIN. If true, the system shall not display the purchase-enabling links in the BIN. The Content Display window shall serve as a web browser whenever an associated BIN link is clicked. The system shall display the contents of the link in the Content Display window (See FIG. 4). In addition, if any of the associated BIN links contains a video clip, the system shall display the virtual kiosk video components while the specific link is clicked and viewed. The virtual kiosk video components shall consist of a graphical mute button, “+” and “−” volume control buttons, a “<<Replay” button, a “Skip>>” button, and a time-lapse meter. After viewing the video clip contained in the link, if the user clicks another BIN link that contains no video clip, the system shall hide the video components from the BIN Mode layout. Within the BIN, the system shall display the associated links of the brand as either Simple Tabular format or Pre-Post Purchase format. If there are more than 3 associated links for the BIN, the system shall display the batch navigation bar at the bottom of the Simple Tabular or Pre-Post Purchase table. If the creator of the MMVK had previously selected the “Enable Voting for Link” feature in Brandkey Create™, the system shall display the “Rating” Indicator pull-down list along with the “Vote” button when an associated link in the BIN is clicked. When the user votes for the selected link: The system shall save the vote in the database. The system re-calculates the “Rating” Indicator. The system shall refresh the “Rating” Indicator if needed. If the Ad Mode was selected second when creating the virtual kiosk, the system shall determine the Ad Mode as the next mode and display the Ad Mode under the “Ads” tab to the right of the “Info” tab. If the play list is empty for the Ad Mode, the system shall not display “Ads” tab in the virtual kiosk. If the user clicks the “Ads” tab, the system shall generate a list of ad-spot video clips previously selected in Brandkey Advertise™. If the Promo Mode was selected third when creating the virtual kiosk, the system shall determine the Promo Mode as the next mode and display the Promo Mode under the “Promos” tab to the right of the “Ads” tab when the “Ads” tab is clicked the first time. If the play list is empty for the Promo Mode, the system shall not display the “Promos” tab in the virtual kiosk. For the Ad Mode, the system shall resize, display, and run the generated list of ad-spot video clips in the Ad-Spot Display window. The system shall display the video components below the Ad-Spot Display window, an information text bar near the bottom, and three buttons at the bottom, namely, “Send to Friend”, “Download”, and “Buy Now” as long as they each have been enabled and there has been a desktop icon image uploaded for the Download button and there has been a link specified for the Buy Now button. While the ad-spot video clips are playing, the user may click the “<<Replay” or “Skip>>” button at any time. If the user clicks the “<<Replay” button, the system shall replay the currently playing ad-spot video clip. If the user clicks the “Skip>>” button, the system shall interrupt the ad-spot video clip currently playing, advance to the next video, and start playing. When the last ad-spot video in the list has played, the system shall display the contents of the “Promos” tab automatically. If the user clicks the “Promos” tab prior to the last ad-spot video completing, the system shall generate a list of promo-spot video clips previously selected in Brandkey Promote™. The system shall resize, display, and run the generated list of promo-spot video clips in the Promo-Spot Display window. The system shall display the video components below the Promo-Spot Display window, and a promotions-related text bar near the bottom. If the “Send to Friend” feature has been enabled, the system shall display the “Send to Friend” button at the bottom of the Promo Mode layout. As long as a desktop icon has been uploaded, and if the “Download” feature has been enabled, the system shall display the “Download” button at the bottom of the Promo Mode layout. The system shall display the “Buy Now” feature at the bottom of the Promo Mode layout if it is enabled and an associated link has been specified. The system shall display a default image supplied by the virtual kiosk owner in the Content Display window whenever the virtual kiosk is in an idle state. While the promo-spot video clips are playing, the user may click the “<<Replay” or “Skip>>” button at any time. If the user clicks the “<<Replay” button, the system shall replay the currently playing promo-spot video clip. If the user clicks the “Skip>>” button, the system shall interrupt the promo-spot video clip currently playing, advance to the next video, and start playing. When the last promo-spot video in the list has played, the system shall remain in that state until the user clicks a button. The system shall display the default image, if one has been defined for the BIN, in the Content Display window. If the user clicks the “Home” tab at anytime, the system shall reset the virtual kiosk to the original order while the system re-displays the “Loading . . . ” splash screen. When the reset is complete, the system shall replace the splash screen with the Vendor-Specific Virtual Kiosk displaying the “Info” tab section, the “Ads” tab, the “Promos” tab, and if there is more than one product associated with the Vendor-Specific Virtual Kiosk, the “Search” tab to the right of the other tabs.

Launch Multi-Mode Virtual Kiosk with BIN, and Ad Modes

After the system has displayed the BIN Mode and Ad Mode, the system shall check for the next mode. The system determines there is no Promo Mode, and the system shall remain in Ad Mode state until the user clicks a button. If the user clicks the “Home” tab at anytime, the system shall reset the virtual kiosk to the original order while the system re-displays the “Loading.” splash screen. When the reset is complete, the system shall replace the splash screen with the Vendor-Specific Virtual Kiosk displaying the “Info” tab section, the “Ads” tab, and if there is more than one product associated with the Vendor-Specific Virtual Kiosk, the “Search” tab to the right of the other tabs.

Launch Multi-Mode Virtual Kiosk with BIN Only

After the system has displayed the BIN Mode, the system shall check for the next mode. The system determines there is neither Ad Mode nor Promo Mode, and the system shall remain in the BIN Mode. If the user clicks the “Home” tab at anytime, the system shall reset the virtual kiosk to the original order while the system re-displays the “Loading . . . ” splash screen. When the reset is complete, the system shall replace the splash screen with the Vendor-Specific Virtual Kiosk displaying the “Info” tab section, and if there is more than one product associated with the Vendor-Specific Virtual Kiosk, the “Search” tab to the right of the “Info” tab.

Launch Multi-Mode Virtual Kiosk with Ad and Promo Modes

If the Ad Mode was selected first when creating the virtual kiosk, the system determines there is no BIN Mode and displays the Ad Mode under the “Ads” tab to the right of the “Home” tab. The system shall check for the next mode. The system determines the Promo Mode is next and displays the Promo Mode under the “Promos” tab to the right of the “Ads” tab. If the user clicks the “Home” tab at anytime, the system shall reset the virtual kiosk to the original order while the system re-displays the “Loading . . . ” splash screen. When the reset is complete, the system shall replace the splash screen with the Vendor-Specific Virtual Kiosk displaying the “Ads” tab section, the “Promos” tab to the right of the “Ads” tab, and if there more than one product associated with the Vendor-Specific Virtual Kiosk, the “Search” tab to the right of the “Promos” tab.

Launch Multi-Mode Virtual Kiosk with only Ad or Promo Mode

If either the Ad Mode or Promo Mode was selected as the only mode when creating the virtual kiosk, the system determines there is neither a BIN Mode nor Ad/Promo Mode and displays the Ad/Promo Mode under the “Ads”/“Promos” tab to the right of the “Home” tab. If the user clicks the “Home” tab at anytime, the system shall reset the virtual kiosk to the original order while the system re-displays the “Loading . . . ” splash screen. When the reset is complete, the system shall replace the splash screen with the Vendor-Specific Virtual Kiosk displaying either the “Ads” or “Promos” tab section to the right of the “Home” tab, and if there is more than one product associated with the Vendor-Specific Virtual Kiosk, the “Search” tab to the right of either the “Ads” or “Promos” tab.

The Replay Button is Clicked

If the system is in Ad Mode, the system shall replay the currently playing ad-spot video clip. If the system is in Promo Mode, the system shall replay the currently playing promo-spot video clip. If the system is in BIN Mode, and if any of the associated BIN links contains a video clip, the system shall play the video contained in the BIN link from the beginning.

The Skip Button is Clicked

If the system is in Ad Mode, the system shall interrupt the ad-spot video clip currently playing, advance to the next video, and start playing. If the system is in Promo Mode, the system shall interrupt the promo-spot video clip currently playing, advance to the next video, and start playing. If the system is in BIN Mode, and if any of the associated BIN links contains a video clip, the system shall advance the video to the end and stop.

The Volume Control (+) Button is Clicked

The system increases the volume.

The Volume Control (−) Button is Clicked

The system decreases the volume.

The Search tab is Clicked

If the user clicks the “Search” tab, the system shall display the Search page of the Vendor-Specific Virtual Kiosk (See FIG. 6). The Search page shall contain a Content Display window under the “Search” tab, and a Product Search section near the bottom. If the “Send to Friend” feature has been enabled, the system shall display the “Send to Friend” button at the bottom of the Search layout. As long as a desktop icon has been uploaded, and if the “Download” feature has been enabled, the system shall display the “Download” button at the bottom of the Search layout. The system shall display the “Buy Now” feature at the bottom of the Search layout if it is enabled and an associated link has been specified. The system shall display a default image supplied by the virtual kiosk owner in the Content Display window whenever the virtual kiosk is in an idle state. The Product Search section shall contain a “Search For:” textfield for the search criteria, a “By:” pull-down list for the search parameter, an “In:” pull-down list also for the search parameter, and a Search button. The user types the search criteria and selects the search parameters from the pull-down lists. The user can select from the following available parameters in the “By” pull-down list:
Universal Product Number
Product Descriptor
Trademark
Brand Name
Product Name. The user can also select from available product categories in the “In” pull-down list.
   The User Clicks the Search Button to Initiate the Product Search in the Vendor-Specific Virtual Kiosk

If a search criterion has been entered, the system shall initiate the search of all products associated with the Vendor-Specific Virtual Kiosk. If the system found results, the system shall display the “Results” tab to the right of the “Search” tab (See FIG. 7). The system shall return only active products associated with the Vendor-Specific Virtual Kiosk in the search results. The Results page shall contain a Content Display window near the top, and the search results in a tabular layout near the bottom. If there are more than 3 products to be displayed, the system page shall display the batch navigation bar below the search results table. If the “Send to Friend” feature has been enabled, the system shall display the “Send to Friend” button at the bottom of the Results layout. As long as a desktop icon has been uploaded, and if the “Download” feature has been enabled, the system shall display the “Download” button at the bottom of the Results layout. The system shall display the “Buy Now” feature at the bottom of the Results layout if it is enabled and an associated link has been specified. The system shall display a default image supplied by the virtual kiosk owner in the Content Display window whenever the virtual kiosk is in an idle state.

The User Clicks on a Specific Product in the Search Results

The user clicks on the “Results” tab at the top. The user clicks a link for a specific product on the Results page. The system shall check which display modes are valid for the Vendor-Specific Virtual Kiosk and the order of the display modes. The system shall determine which tabs should be visible. The “Home,” “Search,” and “Results” tabs should be visible. Based on which display modes are valid for the virtual kiosk and will display in the selected display mode order, the system shall display the “Ads,” “Promos,” and “Info” tabs to the right of the “Results” tab. Even if the kiosk has an Ad Mode, however, if the product does not have any advertisements, the system shall not display the “Ads” tab. Also, even if the kiosk has a Promo Mode, if the product does not have any promotions, the system shall not display the “Promos” tab. The system shall refresh the virtual kiosk with the correct tabs displayed along the top. The first tab following the “Results” tab will be shown in the selected state. The system shall cycle through the valid modes in the defined order. The virtual kiosk shall reset just as it did when the kiosk first opened, except that Ads, Promos, and BIN will be related to the selected product. The kiosk will cycle through the modes until the Brand Information Network display mode is reached. The system shall display the Brand Information Network for the selected product, initialized with links for that product. The system shall then wait for user input.

The Send to Friend Button is Clicked

If the user clicks the “Send to Friend” button, the system shall display a small form in the Content Display window that contains a “From:” section comprised of a “Name:” text field, an “E-mail:” text field, and a “Message” text area, a “To:” section comprised of an “E-mail1:” text field, an “E-mail2:” text field, an “E-mail3:” text field, an “E-mail4:” text field, an “E-mail5:” text field, a “Send” button, and a “Cancel” button (See FIG. 5). If the user fills the information on the form and clicks the “Send” button, the system shall send the message via the system SMTP server. The message is sent and the system shall replace the message form with a confirmation page. The confirmation page shall display the following message, “A link to this virtual kiosk has been sent, and a confirmation e-mail has also been sent to your e-mail address. Click here to re-launch this Virtual Kiosk.” If the user clicks the “Cancel” button, the system shall replace the message form with the contents of the previously selected tab. If the user clicks the link to re-launch the Virtual Kiosk, then the system shall reset the virtual kiosk to the original order while the system re-displays the “Loading . . . ” splash screen.

The Download Button is Clicked

If the user clicks the “Download” button, the system shall replace the contents of the Content Display window with the “Download Multi-Mode Virtual Kiosk” form. The “Download Multi-Mode Virtual Kiosk” page shall contain user instructions at the top, a “Name” text field, “City” text field, “State” text field, “Zip/Postal Code” text field, “Country” text field, an “Operating System” pull-down list, a “Purpose of Installation” text area, a “Cancel” button, and a “Next” button. All required fields shall be denoted by an asterisk next to the field name. If the user omits a required field, the system shall display a message indicating the required field is blank. If the user clicks the “Cancel” button, the system shall redisplay the default mode in the Content Display window. If the user clicks the “Next” button, the system shall start the download process and display the second “Download Multi-Mode Virtual Kiosk” page. The second “Download Multi-Mode Virtual Kiosk” page shall contain information indicating the actual download is in progress, instructions for an alternate method, “click here”, to download, a “Back” button, and a “Re-Launch Virtual Kiosk” button. If the user clicks the “Back” button, the system shall reload the first “Download Multi-Mode Virtual Kiosk” page If the user clicks the “Re-Launch Virtual Kiosk” button, the system shall reset the virtual kiosk and display the default mode. During the download process, the system shall display a download dialog window. The user shall choose where to save the zipped MMVK package on their computer through the download dialog window.

The Buy Now Button is Clicked

If the user clicks the “Buy Now” button, the system shall open the “Buy Now” associated link in the parent window.

Requested Virtual Kiosk is Not Active or Deployed and the Installed Virtual Kiosk is Active

The system shall display the following error message on the screen, “The requested Virtual Kiosk is no longer available from [Virtual Kiosk Sponsor's Name].”

The Launching Domain is a Forbidden Domain

The system shall display the following error message on the screen, “This website is not authorized to launch the requested Virtual Kiosk. Please contact admin@bksnetworks.com to inform them of any illegal use of the requested Virtual Kiosk. Thank you.”

One or More Visual Attributes of the Requested Virtual Kiosk are Not Available

The system shall display the following error message on the screen, “The requested Virtual Kiosk is currently not available. Please try back again later.”

No Search Criteria are Entered in the Vendor-Specific Virtual Kiosk Product Search Page

The system shall display the following error message on the screen, “A value must be entered in the Search Criteria in order to initiate the Product Search.”

No Search Results were Returned from the Product Search in the Vendor-Specific Virtual Kiosk

The system shall display the following error message on the screen, “No products were found matching your search criteria. Please try another search.”

Description of the Operation of the Multi-Product Multi-Mode Virtual Kiosk (MMVK) of the Illustrative Embodiment of the Present Invention

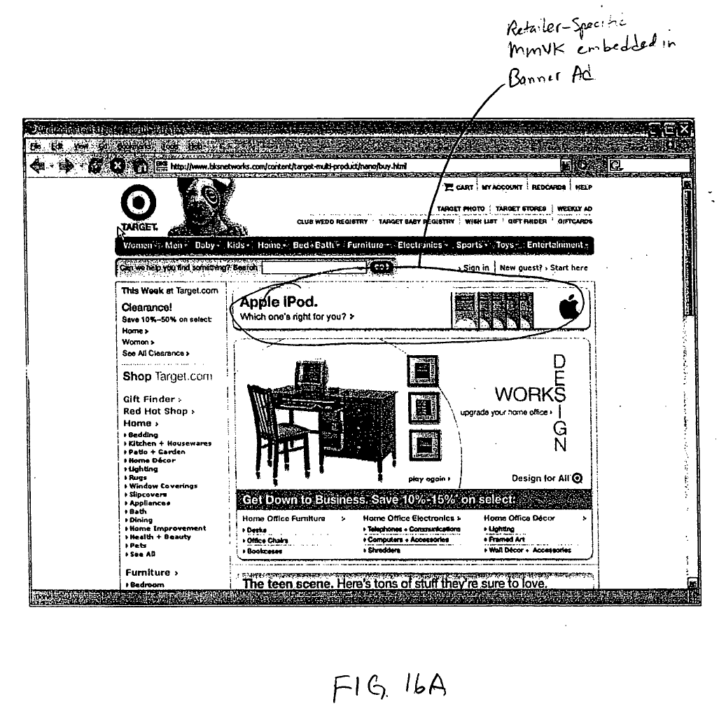

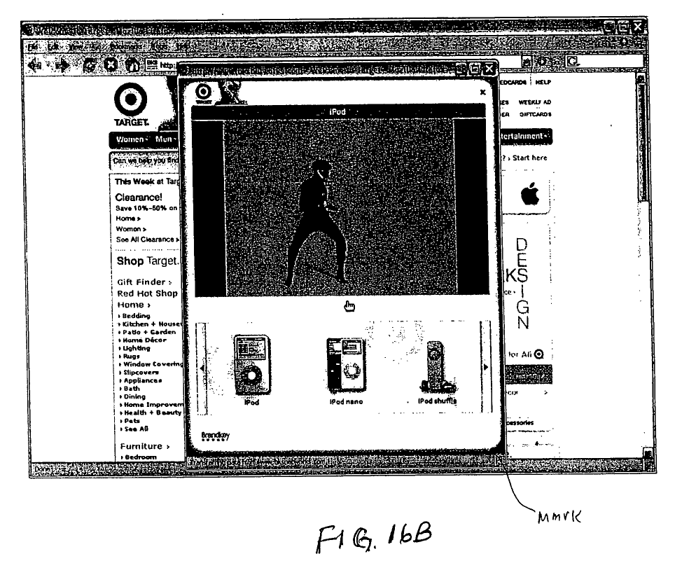

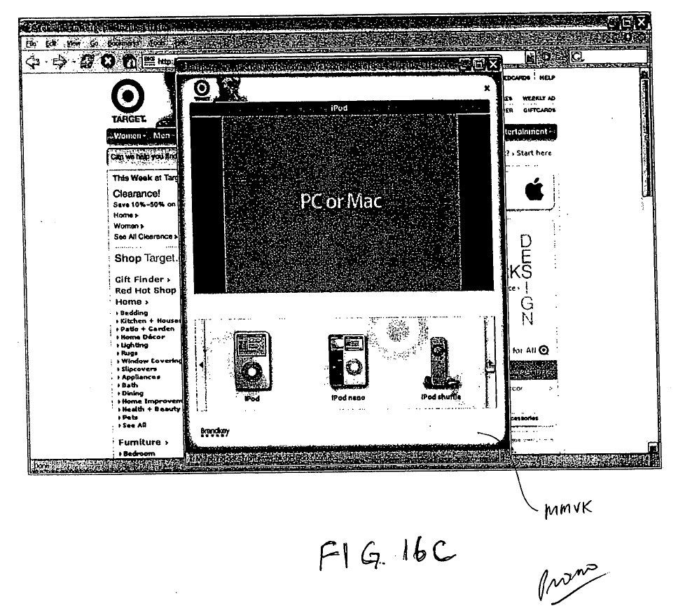

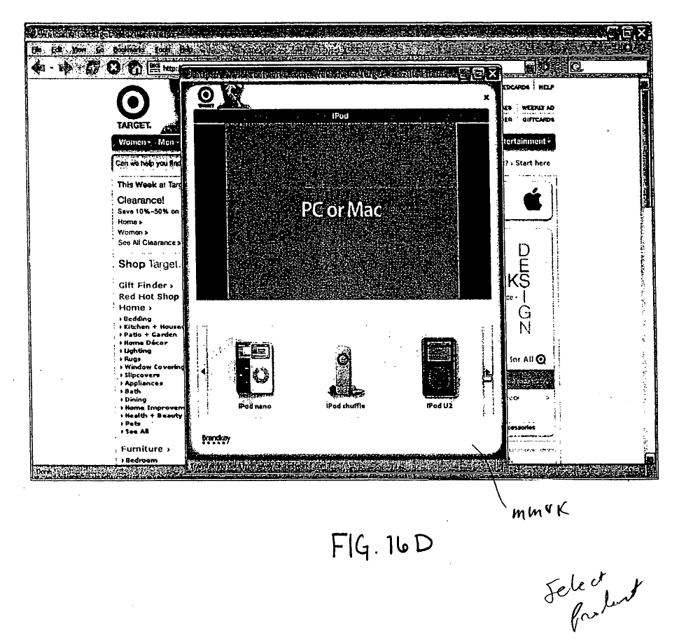

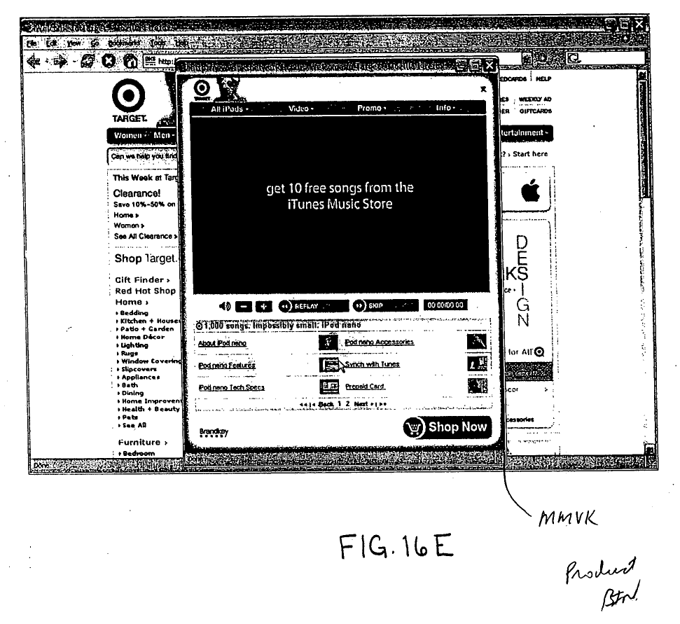

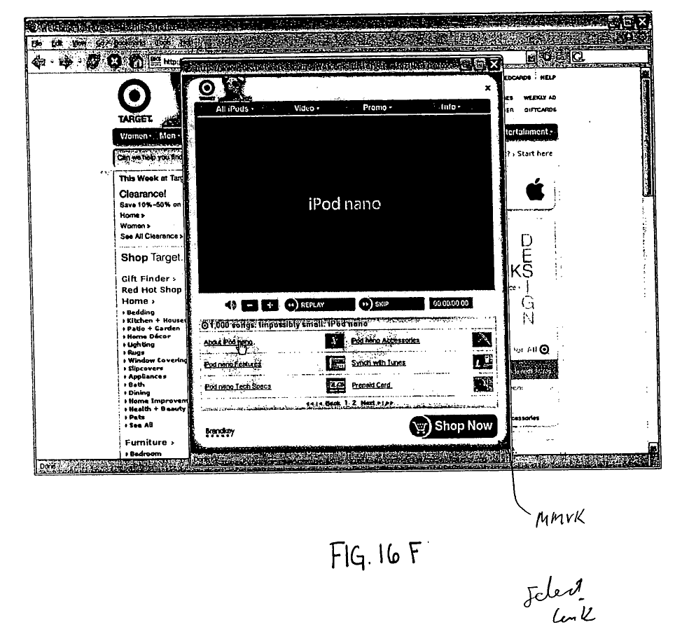

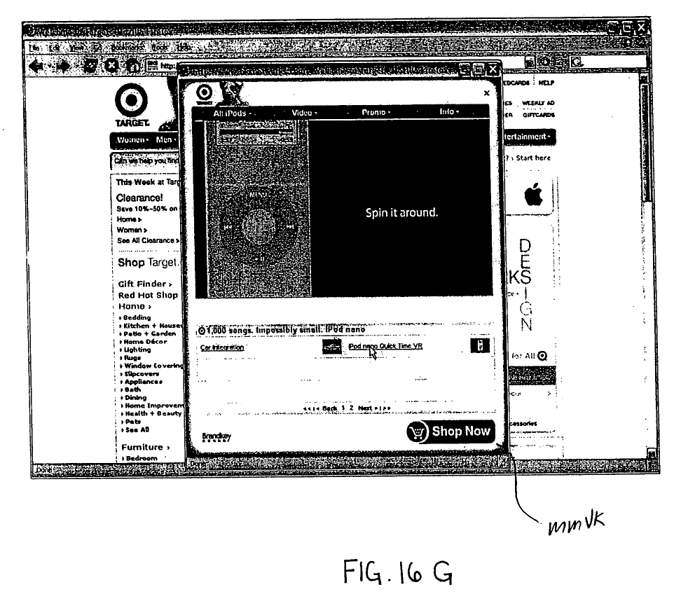

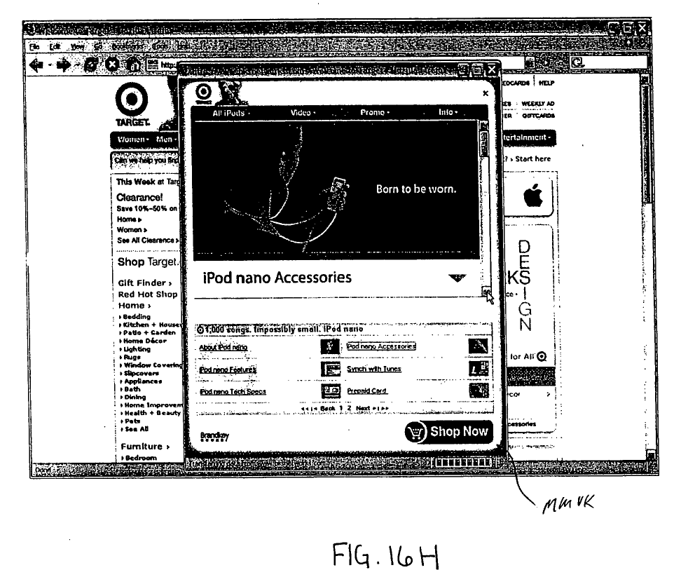

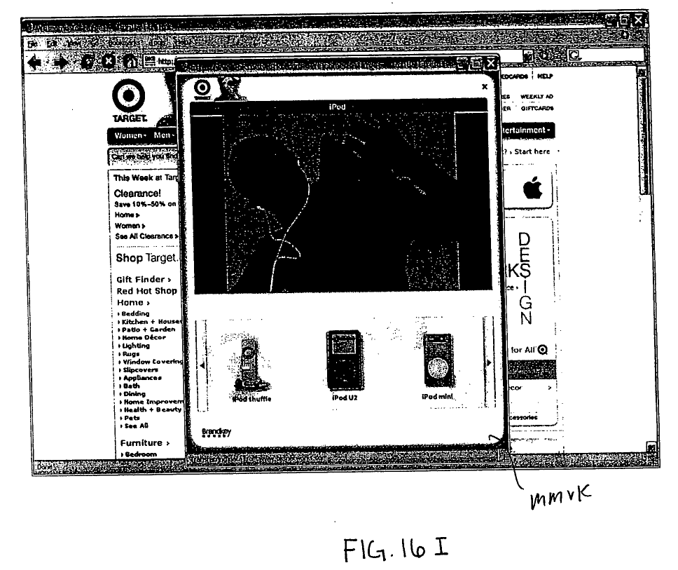

In FIGS. 16A through 16CC, the behavior of an illustrative embodiment of a Multi-Product MMVK of the present invention is shown. In general, the Multi-Product MMVK can be either a Vendor-Specific MMVK that is programmed with multiple branded products, from a single manufacturer/vendor (e.g. Apple Computer Corp), or a Retailer-Specific MMVK that is programmed by a retailer, with the BINs associated with multiple UPN-indexed branded products, from one or more manufacturers/vendors. In the illustrative embodiment shown in FIGS. 16A through 16CC, the MMVK is formulated as a Retailer-Specific MMVK that is programmed by a retailer (i.e. Target Stores), with the BINs associated with multiple UPN-indexed branded products, under a single brand (i.e. iPod) from a single manufacturer/vendor (i.e. Apple Computer).

While the Multi-Product MMVK shown in FIG. 16A through is similar in many ways to the Multi-Product (i.e. Vendor-Specific) MMVK described in FIGS. 12A through 12G, there are some notable differences, namely: instead of providing a Search Tab, as shown in FIGS. 12F and 12G, MMVK design of FIGS. 16A through 16CC includes a horizontally-scrollable Product Selection Menu, in which each branded product (programmed into the MMVK) is graphically represented by an image of the product, as shown in FIGS. 16B through 16I, and this graphical menu can be displayed at any time by selecting the Product Search Tab (i.e. indicated by “iPod”) shown in FIGS. 16A through 16CC.

In FIG. 16A, a user at an exemplary Web page of a retailer's e-commerce site (i.e. e-store) selects the MMVK tag associated with a (Multi-Product) Retailer-Specific Multi-Mode Virtual Kiosk (MMVK) of the present invention, that has been embedded within a banner ad on the retailer's e-commerce site. In the illustrative embodiment, the Retailer-Specific MMVK is programmed with a number of different products (i.e. UPNs), falling under a particular manufacturer brand (i.e. Trademark). When the MMVK is launched, it automatically runs an ad spot for the manufacturer brand in the content display panel of the MMVK GUI, while the different models of MP3 player product available for selection are shown in a horizontally-scrollable product menu section of the GUI of the MMVK.

In FIG. 16C through FIG. 16G, the user's mouse is used to scroll through the horizontally-scrollable product menu section of the Retailer-Specific MMVK, showing all of the UPN-indexed products programmed into the MMVK while the ad spot for the manufacturer brand is running.

In FIG. 16H, the ad spot for the product brand running is interrupted when the user selects a particular product from the product menu stage section of the MMVK GUI, at which time, the MMVK plays the preprogrammed ads, promos and brand information links for the selected branded product.

In FIGS. 16I and 16J, a particular brand information link has been selected from the brand information menu section of the MMVK GUI, and in response thereto, the product information page is displayed in the display area of the Retailer-Specific MMVK.

In FIGS. 16K through 16M, the user scrolls the product information page displayed in the display area of the Retailer-Specific MMVK.

In FIGS. 16N and 16O, the user scrolls forward through the brand information link scroll bar in the MMVK GUI, so as to make other programmed information links viewable and accessible to the user.

In FIGS. 16P and 16Q, the user selects a rich-media video link from the brand information link scroll bar.

In FIGS. 16R and 16S, the user scrolls in reverse through the brand information link scroll bar in the MMVK GUI, so as to make other programmed information links once again viewable and accessible to the user, while the rich media video link continues to be displayed in the content display section (i.e. window) of the MMVK GUI.

In FIGS. 16T and 16V, the user scrolls through the content display area after having selected a different brand information link from the MMVK GUI.

In FIG. 16W, the user selects a different product from the product menu selection section of the MMVK GUI;

In FIG. 16X, the Retailer-Specific MMVK displays, in the content display area of its dynamically-generated GUI, a particular brand information link (i.e. “Music to Go”) from the brand information display area of the MMVK GUI.

In FIGS. 16Y through 16Z, the Retailer-Specific MMVK displays, in the content display area of its GUI, another particular brand information link (i.e. “iPod shuffle Tech Specs”) from the brand information display area of the MMVK GUI.

In FIG. 16AA, the Retailer-Specific MMVK displays, in the content display area of its GUI, a promo spot that has been programmed for the currently selected product.

Finally, in FIGS. 16BB and 16CC, the user selects the Shop Now (i.e. Buy Now) button on the MMVK GUI which automatically (and seamlessly) takes the consumer/user to the Check Out page of the retailer's ecommerce site, so as to enable the consumer to consummate the purchase of the selected product.

Use Case Description of the Multi-Product MMVK of the Present Invention

Below is presented a Use Case which describes the operation of a Multi-Product (e.g. Retailer-Specific) MMVK that is launched from a given launch environment. When the user clicks on the embedded MMVK tag to launch the MMVK from its launch environment, the following flow of events occurs:

Launch Multi-Mode Virtual Kiosk with BIN, Ad, and Promo Modes Respectively

The use case begins when the user clicks on the HTML-Encoded Brandkey™ Button to launch the Retailer-Specific Multi-Mode Virtual Kiosk. The embedded URL tag contains the encrypted identification number of the installed Retailer-Specific Virtual Kiosk to be launched. The tag sends a request to the system for the virtual kiosk. The system searches for the installed virtual kiosk id, and the system responds by sending back a “Loading . . . ” splash screen to the requestor. When the system finds the virtual kiosk id, the system then determines whether or not the requested virtual kiosk is still active and deployed. If the virtual kiosk is active and deployed, the system shall check whether the requesting domain (website where the virtual kiosk is launched from) is an allowed domain. If the virtual kiosk is launched from an allowed domain, the system shall determine the type of virtual kiosk that is being requested. The system shall determine the color to be used in displaying the requested Retailer-Specific Virtual Kiosk. The system shall determine which display modes and the order they play on the specific Retailer-Specific Virtual Kiosk. The system shall replace the opened splash screen with the actual Retailer-Specific Virtual Kiosk. If the Brand Information Network (BIN) Mode was selected first when creating the virtual kiosk, the system shall display the BIN Mode under the “Info” tab to the right of the “Home” tab followed by the “Ads” tab. The BIN Mode layout shall contain a Content Display window near the top, all associated links (BIN) in the middle, and an information text bar near the bottom. The system shall check how many products or services are associated with this virtual kiosk. If there is more than one product or service associated, the system shall display the “Search” tab to the right of all other tabs. If there are no products or services associated, the “Search” tab will not be displayed. If there is only one product or service associated with the virtual kiosk, the system shall not display the “Search” tab. As soon as the “Promo” tab is selected, the system shall display the “Info” tab. If the “Send to Friend” feature has been enabled, the system shall display the “Send to Friend” button at the bottom of the BIN Mode layout. As long as a desktop icon has been uploaded, and if the “Download” feature has been enabled, the system shall display the “Download” button at the bottom of the BIN Mode layout. The system shall display the “Buy Now” feature at the bottom of the BIN Mode layout if it is enabled and an associated link has been specified. The system shall display a default image supplied by the virtual kiosk owner in the Content Display window whenever the virtual kiosk is in an idle state. The system checks if a retailer has installed the multi-mode virtual kiosk. If so, the system checks if there are any purchase-enabling links within the BIN. If true, the system shall not display the purchase-enabling links in the BIN. The Content Display window shall serve as a web browser whenever an associated BIN link is clicked. The system shall display the contents of the link in the Content Display window. In addition, if any of the associated BIN links contains a video clip, the system shall display the virtual kiosk video components while the specific link is clicked and viewed. The virtual kiosk video components shall consist of a graphical mute button, “+” and “−” volume control buttons, a “<<Replay” button, a “Skip>>” button, and a time-lapse meter. After viewing the video clip contained in the link, if the user clicks another BIN link that contains no video clip, the system shall hide the video components from the BIN Mode layout. Within the BIN, the system shall display the associated links of the brand as either Simple Tabular format or Pre-Post Purchase format. If there are more than 3 associated links for the BIN, the system shall display the batch navigation bar at the bottom of the Simple Tabular or Pre-Post Purchase table. If the Ad Mode was selected second when creating the virtual kiosk, the system shall determine the Ad Mode as the next mode and display the Ad Mode under the “Ads” tab to the right of the “Info” tab. If the play list is empty for the Ad Mode, the system shall not display “Ads” tab in the virtual kiosk. If the user clicks the “Ads” tab, the system shall generate a list of ad-spot video clips previously selected in Brandkey Advertise™. If the Promo Mode was selected third when creating the virtual kiosk, the system shall determine the Promo Mode as the next mode and display the Promo Mode under the “Promos” tab to the right of the “Ads” tab when the “Ads” tab is clicked the first time. If the play list is empty for the Promo Mode, the system shall not display the “Promos” tab in the virtual kiosk. For the Ad Mode, the system shall resize, display, and run the generated list of ad-spot video clips in the Ad-Spot Display window. The system shall display the video components below the Ad-Spot Display window, an information text bar near the bottom, and three buttons at the bottom, namely, “Send to Friend”, “Download”, and “Buy Now” as long as they each have been enabled and there has been a desktop icon image uploaded for the Download button and there has been a link specified for the Buy Now button. While the ad-spot video clips are playing, the user may click the “<<Replay” or “Skip>>” button at any time. If the user clicks the “<<Replay” button, the system shall replay the currently playing ad-spot video clip. If the user clicks the “Skip>>” button, the system shall interrupt the ad-spot video clip currently playing, advance to the next video, and start playing. When the last ad-spot video in the list has played, the system shall display the contents of the “Promos” tab automatically. If the user clicks the “Promos” tab prior to the last ad-spot video completing, the system shall generate a list of promo-spot video clips previously selected in Brandkey Promote™. The system shall resize, display, and run the generated list of promo-spot video clips in the Promo-Spot Display window. The system shall display the video components below the Promo-Spot Display window, and a promotions-related text bar near the bottom. If the “Send to Friend” feature has been enabled, the system shall display the “Send to Friend” button at the bottom of the Promo Mode layout. As long as a desktop icon has been uploaded, and if the “Download” feature has been enabled, the system shall display the “Download” button at the bottom of the Promo Mode layout. The system shall display the “Buy Now” feature at the bottom of the Promo Mode layout if it is enabled and an associated link has been specified. The system shall display a default image supplied by the virtual kiosk owner in the Content Display window whenever the virtual kiosk is in an idle state. While the promo-spot video clips are playing, the user may click the “<<Replay” or “Skip>>” button at any time. If the user clicks the “<<Replay” button, the system shall replay the currently playing promo-spot video clip. If the user clicks the “Skip>>” button, the system shall interrupt the promo-spot video clip currently playing, advance to the next video, and start playing. When the last promo-spot video in the list has played, the system shall remain in that state until the user clicks a button. The system shall display the default image, if one has been defined for the BIN, in the Content Display window. If the user clicks the “Home” tab at anytime, the system shall reset the virtual kiosk to the original order while the system re-displays the “Loading . . . ” splash screen. When the reset is complete, the system shall replace the splash screen with the Retailer-Specific Virtual Kiosk displaying the “Info” tab section, the “Ads” tab, the “Promos” tab, and if there is more than one product or service associated with the Retailer-Specific Virtual Kiosk, the “Search” tab to the right of the other tabs.

Launch Multi-Mode Virtual Kiosk with BIN, and Ad Modes

After the system has displayed the BIN Mode and Ad Mode, the system shall check for the next mode. The system determines there is no Promo Mode, and the system shall remain in Ad Mode state until the user clicks a button. If the user clicks the “Home” tab at anytime, the system shall reset the virtual kiosk to the original order while the system re-displays the “Loading.” splash screen. When the reset is complete, the system shall replace the splash screen with the Retailer-Specific Virtual Kiosk displaying the “Info” tab section, the “Ads” tab, and if there is more than one product associated with the Retailer-Specific Virtual Kiosk, the “Search” tab to the right of the other tabs.

Launch Multi-Mode Virtual Kiosk with BIN Only

After the system has displayed the BIN Mode, the system shall check for the next mode. The system determines there is neither Ad Mode nor Promo Mode, and the system shall remain in the BIN Mode. If the user clicks the “Home” tab at anytime, the system shall reset the virtual kiosk to the original order while the system re-displays the “Loading . . . ” splash screen. When the reset is complete, the system shall replace the splash screen with the Retailer-Specific Virtual Kiosk displaying the “Info” tab section, and if there is more than one product or service associated with the Retailer-Specific Virtual Kiosk, the “Search” tab to the right of the “Info” tab.

Launch Multi-Mode Virtual Kiosk with Ad and Promo Modes

If the Ad Mode was selected first when creating the virtual kiosk, the system determines there is no BIN Mode and displays the Ad Mode under the “Ads” tab to the right of the “Home” tab. The system shall check for the next mode. The system determines the Promo Mode is next and displays the Promo Mode under the “Promos” tab to the right of the “Ads” tab. If the user clicks the “Home” tab at anytime, the system shall reset the virtual kiosk to the original order while the system re-displays the “Loading . . . ” splash screen. When the reset is complete, the system shall replace the splash screen with the Vendor-Specific Virtual Kiosk displaying the “Ads” tab section, the “Promos” tab to the right of the “Ads” tab, and if there more than one product associated with the Vendor-Specific Virtual Kiosk, the “Search” tab to the right of the “Promos” tab.

Launch Multi-Mode Virtual Kiosk with Only Ad or Promo Mode

If either the Ad Mode or Promo Mode was selected as the only mode when creating the virtual kiosk, the system determines there is neither a BIN Mode nor Ad/Promo Mode and displays the Ad/Promo Mode under the “Ads”/“Promos” tab to the right of the “Home” tab. If the user clicks the “Home” tab at anytime, the system shall reset the virtual kiosk to the original order while the system re-displays the “Loading . . . ” splash screen. When the reset is complete, the system shall replace the splash screen with the Retailer-Specific Virtual Kiosk displaying either the “Ads” or “Promos” tab section to the right of the “Home” tab, and if there is more than one product or service associated with the Retailer-Specific Virtual Kiosk, the “Search” tab to the right of either the “Ads” or “Promos” tab.

The Replay Button is Clicked

If the system is in Ad Mode, the system shall replay the currently playing ad-spot video clip. If the system is in Promo Mode, the system shall replay the currently playing promo-spot video clip. If the system is in BIN Mode, and if any of the associated BIN links contains a video clip, the system shall play the video contained in the BIN link from the beginning.

The Skip Button is Clicked

If the system is in Ad Mode, the system shall interrupt the ad-spot video clip currently playing, advance to the next video, and start playing. If the system is in Promo Mode, the system shall interrupt the promo-spot video clip currently playing, advance to the next video, and start playing. If the system is in BIN Mode, and if any of the associated BIN links contains a video clip, the system shall advance the video to the end and stop.

The Volume Control (+) Button is Clicked

The system increases the volume.

The Volume Control (−) Button is Clicked

The system decreases the volume.

The Search tab is Clicked

If the user clicks the “Search” tab, the system shall determine the number of Products/Services assigned to the Virtual Kiosk. If less than ten (10) Products/Services are assigned to the Virtual Kiosk, then the full list of Products/Services is immediately displayed to the user. If more than ten (10) Products/Services are assigned to the Virtual Kiosk, then the Search page is displayed to the user. The Search page shall contain a Content Display window under the “Search” tab, and a Product Search section near the bottom. If the “Send to Friend” feature has been enabled, the system shall display the “Send to Friend” button at the bottom of the Search layout. As long as a desktop icon has been uploaded, and if the “Download” feature has been enabled, the system shall display the “Download” button at the bottom of the Search layout. The system shall display the “Buy Now” feature at the bottom of the Search layout if it is enabled and an associated link has been specified. The system shall display a default image supplied by the virtual kiosk owner in the Content Display window whenever the virtual kiosk is in an idle state. The Product/Service Search section shall contain a “Search For:” textfield for the search criteria, a “By:” pull-down list for the search parameter, an “In:” pull-down list also for the search parameter, and a Search button. The user types the search criteria and selects the search parameters from the pull-down lists. The user can select from the following available parameters in the “By” pull-down list:
Universal Product/Ser vice Number
Product/Service Descriptor
Trademark/Servicemark
Brand Name
Product/Service Name.

The user can also select from available product categories in the “In” pull-down list.

The User Clicks the Search Button to Initiate the Product/Service Search in the Retailer-Specific Virtual Kiosk

If a search criterion has been entered, the system shall initiate the search of all products or services associated with the Retailer-Specific Virtual Kiosk. If the system found results, the system shall display the “Results” tab to the right of the “Search” tab. The system shall return only active products or services associated with the Retailer-Specific Virtual Kiosk in the search results. The Results page shall appear in the Content Display window near the top, with the search criteria below. Images of the Products/Services along with their name will be displayed on the Search Results page. If the “Send to Friend” feature has been enabled, the system shall display the “Send to Friend” button at the bottom of the Results layout. As long as a desktop icon has been uploaded, and if the “Download” feature has been enabled, the system shall display the “Download” button at the bottom of the Results layout. The system shall display the “Buy Now” feature at the bottom of the Results layout if it is enabled and an associated link has been specified. The system shall display a default image supplied by the virtual kiosk owner in the Content Display window whenever the virtual kiosk is in an idle state.

The User Clicks on a Specific Product/Service in the Search Results

The user clicks on the “Results” tab at the top. The user clicks a link for a specific product/service on the Results page. The system shall check which display modes are valid for the Retailer-Specific Virtual Kiosk and the order of the display modes. The system shall determine which tabs should be visible. The “Home,” “Search,” and “Results” tabs should be visible. Based on which display modes are valid for the virtual kiosk and will display in the selected display mode order, the system shall display the “Ads,” “Promos,” and “Info” tabs to the right of the “Results” tab. Even if the kiosk has an Ad Mode, however, if the product/service does not have any advertisements, the system shall not display the “Ads” tab. Also, even if the kiosk has a Promo Mode, if the product/service does not have any promotions, the system shall not display the “Promos” tab. The system shall refresh the virtual kiosk with the correct tabs displayed along the top. The first tab following the “Results” tab will be shown in the selected state. The system shall cycle through the valid modes in the defined order. The virtual kiosk shall reset just as it did when the kiosk first opened, except that Ads, Promos, and BIN will be related to the selected product/service. The kiosk will cycle through the modes until the Brand Information Network display mode is reached. The system shall display the Brand Information Network for the selected product/service, initialized with links for that product/service. The system shall then wait for user input.

The Send to Friend Button is Clicked

If the user clicks the “Send to Friend” button, the system shall display a small form in the Content Display window that contains a “From:” section comprised of a “Name:” text field, an “E-mail:” text field, and a “Message” text area, a “To:” section comprised of an “E-mail1:” text field, an “E-mail2:” text field, an “E-mail3:” text field, an “E-mail4:” text field, an “E-mail5:” text field, a “Send” button, and a “Cancel” button. If the user fills the information on the form and clicks the “Send” button, the system shall send the message via the system SMTP server. The message is sent and the system shall replace the message form with a confirmation page. The confirmation page shall display the following message, “A link to this virtual kiosk has been sent, and a confirmation e-mail has also been sent to your e-mail address. Click here to re-launch this Virtual Kiosk.” If the user clicks the “Cancel” button, the system shall replace the message form with the contents of the previously selected tab. If the user clicks the link to re-launch the Virtual Kiosk, then the system shall reset the virtual kiosk to the original order while the system re-displays the “Loading . . . ” splash screen.

The Download Button is Clicked

If the user clicks the “Download” button, the system shall replace the contents of the Content Display window with the “Download Multi-Mode Virtual Kiosk” form. The “Download Multi-Mode Virtual Kiosk” page shall contain user instructions at the top, a “Name” text field, “City” text field, “State” text field, “Zip/Postal Code” text field, “Country” text field, an “Operating System” pull-down list, a “Purpose of Installation” text area, a “Cancel” button, and a “Next” button. All required fields be denoted by an asterisk next to the field name. If the user omits a required field, the system shall display a message indicating the required field is blank. If the user clicks the “Cancel” button, the system shall redisplay the default mode in the Content Display window. If the user clicks the “Next” button, the system shall start the download process and display the second “Download Multi-Mode Virtual Kiosk” page. The second “Download Multi-Mode Virtual Kiosk” page shall contain information indicating the actual download is in progress, instructions for an alternate method, “click here”, to download, a “Back” button, and a “Re-Launch Virtual Kiosk” button. If the user clicks the “Back” button, the system shall reload the first “Download Multi-Mode Virtual Kiosk” page. If the user clicks the “Re-Launch Virtual Kiosk” button, the system shall reset the virtual kiosk and display the default mode. During the download process, the system shall display a download dialog window. The user shall choose where to save the zipped virtual kiosk package on their computer through the download dialog window.

The Buy Now Button is Clicked

If the user clicks the “Buy Now” button, the system shall open the “Buy Now” associated link in the parent window.

Requested Virtual Kiosk is Not Active or Deployed and the Installed Virtual Kiosk is Active

The system shall display the following error message on the screen, “The requested Virtual Kiosk is no longer available from [Virtual Kiosk Sponsor's Name].”

The Launching Domain is a Forbidden Domain

The system shall display the following error message on the screen, “This website is not authorized to launch the requested Virtual Kiosk. Please contact admin@bksnetworks.com to inform them of any illegal use of the requested Virtual Kiosk. Thank you.”

One or More Visual Attributes of the Requested Virtual Kiosk are Not Available

The system shall display the following error message on the screen, “The requested Virtual Kiosk is currently not available. Please try back again later.”

No Search Criteria are Entered in the Retailer-Specific Virtual Kiosk Product/Service Search Page

The system shall display the following error message on the screen, “A value must be entered in the Search Criteria in order to initiate the Product/Service Search.”

No Search Results Were Returned from the Product/Service Search in the Retailer-Specific Virtual Kiosk

The system shall display the following error message on the screen, “No products/services were found matching your search criteria. Please try another search.”

Summary of Services Offered to Manufacturer Brands on the Network of the Present Invention

Manufacturers can quickly create, deploy and manage Product-Specific MMVKs for each consumer product registered with the Brandkey® Network.

A Manufacturer's entire product catalogue can be quickly registered on the Brandkey® Network, and a Product-Specific MMVK generated can be generated for each registered product in just minutes.

Each MMVK has three independent modes of information p display that can be easily programmed by different members of the brand management team (e.g. ad and promo agencies).

Each MMVK can be e-commerce triggered with a Buy Now button that links to the shopping cart of the manufacturer's e-commerce site, or a retail partner's site.

Manufacturer's can enable Affiliated Services for each of its MMVKs, allowing Affiliates to earn commissions on MMVKs which they host on their Web sites and properties.

Product-Specific MMVKs can function as virtual product showcases that allow Manufacturers deliver consistent brand merchandising and service to consumers present anywhere in electronic and physical streams of commerce.

Product-Specific MMVKs can also function as turnkey e-commerce stores to support e-commerce transactions anywhere along the fabric of the WWW.

Summary of Services Offered to Retailer Brands on the Network of the Present Invention

Using the Brand Marketing Communication Network, Retailers and other trading partners can rapidly create and deploy Retailer-Specific MMVKs for the products of the retailer's manufacturers/vendors.

Retailer-Specific MMVKs are simply programmed by importing product/brand content managed by the manufacturers/vendors for their products.

Each Retailer-Specific MMVK has ad and promo display modes that can be easily programmed by the Retailer, or its ad and promo agencies.

Retailer-Specific MMVKs can be installed across all of the retailer's marketing and sales channels, both online and in brick and mortar stores.

Each Retailer-Specific MMVK can be e-commerce triggered with a Buy Now button that links to the retailer e-commerce shopping cart.

Retailers can enable Affiliated Service for each of its Retailer-Specific MMVKs, allowing Affiliates to earn commissions on MMVKs which they host on their Web sites and properties.

Retailer-Specific MMVKs can function as virtual product showcases that allow Retailers to deliver consistent brand merchandising and service to consumers present anywhere in electronic and physical streams of commerce.

Retailer-Specific MMVKs can also function as turnkey e-commerce stores to support e-commerce transactions anywhere along the fabric of the WWW.

The Brand Marketing Communication Network enables manufacturers to manage their product brand information with an unprecedented level of efficiency and strategic advantage along the retail value chain.

The Brand Marketing Communication Network also allows any manufacturer/vendor to rapidly generate and deploy powerful Web-based communication instruments (i.e. Multi-Mode Virtual Kiosks or MMVKs) for each and every product that is maintained in the its supply-chain management system or ERP system, and to simply install and manage these MMVKs across all of its Web-based marketing and sales channels, at points of display and sale, BOTH online and in brick and mortar stores.

The Ability to “Buy Later” on a Multi-Mode Virtual Kiosk (MMVK)

In alternative illustrative embodiments of the present invention, Multi-Mode Virtual Kiosks (MMVKs) can be programmed to give consumers the option to purchase an item of interest later. This objective is accomplished by the use of a “Buy Later” button on an MMVK. The “Buy Later” button can be programmed by the product brand manager to appear at a certain time on any installed MMVK. The button can appear either as an actual button at the bottom of the MMVK, or it can also appear as a link in the Brand Information Display Mode of the MMVK.

The Brand Manager will be able to select at which point, in the Consumer-interaction with the MMVK, the “Buy Later” button will appear (i.e. be displayed). Under normal circumstances, the “Buy Later” will be shown after the Consumer has clicked on all available links. The System tracks which links the consumer visits every time one is clicked for metrics reasons. This functionality can also be used to determine when to display the Buy Layer button.

When the Consumer clicks the “Buy Later” button, the System (i.e. network) first checks if there is a Network Cookie on the consumer's computer. This will allow the system to determine if the consumer is a returning User. If the consumer is a returning User of the system, then we already know their user information and can log them in to the system automatically. If no cookie if found, then the consumer is asked to either Log In or Register with the Network. If the consumer registers with the Network, then we collect some basic information about the consumer, and then log them in. If the Consumer already has registered, then they can directly log into the system. Once the Consumer is logged in, then the system will save the “Buy Later” version of the MMVK to the consumer's personal MMVK Directory Page.

An email is sent to the consumer informing them that their Personal Page has been updated and giving them the URL once again. The consumer can go to their Personal page at any time to view the MMVKs they have saved. The brand manager will be given the ability to update the Advertisement and Promotions on any MMVK that they install, for consumer saving. In case they wish to display a different Advertisement of Promotion to the consumer when they pull up their saved MMVK, then they will be able to do that. This will keep the content fresh in the minds of the consumer and reinforce the need to return to the store or e-tail site to complete the transaction.

Using Computational Intelligence to Automatically Update (i.e. Program) Brand-Building Content Inside MMVKs of the Present Invention

In accordance with principles of the present invention, computational intelligence (e.g. AI, neural networks, computational algorithms etc) can be used to automatically update and program the informational links (i.e. URLs) displayed in the Brand Information Network mode of any particular MMVK. Such automated programming can be triggered upon the occurrence of particular conditions, For example, in the event that no action is taken by the Consumer with regard to purchase intent (i.e. the BUY NOW button is activated on the MMVK, but the consumer does not select it within a predetermined amount of time). Specifically, if the Consumer does not click the “Buy” or “Buy Now” or other Action button once he or she has received all information links in the Brand Information Display Mode of the MMVK, then the system/network will update the list of Links in the Brand Information Network, either adding new links (URLs) to the current list of active links (URLs) or substituting links that are currently placed in the Brand Information Network display mode. In a preferred embodiment, the Brandkey Create Subsystem will support services that enable a member of the brand management team Brand Manager to specify a second set of Links to be displayed in the Brand Information Display Mode, in the event that the consumer fails to undertake a particular course of action/behavior with respect to the MMVK in a particular period of time, or performs a particular action within a predetermined situation represented in the RDBMS of the Brand Marketing Communication Network.

Using CRM Databases to Automatically Configure (i.e. Program) BINS and MMVKs According to Consumer Profiles

In accordance with principles of the present invention, the actual content associated with any particular Brand Information Network (BIN) and/or programmed MMVK, including its ad and promo spots, can be automatically programmed using intelligent customer relationship management (CRM) database systems. In such embodiments of the present invention, information profiles are maintained on particular consumers, reflecting their desires, tastes, interests and preferences. Such CRM databases can be integrated with the subsystem architecture of the Network of the present invention, and used to automatically update BINs and MMVK configurations for particular consumers whose identity has been automatically detected using cookie files that have placed on within their Web-browsers, by information servers maintained within the Network. Once a particular consumer has been detected by the Brand Marketing Communication Network, e.g. using cookie management technique, a custom-programmed MMVK can be automatically and dynamically configured “on the fly” using consumer profile information maintained in the CRM database(s) associated with the Brand Marketing Communication Network. This MMVK programming technique can provide brand managers with a high degree of control over their product and/or service brands, yet provide a high degree of personalization to the consumer through custom-programmed MMVKs delivered to each consumer whose identity is determined using this system technique on the Brand Marketing Communication Network.

Maintaining Personalized Virtual Kiosk Directory Pages for Consumers

According to this aspect of the present invention, once a consumer has registered with the Brand Marketing Communication Network, they are automatically assigned a sub-domain under bksnetworks.com domain which is made up of [username].bksnetworks.com. Then, whenever the consumer goes to this domain, he or she will access a Personal Virtual Kiosk Directory page that has been particularly assigned him or her.

This Personal Virtual Kiosk Directory page will pull the full list of MMVKs that the Consumer has saved. The list of MMVKs will be displayed to the Consumer ordered by SIC Category. The Consumer may click on any MMVK to launch it. If any Virtual Kiosk has been deactivated, then the MMVK will still appear in the Directory page, but there will be a message next to it, informing the Consumer that the MMVK has been deactivated and listing any new MMVKs that have been created since, for the same Product or Service.

Consumers will be able to log into the Brand Marketing Communication Network to update their Personal pages. They will be able to personalize the pages in terms of layout, color, text, font, messaging. They will also be able to email their pages to their friends as well as remove any MMVKs they no longer wanted. Consumers may also download a desktop icon for this page. This will allow the Consumer to be able to access this page of Virtual Kiosks directly from their desktops. It will also allow Brand Managers to have an always-open channel to Consumers via this desktop icon and page. They could also search the Brand Marketing Communication Network to find new or other Virtual Kiosks to add to their Personal pages. Consumers may also opt-into or opt-out-of consumer research and further mailings from the brands whose MMVKs they have. Depending on the amount of personal information that the Brand Marketing Communication Network receives from the consumer, the Brand Marketing Communication Network can furnish this information to manufacturer and retailer brands to help them shape their campaigns and target consumers more effectively.

A primary benefit associated with the Personal Virtual Kiosk Directory is to provider one central resource for consumers to access all their MMVKs. Thus, the Personal Virtual Kiosk Directory serves as a MMVK storage and organizing area for Consumers. The Personal Virtual Kiosk Directory is dynamically generated for each Consumer when it is requested. That way, there can be no spidering of the pages for anyone to find out which Virtual Kiosks are saved on whose pages, unless that information comes directly from the Brand Marketing Communication Network.

Driving E-Commerce Through MMVKs on the Brand Marketing Communication Network of the Present Invention, with Transaction and Commission Tracking Services Enabled

The Brand Marketing Communication Network of the present invention supports a powerful suite of affiliate supporting services which benefits manufacturers, retailers, web-hosting sites, and other end-users on the Web. Such affiliate services include the tracking and management of sales transactions conducted through MMVKs on the Network, as well as commissions earned by affiliates (e.g. consumers, Web site publishers et al) who install and host e-commerce-enabling MMVKs. Transaction and commission tracking services according to the present invention (i.e. affiliate services) can help drive e-commerce transactions anywhere along the fabric of the Web, in both electronic and physical streams of commerce, by ensuring that affiliates earn commissions on all e-commerce transactions derived from MMVK's hosted on their Web spaces and having affiliate services (i.e. transaction and commission tracking and management services) running. Affiliate supporting services in accordance with the present invention also allow affiliates to donate a portion, or all of the sales commissions (earned through MMVKs) to Charities of their choice who have registered with the Brandkey Network and satisfy IRS requirements. Using the affiliate services of the present invention, manufacturer's can sell their branded products outside of conventional retail sales channels, and retailers can sell branded merchandise to consumers who are outside of their online stores, and anywhere the expanding fabric of the WWW extends (e.g. lifestyle sites, weblogs, etc.). Webs sites which host MMVKs having affiliate services (i.e. transaction and commission tracking and management services) running, can earn substantial sales commissions from retailers or manufacturers, thereby adding to the profit margins of such websites.

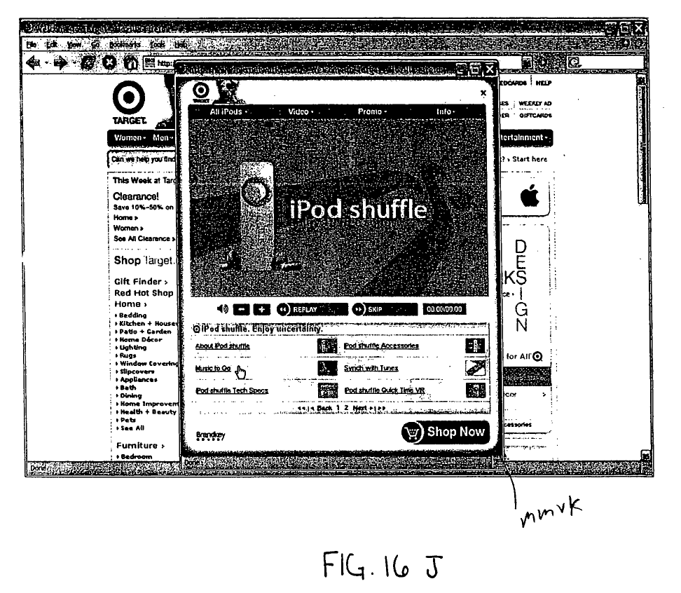

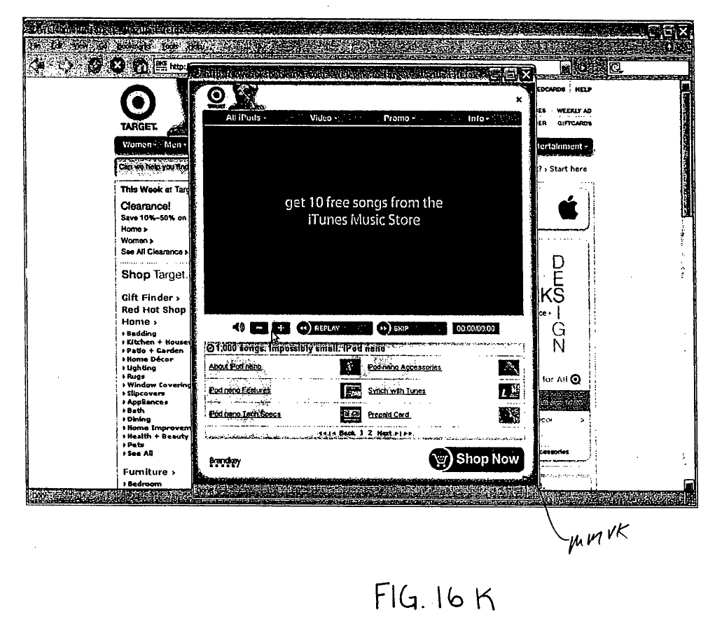

In FIG. 17, the e-commerce transaction enabling and sales commission tracking system of the present invention is illustrated, showing how e-commerce retail transactions enabled by, and sales commissions earned through MMVKs installed on an affiliate site are automatically tracked and managed by the Brand Marketing Communication Network. The BKS network is also described in FIG. 2B. At this juncture, additional services supported by the Brand Marketing Communication Network will now be described, including consumer product transaction tracking services, and sales commission tracking and management services. As shown in FIG. 17, these additional services are enabled by integrating an Internet-enabled transaction and commission tracking and management server C with the Java Application and Database Servers employed on the Network of the present invention.

As shown in FIG. 17, Java-enabled Application Server B hosts the MMVK Serving Application as well as the Brand Marketing Communication Network Application described in great detail above, and wherein the Application Server provides registered affiliate Web sites with the necessary MMVK tags to launch sponsored MMVKs. Once launched, installed MMVKs automatically send detailed consumer metrics (i.e. consumer/MMVK interaction data) back to the Application Server B for storage in the Database Server A, and the MMVK allows the consumer to commence a transaction in the specified retailer's shopping cart which is linked to the Buy Now button on the MMVK, or to a link in any one of the display modes of the MMVK, launched from MMVK hosting Web site D.

As shown in FIG. 17, a Transaction Tracking Script (TTS) is provided to each retailer for maintaining communication between the retailer's ecommerce server (i.e. supporting e-commerce from any particular MMCK) and the Transaction/Commission Management/Tracking Server C. The function of the TTS is to customize the e-commerce process on the retailer's E-Commerce Server E so that the Network Transaction/Commission Tracking and management Server C is able to track all MMVK-initiated transactions from beginning to completion, i.e. once initiated on the retailer's ecommerce site via an MMVK hosted on an affiliate Web Site D. An example of a transaction tracking script code that that would be put into e-commerce pages is as follows:

<script src=“http://www.brandkey.net/mmvktracker.js”
type=“text/javascript”>
</script>
<script>
_mmvkid=“BKS-xxxx-x”;
mmvkTracker( );
</script>
<body onLoad=“javascript:_{——}initTrans( )”>

The Transaction/Commission Management/Tracking Server C receives Transaction Data from the retailers' e-commerce server E regarding all MMVK-initiated transactions, and the Transaction/Commission Management/Tracking Server C processes all Transaction Data received from the retailer's e-commerce Web Server E, generates Commissions Data for all affiliates who installed the MMVKs, and transfers the Commission Data to the Application Server B for storage on the BKS Database Server A. At any time, clients (e.g. affiliates) can view Transaction and Commission Data stored on the Database Server A, via a Web browser pointed to a Web-based GUI generated by Network Application Server B or its associated cluster of Web Servers (not explicitly shown).

In the illustrative embodiment of the present invention, the Transaction/Commission Tracking and Management Server C performs the following functions:

(1) to record all consumer transactions in e-commerce environments that were generated from Affiliate sites;

(2) to process all data received from embedded scripts placed in e-commerce environments;

(i) Which Virtual Kiosk originated the transaction,

(ii) For which product was the transaction originated, and

(iii) Which Affiliate partner hosted this Virtual Kiosk;

(3) to determine whether any further up-selling occur s in the Shopping Cart of the e-commerce provider;

(4) to determine whether the transaction proceeded to fulfillment and if not, where was the transaction dropped;

(5) to determine what was the total transaction (amount and items) that was completed;

(6) to provide data records pertaining to commissions earned by Affiliate partners on all embedded MMVKs;

(7) to provide data records pertaining to commissions payable by Retailers/Manufacturers to Affiliate partners; and

(8) to provide Auditing capabilities to third-party firms to view scrubbed transaction records pertaining to the use and installation of MMVKs on Affiliate sites.

Deploying, Installing and Operating MMVKs on the Brand Marketing Communication Network with Automatic Retail Transaction and Commission Tracking Services Enabled for Affiliate Driven E-Commerce

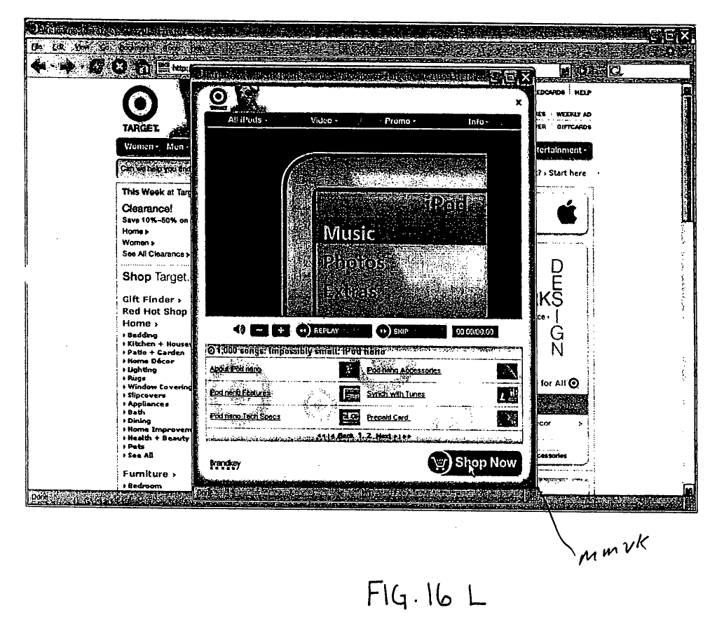

FIG. 18 describes many of the primary technical details underlying the e-commerce enabling and tracking process of the present invention that is carried out on the global Brand Marketing Communication Network depicted in FIG. 17. In this network configuration, e-commerce enabling MMVKs are deployed, installed and operated, with automatic retail transaction and sales commission tracking services enabled conducted in accordance with the principles of the present invention. This will process will now be described in greater detail.

As indicated at Step 1 in the flow chart of FIG. 18, a Client Account is set up for the vendor (i.e. manufacturer) on the Brand Marketing Communication Network depicted in FIG. 17 (the Network).

As indicated at Step 2 in the flow chart of FIG. 18, the manufacturer/vendor registers its Products/Services on the Network.

As indicated at Step 3 in the flow chart of FIG. 18, the manufacturer/vendor registers its retail trading partners on the Network.

As indicated at Step 4, in the flow chart of FIG. 18, retail trading partners are assigned Client accounts on the Network.

As indicated at Step 5 in the flow chart of FIG. 18, the manufacturer/vendor sets up product/service parameters for retailers.

As indicated at Step 6 in the flow chart of FIG. 18, manufacturer/vendor creates MMVKs for its registered Products/Services.

As indicated at Step 7 in the flow chart of FIG. 18, manufacturer/vendor sets up installation environments for its MMVKs to be used in an Affiliate Program, where registered affiliates agree to install e-commerce enabling MMVKs on affiliate owned or control Web properties, in exchange for a sales commission typically based on a percentage of each sales transaction initiated by the affiliate-hosted MMVK deployed on the Network of the present invention. At this time of the process, a generic, network-specific Transaction-Tracking Script (TTS) is generated for distribution to retailers (as well as manufacturers who are operating e-commerce sites and operating as retailers). These transaction tracking scripts (TTS) are provided by the Network Administrator (e.g. Brand Marketing Communication Networks, Inc.) to all retailers and manufacturers who maintain e-commerce sites that are possible targets of an e-commerce initiating MMVK deployed on the Network. Once received, the retailer (or manufacturer) installs its TTS on each of the checkout pages on its e-commerce store generated by the retailer's e-commerce site servers E. Such TTSs enable the Network Transaction/Commission Tracking and Management Server C to automatically track each transaction originating from a MMVK that goes through the retailer's or manufacturer's e-commerce platform.

As indicated at Step 8 in the flow chart of FIG. 18, an affiliate user (e.g. the publisher/owner of a Website, the owner of a Web-log hosting site, a person maintaining a Web site, a person maintaining a web-log, et al) registers with the Network as an “Affiliate” and installs one or more e-commerce enabling MMVKs on his or her Web site or property (e.g. Web log, etc) as the case may be.

As indicated at Step 9 in the flow chart of FIG. 18, the consumer then interacts with the MMVK installed by the Affiliate on a Web site or property owned or controlled by the registered affiliate.

As indicated at Step 10 in the flow chart of FIG. 18, a consumer initiates a consumer transaction through an affiliated-hosted MMVK, at an e-commerce site (of a retailer or manufacturer) by clicking on the Buy Now (Action) button on the MMVK, or any e-commerce initiating link displayed in any of the display modes of the MMVK.

As indicated at Step 11 in the flow chart of FIG. 18, in response to the selection of the Buy Now button on the MMVK (or any e-commerce initiating link displayed in any of the display modes of the MMVK), the MMVK Hosting Website Server D automatically generates “Virtual Kiosk Data” which is sent to the Network Application Server B, for storage on the Network Database Server A, as shown in FIG. 17. “Virtual Kiosk Data” includes data indicating: (i) which Virtual Kiosk initiated the transaction; (ii) where the Virtual Kiosk is installed; and (iii) for which Product/Service was the transaction initiated.

As indicated at Step 12 in the flow chart of FIG. 18, the Transaction Tracking Script (TTS) automatically executes on each page of the Retailer's checkout process (i.e. e-commerce store) so that its e-commerce server E automatically sends further Transaction Data to Transaction/Commission Management/Tracking Application Server D for storage on the Network Application Server B. “Transaction Data” includes: (i) which steps of the transaction process have been completed; (ii) any up-selling of other items have taken place in the transaction process; (ii) whether transaction has been completed; and (iii) complete Transaction Details.

As indicated at Step 13 in the flow chart of FIG. 18, the Transaction Data is processed by the Network Transaction/Commission Tracking and Management Server C so as to determine appropriate commissions for the Affiliate, and this Commission Data is then transmitted to the Network Application Server B for storage on the Network Database Server A, as shown in FIG. 17.

Using the ecommerce-powered, transaction tracking MMVKs of the present invention, every consumer sales affiliate can become an Avon-like representative, earn commissions on sales transactions initiated from any affiliate sponsored MMVK, and donate the commission in whole or part to charities, non-profits and other social causes which represent the affiliate's STAND in the World. Such MMVKs can be thought of as MyStand™ MMVKs, which can be placed anywhere the fabric of the WWW extends, and each MyStand™ MMVK not only has an Ad, Prom and Brand Information Modes programmed by the product brand, to ensure the best possible brand experience where it matters most, but also has the fourth display mode, illustrated in FIG. 12G, which is programmable by the affiliate consumer with:

(i) badges of the charities and non-profits to which earned commissions on transactions will be paid (by BKS);

(ii) images selected by the sales affiliate/advocate, of the affiliate sales person, college attended, music you enjoy or might go well with the product, etc., and

(iii) other consumer-centric messaging by the affiliate, including recommendations, benefits, features, philantrophy, etc (to help promote the product brand).

Also, the Send to Friend (STF) capabilities of such MMVKs allow the consumers to simply transmit the consumer-generated MMVKs to friends, associates, customers, etc., within social networks and other marketspaces along the expanding WWW.

Description of Events that Occur Among Retailers, Manufacturers and Affiliates when Installing a MMVK of the Present Invention, and Conducting an E-Commerce Transaction with E-Commerce Affiliate Services of the Present Invention Enabled

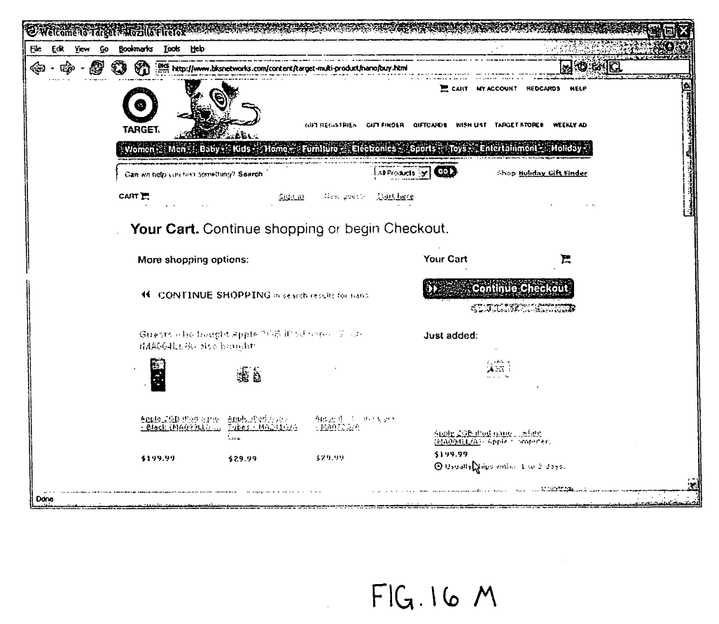

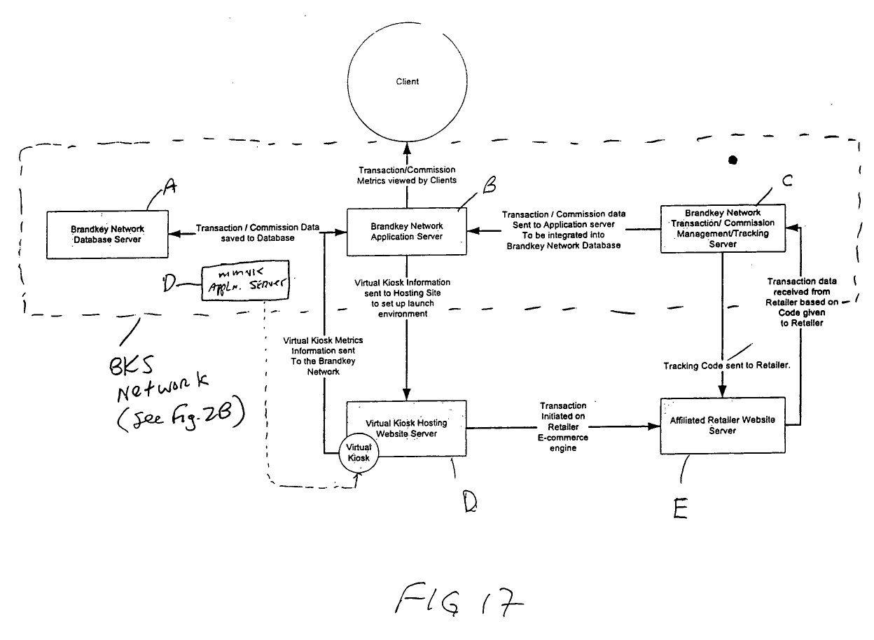

FIG. 19A schematically illustrates a high-level process that occurs among retailers, manufacturers, affiliates and consumers during the execution of the e-commerce enabling and tracking process of the present invention carried out on the global communication network depicted in FIG. 17. As will be described in detail below, with reference to the flow chart shown in FIG. 19B, this process includes the installation of e-commerce enabling MMVKs by affiliates on Web sites and/or related properties, the initiation of e-commerce transactions through these MMVKS by consumers, the automatic tracking of e-commerce transaction initiated through installed MMVKs, and the automatic tracking of commission earned by affiliates through such transactions, in accordance with the principles of the present invention.

As indicated at Step 1 in the flow chart shown in FIG. 19B, the manufacturer or retailer sets up (i.e. creates and deploys) the MMVK on the Network of the present invention. This step is carried out using Brandkey Create, Brandkey Deliver, Brandkey Advertise and Brandkey Promote Subsystems, as described in great detail below.

As indicated at Step 2 in the flow chart of FIG. 19B, manufacturer or retailer sets up Commissions for each MMVK. At the same time, charities need to register with the network so that they can be made available for applidonation

As indicated at Step 3 in the flow chart of FIG. 19B, the affiliate (e.g. web-logger) installs a MMVK, and optionally, can select charities for donations based on all or part of sales commissions earned on transaction initiated through an e-commerce powered MMVK. At this stage, the MMVK already has been assigned a unique ID for each installation so tracking is already enabled on the Network.

As indicated in Step 4 of FIG. 19B, the consumer clicks the “Buy Now” button on the installed MMVK, or a link in any of the display modes of the MMVK initiating an e-commerce transaction on a manufacturer's or retailer's e-commerce site.

As indicated in Step 5 of FIG. 19B, in response to the clicking upon the Buy Now button on the MMVK, the shopping cart associated with retailer's or manufacturer's programmed e-commerce site is automatically activated by the Retailer Web Server E.

As indicated in Step 6 of FIG. 19B, the e-commerce platform on the retailer's or manufacturer's Web server E automatically tracks the origin of the transaction initiated by the affiliate-hosted MMVK.

As indicated in Step 7 of FIG. 19B, during the transaction, the e-commerce site's Web server E sends continuous information to the Network Transaction/Commission Tracking and Managemen Server C informing the Network of transaction progress. If the transaction is not completed for any reason, then the Network Transaction/Commission Tracking and Managemen Server C can identify where shopping cart abandonment occurred along the e-commerce process.

As indicated in Step 8 of FIG. 19B, upon transaction completion, full information about the transaction is automatically sent from the Retailer Web Server E to the Network Transaction/Commission Tracking and Managemen Server C, for generation of commission data, and transfer of transaction and commission data to the Network Application Server B, for storage on the Network Database Server A, as illustrated in FIG. 17.

As indicated in Step 9 of FIG. 19B, complete transaction and commission reports are available on demand from the Network Database Server A using a Web browser pointing to the Web Server clusters associated with the Network Application Server B, in the multi-tier network architecture completed in FIG. 17.

Description of the Process of Installing E-Commerce Enabling MMVKs on an Affiliate's Web Site or Property with Transaction/Commission-Tracking Services Enabled

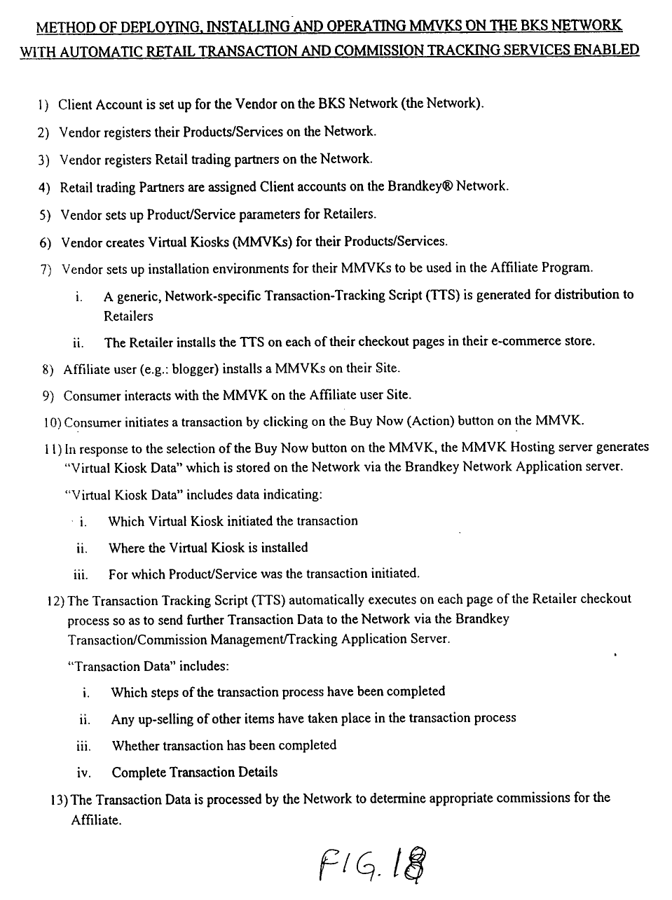

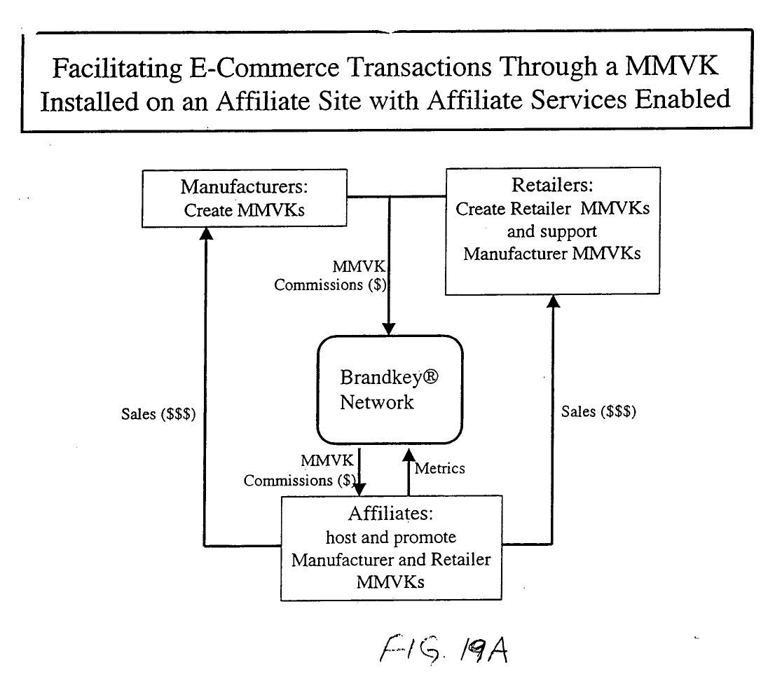

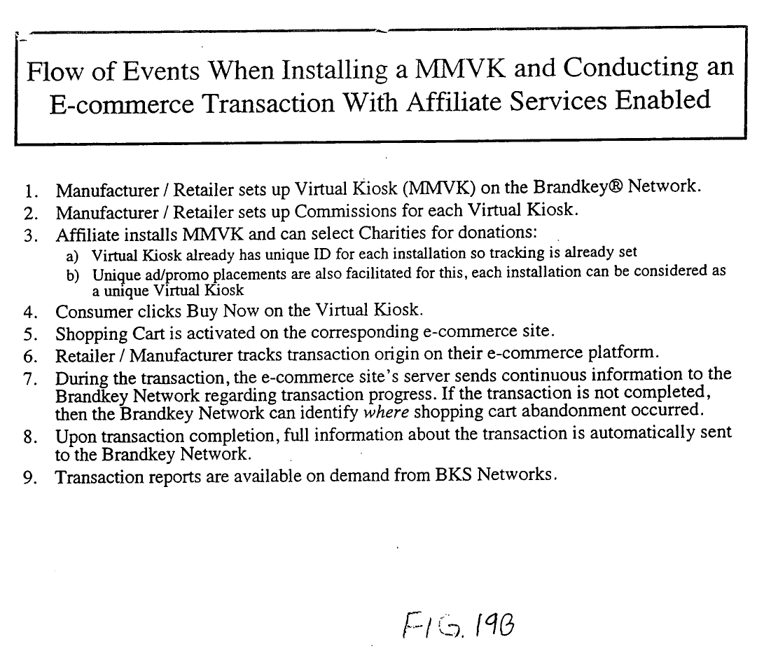

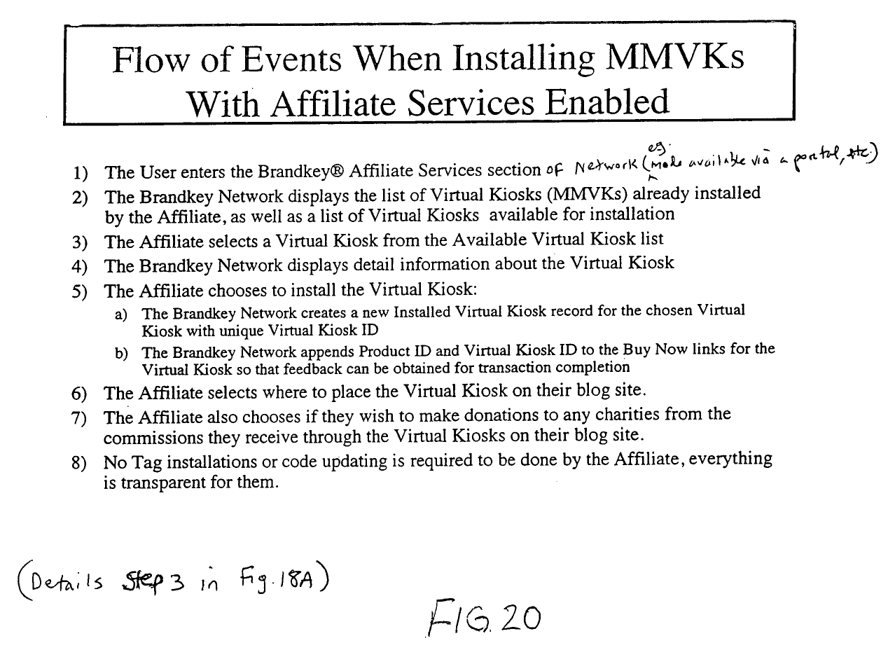

FIG. 20 is a description of the flow of events that occur when an affiliate installs an e-commerce enabling MMVK on a Web site or property owned or controlled by the affiliate (i.e. as indicated in Step 3 of FIG. 18A) using the Brand Marketing Communication Network of FIG. 17, with automatic transaction and commission tracking services enabled. In this

As indicated at Step 1 in FIG. 20, the User (i.e. affiliate) enters the Affiliate Services section on an affiliate Web site (e.g. Web Log Hosting Site) using a Web browser. At this Affiliate Service Section (e.g. affiliate portal) on the Web-hosting Site, the affiliate can (i) install e-commerce enabling MMVKs, (ii) select registered charities of choice to which to make donations based on earned sales commissions, (iii) track and manage earned commissions earned on transactions initiated by affiliate-hosted MMVKs, etc.

As indicated at Step 2 in FIG. 20, the Network Application Server B displays the list of MMVKs that are already installed by the affiliate, as well as a list of MMVKs that are currently available for installation.

As indicated at Step 3 in FIG. 20, the affiliate selects a MMVK from the available MMVK list.

As indicated at Step 4 in FIG. 20, the Network Application Server B displays detail information to the affiliate about the selected MMVK, who is using a Web browser.

As indicated at Step 3 in FIG. 20, the affiliate chooses to install the MMVK on the Web site.

As indicated at Step 4 in FIG. 20, the Network Application Server B creates a new installed MMVK record for the chosen MMVK having a unique MMVK ID.

As indicated at Step 5 in FIG. 20, the Network Application Server B automatically appends Product ID and a MMVK ID to the “Buy Now” links associated with the MMVK so that the Network Application Server B can obtain feedback for completing the transaction.

As indicated at Step 6 in FIG. 20, the affiliate selects where to place the MMVK on his or her web site (e.g. lifestyle site, Web-log etc.).

As indicated at Step 7 in FIG. 20, the affiliate is provided an opportunity make donations to any charities based on the sales commissions earned on completed sales transaction initiated through affiliate-hosted MMVKs.

As indicated at Step 8 in FIG. 20, the affiliate is not required to install any tags or update any code during the installation of e-commerce enabling MMVKs, so that all aspects of MMVK installation are essentially transparent to the affiliate.

Description of Process for Deploying E-Commerce Enabling MMVKs on an Affiliate Web Hosting Site so as to Enable Affiliates to Earn Commissions While Visiting Consumers Purchase Products at E-Commerce Sites of Retailers and Manufacturers Through the Affiliate-Hosted MMVKs

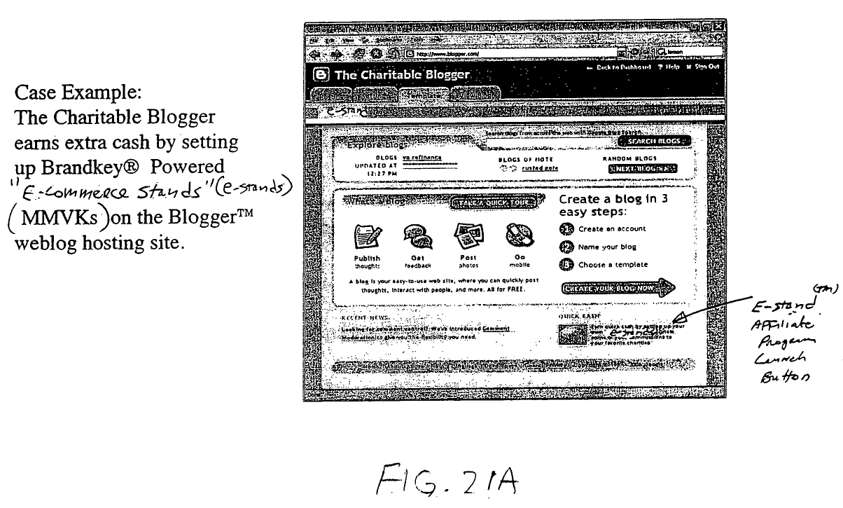

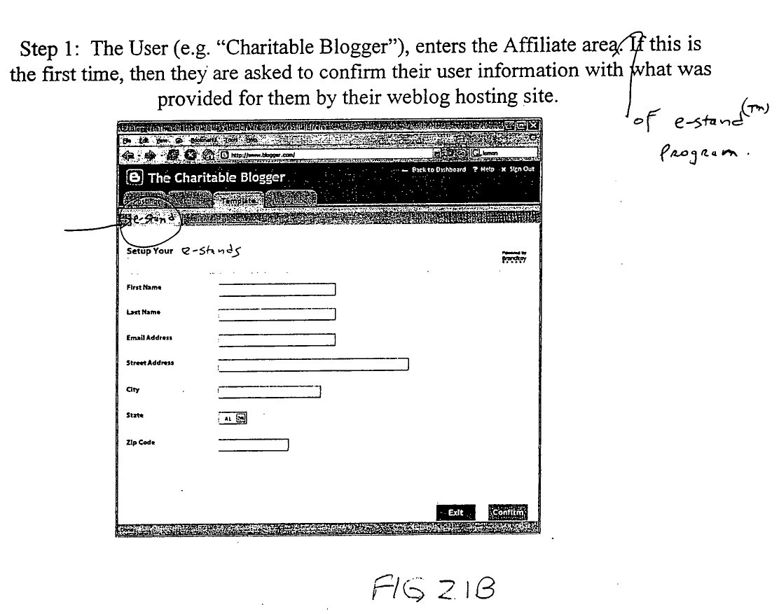

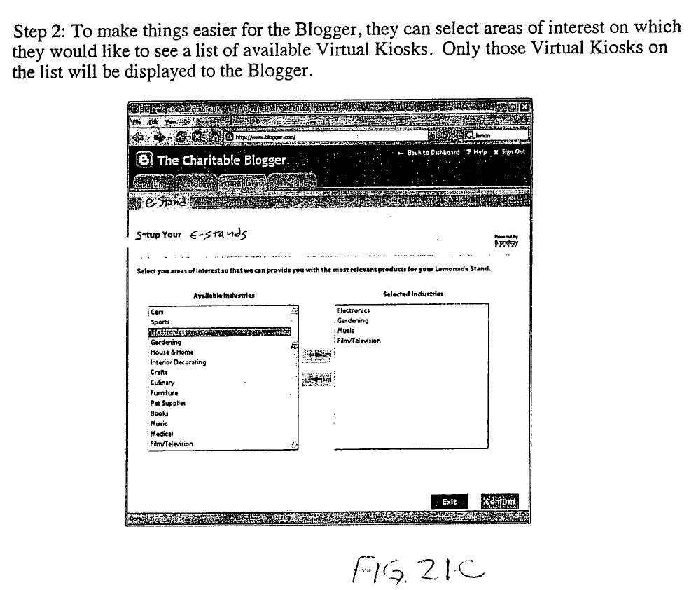

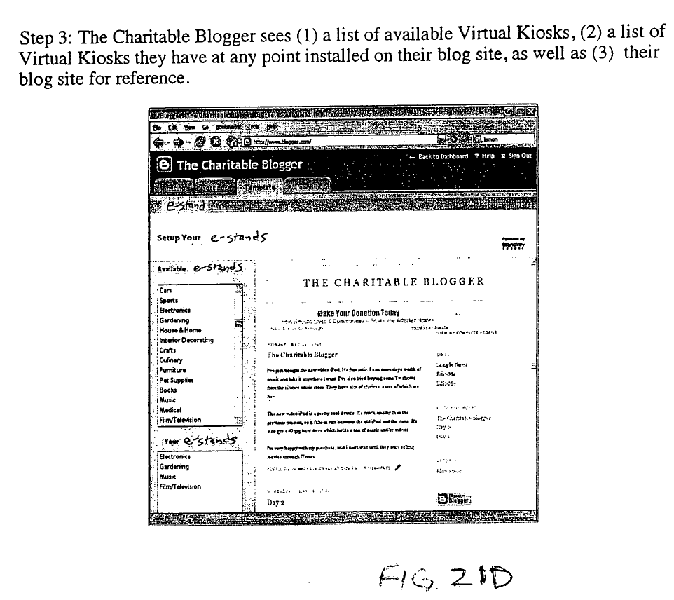

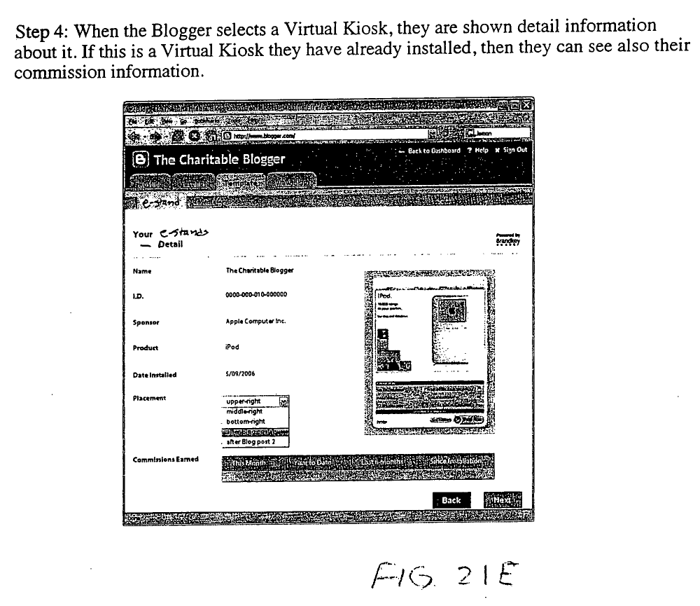

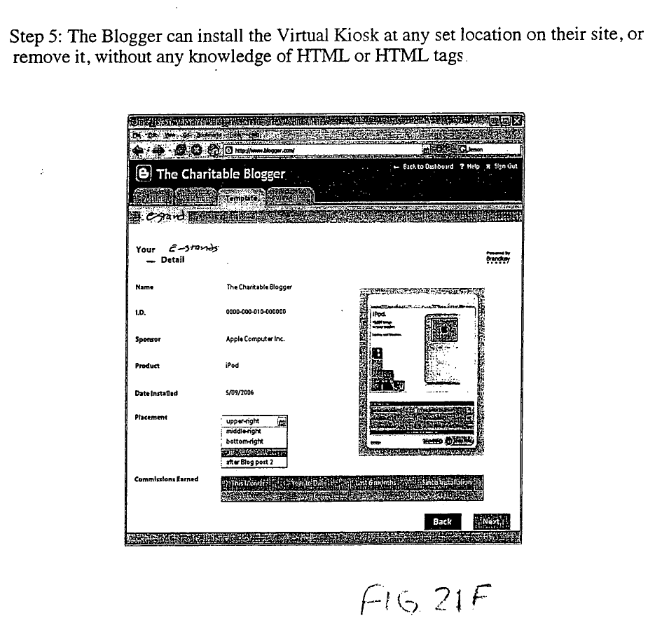

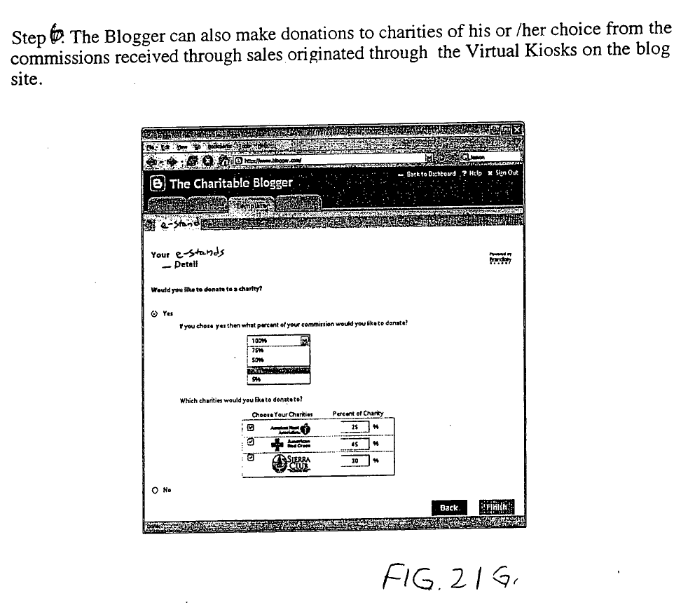

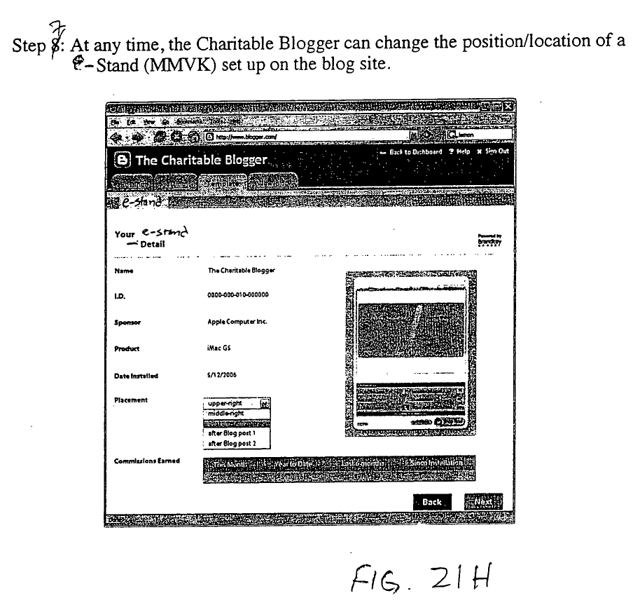

FIGS. 21A through 21G describes the flow of events that occurs when the Brand Marketing Communication Network of the present invention is used by a web-logger when deploying e-commerce enabling MMVKS on his or her web-log site so as to enable the web-logger to earn commissions while visitors purchase products at e-commerce sites of retailers and manufacturers through the installed MMVKS.

As indicated by the GUI screen of FIG. 21A, an affiliate user comes to a Web hosting site (e.g. a Lifestyle Web Site or a WeB-Log Hosting Site) having an e-commerce enabling Affiliate Area or portal (e.g. e-stand™ e-commerce affiliate program), accessible by clicking on an image embedded in the home page of the Web Hosting Site, as indicated in FIGS. 21A through 21G. In accordance with the principles of the present invention, the e-commerce enabling portal will recognize the affiliate user (e.g. blogger) based on the Username/Password forwarded by the Blog Site when the affiliate user enters the portal. In the illustrative embodiment, the e-commerce enabling portal shall operate as an independent site within the Blog Hosting Site. The e-commerce enabling Affiliate portal, indicated in FIG. 21A, can easily be hooked into the Blog Hosting site using the <IFRAME> tag in HTML 4.0. In the source code, the User's username and password can be passed along for verification by the Affiliate Services application. In the illustrative embodiment, the application will be a WebObjects application, based on the Network but using a different GUI. Different GUIs can be created for different Web Hosting Sites so that the Affiliate Services application of the present invention can blend in completely with the look and feel of the Web Hosting Site. The Affiliate Services application will be supported by the Network as well as by a separate Transaction and Commission Tracking software package installed on Server C shown in FIG. 17. Such software packages are generally known in the art and can be modified in accordance with the teaching disclosed herein, and then integrated into the Network of the present invention so as to be able to fully and automatically track transactions and commissions and activity for all e-commerce initiating MMVKs.

As indicated in Step 1 in FIG. 21B, the affiliate user (e.g. “Charitable Blogger”) enters the Affiliate Area of the web-hosting site, and if this is the first time they have entered the area, then they are asked to confirm their user information with what was provided for them by the web-log hosting site.

As indicated in Step 2 in FIG. 21C, to make things easier for the affiliate, the affiliate is asked to select an area of interest on which he or she would like to see or view a list of available MMVKs, and only those MMVKs on the list will be displayed to the affiliate when logging back onto the system at a future date.

As indicated in Step 3 in FIG. 21D, the Network Application Server B (and its cluster of Web Servers) displays to the affiliate (1) a list of available MMVKs, (2) a list of MMVKs that he or she has installed (i.e. set up) on the blog site, and (3) his or her blog site for reference purposes.

As indicated in Step 4 of FIG. 21E, when the affiliate selects a MMVK, the Network Application Server displays detail information about the selected MMVK, and if this MMVK has been previously installed, then the network displays any commission related information relating to the MMVK, for review by the affiliate. As shown on this page, the affiliate user is presented with the detailed information about the selected MMVK, such as; Name of the MMVK, Sponsor (Creator) of the MMVK, Product showcased in the MMVK, Date the MMVK was installed, and full commission information for the MMVK such as; amount of commissions received this month, year-to-date, last 12 months, and since installation. The affiliate user will also be able to set the placement area of the MMVK.

As indicated in Step 5 of FIG. 21F, the affiliate can install the MMVK at any set location on his or her blog site (e.g. as an embedded object or embedded link), as well as remove the MMVK, without possessing any knowledge of HTML or HTML tag technology. In the illustrative embodiment shown, all MMVKs available to the affiliate user can be automatically placed in the following locations within his or her Blog Site, e.g. Top, Right-Side Top, Right-Side Middle, Right-Side Bottom, After specific Posts, and Bottom. The affiliate user can also choose to remove it or not place it at this time. The system shall automatically check to make sure that no MMVKs have been placed in the same location on the affiliate's Web site. Once the affiliate user accepts these settings, then he or she will move to the next page. Each MMVK can be easily integrated into the HTML layer of a Blog page, again by using the <IFRAME> tag. Size and position of each MMVK GUI can be easily controlled with this tag. There will be a script run at each of the possible installation points on the Blog page using the <IFRAME> tag to determine if a MMVK is to be shown in that area, based on the setup done by the User. Alternatively, each MMVK can be installed as pop-up by simply installing its MMVK tag into the fabric of the Web site.

As indicated in Step 6 of FIG. 21G, the affiliate can also make donations to registered charities of his or her choice based on commissions earned/received through sales originated through MMVKs installed on his or her blog site. If the affiliate wishes to donate an amount of his or her earned commissions, then he or she are asked how much of their commission wish to donate, and then which charities and in what percentages shall the donation amount be distributed. Donation to charities is strictly optional. Available charities will be those charities registered on the Network.

As indicated in Step 7 of FIG. 21H, at any time, the affiliate can change the position or location of a MMVK set up on his or her blog site.

As indicated in Step 8, FIG. 21I, at any time, the affiliate can change the commission percentages to be donated to any charity, or completely change the charities to receive any commission-based donations earned through the Web-based Brand Marketing Communication Network of the present invention.

Commissions will be tracked by the Affiliate Services application running on the Network Transaction/Commission Tracking and Managemen Server C shown in FIG. 17. Monthly bills will be sent to manufacturers and/or retailers to collect commissions earned by the affiliates for distribution. In a preferred embodiment, commissions owed to affiliates will be wired from the manufacturer or retailer to a bank account managed by a group of trustees for the benefit of affiliates, retailers, manufacturers et al. Commissions and donations will be sent to the appropriate parties on a monthly basis as long as the amount is greater than a predetermined limit (e.g. $10.00). If the amount is less than this limit for the month, then it will be carried forward to the next month. Commissions and donation will begin to be paid after the second month of sign-up.

Description of MMVK-Powered Retail Display Appliance (RDA) Having Bar Code Reading Capabilities to Support Price Look Up Operations

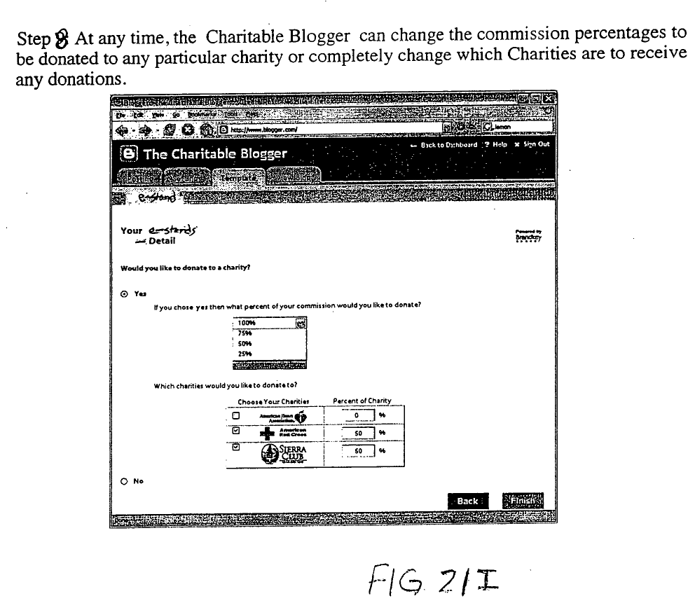

Referring to FIGS. 22 through 24, a Multi-Product MMVK of the present invention executed on a Web-based physical retail display appliance (RDA), with wireless network connectivity to the Internet, will now described.

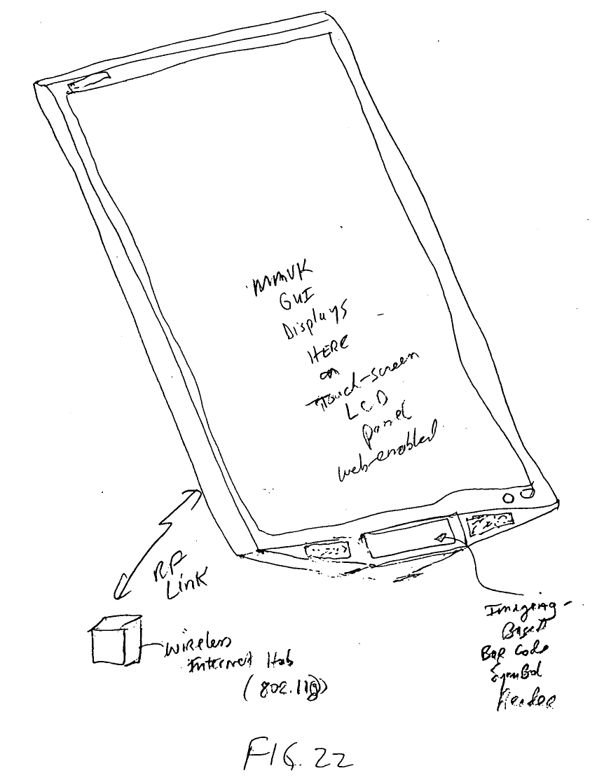

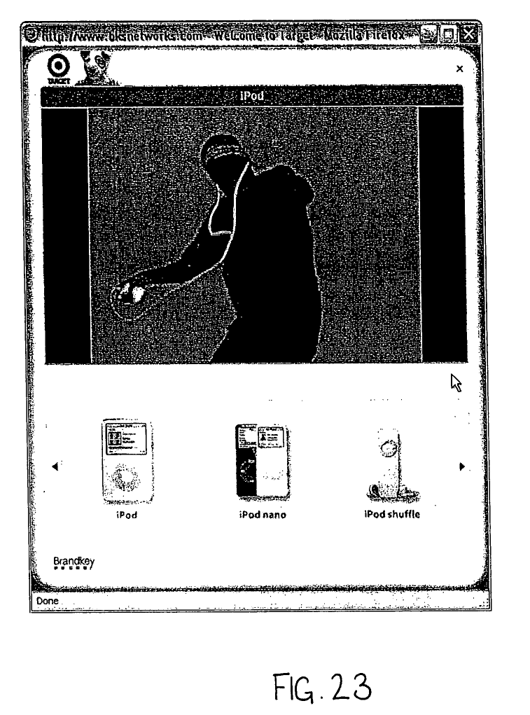

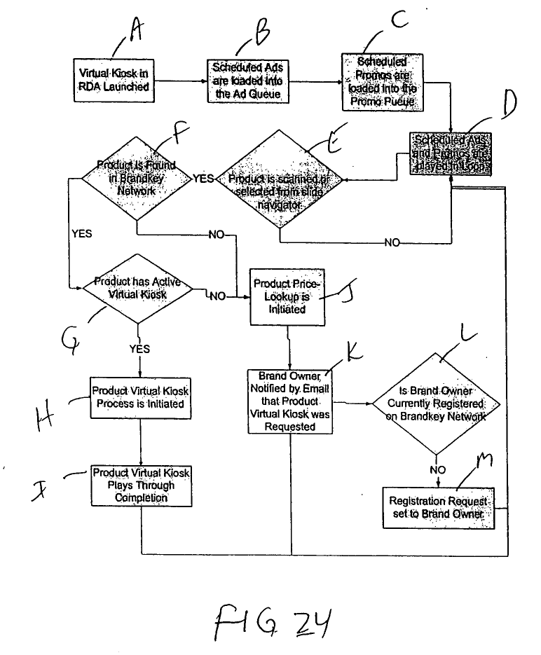

As shown in FIG. 22, the Web-enabled retail display appliance (RDA) of the present invention comprises: a LCD touchscreen panel mounted in an ultra-thin, lightweight housing and having an integrated imaging-based bar code symbol reader for reading UPC symbols on consumer products, and capable of supporting MMVKs of the present invention, including the multi-product MMVK illustrated in FIGS. 23A through 24. In the illustrative embodiment, the Web-enabled RDA of the present invention further comprises a computing platform having a microprocessor, a memory architecture, a system bus, and input/output subsystem supported on a motherboard, as well as an operating system (e.g. OSX, Linux, or MS XP), and software drivers for supporting the LCD touchscreen panel, an imaging-based bar code symbol reader (e.g. Metrologic Focus™ Digital Imaging Bar Code Symbol Reader), network interface card adapter that supports the IEEE 802.11(g) (WiFI) wireless network protocol, and a pair of Web-cameras for detecting the presence of consumers in the field of view (FOV) of the LCD touchscreen display screen. Preferably, the LCD touchscreen display is 8″×10″, which will support at least 800×600 resolution. The computing platform can carry either conventional/flash-based hard drive, adequate memory. The second camera is used to keep track of the number of people who pass by the MMVK on the RDA. By keeping track of not only the number of people interacting with the MMVK, but also the number of people passing the MMVK, the retailer and manufacturer will be able to see how effective the RDA is in any particular retail store environment, and learn from such brand metrics. The system can also interact with the Retailer's inventory control system to calculate the number of products sold in relation to the number of times that product was requested on an RDA.

Once installed and setup, the RDA-hosted MMVK Application is started on this retail appliance. As shown in FIG. 23, programmed advertisements and promotional messages are looped through MMVK on a continual basis. The Brand Marketing Communication Network will be used to enable the retailer to program the initial ad/promo loop, if necessary, free of charge for the retailer.

In the illustrative embodiment, the shopper, when interacting with the MMVK/RDA, can break the ad/promo loop in one of three possible ways:

a) By approaching the RDA to a set distance close to the RDA so that it recognizes that someone is close enough to break the display loop;

b) By taking a consumer product from the shelf and scanning it using its built-in bar-code symbol reader;

c) By selecting a product displayed on the MMVK.

In order for the RDA to automatically recognize that a shopper has approached it to a sufficient distance that the loop should break, the RDA uses one of the built-in cameras mounted on top of the touchscreen display panel. This camera continually captures, buffers and processes images of the FOV of the panel, searching for specific patterns in the captured images that approximate the basic shape of a shopper standing at a specific distance or closer to the RDA and faced in its general direction. Captured and buffered images need only be stored for a short while during image processing and can then be erased thereafter, in the interests of privacy to consumer/shoppers who happen to walk within the FOV of the RDA.

The ad/promo loop of the Multi-Product MMVK will be interrupted when a product is selected from scroll-bar menu, or when the UPC symbol on a consumer product is read by the bar code reader integrated in the RDA shown in FIG. 22. Once the ad/promo loop is broken in this instance, the RDA displays a list of available products in its display. This list can be the full list of products in the general shelf area, a set of products of a particular brand, or other set of products selected on a different criteria. The shopper may select a displayed product by touching its image on the LCD touchscreen display panel. If the shopper swipes the bar-code for a specific product, then the RDA will break the loop of ads/promos currently playing. The system then automatically searches for the selected or swiped product in the RDBMS of the Network. The system will link to the Retailer store database to pull the current price for the selected product. The system will then look for any MMVK that can be displayed for the selected product. The Multi-Product MMVK will then display the price of the scanned product being displayed, along with a programmed image for the selected or scanned consumer product.

If a MMVK has been created for the selected product, then that MMVK is shown to the shopper. However, in the event that no MMVK has been created for the selected product, then the system can display a set of questions for the shopper to answer. The system can also let the shopper know that a further discount can be available to the shopper for answering the questions. The system will then ask the shopper specific questions regarding why they were looking for information on the selected product, what specific information they may have been looking for and possibly any other relevant questions that can be programmed. The System will store the information and on a weekly or monthly basis, a detailed email will be sent to the Retailer as well as all affected Manufacturers that a Virtual Kiosk for these accumulated items was requested, along with the detailed questionnaire answers as filled out by the shoppers.

In FIG. 24, the various states of operation supported by the Multi-Product MMVK are described. As indicated at Block A in FIG. 24, the MMVK (“Virtual Kiosk”) is launched in the RDA of FIG. 22. As indicated at Block B, scheduled ads are loaded into the ad queue of the MMVK running on the RDA. Also, as indicated in Block C, scheduled promos are loaded into the promo queue of the MMVK. At Block D, the MMVK determines whether or not scheduled ads and promos are played in the loop of the MMVK. At Block E, the system determines whether or not a consumer product is scanned by the bar code reader, or selected from the consumer product menu on the MMVK. If not, then the system returns control back to Block D. If a product is scanned or selected at Block E, then the system determines whether or not the product is found in the network RDBMS (i.e. is a registered product on the network). If the scanned product is registered on the network, then at Block H the system initiates the MMVK process for the selected product. Then at Block I, the MMVK plays through completion, and then control returns back to Block D. However, if the scanned or selected product is not registered in the network RDBMS, then the price of the product is looked up in the retailer's price database, and at Block K, the product manufacturer is automatically notified (e.g. by email) that its product has been requested on the Network, but that it is not yet registered thereon, and is therefore invited to register the same on the Network and enjoy the benefits of registration and activation. Thereafter, the system returns to Block D, as shown, Also, if at Block G the system determines that the product is registered on the Network, but that there is no active MMVK for the product (i.e. no programmed BIN for the registered product), then the system proceeds to Block J and looks up the product's price in the price look up database maintained by the retailer.

Property Registration Services Allowing Web-Based Property Owners and/or their Agents to Register Web-Based Properties for Authorized Placement of MMVKs on the Brand Marketing Communication Network of the Present Invention

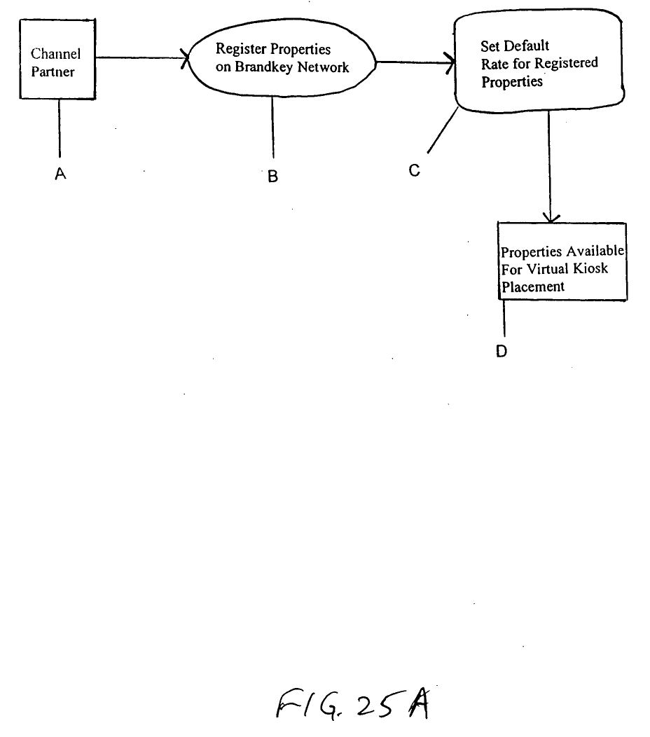

FIG. 25A illustrates a process supported on the marketing communication network of the present invention, whereby a prospective or actual channel partner, wishing to allow manufacturer or service client/brands and their agencies to install MMVKs on their Web-based properties (e.g. online stores, catalogs and the like), logs-into the network of the present invention, and registers its Web-based properties on the network, sets default rates for registered properties, and makes specific parcels of its Web-based properties available for the placement and installation of MMVKs thereon to the agree to MMVK placement fees. At Block B in FIG. 25A, when a Retailer signs up on the Brandkey Network, they are asked to list all their managed properties (websites, etc.). Then at Block C, they are then asked to set a default Virtual Kiosk placement rate for each of their properties. And at Block D, they are asked to specify the properties available for MMVK placement (i.e. MMVK tag installation and MMVK launching).

Placement Fee Negotiation Services Allowing Web-Based Property Owners and/or their Agents to Negotiate Placement Fees for Authorized Placement of MMVKs on Web-Based Properties Registered on the Brand Marketing Communication Network of the Present Invention

FIG. 25B illustrates a process supported on the marketing communication network of the present invention, whereby agencies of a manufacturer brand are enabled to negotiate (with property owner or their agents) final MMVK placement fee rates required to be paid for placing and installing their client/brand's product-specific and brand-specific MMVKs on registered online properties of property owners (e.g. on the product pages of registered online retail stores, catalogs etc).

As shown at Block A in FIG. 25B, the system will allow for Retailers to view properties and default placement fee rates, and and at Block C, if default rates are not acceptable, then for the Retailer or its agent to set up prices for the placement of Virtual Kiosks on their properties. This will be done through a Bid-Acceptance system, illustrated at Blocks D through H. The Retailer can initially set up their Preferred Prices. The Agents can then either accept or give different bids for those Retailers. The Retailers can then either Accept or Reject any bids coming from Agents for placement rights of Virtual Kiosks on their properties.

It is then up to the Agents of the Manufacturers to go into the System and accept or negotiate the Virtual Kiosk placement fees for their Clients with the Retailers. The Agents can view the default rates of the Retailers and then either accept those default rates, or bid on different rates. When an Agent places a bid, then bid goes to the Retailer and it is up to them to either accept or reject the bid as offered by the Agent. If the bid is rejected at Block F, the Retailer can at Block G comment on (i.e. give notice) why the bid was rejected and the process can start over again, at Block Din from the Agent once more. If the bid is accepted, then at Block H the Retailer and Agent will enter into a contract for a specified length of time for the Agent to pay the Retailer the agreed-upon rate for any Virtual Kiosks placed on the Retailers specified property.

In the illustrative embodiment, BKS Networks (i.e. the Network Admin) will act as the intermediary in terms of payment processing for placement fees. The costs for managing the placement fees will be added to the cyclical billing given to Clients. BKS will then receive payment from its Clients for use of the System as well as for the placement fees incurred through their Virtual Kiosk placement. BKS can then forward the placement fees on to the Retailer on a recurring basis.

Retailers will be able to change their rates based on Metrics reporting of usage of the Virtual Kiosks on their properties. Changes will be applicable at the end of each contract for the property. Agents can also request changes to the rate based on their reading of the Metrics reports. If a contract is allowed to expire, then the Virtual Kiosks placed on properties covered by that contract shall be made inactive. Agents will also be able to “ping” the. Script file for each of their Virtual Kiosks during the contract and as long as the Virtual Kiosk is kept active.

Any Client that has an account with BKS Networks that has properties that can host Virtual Kiosks, can set up placement fee structures for their registered properties. Basic Metrics such as Hits, Duration of Stays, and Conversion Rates will be collected and made available to the Agents so that they can better judge the records of the different available properties for hosting MMVKs.

MMVK Placement Services Allowing Client/Brands and/or their Agents to Place MMVKs on Web-Based Properties Registered on the Brand Marketing Communication Network of the Present Invention

FIG. 25C illustrates a process supported on the marketing communication network of the present invention, whereby a client/brand or its agent place generates and installs (i.e. places) a MMVK for its client's product, on one or more Web-based properties that have been registered with the marketing communication network of the present the invention.

As indicated at Block B, the client brand or its agent generates and deploys a MMVK, and at Block C, the System displays a list of Web-based properties on which the property owner and the Network Admin have contracted for the installation of MMVKs for an agreed to placement fee. At Block D, the agent selects one or more registered Web-based properties for installing the deployed MMVK. At Block E, an MMVK installation packaged is sent to the channel partner. Placement Fees should only be applicable to Agencies once the Virtual Kiosk has physically been installed on the designated Property. Therefore, to this end, the installation package for the deployed Virtual Kiosk shall contain a Script file that will respond to specific queries from the System once it is installed in a pre-defined directory on the Retailer's servers. As indicated at Blocks F and G, the System shall request the Script file continuously from the time the Installation package is requested from the System until the time that the Script file sends the appropriate response to the System. At that time, indicated at Block H, the System (i.e. Network) shall begin placement fee rate billing, and cease continuous requests for the Script file and at Blocks I and J, shall request the Script file once a day for as long as the Virtual Kiosk remains active, to ensure that the Virtual Kiosk remains in its designated place for the duration of the contract. If at Block J the MMVK installation confirmation is not received, then at Block K, then the System sends a Missing Installation Report to the agent of record and the retail channel partner on which the MMVK should have been installed. At that instant in time, the System (i.e. Network) automatically initiates a Placement Rate/Fee Billing Credit to the agent of record on behalf of its client.

Automated Work Flow Management Services Allowing Automated Management of Work Flow on the Brand Marketing Communication Network of the Present Invention

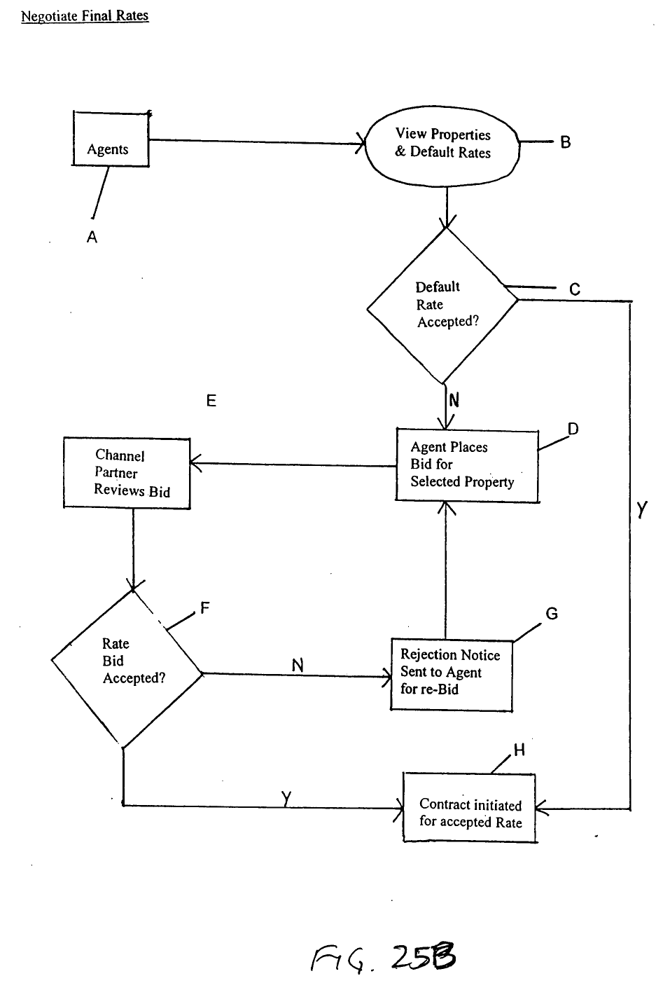

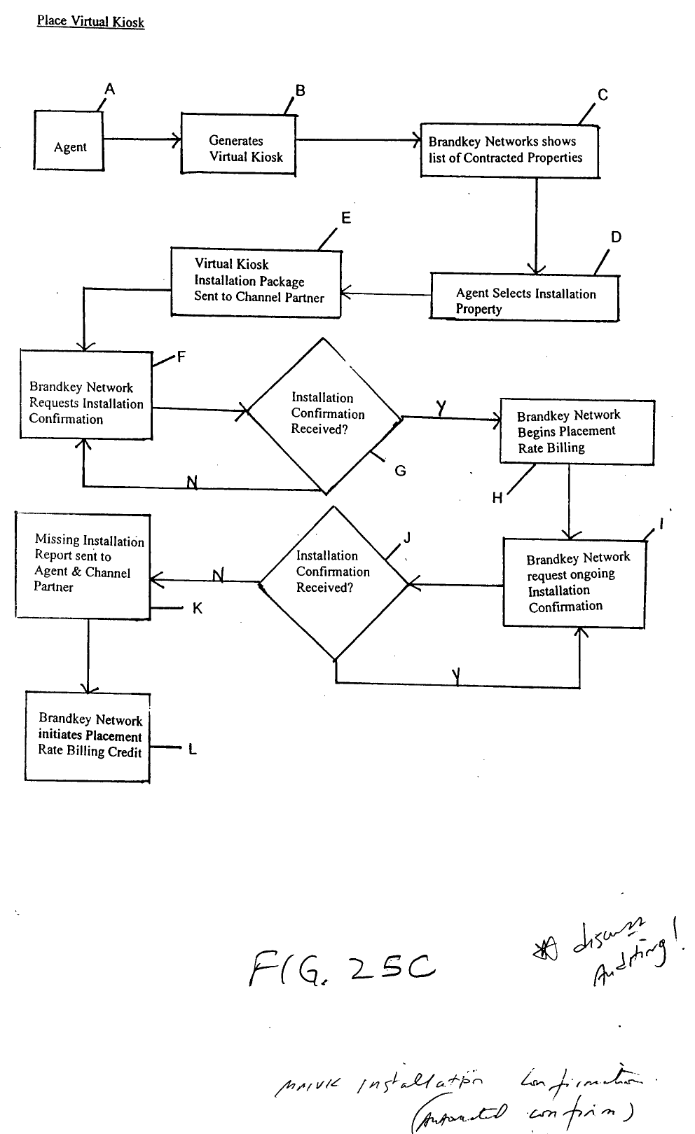

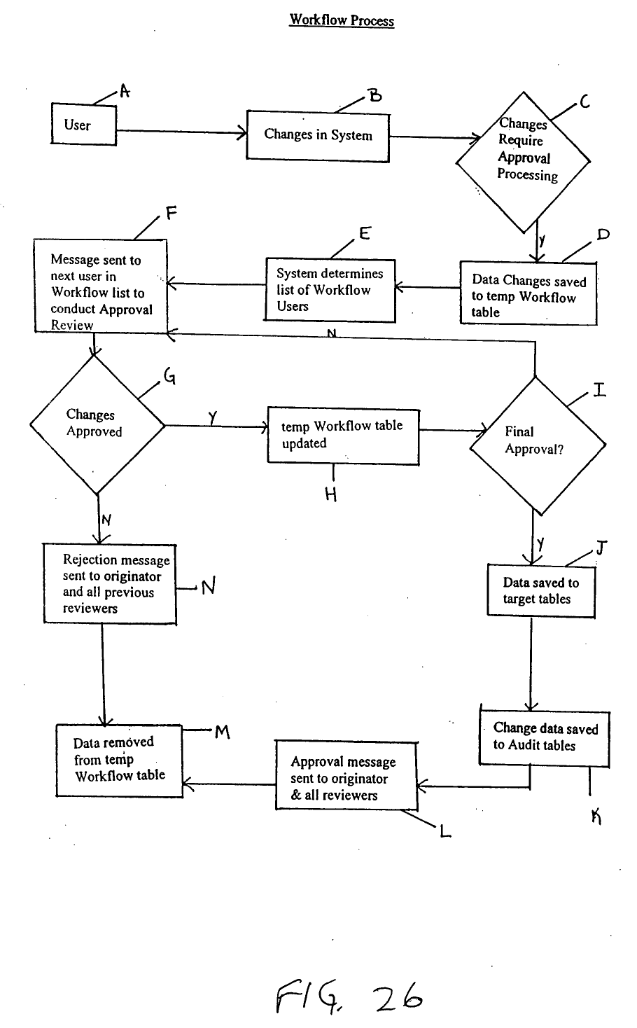

FIG. 26 illustrates the automated work flow (WFA) process supported on the marketing communication network of the present invention, whereby proposed changes to be made to programmed brand-building content contained in installed MMVKs, or changes to be made to the functionalities thereof, are approved by designated users before such changes are made effective on the installed MMVKs for public viewing.

In general, the automated work flow process supported by the System shall allow for the Clients (i.e. users) to be able to set up a Review-Process to take place within the Network on any level of work conducted on the Network (i.e. System) within the Client's Accounts. Such pre-defined review processes will take place and need to be completed before any new assets, such as Virtual Kiosks (i.e. MMVKS), or changes such as new content or Advertisements or Promotions, can go live on any installed Virtual Kiosks.

When the Client signs up to use the Brandkey network, their Account Manager shall ask them to define any Workflow Processes they may wish to implement. Once those processes have been defined for each service provided on the Network, the Account Manager shall enter this information into the Network.

When any change is made as indicated at Block B in FIG. 26, including the generation of a new Virtual Kiosk, the System shall check at Block C whether the service being used requires the following of a Workflow Process. If it does not require Workflow Process, then any new data or changes to the data in the System will simply be saved and any changes will be live immediately.

If a Workflow Process needs to be followed, then at Block D the System shall save the new information in a temporary holding area (e.g. Temporary Workflow Table). Then at Blocks E and F, notices will sent to the first involved person in the Workflow Process for them to review the changes made to the Client data in the System.

When the person comes to review the changes at Block G, then the Network (i.e. System) shall pull the existing data from the RDBMS as usual, and then check for updates in the temporary tables. The data will be updated for review from the temporary tables as required. Whenever changes are not approved at Block G, then the System automatically sends a rejection message to the originator of the change request, as well as all previous reviewers in the Workflow Process.

As indicated at Block G and H, if changes are approved, then the temporary workflow table is updated, and then at Block I, final approved is determined. The System shall then check to determine whether or not there are any more review steps to take. If so, then the process continues, at Blocks F, G and H until the full review workflow has been completed and final approval has been approved. Once the workflow process has been completed, and final approval has been granted at Block I, then System shall save at BLOCK J the data to permanent (target) tables in the RDBMS where the data will be updated, and the new data will go live. Then at Block K, the System saves the changed data to Audit tables within the RDBMS, and sends an approval message to the originator of the data change proposal, and all reviewers within the Workflow Process. Finally at Block M, data is removed or flushed from the temporary Workflow table in the RDBMS.

Automated Auditing of the WorkFlow Process and Other Activities on the Brand Marketing Communication Network of the Present Invention

The System shall allow for complete Auditing Reports to be generated for all Client Accounts. The reason for the need for Auditing Reports is to allow the Client to be able to track what changes were made on their accounts and who made them as well as when they were made. Auditing will also be linked to Workflow Processing so that each change that requires Workflow Processing will be marked as such when the Workflow Process is completed successfully.

The User of a Client Account will go into the System and make changes or create something new such as a Virtual Kiosk on the Network. The System shall go through the Workflow Process if required and once that is complete, the System shall save the new data into the appropriate database tables. The System shall also save the changes into an Auditing table. The System shall record who made the change, when the change was made, what table was affected, what the previous value was, and what the new value has become.

By saving all this information, the System can present reports to queries from Clients regarding changes made in their accounts. The entire histories of Virtual Kiosks, Advertisements, Promotions, Content Links, etc. can be preserved and presented to Clients as and when they are needed.

These and all other such modifications and variations are deemed to be within the scope and spirit of the present invention as defined by the accompanying Claims to Invention.

1-7. (canceled)

8. A Web-based brand marketing communication network, comprising:
a Web-based subsystem for allowing brand management team members to remotely and independently create and deploy a plurality of Web-based Multi-Mode Virtual Kiosks (MMVKs) for a plurality of consumer products that are registered on said network so that said plurality of MMVKs can be installed in and launched from a plurality of HTML-encoded documents accessible on the World Wide Web (WWW) by consumers using a Web browser;
wherein each said MMVK is implemented by (i) a computer-executable server-side component stored on a first Internet-enabled information server operably connected to the WWW, and (ii) a MMVK tag that references said computer-executable server-side component and is embeddable within any said HTML-encoded document, and
wherein each said MMVK, when generated by said first Internet-enabled information server, has a graphical user interface (GUI) that is characterized by a plurality of independently programmable display modes selected from the group consisting of (i) an advertising display mode for displaying one or more advertising spots, (ii) a promotional display mode for displaying one or more promotional spots, (iii) a brand information display mode for displaying a set of consumer product information resources arranged for selection by the consumer; and (iv) a consumer-generated content (CGC) display mode for displaying consumer-generated or selected content;
a second Web-based subsystem for allowing brand management team members to remotely and independently program said set of consumer product information resources displayable during said brand information display mode of each said installed MMVK; and
a third Web-based subsystem for allowing members of the brand management team to remotely and independently program the advertising and promotional display modes of each MMVK with one or more advertising and promotional spots, as a given application may require; and
a fourth Web-based subsystem for allowing consumers to remotely and independently program the CGC display modes of each MMVK with consumer generated or selected content;
wherein, upon the Web-browser of the consumer encountering one said MMVK tag installed in one said HTML-encoded document, the computer-executable server-side component corresponding to the MMVK tag is automatically executed and the corresponding MMVK is generated by said first Internet-enabled information server and served to the Web browser for display and review by the consumer.

9. The Web-based brand communication network of claim 8, wherein said second Web-based subsystem allows members of the brand management team of any registered consumer product to create and manage, for each registered consumer product, a brand information network (BIN) link structure comprising the following items:
(i) a Universal Product Number (UPN) assigned to the consumer product;
(ii) a Trademark (TM) assigned to the consumer product; and
(iii) a set of URLs for a plurality of brand information resources located on the WWW, that can be selected to program said set of consumer product information resources for the consumer product.

10. The Web-based brand communication network of claim 9, wherein, for each MMVK created and deployed for a registered consumer product on said network, the computer-executable server-side component associated with the MMVK comprises the UPN assigned to the consumer product.

11. The Web-based brand communication network of claim 9, wherein, for each MMVK created and deployed for a registered consumer product on said network, the MMVK tag associated with the MMVK is indexed using the UPN assigned to the registered consumer product.

12. The Web-based brand communication network of claim 8, wherein, for each MMVK created and deployed for a particular consumer product on said network, the computer-executable server-side component associated with the MMVK comprises a consumer product information (CPIR) requesting servlet loaded onto said first Internet-enabled information server.

13. The Web-based brand communication network of claim 9, wherein said BIN link structure further comprises, for each consumer product,
(iv) a Product Descriptor (PD) associated with the consumer product; and
(v) a set of display attributes associated with each consumer product information resource in said CPI link structure.

14. The Web-based brand marketing communication network of claim 8, wherein said set of consumer product information resources are selected from the group consisting of product videos, audio files, product images, product specifications, product advertisements, and product promotions.

15. The Web-based brand communication network of claim 13, wherein said set of display attributes are selected from the group consisting of text for said URLs, graphical icons displayed next to said URLs, and sound files associated with said URLs.

16. The Web-based brand communication network of claim 9, wherein after a BIN link structure has been initially created for a registered consumer product using said second Web-based subsystem, then a member of the brand management team can create and deploy one or more MMVKs for the registered consumer product using said first Web-based subsystem, and then program the advertising and promotional display modes of said one or more MMVKs.

17. The Web-based brand communication network of claim 8, wherein said HTML-encoded documents are selected from the group consisting of Web pages, product images, product documents, and graphical icons.

18. The Web-based brand communication network of claim 8, wherein said HTML-encoded documents are associated with an e-commerce site of a retailer.

19. The Web-based brand communication network of claim 13, wherein said Universal Product Number (UPN), said Trademark (TM) and said Product Descriptor (PD) associated with each said BIN link structure are imported into said network from the manufacturer's supply-chain information management system using electronic file transfer techniques.

20. The Web-based brand communication network of claim 8, wherein the Web browser of the consumer is supported on a client computing machine selected from the group consisting of a desktop computer, a portable computer, a portable digital assistant (PDA), and mobile computer, and physical retail kiosk.

21. The Web-based brand communication network of claim 8, which further comprises a second Internet-enabled information server for serving a library of MMVK tags on the WWW for said plurality of consumer products registered with said network; and wherein each said MMVK tag in said library is accessible from said second Internet-enabled information server for installation in an HTML-encoded document by embedding the MMVK tag in the HTML-based document.

22-36. (canceled)

37. An Internet-based brand marketing communication network for managing and delivering brand marketing communications over brand marketing communication channels (BMMCs) to consumers present along E-Commerce (EC) enabled marketspace on the World Wide Web (WWW), including EC-enabled WWW-sites, EC-enabled stores and EC-enabled online product catalogs, said Internet-based brand marketing communication network comprising:
a plurality of e-commerce platforms supporting a plurality of EC-enabled market spaces selected from the group consisting of EC-enabled WWW-sites, EC-enabled stores and EC-enabled online product catalogs, wherein each said EC-enabled market space includes a plurality of HTML-encoded pages containing images and/or text descriptions of consumer products which are offered for sale through said EC-enabled market space;
a first Internet-based subsystem for allowing brand management team members, associated with a particular consumer product or group of consumer products, and/or authorized parties, to create and deploy a plurality of Internet-based Multi-Mode Virtual Kiosks (MMVKs) for a plurality of consumer products that are marketed on said Internet-based brand marketing communication network, so that said plurality of MMVKs can be installed in and launched from a plurality of said HTML-encoded pages located in said EC-enabled market space, and accessible by consumers using a Web browser;
wherein each said MMVK is implemented by (i) a computer-executable server-side component stored on a first Internet-enabled information server operably connected to the WWW, and (ii) a MMVK tag that references said computer-executable server-side component and is embeddable within any of said HTML-encoded pages located in said EC-enabled market space;
wherein each said MMVK, when generated by said first Internet-enabled information server, has a graphical user interface (GUI) that is characterized by a plurality of independently programmable display modes selected from the group consisting of (i) an advertising display mode for displaying one or more advertising spots, (ii) a promotional display mode for displaying one or more promotional spots, (iii) a brand information menu display mode for displaying a set of brand-building information resources arranged for selection by the consumer using said Web browser, and (iv) a consumer-generated content (CGC) display mode for displaying consumer-generated or selected content
wherein each said installed MMVK establishes one said brand marketing communication channel (BMMC) between members of said brand management team and the EC-enabled market space where said MMVK is installed;
a plurality of Internet-based information servers operably connected to the WWW, for storing and serving said one or more advertising spots, said one or more promotional spots and said set of brand-building information resources to said Web browser, for display to the consumer through said plurality of independently programmable display modes of each said MMVK;
a second Internet-based subsystem for allowing brand management team members and/or their agents to independently program said set of brand building information resources displayable during said brand information menu display mode of each said installed MMVK; and
a third Internet-based subsystem for allowing members of the brand management team to independently program the advertising and promotional display modes of each MMVK with one or more advertising and promotional spots, as a particular marketing and/or merchandising program may require;
a fourth Web-based subsystem for allowing consumers to remotely and independently program the CGC display modes of each MMVK with consumer generated or selected content;
wherein, upon the Web-browser of the consumer encountering one said installed MMVK tag along said EC-enabled market space, the computer-executable server-side component corresponding to the MMVK tag is automatically executed and the corresponding MMVK is generated by said first Internet-enabled information server and served to the Web browser, for display of said display modes in a programmed display order, and review by the consumer at the EC-enabled market space.

38. The Internet-based brand marketing communication network of claim 37, wherein said second Internet-based subsystem allows members of the brand management team of any consumer product to create and manage, for each consumer product, a brand information network (BIN) comprising the following items:
(i) a Universal Product Number (UPN) assigned to the consumer product;
(ii) a Trademark (TM) assigned to the consumer product; and
(iii) a set of URLs for a plurality of brand-building information resources located on the WWW, that can be selected to program said set of consumer product information resources for the consumer product.

39. The Internet-based brand marketing communication network of claim 37, wherein, for each MMVK created and deployed for a consumer product on said Internet-based brand marketing communication network, the computer-executable server-side component associated with the MMVK comprises the UPN assigned to the consumer product.

40. The Internet-based brand marketing communication network of claim 37, wherein, for each MMVK created and deployed for a consumer product on said Internet-based brand marketing communication network, the MMVK tag associated with the MMVK is indexed using the UPN assigned to the consumer product.

41. The Internet-based brand marketing communication network of claim 37, wherein, for each MMVK created and deployed for a particular consumer product on said Internet-based brand marketing communication network, the computer-executable server-side component associated with the MMVK comprises a MMVK-enabling servlet loaded onto said first Internet-enabled information server.

42. The Internet-based brand marketing communication network of claim 38, wherein said BIN further comprises, for each consumer product,
(iv) a Product Descriptor (PD) associated with the consumer product; and
(v) a set of display attributes associated with each brand-building information resource in said BIN.

43. The Internet-based brand marketing communication network of claim 37, wherein said set of brand-building information resources are selected from the group consisting of product videos, audio files, product images, product specifications, product advertisements, and product promotions.

44. The Internet-based brand marketing communication network of claim 42, wherein said set of display attributes are selected from the group consisting of text for said URLs, graphical icons displayed next to said URLs, and sound files associated with said URLs.

45. The Internet-based brand marketing communication network of claim 38, wherein after a brand information network (BIN) has been initially created for a consumer product using said second Internet-based subsystem, then a member of the brand management team can create and deploy one or more MMVKs for the consumer product using said first Internet-based subsystem, and then program the advertising and promotional display modes of said one or more MMVKs.

46. The Internet-based brand marketing communication network of claim 42, wherein a supply-chain information management system is used to import said Universal Product Number (UPN), said Trademark (TM) and said Product Descriptor (PD) associated with each said BIN, into said Internet-based brand marketing communication network.

47. The Internet-based brand marketing communication network of claim 37, wherein the Web browser of the consumer is supported on a client computing machine selected from the group consisting of a desktop computer, a portable computer, a portable digital assistant (PDA), and mobile computer, cell phone, and physical retail kiosk.

48. The Internet-based brand marketing communication network of claim 37, wherein said Web browser of the consumer encountering one said MMVK tag further comprises the consumer clicking on a graphical component at which said MMVK tag is embedded in said HTML-encoded page.

49. The Internet-based brand marketing communication network of claim 37, wherein the GUI of one or more of said MMVKs includes a call to action button, which when selected by a consumer automatically displays an associated HTML-page enabling the consumer to act upon the consumer product associated with said MMVK.

50. The Internet-based brand marketing communication network of claim 37, wherein said call to action button is a Buy Now button, which enables consumers to purchase the consumer product associated with said MMVK.

51. The Internet-based brand marketing communication network of claim 37, wherein the GUI of one or more of said MMVKs includes a Send to Friend button, which when selected by a consumer automatically displays an associated HTML-page within the GUI of said MMVK, enabling the consumer to send the MMVK to a friend, associate or other person, by way of email transmission.

52. The Internet-based brand marketing communication network of claim 37, wherein the brand information networks (BINs) of multiple consumer products are used to program at least one said MMVK with brand marketing communications associated with said multiple consumer products.

53. The Internet-based brand marketing communication network of claim 52, wherein said multiple consumer products are marked with a common trademark that is associated with a single product brand.

54-81. (canceled)
